(19) United States
(12) Patent Application Publication
(10) Pub. No.: US 2008/0003043 A1
(43) Pub. Date: Jan. 3, 2008

(54) APPARATUS FOR PRODUCING A LABEL, APPARATUS FOR DETECTING A MARK, APPARATUS FOR DETECTING A TAPE END, CARTRIDGE FOR PRODUCING A LABEL ROLL OF TAPE FOR PRODUCING A LABEL, AND MARKED TAPE

(76) Inventors: Tomoyasu Fukui, Inuyama-shi (JP); Takuya Nagai, Nagoya-shi (JP); Yoshinori Maeda, Nagoya-shi (JP); Mitsugi Tanaka, Nagoya-shi (JP); Hiroshi Miyashita, Nagoya-shi (JP)

Correspondence Address: BAKER BOTTS LLP;C/O INTELLECTUAL PROPERTY DEPARTMENT, THE WARNER, SUITE 1300, 1299 PENNSYLVANIA AVE, NW, WASHINGTON, DC, 20004-2400, US

(21) Appl. No.: 11/767,119

(22) Filed: Jun. 22, 2007

Related U.S. Application Data
(63) Continuation-in-part of application No. PCT/JP2005/023867, filed on Jan. 27, 2005.

(30) Foreign Application Priority Data
Jan. 14, 2005 (JP) 2005-007361
Jan. 25, 2005 (JP) 2005-017492
Apr. 15, 2005 (JP) 2005-117707
Dec. 28, 2004 (JP) 2004-380321
Dec. 27, 2004 (JP) 2004-376906

(51) Int. Cl. B41J 11/00

(52) U.S. Cl. 400/615.2

(57) ABSTRACT

An apparatus for producing a label prevents malfunctions and/or inappropriate operations possibly associated with respective processes in a label producing procedure. An adhesive layer of a base tape is wound around the peripheral surface of a first reel member to form a base tape roll. A print-receiving tape is wound around the peripheral surface of a second reel member to form a print-receiving tape roll. The two rolls are placed in a cartridge which is then loaded into the apparatus for producing a label. The base tape and print-receiving tape are fed out from the base tape roll and print-receiving tape roll, respectively, while a predetermined character is printed on the print-receiving tape. The printed print-receiving tape is bonded to the base tape to produce a RFID label. The first reel member associated with the base tape roll included in the cartridge is formed with a groove or a projection on the peripheral surface thereof.

### CROSS-REFERENCE TO RELATED APPLICATION

This is a CIP application PCT/JP2005/023867, filed Dec. 27, 2005, which was not published under PCT article 21 (2) in English and claims the benefits of Japanese Patent application No. 2005-07361 filed Jan. 14, 2005, No. 2005-017492 filed Jan. 25, 2005, No. 2004-380321 filed Dec. 28, 2004, No. 2004-376906 filed Dec. 27, 2004, and No. 2005-117707 filed Apr. 15, 2005.

### BACKGROUND OF THE INVENTION

1. Field of the Invention

The present invention relates to an apparatus for producing a label for sequentially producing labels, apparatus for detecting a mark configured to detect a mark and a tape end of a marked tape included in the apparatus for producing a label, and a cartridge for producing a label, a roll of tape for producing a label, and a marked tape for use in the apparatus for producing a label.

2. Description of the Related Art

An apparatus for producing a label prints desired characters on a tape, i.e., a print-receiving material which is contained in a cartridge in a rolled shape, and discharges the printed tape cut into a label, as is conventionally known in the art. The apparatus for producing a label comprises a rolled base tape and a rolled print-receiving tape which is to be adhered to the base tape. The apparatus for producing a label prints predetermined characters on the print-receiving tape, while feeding out the base tape and print-receiving tape from the respective rolls, and adheres the printed print-receiving tape to the base tape to produce a label.

In the apparatus for producing a label as described above, when labels are produced while the base tape and print-receiving tape are fed out, the tapes are eventually fed out and consumed to the ends of the tapes at which the apparatus for producing a label can no longer produce any labels.

Patent Publication 1, for example, describes a tape handling approach for handling such a tape when it reaches its end. Specifically, when a rolled tape (strip film) is fixed to a roll core (paper tube) at its end, a web end detecting apparatus disclosed therein detects that the tape is approaching to its end, based on fluctuations of an intermediate roller (dancer roller) disposed in a feeding path, and stops transporting the tape, thereby preventing the tape from being torn from the roll core.

Patent Publication 2, for example, describes another tape handling approach for handling a tape when it reaches its end. Specifically, a light reflection tape made of a metal tape having a high light reflectivity is attached at the end of a base tape in a tape transport direction, such that the metal tape is detected by a detecting device (tape end sensor) in a tape printing apparatus, thereby detecting that the tape is approaching to its end.

Patent Publication 2 also proposes mark-based approaches for controlling a print start timing when a label is produced and for controlling positioning when the tape is cut. Specifically, an identification mark (sensor mark) represented by a black line has been previously printed on one side of a print-receiving tape. The apparatus for detecting a tape end detects this identification mark by a detecting device (tape sensor), and conducts the foregoing control in accordance with the detected identification mark.

In recent years, RFID (Radio Frequency Identification) systems permit a compact RFID label and a reader (reading device)/writer (writing device) to read/write information therebetween in a non-contact fashion, as is also known in the art. A RFID circuit element contained in the RFID label comprises an IC circuit part configured to store predetermined RFID tag information, and an antenna connected to the IC circuit part configured to transmit/receive information. Since the reader/writer can access RFID tag information in the IC circuit part (for reading or writing information) even if the RFID label is soiled or is positioned at a site at which the RFID label is invisible. With such usefulness, the RFID system is expected to be applied to practical use in a wide variety of fields such as commodity management, inspection process, and the like.

The configuration of the apparatus for producing a label, described above, may be applied for producing such a RFID label. Specifically, an elongated tag tape is mounted with RFID circuit elements at predetermined intervals in the longitudinal direction of the tape. The tag tape is fed out from a tag tape roll to transport each RFID circuit element along the longitudinal direction of the tape. During the transport, predetermined RFID tag information generated in an apparatus for producing RFID label is transmitted to each RFID circuit element through an antenna of the apparatus and an antenna of the RFID circuit element to sequentially write the RFID tag information into an IC circuit part of the RFID circuit element connected to the antenna (or RFID tag information stored in the IC circuit part is read). Subsequently, after the RFID tag information has been written into (or read from) the RFID circuit element, the RFID circuit element is transported downstream in the transport direction. Next, print information is printed on the surface of the tag tape by a printing device such as a print head. The print information corresponds to the RFID tag information written into (or read from) the RFID circuit element. Then, the tag tape is cut by a cutter such as a cutter into a label of a predetermined length, thus completing a RFID label.

For cutting a tape fed out from a roll in the foregoing manner to sequentially and efficiently produce labels, the accent is placed on cut position control for controlling a cutter to cut an appropriate position of a transported tape. Techniques related to such cut position control are proposed, for example, by Patent Publication 3.

Patent Publication 3 relates to a laminating apparatus configured to sandwich a form such as a document, a card and the like with a pair of adhesive sheets from above and below to produce a laminated sheet. The pair of upper and lower adhesive sheets are fed out from an adhesive sheet roll disposed above a form feeding path and from another adhesive sheet roll disposed below the form feeding path, respectively. The resulting three-layer laminated body made up of the upper adhesive sheet, form, and lower adhesive sheet are cut by a cutter blade. When the upper or lower adhesive sheet is made of a thick magnet sheet, the laminating apparatus is controlled to avoid cutting the laminate but cut a two-layer laminated portion made up of the upper and lower adhesive sheets without the form, thereby preventing jamming of the tape due to malfunctions of a feeding motor and cutting failures.

Patent Publication: JP,A, 10-129631;

Patent Publication: JP,A, 7-214876; and

Patent Publication: JP,A, 2001-96617.

The prior art techniques described above present the following challenges.

In the label producing apparatus which adheres two tapes (base tape and print-receiving tape) to produce a label as described above, the two tapes may not match in length, in which case, one tape has fed out from the roll to the end whereas the other tape still remains and is being fed out. In such a scenario, the remaining tape which is being fed out can have nowhere to go, and stay in a space near the roll to cause a jam. The web end detecting method and apparatus described in Patent Publication 1 do not particularly take into consideration such two tapes fed from respective rolls and therefore fails to prevent the jamming. On the other hand, when a mark made of a different material is attached to the end of a tape as described in Patent Publication 2, extra steps are required for attaching such a mark on the tape, resulting in an increase in manufacturing efforts and cost.

In recent years, one side of a tape or a label (for example, the opposite side to the printed side, i.e., the side on which the identification mark is attached) is not left blank, but predetermined decorative marks (for example, enterprise logo, product log, character design, and the like) have been increasingly printed on that side for purposes of advertising effects, users' enjoyment and the like. In this event, such a decorative mark is printed on the one side together with the identification mark. Therefore, when the identification mark is relied on to conduct a variety of control operations for producing labels as described in Patent Publication 2, the detecting device will experience difficulties in distinguishing the identification mark from the decorative mark unless appropriate actions are taken therefor, and the detecting device can fail to reliably recognize the identification mark. Consequently, the tape printing apparatus experiences difficulties in the print start timing control and tape cut positioning control based on the identification mark, and possibly suffers from a lower accuracy.

In the laminating apparatus described in Patent Publication 3, supposing that the cutter successfully cuts the three-layer laminated portion including the magnet sheet, the laminate or product is not particularly involved in any problem. However, actually, the laminating apparatus avoids cutting the three-layer laminated portion in order to escape troubles in the motor due to the lack of its tape feeding capabilities, or tape jamming due to inappropriate pausing of the transport or cutting of the cutter resulting from the motor troubles. In other words, the three-layer laminated portion can be cut off if an extra approach is provided for avoiding troubles as described above (for example, by use of a more powerful motor).

On the other hand, for producing a RFID label as described above, the tag producing apparatus forces the cutter to cut an elongated tag tape, which comprises RFID circuit elements arranged at predetermined intervals in the longitudinal direction thereof, to a predetermined length to produce a RFID label, i.e., a product which contains a RFID circuit element. In this event, if the cutter cuts part of an IC circuit part or an antenna of the RFID circuit element by mistake, the resulting RFID label can no longer serve as it should. Accordingly, the cutter must avoid such erroneous cutting and cut the tape at a correct position. Patent Publication 3 does not disclose such cut position control for keeping normal the essential functions of a product itself.

As will be appreciated from the foregoing, the respective prior art techniques experience difficulties in preventing malfunctions and inappropriate operations, such as tape jamming (erroneous transport), failure in detection of a mark or tape end (erroneous detection), cutting of a RFID circuit element (erroneous cutting), during a sequence of label producing procedures of the label producing apparatus, which include operations for transporting tapes while detecting appropriate marks, performing predetermined processing such as printing, and cutting the tapes to form a label.

### SUMMARY OF THE INVENTION

It is a first object of the present invention to provide a label producing apparatus which is capable of preventing erroneous operations and/or inappropriate operations in respective processes performed in a label producing procedure, apparatuses included in or associated with the label producing apparatus configured to detect a mark and a tape end of a marked tape, and a cartridge for producing a label, a roll of tape for producing a label, and a marked tape for use in the label producing apparatus.

It is a second object of the present invention to provide a label producing apparatus which is capable of preventing a tape from jamming in a space near a roll within the label producing apparatus, thereby preventing erroneous operations and/or inappropriate operations in a transport process, a roll of tape for producing a label, and a cartridge for producing a label for loading the roll of tape for producing a label therein.

It is a third object of the present invention to provide a label producing apparatus which is capable of preventing erroneous operations and/or inappropriate operations in a detecting process by reliably recognizing an identification mark even if a decorative mark is borne on a tape surface together with the identification mark, a marked tape, and an apparatus for detecting a mark configured to detect a marked tape.

It is a fourth object of the present invention to provide a label producing apparatus which is capable of preventing erroneous operations and/or inappropriate operations in a detecting process by taking an appropriate actions at the end of a tape configured to detect the tape end in a simple manner and at a low cost, a roll of tape for producing a label, and an apparatus for detecting a tape end.

It is a fifth object of the present invention to provide a label producing apparatus which is capable or sequentially and efficiently producing RFID labels while preventing erroneous operations and/or inappropriate operations in a cutting process, which could result in erroneous cutting of an IC circuit part or an antenna in a RFID circuit element.

### BRIEF DESCRIPTION OF THE DRAWINGS

FIG. 1 is a diagram generally illustrating the configuration of a RFID tag manufacturing system to which a label producing apparatus having a roll of tape for producing a label is applied in accordance with a first embodiment of the present invention.

FIG. 2 is a conceptual diagram representing the configuration of the label producing apparatus shown in FIG. 1 in greater detail.

FIG. 3 is a top plan view illustrating the outer appearance and structure of the label producing apparatus shown in FIG. 1.

FIG. 4 is a perspective view illustrating the outer appearance and structure of the label producing apparatus shown in FIG. 1.

FIG. 5 is an explanatory diagram conceptually illustrating the structure of a cartridge shown in FIG. 2 together with the detailed structure of a base tape in enlarged view.

FIG. 6 is a top plan view illustrating in detail the structure of a reel member of a base tape roll.

FIG. 7 is a perspective view generally illustrating the structure of the reel member of the base tape roll.

FIG. 8 is an enlarged view of a portion P in FIG. 6.

FIG. 9 is a functional block diagram illustrating functions of a radio frequency circuit shown in FIG. 2 in detail.

FIG. 10 is a functional block diagram illustrating functional components of a RFID circuit element.

FIG. 11A, 11B are a top plan view and a bottom plan view illustrating the appearance of an exemplary RFID label.

FIG. 12 is a cross-sectional view taken along a line XII-XII′ in

FIG. 13 is a diagram illustrating an exemplary screen displayed on a terminal or a general purpose computer when RFID tag information is written or read.

FIG. 14 is a flow chart illustrating a control procedure executed by a control circuit shown in FIG. 2.

FIG. 15 is a flow chart illustrating in detail a procedure in step S1200 in FIG. 14.

FIG. 16A-C are diagrams conceptually illustrating the shape of a reel in the first embodiment of the present invention, the shape of a reel in an exemplary modification, and the shape of a reel in another exemplary modification.

FIG. 17 is a flow chart illustrating a RFID tag information reading and printing procedure executed by the control circuit.

FIG. 18A, 18B are cross-sectional view schematically illustrating a base tape roll loaded in a label producing apparatus according to the second embodiment of the present invention, and a cross-sectional view schematically illustrating the end of the base tape.

FIG. 19A, 19B are cross-sectional views schematically illustrating the structure of an exemplary modification to the base tape roll.

FIG. 20A, 20B are cross-sectional views schematically illustrating an exemplary modification to the end of the base tape.

FIG. 21 is a conceptual diagram illustrating in detail the configuration of a label producing apparatus according to a third embodiment of the present invention.

FIG. 22 is an explanatory diagram for describing in detail the structure of a cartridge shown in FIG. 21.

FIG. 23 is a diagram viewed from a direction indicated by an arrow E in FIG. 22.

FIG. 24A, 24B are a top plan view and a bottom plan view illustrating the appearance of an exemplary RFID label.

FIG. 25 is a cross-sectional view taken along a section XXV-XXV′ in FIG. 24.

FIG. 26 is a flow chart illustrating a control procedure executed by the control circuit.

FIG. 27 is a flow chart illustrating in detail a procedure at step S200 in FIG. 26.

FIG. 28 is a flow chart illustrating a control procedure executed by the control circuit in an exemplary modification for writing information into a RFID circuit element.

FIG. 29 is a flow chart illustrating in detail a procedure at step S200A in FIG. 28.

FIG. 30 is an explanatory diagram for describing in detail the structure of an exemplary modification to the cartridge which eliminates bonding.

FIG. 31 is a top plan view seen from a direction indicated by an arrow E′ in FIG. 30.

FIG. 32 is an explanatory diagram for describing in detail the structure of an exemplary modification to the cartridge, which has a blank mark borne at least before or after an identification mark.

FIG. 33 is a to plan view seen from a direction indicated by an arrow E″ in FIG. 32.

FIG. 34A, 34B are a top plan view and a bottom plan view illustrating the appearance of an exemplary RFID label.

FIG. 35 is a diagram illustrating an exemplary signal detected by a sensor.

FIG. 36 is a diagram illustrating in detail the structure of an exemplary modification to the base tape which has an identification mark slantly borne thereon, as viewed from one side thereof.

FIG. 37A, 37B are explanatory diagrams illustrating behaviors for printing the identification mark by a rolled printing master.

FIG. 38A, 38B are a top plan view and a bottom plan view illustrating the appearance of an exemplary RFID label which has a separation sheet in an inverted color.

FIG. 39 is an explanatory diagram for describing in detail the structure of a cartridge loaded in a RFID label producing apparatus according to a fourth embodiment of the present invention.

FIG. 40 is a top plan view seen from a direction indicated by an arrow E in FIG. 39.

FIG. 41 is a diagram illustrating the structure of a base tape shown in FIG. 40 near the end in the feeding direction.

FIG. 42A, 42B are a top plan view and a bottom plan view illustrating the appearance of an exemplary RFID label.

FIG. 43 is a cross-sectional view taken along a section XXXXIII-XXXXIII′ in FIG. 42.

FIG. 44 is a flow chart illustrating a control procedure executed by the control circuit.

FIG. 45 is a diagram illustrating the structure the base tape which has an incision (cutout) in different shape and manner in of an exemplary modification.

FIG. 46 is a diagram illustrating the structure of the base tape which has an incision (cutout) in different shape and manner in another exemplary modification.

FIG. 47 is a diagram illustrating the structure of the base tape near the end in an exemplary modification which involves detection of a released tape end.

FIG. 48 is a table stored in the control circuit for recognizing that a released end is the tape end.

FIG. 49 is a diagram illustrating a control procedure executed by the control circuit.

FIG. 50 is a diagram illustrating an exemplary modification in which an incision is further formed in the straight free end side.

FIG. 51 is an explanatory diagram for describing in detail the structure of a cartridge in an exemplary modification which employs a light absorbing device.

FIG. 52 is an explanatory diagram for describing in detail the structure of the cartridge in an exemplary modification which employs a reflector.

FIG. 53 is a flow chart illustrating a control procedure executed by the control circuit in an exemplary modification when information is written into the RFID circuit element.

FIG. 54 is an explanatory diagram illustrating in detail the structure of the cartridge in an exemplary modification which omits the bonding.

FIG. 55 is a top plan view (illustrating near the tape end) seen from a direction indicated by an arrow E′ in FIG. 54.

FIG. 56 is a perspective view generally illustrating an exemplary modification to the label producing apparatus which employs a tape which does not contain tags.

FIG. 57 is a perspective view illustrating the label producing apparatus of FIG. 56 when an upper cover is removed.

FIG. 58 is a side view of the structure illustrated in FIG. 57.

FIG. 59 is a cross-sectional view taken along a section X-X′ in FIG. 58.

FIG. 60A, 60B are a perspective view illustrating the label producing apparatus of FIG. 56 when the upper cover and a tag tape roll are removed therefrom, and an enlarged perspective view of a portion W in FIG. 58A.

FIG. 61 is a rear perspective view illustrating the label producing apparatus of FIG. 56 when the upper cover is removed therefrom.

FIG. 62 is a side sectional view illustrating the label producing apparatus of FIG. 56 in which a tape holder is mounted, when the upper cover is removed therefrom.

FIG. 63 is a conceptual diagram illustrating a control system of the label producing apparatus illustrated in FIG. 56.

FIG. 64A, 64B are a perspective view taken from upper front and a perspective view taken from lower rear, illustrating in detail the structure of a tag roll tape which is loaded in the label producing apparatus illustrated in FIG. 56.

FIG. 65A, 65B are a perspective view taken from a diagonally rear side and a perspective view taken from a diagonally front side, illustrating a tape holder.

FIG. 66A-C are a left side view, a front view, and a right side view illustrating in detail the structure of the tape holder.

FIG. 67 is a cross-sectional view taken along a section Y-Y′ in FIG. 66A.

FIG. 68 is a cross-sectional view taken along a section Z-Z′ in FIG. 66A.

FIG. 69A-E are diagrams illustrating examples of sensor holes indicative of the type of a tag tape for a tape discriminator of a positioning/holding member.

FIG. 70A, 70B are explanatory diagrams for describing an exemplary operation for loading a tape holder into the label producing apparatus.

FIG. 71A, 71B are a top plan view and a bottom plan view illustrating the appearance of an exemplary label.

FIG. 72 is a cross-sectional view taken along a section XXXXXXXII-XXXXXXXII′ in FIG. 71.

FIG. 73 is a flow chart illustrating a control procedure executed by the control circuit.

FIG. 74 is a perspective view illustrating a RFID label producing apparatus according to a fifth embodiment of the present invention when an upper cover is removed therefrom.

FIG. 75 is a side view of the structure illustrated in FIG. 74.

FIG. 76 is a cross-sectional view illustrating the apparatus for producing a label of FIG. 74, loaded with the tape holder, when the upper cover is removed therefrom.

FIG. 77 is a conceptual diagram illustrating a control system of the apparatus for producing a label.

FIG. 78A, 78B are a top plan view and a bottom plan view illustrating the appearance of an exemplary RFID label T.

FIG. 79 is a cross-sectional view taken along a section XXXXXXXIX-XXXXXXXIX′ in FIG. 78.

FIG. 80A-E are explanatory diagrams illustrating positional relationships of an identification mark and a RFID circuit element on a tag tape to a mark sensor, a print head, and a cutter unit.

FIG. 81A-E are conceptual diagrams illustrating in detail positional relationships among a print area of the tag tape, the RFID circuit element, and the identification mark in the respective states illustrated in FIGS. 80A-E.

FIG. 82 is a flow chart illustrating a control procedure executed by the control circuit.

FIG. 83 is a conceptual diagram illustrating a control system in an exemplary modification to the apparatus for producing a label, in which the tag tape is cut by a cutter unit which is driven by a solenoid based on manual operations.

FIG. 84 is a flow chart illustrating a control procedure executed by the control circuit.

FIG. 85 is a conceptual diagram illustrating a control system in an exemplary modification to the apparatus for producing a label in which the tag tape is automatically cut by the cutter unit.

FIG. 86 is a flow chart illustrating a control procedure executed by the control circuit.

FIG. 87 is a conceptual diagram illustrating in detail positional relationships among a print area of the tag tape, the RFID circuit element, and each trigger mark in an exemplary modification in which identification marks are implemented by trigger marks which correspond to a start point and an end point of a cut prohibited area, respectively.

FIG. 88 is a flow chart illustrating a control procedure executed by the control circuit.

FIG. 89 is a conceptual diagram illustrating in detail positional relationships among the print area of the tag tape, the RFID circuit element, and each trigger mark in an exemplary modification in which the trigger mark is borne only at the starting point.

FIG. 90 is a flow chart illustrating a control procedure executed by the control circuit.

FIG. 91 is a conceptual diagram illustrating in detail positional relationships among the print area of the tag tape, the RFID circuit element, the identification mark, and a blank zone in an exemplary modification in which the blank zone is specified within a cut enabled area.

### DETAILED DESCRIPTION OF THE PREFERRED EMBODIMENTS

In the following, some embodiments of the present invention will be described with reference to the accompanying drawings.

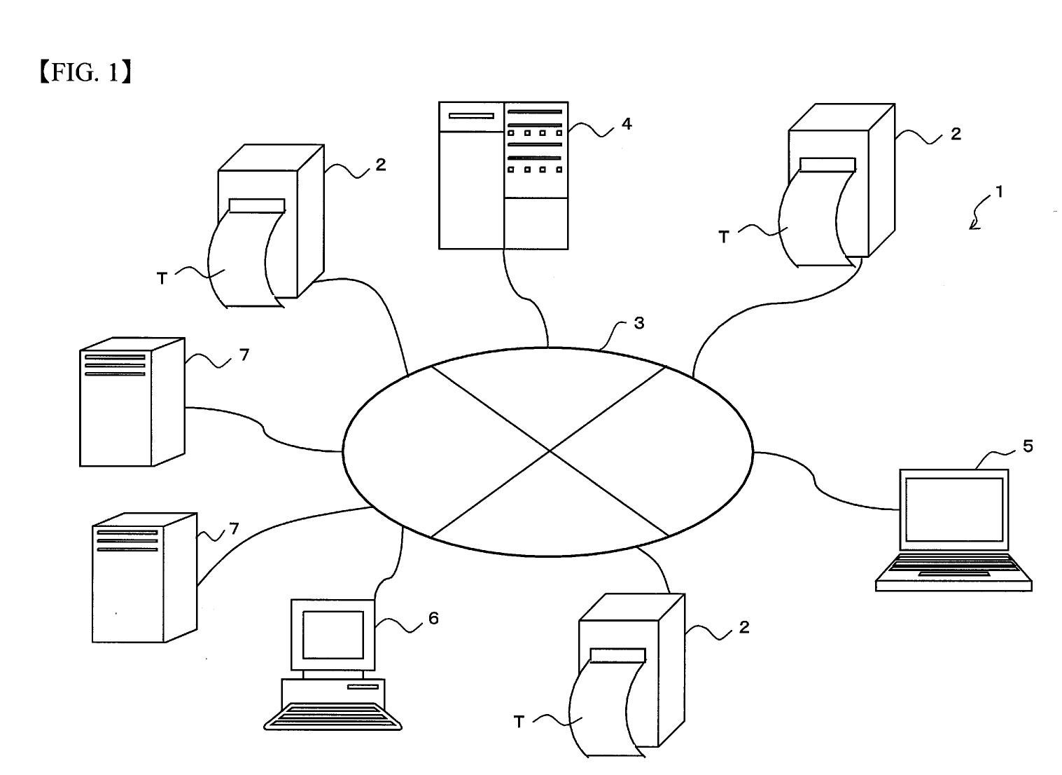

A first embodiment of the present invention will be described with reference to FIGS. 1 to 17.

FIG. 1 is a diagram illustrating the configuration of a RFID tag manufacturing system to which a label producing apparatus is applied in accordance with the first embodiment.

In the RFID tag manufacturing system 1 illustrated in FIG. 1, the tag-label producing apparatus 2 (apparatus for producing a label) according to the embodiment is connected to a route server 4, a terminal 5, a general purpose computer 6, and a plurality of information servers 7 through a wired or a wireless communication network 3.

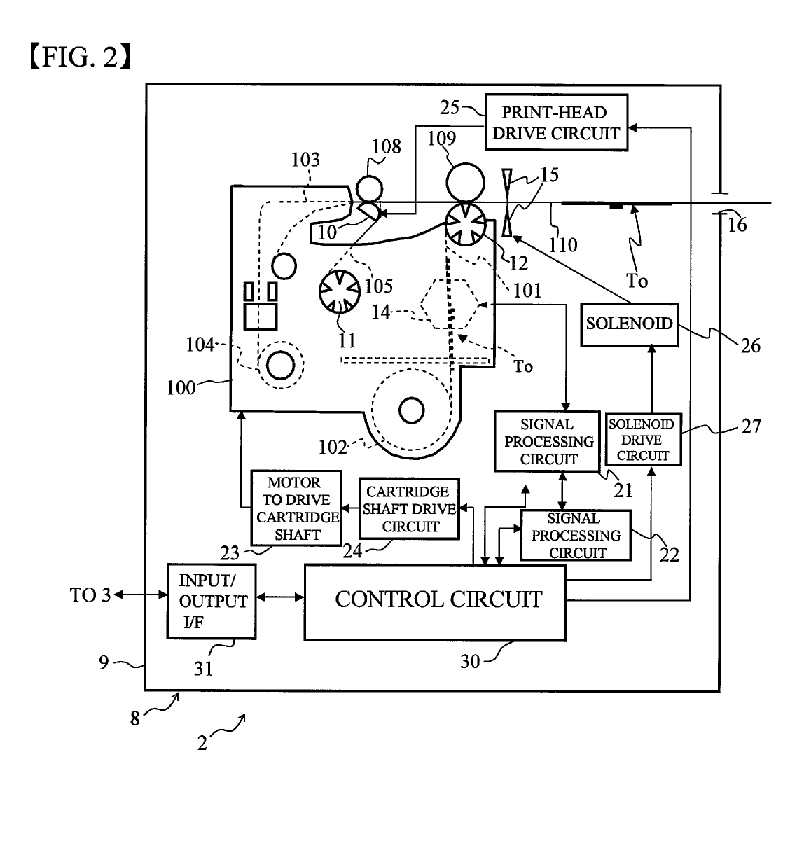

FIG. 2 is a conceptual diagram representing the configuration of the label producing apparatus 2 illustrated in FIG. 1 in greater detail.

In FIG. 2, a main body 8 of the label producing apparatus 2 is formed with a recessed cartridge holder (not shown, container receiving holder) in which a cartridge (label container) 100 is removably loaded.

The main body 8 comprises a print head (printing device, thermal head) 10 configured to print predetermined characters on a cover film (print-receiving tape) 103 fed out from a print-receiving tape roll (second roll) 104; a ribbon take-up roller driving shaft 11 configured to drive an ink ribbon 105 that has finished the print to the print-receiving tape 103; a feeding roller driving shaft 12 configured to transport the print-receiving tape 103 and a base tape (tag tape, label tape, label medium) 101 for a label tape fed out from a base tape roll (first roll, roll of tape for producing a label) 102 which serves as a roll of tape for producing a label, while bonding the print-receiving tape 103 to the base tape 101, to feed out the resulting tag label tape 110 with print from the cartridge 100; an antenna (apparatus antenna) 14 configured to transmit/receive a signal to/from RFID circuit elements To (described later in detail) disposed on the tag label tape 110 with print using a radio frequency in a UHF band or the like; a cutter 15 configured to cut off the tag label tape 110 with print to a predetermined length at a predetermined timing to produce a label-shaped RFID label T (described later in detail); a carry-out exit (discharge port) 16 configured to deliver the RFID label T to the outside; and a housing 9 which is formed with the cartridge holder for removably fitting the cartridge 100 therein, and the carry-out exit 16, and defines a shell for containing the foregoing components.

The antenna 14 comprises a so-called patch antenna which is directive to one direction (in front on the sheet of FIG. 2 in this example), and is disposed near a feeding path in a plane which intersects with the surface of the base tape 101 (in a plane perpendicular to the surface of the base tape 101 in this example, however, the plane may intersect with the surface of the base tape 101 at angle of 45°, 60° or the like, other than 90°) on the feeding path (between the position at which the tape is fed out from the base tape roll 102 to the feeding roller driving shaft 12).

The main body 8 further includes a radio frequency circuit 21 configured to access (reading or writing) the RFID circuit element To through the antenna 14; a signal processing circuit 22 configured to process a signal read from the RFID circuit element To; a motor 23 to drive cartridge shaft configured to drive the ribbon take-up roller driving shaft 11 and the feeding roller driving shaft 12 described above; a cartridge shaft drive circuit 24 configured to control the drive of the motor 23 to drive cartridge shaft; a print-head drive circuit 25 configured to control the power supplied to the print head 10; a solenoid 26 configured to drive the cutter 15 to perform cutting operations; a solenoid drive circuit 27 configured to control the solenoid 26; a tape-feeding-roller motor 28 configured to drive the feed rollers 17; a tape-feeding-roller drive circuit 29 configured to control the tape-feeding-roller motor 28; and a control circuit 30 configured to generally control the label producing apparatus 2 through the radio frequency circuit 21, signal processing circuit 22, cartridge shaft drive circuit 24, print-head drive circuit 25, solenoid drive circuit 27, tape-feeding-roller drive circuit 29, and the like.

The control circuit 30, which is based on a so-called microcomputer, comprises a central processing unit (CPU), a ROM, a RAM and the like, though detailed illustration is omitted. The control circuit 30 performs signal processing in accordance with a program previously stored in the ROM using a temporary storage function of the RAM. The control circuit 30 is also connected, for example, to the communication network 3 through an input/output interface 31, so that the control circuit 30 can communicate information with the aforementioned route server 4, other terminals 5, general purpose computer 6, information server 7 and the like, all of which are connected to the communication network 3.

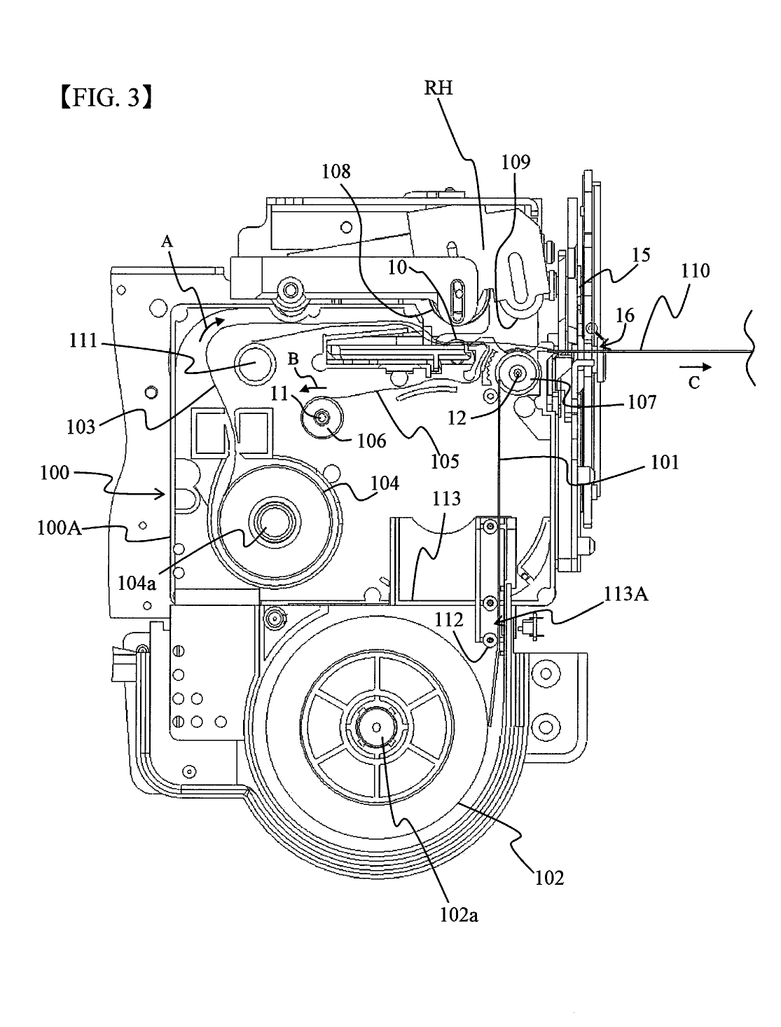

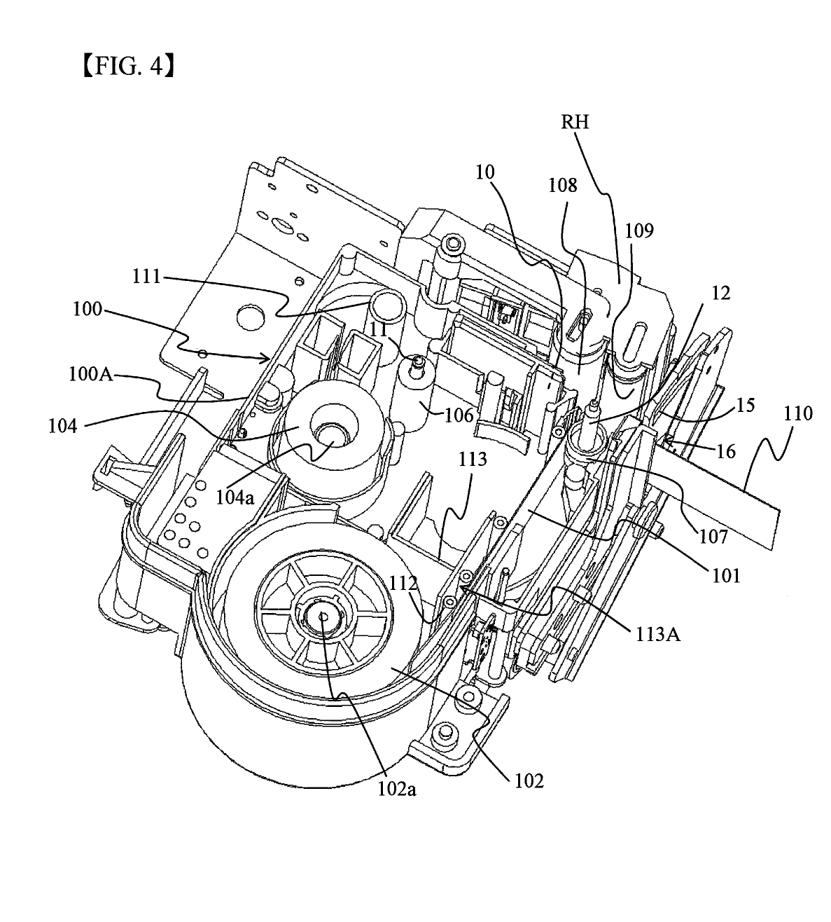

FIGS. 3 and 4 are a top plan view and a perspective view, respectively, illustrating the appearance and structure of the label producing apparatus 2 when the cartridge 100 is loaded in the cartridge holder (note that a front cover has been removed from the label producing apparatus 2).

Referring first to FIG. 3, the cartridge 100 comprises a housing 100A; the base tape roll 102 loaded in the housing 100A and having the elongated base tape 101 wound therearound; the print-receiving tape roll 104 having the transparent print-receiving tape 103 approximately as wide as the base tape 101 wound therearound; a ribbon-supply-side roll 111 configured to feed out the ink ribbon 105 (a thermal transfer ribbon, however, the ribbon-supply-side roll 111 is not required when the print-receiving tape is made of a heat sensitive tape); a ribbon take-up roller 106 configured to take up a ribbon 105 after characters have been printed on the print-receiving tape 103; a feeding roller 107 (feeding device); a guide roller 112; and a shield member 113 configured to pass the base tape 101 through a through space 113A to reduce electric wave signals which can leak from the antenna 14 to the base tape roll 102.

The feeding roller 107 presses the base tape 101 against the print-receiving tape 103 to bond them to each other into the tag label tape 110 with print which is then fed in a direction indicated by an arrow A (also acts as a tape feed roller).

The base tape roll 102 has the base tape 101 wound around a reel member (shaft member, first shaft member) 102a. The base tape 101 has a plurality of the RFID circuit elements To sequentially formed in a longitudinal direction at predetermined regular intervals. The reel member 102a has its axis substantially perpendicular to the longitudinal direction of the base tape 101.

The print-receiving tape roll 104 has the print-receiving tape 103 wound around a reel member (second shaft member) 104a. The print-receiving tape 103 fed out from the print-receiving tape roll 104 is pressed against the ribbon 105 driven by the ribbon supply roll 111 and the ribbon take-up roller 106, which are disposed inward from the back side of the print-receiving tape 103 (i.e., the side of the print-receiving tape 103 which is bonded to the base tape 101), by the print head 10, such that the ribbon 105 is brought into close contact with the back side of the print-receiving tape 103.

The ribbon take-up roller 106 and the feeding roller 107 are respectively driven to rotation by a driving force of the motor 23 to drive cartridge shaft (see FIG. 2 described above) which is transmitted to the ribbon take-up roller driving shaft 11 and the feeding roller driving shaft 12. The motor 23 to drive cartridge shaft may be, for example, a pulse motor disposed outside of the cartridge 100.

In the cartridge 100 configured as described above, the base tape 101 fed out from the base tape roll 102 is supplied to the pressure roller 107. The print-receiving tape 103 fed out from the print-receiving tape roller 104, in turn, is pressed against the ink ribbon 105 driven by the ribbon supply roll 111 and the ribbon take-up roller 106, which are disposed inward from the back side of the print-receiving tape 103 (i.e., the side of the print-receiving tape 103 which is bonded to the base tape 101), by the print head 10, such that the ribbon 105 is brought into close contact with the back side of the print-receiving tape 103.

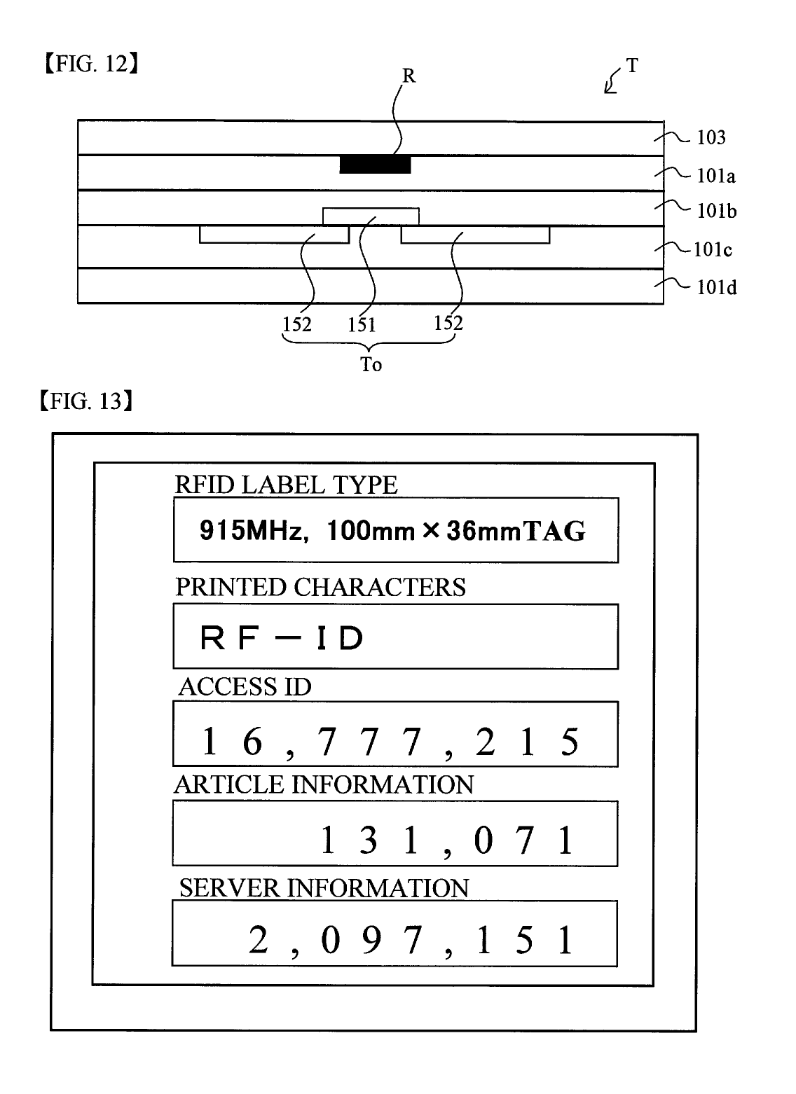

Then, when the cartridge 100 is loaded in the cartridge holder of the main body 8, and a roll holder RH (not shown) is moved from a separate position (illustrated position) to a contact position, the print-receiving tape 103 and the ink ribbon 105 are sandwiched between the print head 10 and a platen roller 108, while the base tape 101 and the print-receiving tape 103 are sandwiched between the feeding roller 107 and a sub-roller 109. Subsequently, the ribbon take-up roller 106 and the feeding roller 107 are driven to rotate in directions indicated by arrows B and D, respectively, in synchronism with each other by the driving force of the motor 23 to drive cartridge shaft. In this event, the feeding roller driving shaft 12, the sub-roller 109 and the platen roller 108 described above are coupled with each other by gears (not shown), such that the pressure roller 107, sub-roller 109, and platen roller 108 are rotated with the accompaniment to the driven feeding roller driving shaft 12 to feed out the base tape 101 from the base tape roll 102 to the feeding roller 107, as described above. On the other hand, the print-receiving tape 103 is fed out from the print-receiving tape roll 104, and a plurality of heating elements of the print head 10 are powered by the print-head drive circuit 25. As a result, a character R (see FIG. 12, later described) is printed on the back side of the print-receiving tape 103. The character R corresponds to a RFID circuit element To on the base tape 101 to which the print-receiving tape 103 is to be bonded. Then, the base tape 101 is bonded to and integrated with the print-receiving tape 103, on which the character R has been printed, by the feeding roller 107 and sub-roller 109 to form a tag label tape 110 with print which is delivered to the outside of the cartridge 100. Subsequently, the ribbon take-up roller driving shaft 11 is driven to take up the ink ribbon 105, which has been used to print the character R on the print-receiving tape 103, onto the ribbon take-up roller 106.

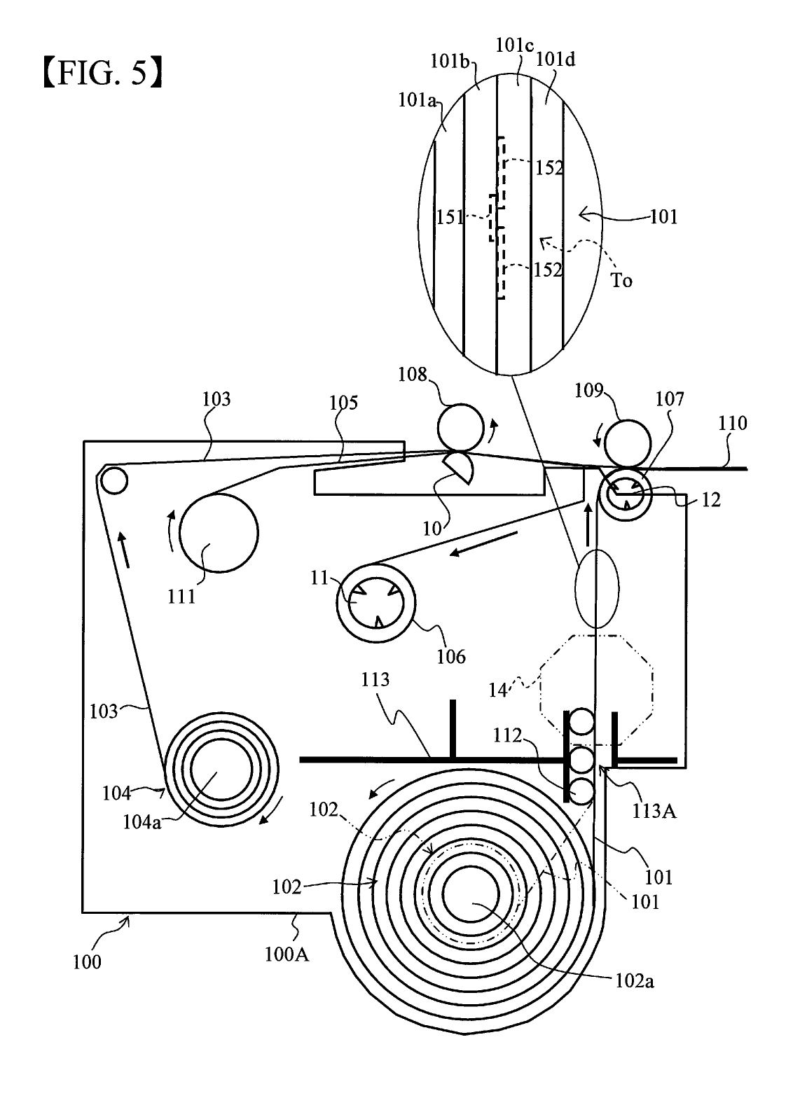

FIG. 5 is an explanatory diagram conceptually illustrating the structure of the cartridge 100 shown in FIGS. 2, 3, 4, together with a detailed enlarged view illustrating the structure of the base tape 101.

Referring to FIG. 5, in this embodiment, the base tape 101 has a four-layer structure (see a partially enlarged view in FIG. 5) which comprises a laminate comprised of an adhesive layer 101a made of an appropriate adhesive material, a colored base film 101b (tape base) made of PET (polyethylene terephthalate) or the like, an adhesive layer 101c made of an appropriate adhesive material, and a separation sheet (parting agent) 101d in this order from a side thereof which is rolled inward (from the left in FIG. 5) to the opposite side (to the right in FIG. 5).

The base film 101b is provided with an antenna (tag antenna) 152 integrally formed on the back surface thereof (on the right side in FIG. 5) configured to transmit/receive information, and an IC circuit part 151 connected to the antenna 152 configured to store information. The base film 101b, antenna 152, and IC circuit part 151 make up the RFID circuit element To. The adhesive layer 101a is formed on the front side of the base film 101b (on the left side in FIG. 5) for bonding the print-receiving tape 103 thereon at a later time. The separation sheet 101d is also bonded to the back surface (on the right side of FIG. 5) of the base film 101b by the adhesive layer 101c for wrapping the RFID circuit element To therein. It should be noted that the separation sheet 101d is peeled off when the finished RFID label T is bonded to a predetermined article or the like, so that the adhesive layer 101c enables the RFID label 5 to be bonded to the article or the like.

The guide roller 112 in turn guides the base tape 101 fed out from the base tape roller 102 such that the distance between the feeding path of the base tape 101 and the antenna 14 is restricted within a predetermined range at all times, even if the base tape 101 is fed out from a different position of the base tape roll 102 as the base tape 101 is consumed (see two-dot chain lines in FIG. 5).

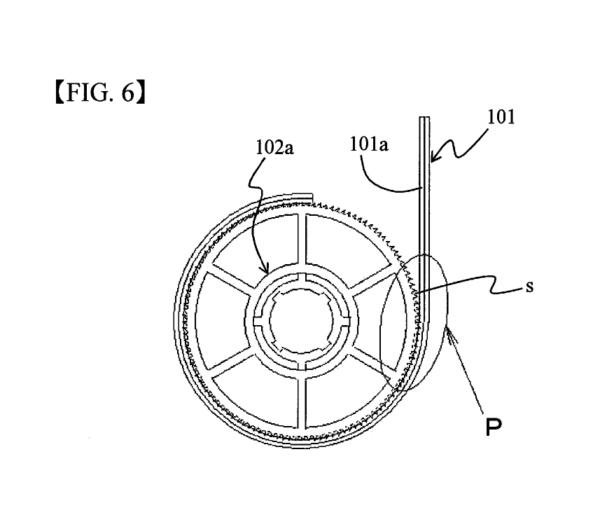

FIG. 6 is a top plan view illustrating in detail the structure of a reel member 102a of the base tape roll 102 which is an essential component of this embodiment. As illustrated in FIG. 6, the adhesive layer 101a of the base tape 101 is wound around the periphery of the entirely gear-shaped reel member 102a resulting from a large number of grooves s (malfunction preventing device) formed therearound.

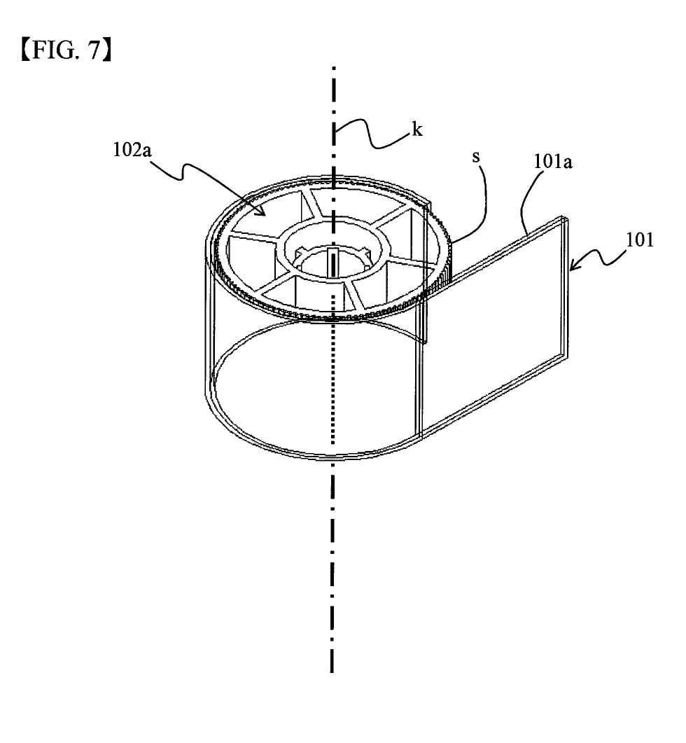

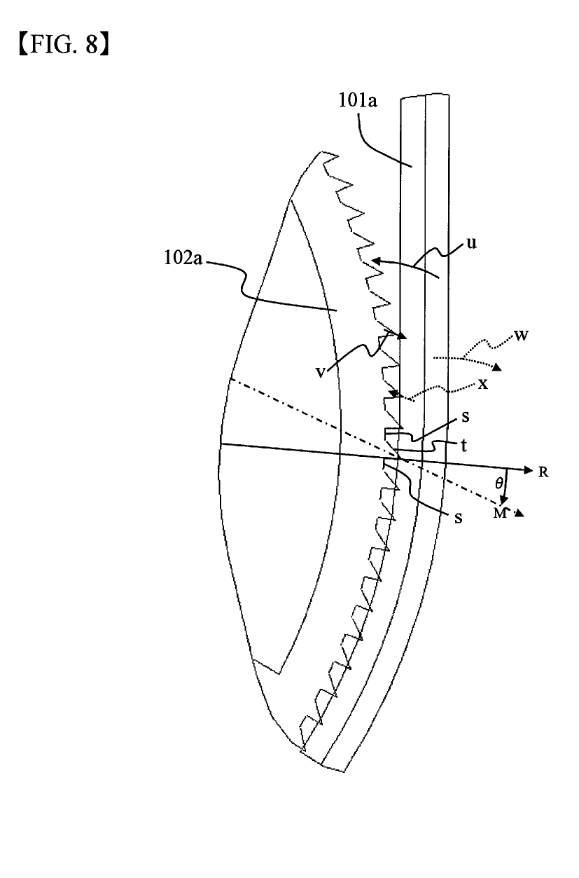

FIG. 7 is a perspective view generally illustrating the structure of the reel member 102a. As illustrated, the grooves s of the reel member 102a are formed over the entire circumference of the reel member 102a and substantially in parallel with the axial direction indicated in FIG. 8.

FIG. 8 is an enlarged view of a portion P in FIG. 6. As illustrated, the grooves s of the reel member 102a are formed such that the leading end of a projection t between adjacent grooves is inclined by angle θ (from a radial direction R) to a direction M in which the base tape 101 is wound around the reel member 102a.

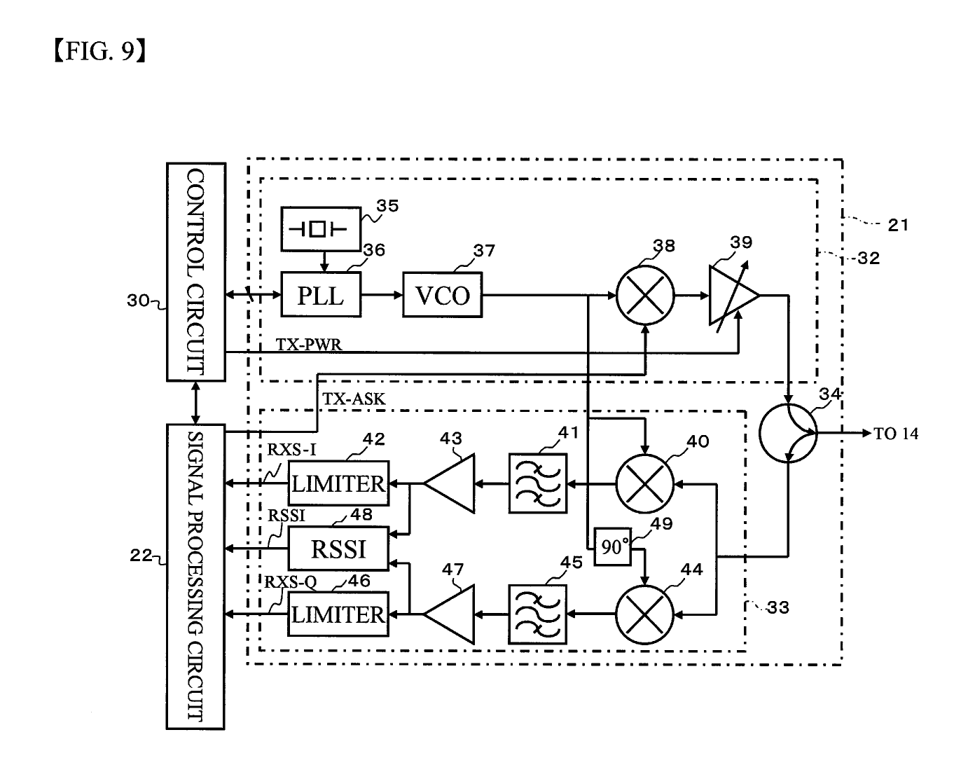

FIG. 9 is a functional block diagram illustrating functions of the radio frequency circuit 21 in detail. Referring to FIG. 9, the radio frequency circuit 21 comprises a transmitting portion 32 configured to transmit a signal to the RFID circuit element To through the antenna 14; a receiving portion 33 configured to receive reflected waves from the RFID circuit element To, received by the antenna 14; and a transmit-receive splitter 34.

The transmission portion 32 comprises a crystal oscillator 35 configured to generate a carrier for accessing (reading or writing) RFID tag information (RFID tag control information) in the IC circuit part 151 of the RFID circuit element To; a PPL (Phase Locked Loop) 36; a VCO (Voltage Controlled Oscillator) 37; a transmission multiplying circuit 38 (which may be implemented by an amplification factor variable amplifier or the like for amplitude modulation) configured to modulate the carrier generated by the crystal oscillator 35 based on a signal supplied from the signal processing circuit 22 (modifying the amplitude of the carrier based on a “TX_ASK” signal from the signal processing circuit 22 in this embodiment); and a variable transmission amplifier 39 configured to determine an amplification factor based on a “TX_PWR” signal from the control circuit 30 to amplify the carrier modulated by the transmission multiplying circuit 38. The carrier generated by the crystal oscillator 35 preferably falls within the UHF band, and the output of the transmission amplifier 39 is transmitted to the antenna 14 through the transmit-receive splitter 34 and then supplied to the IC circuit part 151 of the RFID circuit element To. It should be noted that the RFID tag information is not limited to a modulated signal but may be simply a carrier.

The receiving portion 33 comprises a first receiving signal multiplying circuit 40 configured to multiply reflected wave from the RFID circuit element To received by the antenna 14 by the carrier for demodulation; a first band-pass filter 41 configured to extract signals only in a required band from the output of the first receiving signal multiplying circuit 40; a first receiving signal amplifier 43 configured to amplify the output of the first band-pass filter 41; a first limiter 42 configured to further amplify the output of the first receiving signal amplifier 43 and converting the amplified output to a digital signal; a second receiving signal multiplying circuit 44 configured to multiply the reflected waves from the RFID circuit element To received by the antenna 14 by the carrier, the phase of which has been delayed by 90° by a phase shifter 49 after the carrier was generated; a second band-pass filter 45 configured to extract signals only in a required band from the output of the second receiving signal multiplying circuit 44; a second receiving signal amplifier 47 configured to amplify the output of the second band-pass filter 45; and a second limiter 46 configured to further amplify the output of the second receiving signal amplifier 47 and converting the amplified output to a digital signal. A signal “RXS-I” output from the first limiter 42, and a signal “RXS-Q” output from the second limiter 46 are applied to the signal processing circuit 22 configured to further process.

The outputs of the first receiving signal amplifier 43 and second receiving signal amplifier 47 are also applied to an RSSI (Received Signal Strength Indicator) circuit 48 which in turn applies the signal processing circuit 22 with a signal “RSSI” indicative of the strength of these signals. In this way, the label producing apparatus 2 of this embodiment demodulates reflected waves from the RFID circuit element To through I-Q orthogonal demodulation.

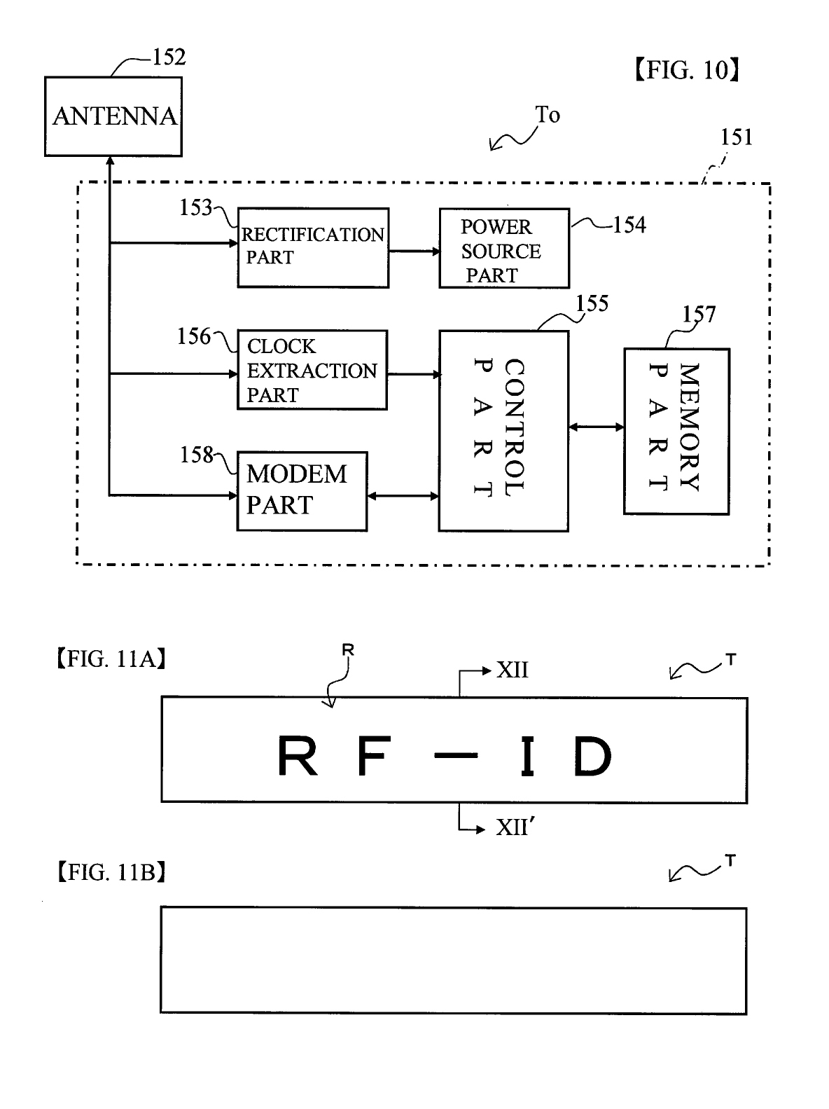

FIG. 10 is a functional block diagram illustrating functional components of the RFID circuit element To. Referring to FIG. 10, the RFID circuit element To comprises the aforementioned antenna 152 configured to transmit/receive signals to/from the antenna 14 of the label producing apparatus 2 at a radio frequency in the short wave band, UHF band, microwave band or the like in a non-contact fashion; and the IC circuit part 151 connected to the antenna 152.

The IC circuit part 151 comprises a rectification part 153 configured to rectify a carrier received by the antenna 152; a power source part 154 configured to accumulate energy of the carrier rectified by the rectification part 153 for use by the IC circuit part 151 as a drive power source; a clock extraction part 156 configured to extract a clock signal from the carrier received by the antenna 152 and supplying the extracted clock signal to a control part 155; a memory part 157 which functions as an information storage device capable of storing predetermined information signals; a modem part 158 connected to the antenna 152; and the control part 155 configured to control the operation of the RFID circuit element To through the rectification part 153, clock extraction part 156, modem part 158 and the like.

The modem part 158 demodulates communication signals transmitted from the antenna 14 of the tag-label producing apparatus 2 and received by the antenna 152, and modulates and reflects the carrier received by the antenna 152 based on a response signal from the control part 155.

The control part 155 conducts basic control involved in interpreting a received signal demodulated by the modem part 158, generating a response signal based on information signals stored in the memory part 157, transmitting the response signal back through the modem part 158 and the like.

FIGS. 11A and 11B are a top plan view and a bottom plan view, respectively, illustrating the appearance of an exemplary RFID label T which is formed by reading or writing information from or to the RFID circuit element To, and cutting the tag label tape 110 with print into individual RFID labels T, as previously described. FIG. 12 in turn is a cross-sectional view taken along a line XII-XII′ in FIG. 11A.

Referring to FIGS. 11A, 11B, 12, the RFID label T contains a plurality (two in this embodiment) of RFID circuit elements To.

As illustrated in FIG. 12, the RFID label T has the RFID circuit elements To embedded in a five-layer structure in which the print-receiving tape 103 is added to the four-layer structure illustrated in FIG. 5. The five layers are comprised of the print-receiving tape 103, the adhesive layer 101a, the base film 101b, the adhesive layer 101c, and the separation sheet 101d, which are laminated from the print-receiving tape 103 (upper side in FIG. 12) to the opposite side (lower side in FIG. 12). As described above, the RFID circuit elements To, each including the antenna 152 and disposed on the back side of the base film 101b, is embedded in the adhesive layer 101c, and a character R (in the example, a character “RF-ID” indicative of the type of the RFID label T) is printed on the back side of the print-receiving tape 103.

FIG. 13 is a diagram illustrating an exemplary screen which may be displayed on the terminal 5 or general purpose computer 6 when the tag-label producing apparatus 2 as described above accesses RFID tag information (for reading or writing) in the IC circuit part 151 of the RFID circuit element To.

Referring to FIG. 13, in this embodiment, the terminal 5 or general purpose computer 6 can display the type of a RFID label (access frequency and tag size); the character R printed on the RFID label corresponding to the RFID circuit element To; an access (read or write) ID unique to the RFID circuit element To; the address of article information stored in the information server 7; the address at which information corresponding thereto is stored in the route server 4; and the like. For producing a RFID label, the tag-label producing apparatus 2 is activated through operations on the terminal 5 or general purpose computer 6 to print the character R on the print-receiving tape 103 and write information such as the write ID, article information and the like into the IC circuit part 151 (or read RFID tag information such as article information previously stored in the IC circuit part 151). In this event, it should be noted that the “read/write” of the RFID tag control information should be understood in a broader sense to include not only the read/write of data, as literally interpreted, but also the transmission of a signal for halting a response such as a signal based on “Kill” and “Sleep” commands.

Also, the route server 4 stores a correspondence relationship between the ID of the RFID circuit element To in the produced RFID label T and information written into the IC circuit part 151 of the RFID circuit element To (or information read from the IC circuit part 151) during a read or a write operation as described above, such that the correspondence relationship can be referenced as required.

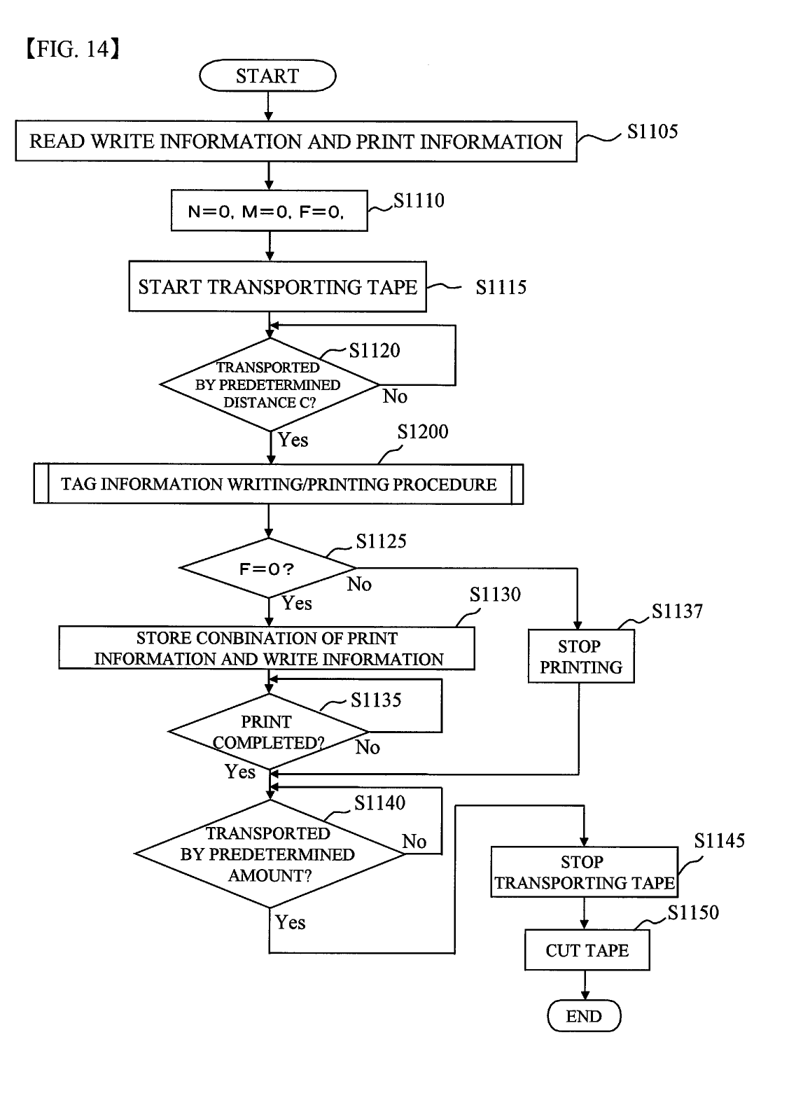

FIG. 14 is a flow chart illustrating a control procedure executed by the control circuit 30 during the production of the RFID label T in a scenario where a predetermined character is printed by the print head 10 on the print-receiving tape 103, while the base tape 101 is transported to write RFID tag information into an associated IC circuit part, and then the base tape 101 is bonded to the print-receiving tape 103 to form the tag label tape 110 with print which is then cut into each RFID label T which contains an associated RFID circuit element To.

Referring to FIG. 14, the flow is first started at step S1105 in response to a write operation performed by the tag-label producing apparatus 2, for example, through the terminal 5 or general-purpose computer 6. Then, the tag-label producing apparatus 2 reads, through the communication network 3 and input/output interface 31, information which has been entered through the terminal 5 or general purpose computer 6 and which should be written into the RFID circuit element To, and print information which should be printed on the RFID label T by the print head 10 corresponding to the entered information, as mentioned above.

Subsequently, at step 1110, the control circuit 30 initializes a variable M, N each for counting the number of times a retry is made when no response is returned from the RFID circuit element To, and a flag F indicative of a normal or a failed communication.

Then, at step S1115, the control circuit 30 outputs a control signal to the cartridge shaft drive circuit 24 to drive the ribbon take-up roller 106 and feeding roller 107 with a driving force of the motor 23 to drive cartridge shaft. In this way, the base tape 101 is fed out from the base tape roll 102 and supplied to the feeding roller 107, while the print-receiving tape 103 is fed out from the print-receiving tape roll 104. As a result, the base tape 111 is bonded to the print-receiving tape 103 by the feeding roller 107 (and sub-roller 109) for integration into the tag label tape 110 with print which is then transported to the outside of the cartridge 100.

Subsequently, at step S1120, the control circuit 30 determines whether or not the tag label tape 110 with print has been transported by a predetermined distance C (for example, a transport distance long enough for the next RFID circuit element To, to reach a position substantially opposite to the antenna 14 after RFID tag information has been written into the preceding RFID circuit element To, and a corresponding character has been printed on the print area of the print-receiving tape 103 corresponding to the RFID circuit element To). The determination on the transport distance may be made, for example, by detecting an appropriate identification mark borne on the base tape 101 by a known tape sensor which may be additionally provided for this purpose. When the determination at step S1120 is YES, the flow goes to step S1200.

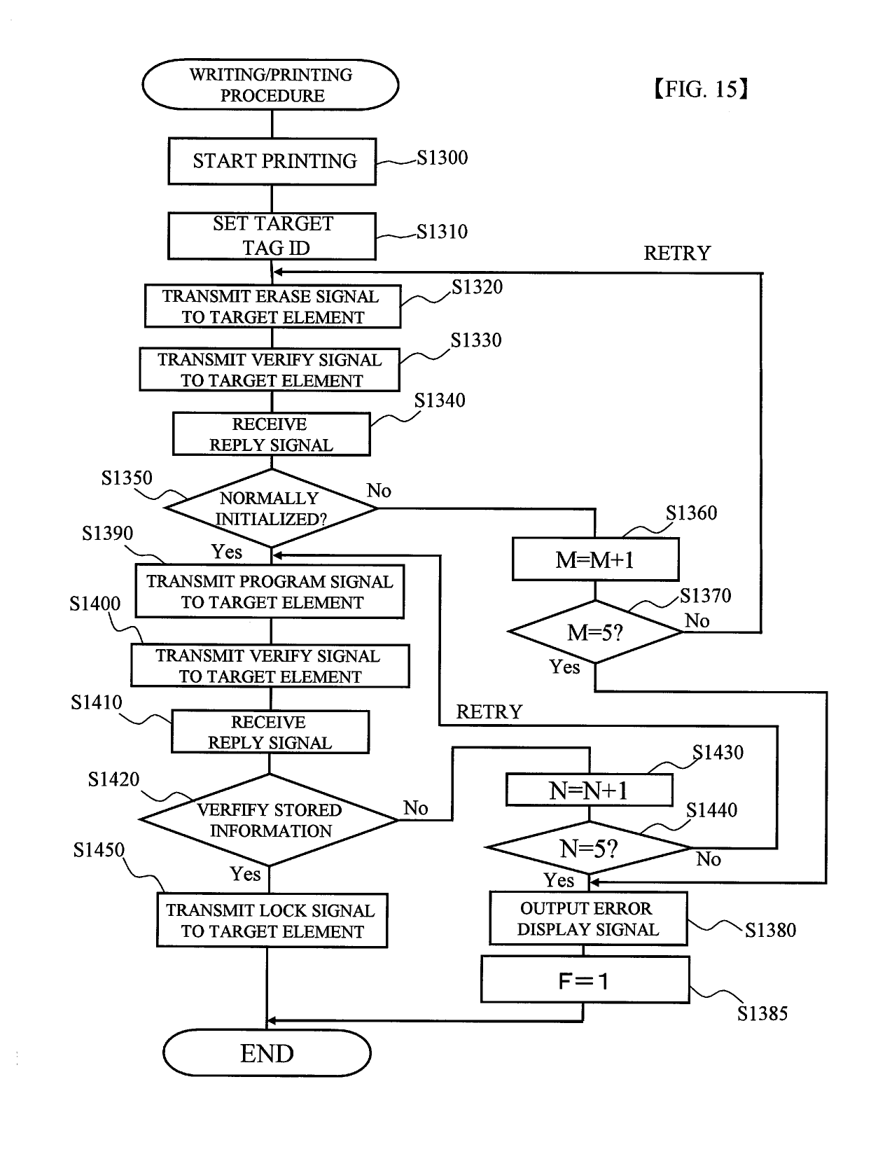

At step S1200, the control circuit 30 performs a tag information writing/printing procedure which involves initializing (erasing) the memory part 157 for writing the RFID tag information, and transmitting the RFID tag information to the RFID circuit element To on the base tape 101, and forcing the print head 10 to print the character R on the corresponding area of the print-receiving tape 103 (see FIG. 15, later described, for further details). After step S1200 is completed, the flow goes to step S1125.

At step S1125, the control circuit 30 determines whether or not the flag F is set to “0.” When the write processing has been normally completed, the flag F remains to be “0” (see step S1385 in a flow chart illustrated in FIG. 15, later described). Accordingly, the determination at step S1125 should be YES, causing the flow to go to step S1130.

At step S1130, the control circuit 30 outputs a combination of the information written into the IC circuit part 151 of the RFID circuit element To at step S1200 with the print information previously printed by the print head 10 corresponding thereto for storage in the information server 7 and route server 4 through the terminal 5 or general purpose computer 6 by way of the input/output interface 31 and communication network 3. The information may be stored, for example, in a database which can be accessed by the terminal 5 or general purpose computer 6 as required.

Subsequently, the control circuit 30 confirms at step S1135 whether or not characters have been printed on areas of the print-receiving tape 103 corresponding to the RFID circuit elements To which should be processed at this time, followed by the flow going to step S1140.

At step S1125 described above, if the writing procedure has not been normally completed for some reason, the flag F is set to “1” (see at step S1385 in the flow chart illustrated in FIG. 15, later described). Accordingly, the determination at step S1125 is NO, causing the flow to go to step S1137, where the control circuit 30 outputs a control signal to the print-head drive circuit 25 to stop the power to the print head 10 which stops the printing in response to the control signal. In this way, the control circuit 30 explicitly displays that a pertinent RFID circuit element To is defective through such interrupted printing. Alternatively, the control circuit 30 may force the print head 10 to print a special message for alarming or drawing the operator's attention to such a defective product, instead of the interrupted printing.

After step S1137 is completed, the flow goes to step S1140.

At step S1140, the control circuit 30 determines whether or not the tag label tape 110 with print has been further transported by a predetermined distance (for example, a transport distance long enough for a RFID circuit element To under processing and a print area on the print-receiving tape 103 corresponding thereto to go beyond the cutter 15 by a predetermined length (margin)). The determination on the transport distance may also be made, for example, by detecting an appropriate identification mark borne on the base tape 101 by a tape sensor, in a manner similar to step S1120 above. When the determination at step S1140 is YES, the flow goes to step S1145.

At step S1145, the control circuit 30 outputs a control signal to each of the cartridge shaft drive circuit 24 and tape-feeding-roller drive circuit 29 to stop driving the motor 23 to drive cartridge shaft and tape-feeding-roller motor 28, thus stopping rotations of the ribbon take-up roller 106 and feeding roller 107. This results in stopping the transport of the base tape 101 fed out from the base tape roll 102 and the print-receiving tape 103 fed out from the print-receiving tape roll 104, so that the transport of the tag label tape 110 with print is also stopped.

Subsequently, at step S1150, the control circuit 30 outputs a control signal to the solenoid drive circuit 27 to drive the solenoid 26 which forces the cutter 15 to cut the tag label tape 110 with print. As described above, the RFID circuit element To under processing, for example, had been bonded to a printed area of the print-receiving tape 103 corresponding thereto to create the tag label tape 110 with print which has sufficiently passed beyond the cutter 15 at this time. The tag label tape 110 with print cut by the cutter 15 results in a RFID label T in which predetermined RFID tag information has been written into the RFID circuit element To and on which a predetermined character (a common word in this embodiment, as described above) has been printed in correspondence to the RFID tag information. In this way, the RFID label T produced at step S1150 is transported toward the carry-out exit 16 and further to the outside of the tag-label producing apparatus 2 from the carry-out exit 16.

FIG. 15 is a flow chart illustrating in detail a procedure included in the aforementioned step S1200.

Referring to FIG. 15, at step S1300, the control circuit 30 powers the print head 10 and outputs a control signal to the print-head drive circuit 25 to print a character R such as characters, symbols, bar code or the like, read at step S1105 in FIG. 14, on an area of the print-receiving tape 103 corresponding to the RFID circuit element To under processing (the area which is to be bonded to the back side of the RFID circuit element To by the feeding roller 107).

Then, at step S1310, the control circuit 30 sets an identification number ID which is to be assigned to the RFID circuit element To, into which RFID tag information is to be written, by a known appropriate method.

Subsequently, at step S1320, the control circuit 30 outputs an “Erase” command to the signal processing circuit 22 for initializing information stored in the memory part 157 of the RFID circuit element To. In response, the signal processing circuit 22 generates an “Erase” signal, as access information, which is transmitted to the target RFID circuit element To through the radio frequency circuit 21 to initialize the memory part 157 of the RFID circuit element To.

Next, at step S1330, the control circuit 30 outputs a “Verify” command to the signal processing circuit 22 for verifying the contents of the memory part 157. In response, the signal processing circuit 22 generates a “Verify” signal, as access information, which is transmitted to the target RFID circuit element To through the radio frequency circuit 21 to prompt the RFID circuit element To return a reply. Then, at step S1340, the tag-label producing apparatus 2 receives a reply signal transmitted from the target RFID circuit element To in response to the “Verify” signal through the antenna 14, and the control circuit 30 captures the reply signal through the radio frequency circuit 21 and signal processing circuit 22.

Next, the control circuit 30 verifies information stored in the memory part 157 of the RFID circuit element To, based on the reply signal, at step S1350 to determine whether or not the memory part 157 has been normally initialized.

When the determination is NO, the flow goes to step S1360, where M is incremented by one. Then, the flow goes to step S1370, where the control circuit determines whether or not M is equal to five. When M is equal to or less than four (M≦4), the determination at step S1370 is NO, causing the flow to return to step S1320 from which the control circuit 30 repeats a similar procedure. When M is equal to five, the flow goes to step S1380, where the control circuit 30 outputs an error display signal to the terminal 5 or general purpose computer 6 through the input/output interface 31 and communication network 3 to display a corresponding failure (error) in the writing procedure on the terminal 5 or general purpose computer 6, followed by the termination of the flow in FIG. 15. In this way, the retries are allowed up to five times even if the initialization fails. It should be noted that the tag-label producing apparatus 2 does not either receive a reply signal at step S1340 when the base tape 101 wound in the base tape roll 102 has been used up, due to the absence of the RFID circuit element To, causing the control circuit 30 to display the failure at step S1380.

When the determination at step S1350 is YES, the flow goes to step 1390, where the control circuit 30 outputs a “Program” command to the signal processing circuit 22 for writing desired data into the memory part 157. In response, the signal processing circuit 22 generates a “Program” signal (i.e., RFID tag information such as the tag ID), as access information, which is transmitted to the target RFID circuit element To through the radio frequency circuit 21 to write the information into the memory part 157 of the target RFID circuit element To.

Subsequently, at step S1400, the control circuit 30 outputs a “Verify” command to the signal processing circuit 22. In response, the signal processing circuit 22 generates a “Verify” signal, as access information, which is transmitted to the target RFID circuit element To through the radio frequency circuit 21 to prompt the RFID circuit element To return a reply. Then, at step S1410, the tag-label producing apparatus 2 receives a reply signal transmitted from the target RFID circuit element To in response to the “Verify” signal through the antenna 14, and the control circuit 30 captures the reply signal through the radio frequency circuit 21 and signal processing circuit 22.

Next, the control circuit 30 verifies information stored in the memory part 157 of the RFID circuit element To based on the reply signal at step S1420 to determine whether or not the transmitted predetermined information is normally stored in the memory part 157.

When the determination at step S1420 is NO, the flow goes to step S1430, where N is incremented by one. Then, the control circuit 30 further determines at step S1440 whether or not N is equal to five. The determination is NO when N is equal to or less than four (N≦4), in which case the flow returns to step S1390, from which the control circuit 30 repeats a similar procedure. When N is equal to five (N=5), the flow goes to the aforementioned step S1380, where the terminal 5 or general purpose computer 6 is forced to display a corresponding failure (error) in the writing procedure. At step S1385, the control circuit 30 sets the flag F to “1,” followed by the termination of the flow. In this way, even in the event of a failure in writing the RFID tag information, the tag-label producing apparatus 2 retries the writing procedure up to five times.

When the determination at step S1420 is YES, the flow goes to step S1450, where the control circuit 30 outputs a “Lock” command to the signal processing circuit 22. In response, the signal processing circuit 22 generates a “Lock” signal which is transmitted to the RFID circuit element To, into which the RFID tag information is to be written, through the radio frequency circuit 21. Thus, additional information is prohibited from being written into the RFID circuit element To. Eventually, the RFID tag information has been completely written into the target RFID circuit element To which is then discharged, followed by the termination of the flow.

Through the foregoing routine, RFID tag information can be written into the RFID circuit element To under processing on the base tape 101, and the character R corresponding to the RFID tag information can be printed on the corresponding area of the print-receiving tape 103 within the cartridge 100.

In the label producing apparatus 2 of the embodiment configured as described above, the print-receiving tape 103 fed out from the print-receiving tape roll 104 is bonded to the base tape 101 fed out from the base tape roll 102 by the feeding roller 107 to form the tag label tape 110 with print which is then used to produce the RFID label T.

Here, when the base tape 101 containing the RFID circuit element To is bonded to the print-receiving tape 103 to create the RFID label T as described above, it is a general tendency that the overall length of the relatively expensive base tape 101 has been previously set shorter than the overall length of the relatively cheep print-receiving tape 103 in the cartridge 100 (with the intention of ensuring that the base tape 101 is used up earlier) For this reason, at the time the base tape 101 is used up and is no longer fed out from the base tape roll 102, the print-receiving tape 103 still remains in and is fed out from the print-receiving tape roll 104. In this event, if the base tape 101 is securely fixed to the reel member 102a of the base tape roll 102, the exhausted base tape 101 will cause the tag label tape 110 with print to stop transporting, whereas the print-receiving tape 103 is still continuously fed out from the print-receiving tape roll 104 and has nowhere to go in a space closer to the print-receiving tape roll 104 than the feeding roller 107 and sub-roller 109. Consequently, the fed print-receiving tape 102 can stagnate in a nearby space (space near the print head 10 and platen roller 108 in this example) to possibly result in jamming.

To solve this problem, in this embodiment, the reel member 102a around with the base tape 101 is wound is formed with grooves s on the peripheral surface thereof around which the base tape 101 is wound. These grooves s can reduce the area of the adhesive layer 101a of the base tape 101 in contact with the peripheral surface of the reel member 102a. As a result, when the base tape 101 has used up and reached the end thereof earlier than the print-receiving tape 103, the end edge of the base tape 101 can be relatively readily detached and removed from the reel member 102a. As a result, the tape 110 still remains driven (the tape 110 is made only of the print-receiving tape 103 after the base tape 101 is used up), so that the print-receiving tape 103 alone is continuously fed out from the print-receiving tape roll 104 in a manner similar to before, thus making it possible to prevent the jamming as mentioned above. In other words, malfunctions and/or inappropriate operations can be prevented in the tape transport process.

Also notably, in this embodiment, a plurality (a large number, in this example) of grooves s are formed on the peripheral surface of the reel member 102a to cover substantially the entire peripheral surface. The grooves s formed in this way can ensure that the contact area reduction effect is provided substantially over the overall peripheral surface.

Further notably, in this embodiment, the grooves s on the reel member 102a run substantially in parallel with the axial direction k. Specifically, since the base tape 101 is fed out in a direction substantially perpendicular to the axial direction k from the outer peripheral surface of the reel member 102 (tangential direction, see FIG. 7), the grooves s extended substantially in parallel with the axial direction k can most effectively reduce the contact area of the base tape adhesive layer 101a with the peripheral surface of the reel member 102a.

Further notably, in this embodiment, the leading end of each projection t between adjacent grooves s is formed to incline in a direction M in which base tape 101 is wound (from a radial direction R). In this way, when the base tape 101 is wound around the peripheral surface of the reel member 102a during the manufacturing (see a direction indicated by an arrow u in FIG. 8), the leading ends of the projections t are engaged into the adhesive layer 101a of the base tape 101 (see a direction indicated by an arrow v in FIG. 8) to ensure that the base tape 101 is secured to the peripheral surface of the reel member 102a. On the other hand, when the base tape 101 is fed out from the reel member 102a (see a direction indicated by v in FIG. 8), the adhesive layer 101a of the base tape 101 can be readily detached from the projections of the reel member 102a (see a direction indicated by an arrow x in FIG. 8).

It should be understood that the present invention is not limited to the foregoing embodiment, but a variety of modifications can be made thereto without departing from the spirit and scope of the invention. In the following, such exemplary modifications will be described one by one.

(1-1) Variations in Shape of Reel:

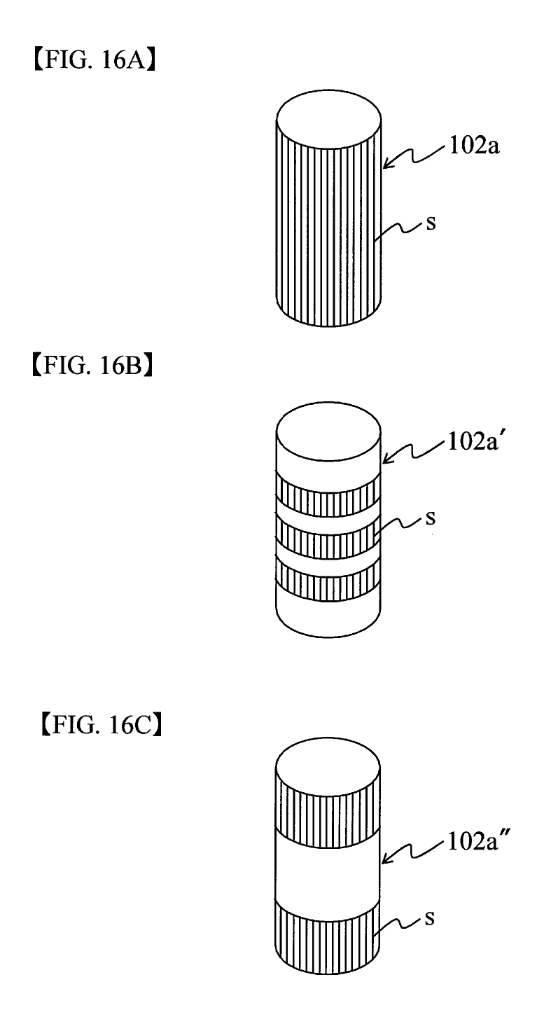

FIG. 16A is a diagram conceptually illustrating the structure of the reel member 102a in the foregoing embodiment. The reel member formed with the grooves s is not limited to the illustrated shape but may be implemented in different shapes.

FIG. 16B is a diagram conceptually illustrating the structure of an exemplary modification to the reel member, wherein grooves s are formed separately in a plurality of zones (in three zones in this example) on the peripheral surface of a reel member 102a′ in the axial direction. FIG. 16C is a diagram conceptually illustrating another exemplary modification to the reel member, wherein grooves s are formed in upper and lower end zones on the peripheral surface of a reel member 102a″ in the axial direction.

With the reels 102a′, 102a″ which have the grooves s formed in zones separated from each other as described above, a smaller area of the adhesive layer 101a of the base tape 101 can also be in contact with the peripheral surface of the reel member 102a′ or 102a″, at least as compared with a reel which is not at all formed with any groove s, to permit the end edge of the base tape 101 to be readily detached from the reel member 102a′ or 102a″. Accordingly, the foregoing exemplary modifications can provide similar advantages to those of the foregoing embodiment.

(1-2) When Information is Simply Read from RFID Circuit Element to:

While the foregoing embodiment has been described in connection with an illustrative scenario in which the RFID tag information is transmitted to the RFID circuit element To to write the information into the IC circuit part 151, the present invention is not limited to such a scenario. Alternatively, the present invention can be applied to a label T which is produced by reading RFID tag information from a read-only RFID circuit element To which previously stores predetermined RFID tag information in a non-erasable manner, and printing a character corresponding to the read RFID tag information.

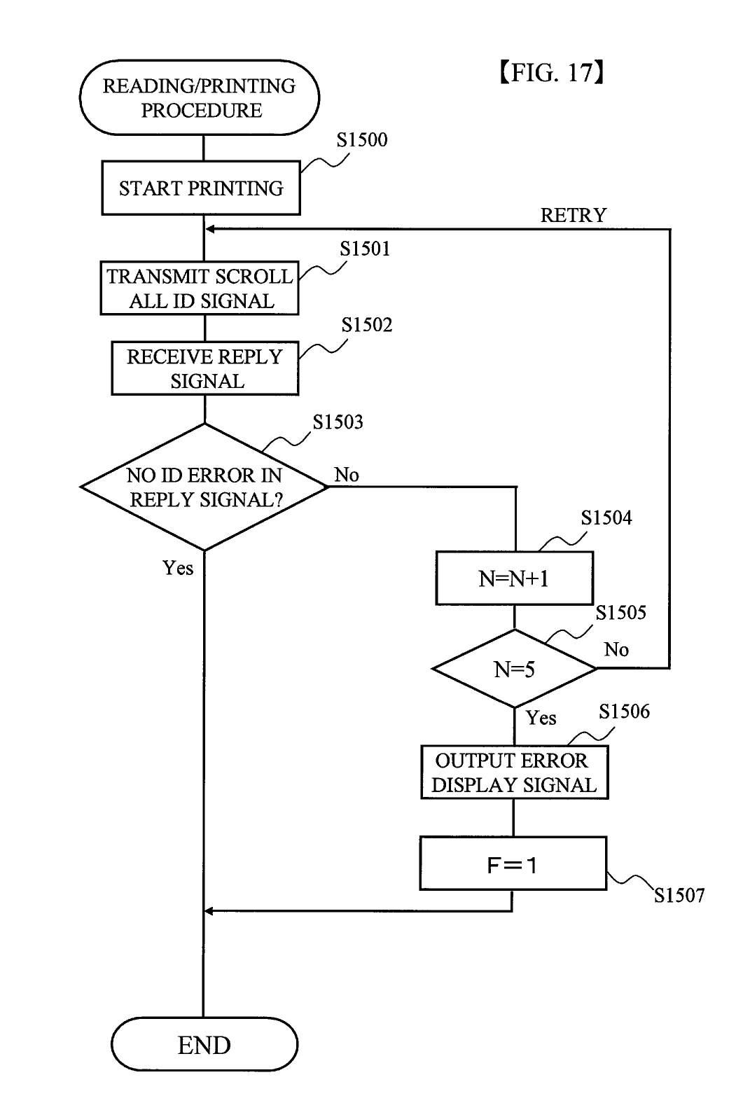

In this application, the control circuit 30 may simply read print information at step S1105 in FIG. 14, and performs the RFID tag information read/print process at step S1200 (see FIG. 17, later described, for further details). At subsequent step S1130, the control circuit 30 saves a combination of the print information with the read RFID tag information.

FIG. 17 is a flow chart illustrating in detail the tag information reading/printing procedure mentioned above.

Referring to FIG. 17, at step S1300, the control circuit 30 powers the print head 10 and outputs a control signal to the print-head drive circuit 25 to print a character R such as characters, symbols, bar code or the like, read at step S1105 in FIG. 14 above, on an area of the print-receiving tape 103 corresponding to the RFID circuit element To under processing (the area which is to be bonded to the back side of the RFID circuit element To by the feeding roller 107), in a manner similar to step S1330 in FIG. 15.

Then, at step S1501, the control circuit 30 outputs a “Scroll All ID” command to the signal processing circuit 22 for reading information stored in the RFID circuit element To. Based on the “Scroll All ID” command, the signal processing circuit 22 generates a “Scroll All ID” signal as wireless tag information, which is transmitted to a RFID circuit element To intended for reading (target RFID circuit element) through the signal processing circuit 22, to prompt the RFID tag circuit element To return a response signal.

Next, at step S1502, the tag producing apparatus 2 receives the reply signal (RFID tag information including tag ID information and the like) transmitted from the target RFID circuit element To in response to the “Scroll All ID” signal through the antenna 14. Then, the control circuit 30 captures the reply signal through the radio frequency circuit 21 and signal processing circuit 22.

Next, the control circuit 30 determines at step S1503 whether or not the reply signal received at step S1502 is erroneous using a known error detecting code (CRC (Cyclic Redundancy Check) code or the like).

When the determination is NO, the flow returns to step S1504, where N is incremented by one. Then, the control circuit 30 further determines at step S1505 whether or not N is equal to five. The determination is NO when N is equal to or less than four (N≦4), in which case the flow returns to step S1501, from which the control circuit 30 repeats a similar procedure. When N is equal to five (N=5), the flow goes to step S1506, where an error display signal is output to the terminal 5 or general-purpose computer 6 through the input/output interface 31 and communication network 3, forcing the terminal 5 or general purpose computer 6 to display a corresponding failure (error) in the reading procedure. Then, at step S1507, the control circuit 30 sets the flag F to “1,” followed by the termination of the flow. In this way, even in the event of a failure in reading the RFID tag information, the label producing apparatus 2 retries the reading procedure up to five times, thereby ensuring the reliability for reading.

When the determination at step S1503 is YES, this means that the RFID tag information has been successfully read from the target RFID circuit element To, followed by the termination of the routine.

Through the foregoing routine, the label producing apparatus 2 can access and read the RFID tag information (tag identification information and the like) stored in the IC circuit part 151 of the target RFID circuit element To within the cartridge 100.

The exemplary modification above can also provide similar advantages to those in the foregoing embodiment.

(1-3) Others:

In the example described above, the reel member is formed with grooves on the peripheral surface thereof for preventing malfunctions, and a smaller area of the adhesive layer of the base tape can be brought into contact with the reel member by virtue of the resulting toothed shape of the reel member. The present invention, however, is not limited to such a reel member formed with grooves. Instead of the grooves, projections may be formed on the peripheral surface of the reel member to serve as a malfunction preventing device which results in a similar toothed shape of the reel member which contributes to a reduction in the area of the adhesive layer of the base tape in contact with the reel member (in other words, the reel member is only required to be formed with projections and/or grooves which reduce the area of the adhesive layer of the base tape in contact with the reel member). The projections may have a cross-sectional shape which tapers toward the leading end thereof, such as a saw-tooth shape (most preferable. See the embodiment described above), a rectangular shape, or the like, or alternatively may have another shape such as a circular or columnar shape.

Also, the foregoing embodiment has shown the exemplary label producing apparatus which reads/writes RFID tag information from/to the tape 101 moving within the cartridge 100, and prints a character on the tape 103 similarly moving within the cartridge 100. The present invention is not limited to this particular example, but the label producing apparatus may print a character on the tap 103 which is stopped at a predetermined position, and read/write RFID tag information from/to the tape 101 which is stopped and further held by a predetermined transport holder (this is applied to a second embodiment, later described, as well).

Also, in the foregoing embodiment, the label producing apparatus employs a label tape which is the base tape 101 that contains the RFID circuit element To. The present invention, however, is not limited to the use of such a particular label tape, but may employ a normal base tape which does not contain the RFID circuit element To. Further, the present invention may be applied to a label producing apparatus (without the antenna 14, and the signal processing circuit 22 and high frequency circuit 21 associated therewith, and the like) which employs such a normal tape. Such a label producing apparatus can also provide the essential advantage of the present invention, i.e., the prevention of tape jamming (this is applied to the second embodiment, later described, as well).

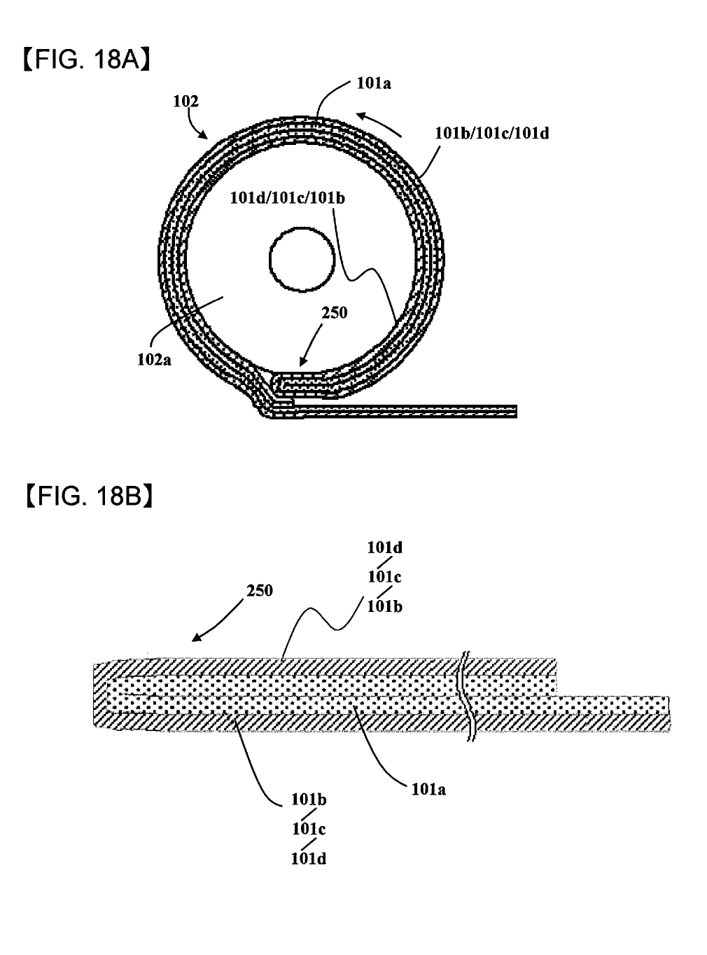

Now, a second embodiment of the present invention will be described with reference to FIGS. 18 to 20. Unlike the first embodiment which employs a reel member formed with grooves that serve as the malfunction preventing device, in the second embodiment, the base tape has a non-adhesive area on the lower side at the end thereof from which the base tape is wound around the reel member. The non-adhesive area has substantially no adhesive force. Parts equivalent to those in the first embodiment are designated the same reference numerals, and a description thereon is omitted or simplified as the case may be.

A label producing apparatus 2 of the second embodiment is applicable, for example, to the RFID tag manufacturing system 1 illustrated in FIG. 1 above, and is similar in configuration to that of the first embodiment illustrated in FIGS. 2 to 5 above. Specifically, a cartridge 100 contained in the label producing apparatus 2 is similar to that illustrated in FIG. 5 in the first embodiment, and comprises abase tape roll 102 and a print-receiving tape roll 104. Like the first embodiment, the base tape roll 102 includes the base tape 101 which is wound around the peripheral surface of a reel member (shaft member, spool) 102a, the axial direction of which is substantially perpendicular to the longitudinal direction of the base tape 101. The base tape 101 is formed with a plurality of RFID circuit elements To sequentially arranged at predetermined equal intervals in the longitudinal direction. The radio frequency circuit 21 and RFID circuit element To are also similar in configuration to those illustrated in FIGS. 8 and 9 above.

The control circuit 30 executes the control procedure represented by the flow charts in FIGS. 13 and 14 to write corresponding RFID tag information into a target RFID circuit element To on the base tape 101, print a character R corresponding to the RFID tag information on a corresponding area on the print-receiving tape 103, and cut the tapes 101, 103 to a predetermined length to produce a RFID label T. The produced RFID label T is similar in configuration to those illustrated in FIGS. 10A, 10B, 11 above. In this event, the terminal 5 or general-purpose computer 6 displays, for example, the screen illustrated in FIG. 12 above.

FIG. 18A is a cross-sectional view illustrating in detail the structure of the base tape roll 102 which is an essential component of the second embodiment. FIG. 18B is a cross-sectional view schematically illustrating one end of the base tape 101. It should be noted that though the base tape 101 is actually in a four-layer structure, the base film 101b, adhesive layer 101c, and separation sheet 101d are schematically represented by a single layer (hereinafter designated “101b/101c/101d” in the laminating order in the drawings) in FIG. 18A for purposes of simplifying the description. Accordingly, the base tape 101 is represented by a total of two layers which consist of the single laminate layer and the adhesive layer 101a. FIG. 18A also depicts the tape in a larger thickness for emphasis. In addition, in FIG. 18B, the upward direction on the sheet is the most inner side in the roll axial direction. As illustrated in FIG. 18A, the base tape roll 102 comprises the reel member 102a (shaft member), the axial direction of which is perpendicular to the longitudinal direction of the base tape 101, and is wound with the adhesive layer 101a of the base tape 101 around its peripheral surface. Also, as illustrated in FIG. 18B, the base tape 101 has a turned edge 250 (non-adhesive area, malfunction preventing device) at the end, at which the base tape 101 is folded back such that the separation sheet 101d is positioned on the most inner side in the radial direction of the roll.

Specifically, the turned edge 250 of the base tape 101 at the end thereof does not adhere to the reel member 102a (or has an adhesive force substantially weak enough to readily come off the reel member 102a), bur is rolled around the reel member 102a (in a radially laminated structure). With this turned edge 250, when the base tape 101 has been used up and reaches the tape end, the end can be relatively easily released from the reel member 102a. Since the base tape 101 is released from the reel member 102a immediately after it has fed out, the print-receiving tape 103 alone is continuously fed out in a similar manner, thus preventing the print-receiving tape 103 from jamming. In addition, since the turned edge 250 is formed simply by folding back the end of the base tape 101, the non-adhesive area can be readily formed at the beginning end of the base tape 101, from which the base tape 101 is wound around the reel member 102a, in a simple structure without the need for adding any dedicated members.

Though not shown, when the reel member 102a, i.e., paper tube is not used, i.e., when the base tape 101 is wound to form a hollow in the center, the base tape 101 provides similar advantages to the above. For forming such a hollow, the reel member 102a may be removed from the center of the wound base tape 101 in the axial direction after the base tape 101 has been wound into a roll shape similar to that illustrated in FIG. 18A.

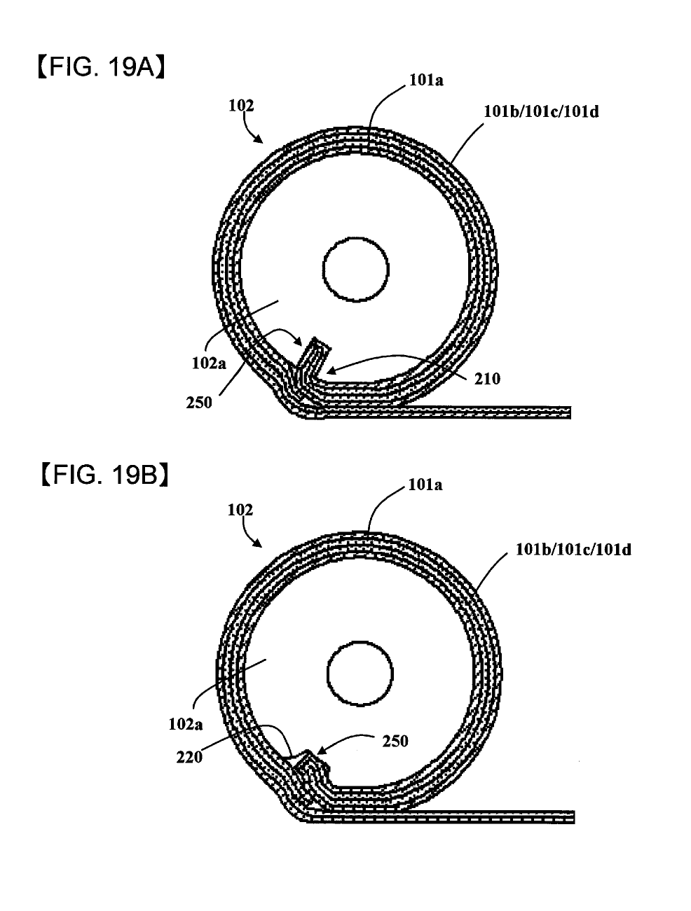

FIGS. 19A, 19B are cross-sectional views each illustrating an exemplary modification to the base tape roll 102. Likewise, FIGS. 19A, 19B schematically represent the base tape 101 in a two-layer structure consisting of the adhesive layer 101a and laminate including the base film 101a and the like, and depict the tape in a larger thickness for emphasis. In an exemplary modification illustrated in FIG. 19A, the reel member 102a (shaft member) is provided with an incision (engagement recess) 210 cut thereinto along the axial direction, and the turned edge 250 (non-adhesive area) of the base tape 101 is fit into the incision 210 for engagement with the reel member 102a. The rest of the structure is similar to that of FIG. 18.

With the addition of the incision 210 into which the turned edge 250 of the base tape 101 is fitted, the base tape 101 can be strongly coupled to the reel member 102a during a normal use, while ensuring the ease of release from the reel member 102a at the time the base tape 101 has been used up, in addition to the advantages provided by the structure of FIG. 18, thus maintaining good workability for winding and the like.

In an exemplary modification illustrated in FIG. 19B, instead of the incision 210 formed in the reel member 102a as illustrated in FIG. 19A, the reel member 102a is provided with a recess 220 (engagement recess) formed along the axial direction thereof, such that the turned edge 250 (non-adhesive area, malfunction preventing device) of the base tape 101 is fitted into the recess 220 for engagement with the reel member 102a. The rest of the structure is similar to that of FIG. 19A. In addition to similar advantages of the exemplary modification illustrated in FIG. 19A, the reel member 102a formed with the recess 220 can prevent the rolled base tape 101 from deforming due to the thickness of the turned edge 250.

In the foregoing description, the print-receiving tape 104 is wound around the reel member 104a to form a fourth roll, while the base tape 101 is wound around the reel member 102a to form the base tape roll 102 which is a third roll and also serves as the roll of tape for producing a label. The base tape roll 102 is made up of the tape base (base film 101b) and the adhesive layer on one surface of the tape base, and is used for a label medium which is wound in the circumferential direction such that the base tape is laminated in the radial direction.

The label producing apparatus 2 of the second embodiment as described above is similar to the first embodiment in that the print-receiving tape 103 fed out from the print-receiving tape roll 104 is bonded to the base tape 101 fed out from the base tape roll 102 by the feeding roller 107 to create the tag label tape 110 with print which is used to produce the RFID label T.

Here, when the base tape 101 containing the RFID circuit element To is bonded to the print-receiving tape 103 to create the RFID label T as described above, it is a general tendency that the overall length of the relatively expensive base tape 101 has been previously set shorter than the overall length of the relatively cheep print-receiving tape 103 in the cartridge 100 (with the intention of ensuring that the base tape 101 is used up earlier). In other words, the print-receiving tape 103 comprises an extension to have the overall length longer than the base tape 101. For this reason, at the time the base tape 101 is used up and is no longer fed out from the base tape roll 102, the print-receiving tape 103 still remains in and is fed out from the print-receiving tape roll 103. In this event, if the base tape 101 is securely fixed to the reel member 102a of the base tape roll 102, the exhausted base tape 101 will cause the tag label tape 110 with print to stop transporting, whereas the print-receiving tape 103 is still continuously fed out from the print-receiving tape roll 104 has nowhere to go in a space closer to the print-receiving tape roll 104 than the feeding roller 107 and sub-roller 109, and can stay in a nearby space (space near the print head 10 and platen roller 108 in this example) to possibly result in jamming.

Accordingly, in the second embodiment, the end of the base tape 101 is folded back to make the turned edge 250 which does not adhere to (at least substantially hardly adhere to) the reel member 102a (or a hollow is formed at the center of the rolled base tape 101). In this way, the base tape roll 102 is provided with a roll structure which does not adhere to the reel member 102a. As a result, when the base tape 101 has used up and reached the end thereof earlier than the print-receiving tape 103, the end edge of the base tape 101 can be relatively readily detached and removed from the reel member 102a. As a result, the tape 110 still remains driven (the tape 110 is made only of the print-receiving tape 103 after the base tape 101 is used up), so that the print-receiving tape 103 alone is continuously fed out from the print-receiving tape roll 104 in a manner similar to before, thus making it possible to prevent the jamming as mentioned above. In other words, malfunctions and/or inappropriate operations can be prevented in the tape transport process.

It should be understood that the second embodiment is not limited to the foregoing, but can be modified in various ways without departing from the spirit and technical idea. The following description will be focused on such exemplary modifications one by one.

(2-1) Variations in Base Tape End:

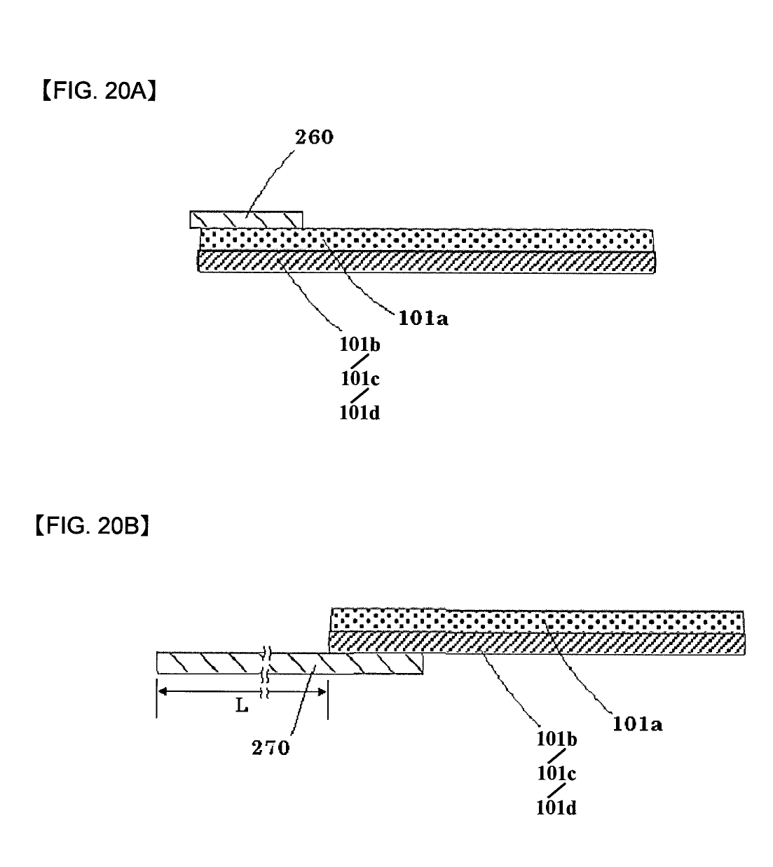

FIGS. 20A, 20B are cross-sectional views each illustrating an end portion of the base tape 101. It should be noted that though the base tape 101 is actually in a four-layer structure, the base tape 101 is schematically represented in a two-layer structure consisting of the adhesive layer 101a and a laminate including the base film 101b and the like for purposes of simplifying the description, in a manner similar to the aforementioned FIG. 18B. FIG. 20A also depicts the tape in a larger thickness for emphasis. In addition, in FIGS. 20A, 20B, the upward direction on the sheet is the most inner side in the roll axial direction. In an exemplary modification illustrated in FIG. 20A, a non-adhesive member 260 (first non-adhesive member, non-adhesive area, malfunction preventing device) is attached to the end of the base tape 101 in the longitudinal direction thereof so as to cover the adhesive layer 101a. By thus covering the adhesive layer 101a with the non-adhesive member 260 attached to the base tape 101, a non-adhesive area can be simply formed at the leading end of the base tape 101 from which it is wound around the reel member 102a. In this event, the non-adhesive member 260 may be joined to the base tape 101, for example, with Hotchkiss™, i.e., a stapler or another adhesive.

In an exemplary modification illustrated in FIG. 20B, anon-adhesive member 270 (second non-adhesive member, non-adhesive area, malfunction preventing device) is attached to the end of base tape 101 to extend the base tape 101. The length L of the non-adhesive member 270, by which the non-adhesive member 270 extends from the base tape 101 (in the longitudinal direction), should be long enough to be wound around the reel member 102a at least once. In this way, since the base tape 101 is ensured not to adhere to the reel member 102a while it is wound around the reel member 102a once from the leading end, the end of the base tape 101 can be more reliably released from the reel member 102a when the base tape 101 has been used up and reached the tape end (a similar advantage can be provided by the non-adhesive member 260 or turned edge 250 if they are made to have a length long enough to be wound around the reel member 102a at least once). In this event, the non-adhesive member 270 may also be joined to the base tape 101, for example, with a Hotchkiss™ or another adhesive.

(2-2) When Information is Simply Read from RFID Circuit Element to:

As previously described in Section (1-2) above in the first embodiment, the second embodiment can also be applied to a label T which is produced by reading RFID tag information from a read-only RFID circuit element To which previously stores predetermined RFID tag information in a non-erasable manner, and printing a character corresponding to the read RFID tag information. As previously described in Section (1-2) above, the control circuit 30 may execute the flowchart illustrated in FIG. 17. This exemplary modification also provides similar advantages to those of the foregoing embodiment.

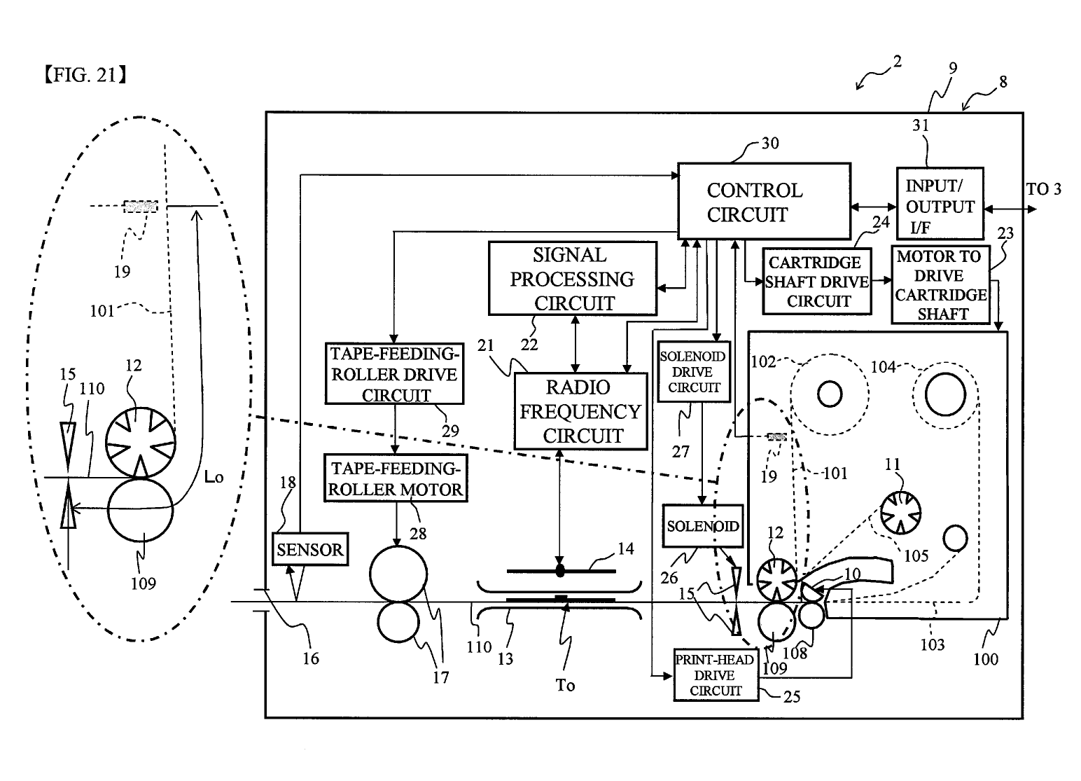

A third embodiment of the present invention will now be described with reference to FIGS. 21 to 38. The third embodiment relates to a label producing apparatus which comprises a malfunction preventing device that prevents malfunctions of a detecting device configured to detect an object to be detected on a label medium. Parts equivalent to those in the first and second embodiments are designated the same reference numerals, and descriptions thereon are omitted or simplified as appropriate.

The label producing apparatus 2 of the third embodiment is applied, for example, to the RFID tag manufacturing system 1 illustrated in FIG. 1 above, as is the case with the first and second embodiments described above. FIG. 21 is a diagram conceptually illustrating in detail the structure of the label producing apparatus 2, and is substantially comparable to FIG. 2 above.

Referring to FIG. 21, the tag-label producing apparatus 2 of the third embodiment differs from the tag-label producing apparatus 2 in the first and second embodiments in the following aspects. Unlike the first and second embodiments, signals are transmitted/received to/from a RFID circuit element To (described later in greater detail) outside of the cartridge 100 through the antenna 14 over the air using a high frequency in the UHF band or the like. The RFID circuit element To is contained in the printed tag-label tape 110 (in other words, in the base tape 101) which is made up of the base tape 101 and the print-receiving tape 103 adhered thereto and discharged from the cartridge 100.

The label producing apparatus 2 also comprises a pair of feeding guides 13 configured to hold a RFID tag circuit element To in a predetermined access area opposite to the antenna 14 upon transmission/reception of signals over the air, and guiding the cut tape 110 (i.e., RFID label T); a feed roller 17 configured to transport the guided RFID label T to the carry-out exit (discharge port) 16; a tape end sensor 18 configured to detect whether or not a RFID label T exists at the carry-out exit 16; and a sensor 19, i.e., an optical detecting device disposed relatively near the base tape 101 immediately after it is fed out from the base tape roll 102.

Also, associated with the additional components described above, the apparatus body 8 additionally comprises a tape-feeding-roller motor 28 configured to drive the feed roller 17, and a tape-feeding-roller drive circuit 29 configured to control the tape-feeding-roller motor 28. The tape-feeding-roller drive circuit 29 is controlled based on a control signal from the control circuit 30. The control circuit 30 is applied with detection signals from the sensors 18, 19.

The radio frequency circuit 21 is similar in detailed configuration to the radio frequency circuit 21 described above with reference to FIG. 8 in the first embodiment, and the RFID circuit element To is also similar in detailed configuration to the RFID circuit element To described above with reference to FIG. 9 in the first embodiment. A distance Lo will be described later in a fourth embodiment.

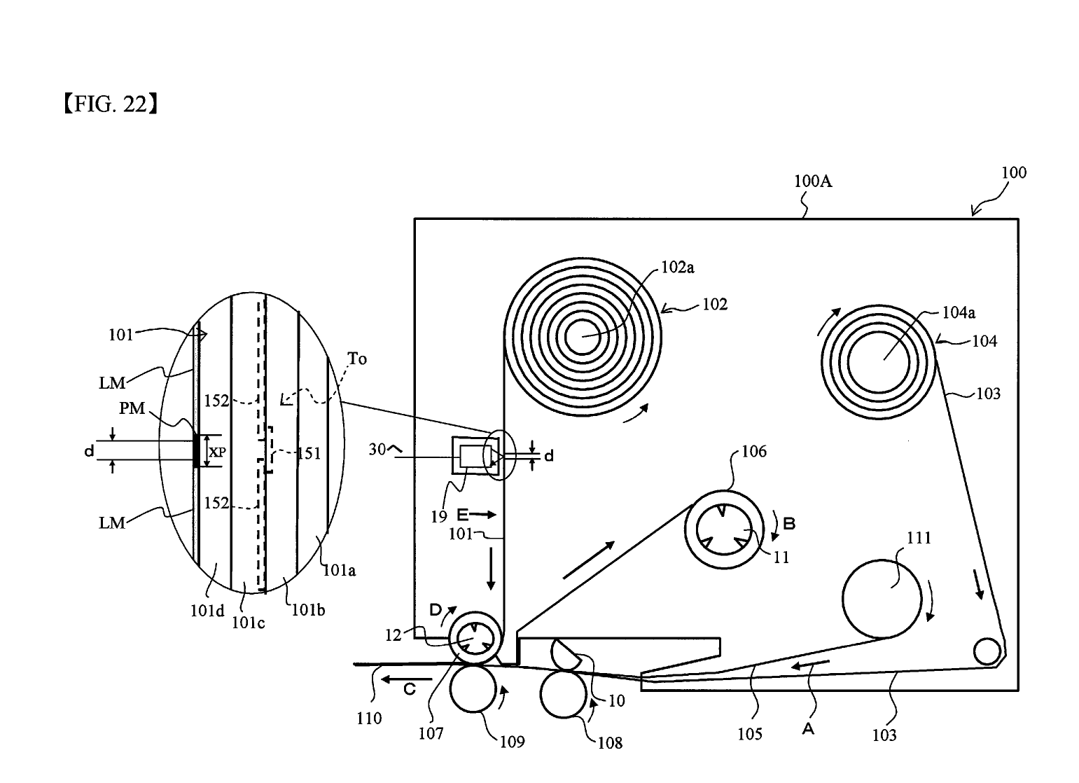

FIG. 22 is an explanatory diagram for describing in detail the structure of the cartridge 100 associated with the label producing apparatus 2 of the third embodiment, and is substantially comparable to FIG. 5 above.

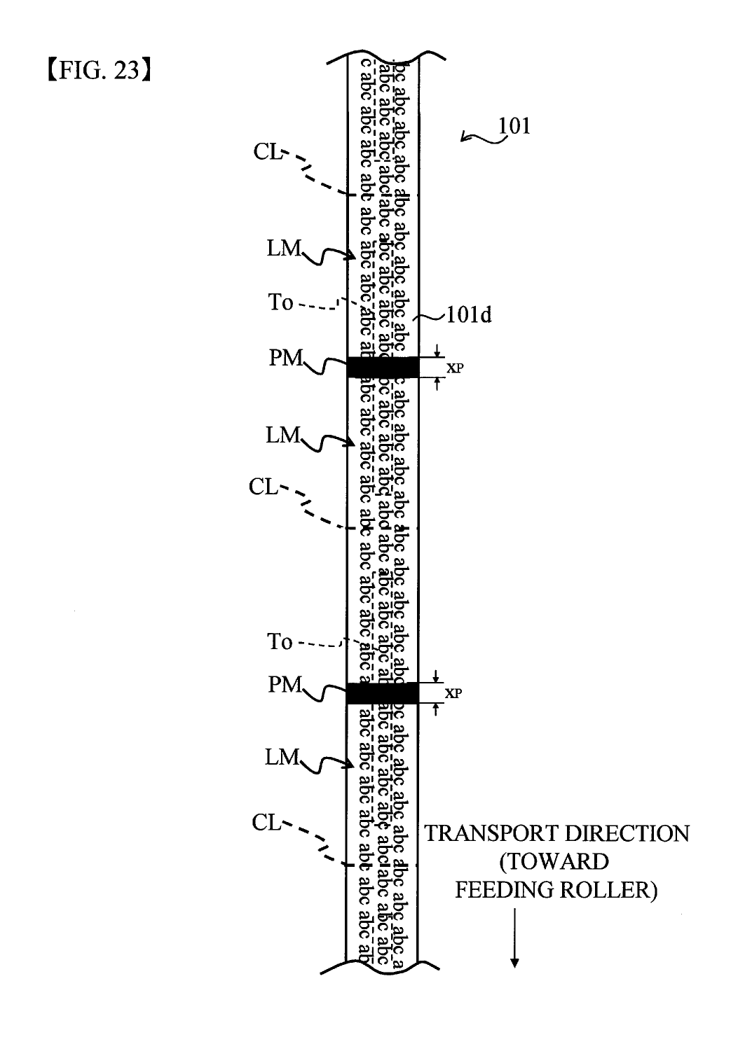

Referring to FIG. 22, the third embodiment differs in configuration from the first and second embodiments in the following aspects. On the separation sheet 101d of the base tape 101 in a four-layer structure comprised of the adhesive layer 101a (bonding adhesive layer), base film 101b (tape base layer), adhesive layer 101c (affixing adhesive layer), and separation sheet 101d (separation material layer) laminated in this order, access marks (first identification marks) PM are borne (for example, by printing) at predetermined intervals for establishing a timing for controlling the print head 10 to start printing (i.e., location of a start point) and positioning the tape during transport. Also, decorative marks, i.e., Logo marks LM are borne in a majority of the surface on the separation sheet 101d except for those areas on which the access marks PM are borne (see FIG. 23, later described, for further details).

As described above, the label producing apparatus 2 comprises the sensor 19 which is, for example, a reflective photo-electric sensor having a light emitter and a light receiver. Light emitted from the light emitter is reflected by a reflective object, if any, between the light emitter and light receiver, and impinges on the light receiver. The sensor 19 generates a control output value in accordance with the intensity of the reflected light, and outputs a signal indicative of the detected light intensity to the control circuit 30. In this event, the sensor 19 can read the base tape 101 within a range d (for example, a longitudinal dimension of the base tape 101, which is applied in the following description as well) in the longitudinal direction of the base tape 101 (vertical direction in FIG. 22). The access mark PM has a longitudinal dimension XP larger than the reading range d.

FIG. 23 is a diagram illustrating in detail the structure of the base tape 101 on one side (backside), viewed from a direction indicated by an arrow E in FIG. 22.

Referring to FIG. 23, on the separation sheet 101d of the base tape 101, the access mark PM (first identification mark) is borne corresponding to each RFID circuit element To for use in establishing the timing at which the print head 10 is controlled to start printing (location of a start point), or for use in positioning the base tape 101 such that it is cut at a cut position CL by the cutter 15 (described later in greater detail). The access marks PM are borne at the same pitch as the pitch at which the RFID circuit elements To are arranged in the base tape 101. Thus, each access mark PM is placed in substantially the same positional relationship to each RFID circuit element To (in this example, the access mark PM is positioned near the center of an associated RFID circuit element To in the longitudinal direction). Consequently, the base tape 101 wound in the base tape roll 102 includes the same number of access marks PM as the RFID circuit elements To.

Also, Logo marks LM are borne in a majority of the surface on the separation sheet 101d except for those areas on which the access marks PM (a character “abc” in this example, or character design, and the like) such as enterprise logo, product log or the like are borne for purposes of advertising effects, users' enjoyment and the like.

FIG. 23 virtually shows cut lines (scheduled cut lines) CL on the base tape 101 from which it is cut to a predetermined length, including each RFID circuit element, by the cutter 15 to produce a RFID label T.

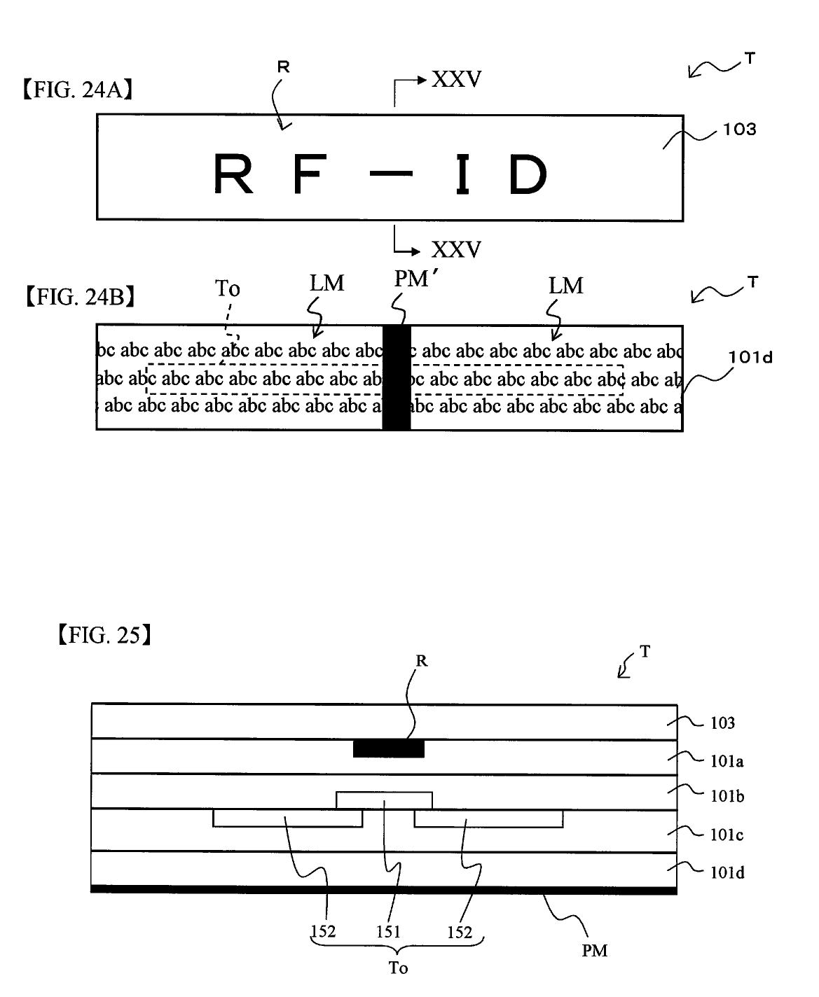

FIGS. 24A and 24B are diagrams illustrating an exemplary appearance of a complete RFID label T, cut off from the tag label tape 110 with print after RFID tag information has been read from the RFID circuit element To. FIG. 24A is a top plan view (seen from above the print-receiving tape 103), and FIG. 24B is a bottom plan view (seen from below the separation sheet 101d). FIGS. 24A and 24B are comparable to FIGS. 11A and 11B, respectively, in the first embodiment. FIG. 25 in turn is a cross-sectional view taken along a section XXV-XXV′ in FIG. 24, comparable to FIG. 12 in the first embodiment.

Referring to FIGS. 24A, 24B, 25, the RFID label T is in a five-layer structure in which the print-receiving tape 103 is added to the four-layer structure illustrated in FIG. 22. The five layers are comprised of the print-receiving tape 103, the adhesive layer 101a, the base film 101b, the adhesive layer 101c, and the separation sheet 101d, which are laminated from the print-receiving tape 103 (upper side in FIG. 25) to the opposite side (lower side in FIG. 25). As described above, the RFID circuit elements To, each including the antenna 152 and disposed on the back side of the base film 101b, is embedded in the adhesive layer 101c, and a character R (in the example, a character “RF-ID” indicative of the type of the RFID label T in this example) is printed on the back side of the print-receiving tape 103. Also, the access mark PM and logo marks LM are borne on the surface of the separation sheet 101d (on the front surface in FIG. 24B, and on the bottom surface in FIG. 25), for example, by printing.

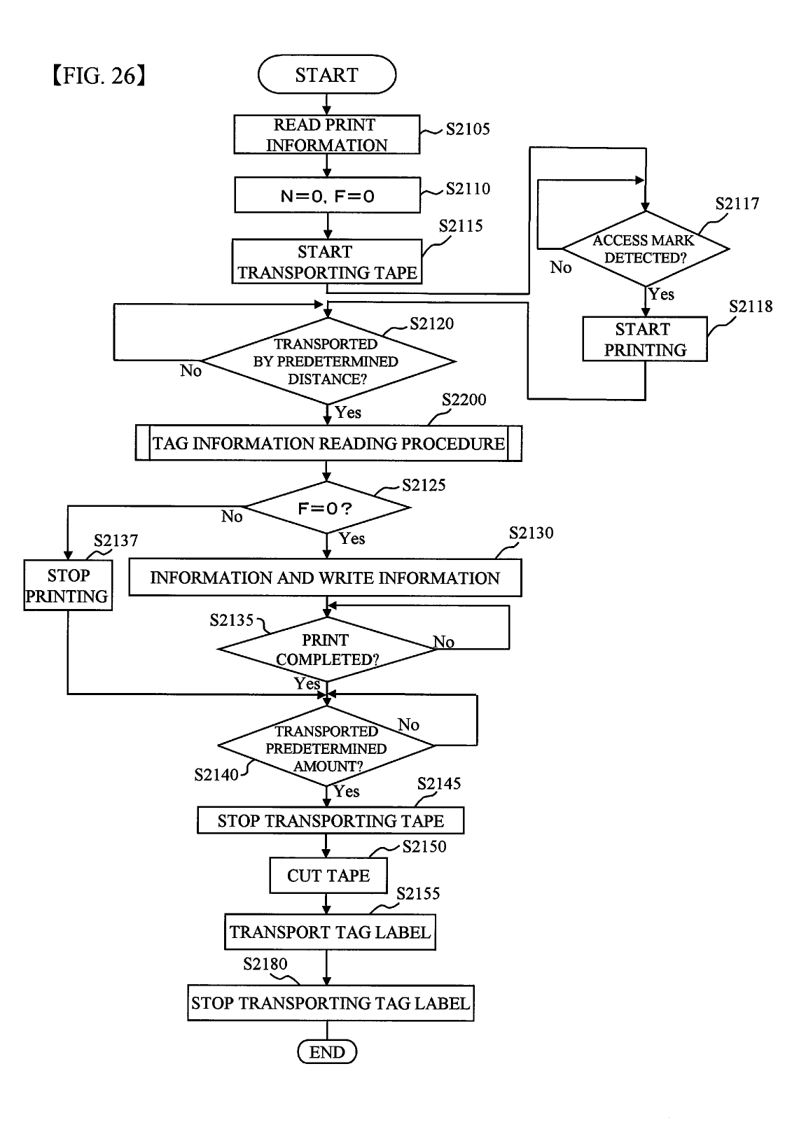

FIG. 26 is a flow chart illustrating a control procedure executed by the control circuit 30 during the production of the RFID label T in a scenario where a predetermined character is printed by the print head 10 on the print-receiving tape 103 which is transported while the base tape 101 is bonded to the print-receiving tape 103 to form the tag label tape 110 with print which is then cut into individual RFID labels T, each of which contains one RFID circuit element To. FIG. 26 is substantially comparable to FIG. 14 in the first embodiment.

Referring to FIG. 26, the flow is started in response to a read operation performed by the tag-label producing apparatus 2, for example, through the terminal 5 or general-purpose computer 6 (or possibly through a manipulation panel, not shown, provided on the tag-label producing apparatus 2 itself, which may be employed in the following embodiments and modifications). First, at step S2105, the tag-label producing apparatus 2 reads, through the communication network 3 and input/output interface 31, information which is entered through the terminal 5 or general purpose computer 6 and which the operator wishes to write into the IC circuit part 151 of the RFID circuit element To; and print information which should be printed on the RFID label T by the print head 10.

Subsequently, at step 2110, the control circuit 30 initializes a variable N for counting the number of times a retry is made when no response is returned from the RFID circuit element To (number of times of access retries), and a flag F indicative of a normal or a failed communication.

Then, at step S2115, the control circuit 30 outputs a control signal to the cartridge shaft drive circuit 24 to drive the ribbon take-up roller 106 and feeding roller 107 with a driving force of the motor 23 to drive cartridge shaft, in a manner similar to step S1115 in FIG. 14. In this way, the base tape 101 is fed out from the base tape roll 102 and supplied to the feeding roller 107, while the print-receiving tape 103 is fed out from the print-receiving tape roll 104. Also, in this event, the control circuit 30 outputs a control signal to the tape-feeding-roller motor 28 through the tape-feeding-roller drive circuit 29 to rotate the feed roller 17.

Next, the flow goes to step S2117, where the control circuit 30 determines whether or not the access mark PM is detected by the sensor 19 on the base tape 110 (whether or not a mark detection signal is entered).

Specifically, in the third embodiment, the access mark PM has the length XP which is set longer than a reading range d of the sensor 19. Accordingly, when the base tape 101 is transported in the foregoing manner to such a point at which the access mark PM falls within the reading range, the reading range (i.e., a first reading range) only includes optical information corresponding to the access mark PM. This causes the sensor 19 to output a different detection result from a detection result which is output by the sensor 19 when the logo mark LM falls within the reading range (i.e., a second reading range). For example, when the access mark PM is a solid painted area in a shape as illustrated in FIGS. 23 and 24, a small amount of light is reflected from the access mark PM. On the other hand, in regard to the logo mark LM, though a smaller amount of light is reflected from printed characters of the logo mark LM, a larger amount of light is reflected from the area which defines the logo mark LM except for the characters. As such, a larger amount of light is reflected from the logo mark LM as a whole than the access mark PM, causing the sensor 19 to output a larger signal value (or the logo mark LM may be designed with a number of characters (or printed area) which results in a larger amount of reflected light). Thus, the sensor 19 can reliably recognize the access mark PM in accordance with the difference in the amount of reflected light. At step S2117, the control circuit 30 determines whether or not the access mark PM is detected in accordance with the result of the detection made by the sensor 19 based on the foregoing principle.

The determination at step S2117 is NO while the access mark PM is not detected (while the logo mark LM remains at a position opposite to the sensor 19, instead of the access mark PM, though the base tape 101 is being fed out). The determination at step S2177 is YES when the base tape 101 is further fed out to cause the access mark PM to reach the position opposite to the sensor 19, permitting the sensor 19 to detect the access mark PM. In response, the flow goes to step S2118.

At step S2118, the control circuit 30 outputs a control signal to the print-head drive circuit 25 which powers the print head 10. In response, the printhead 10 starts printing the character R read at step S2105, such as characters, symbols, bar code or the like on a predetermined area of the print-receiving tape 103 (area which is to be bonded to the back side of base tape 101 in which RFID circuit elements To are arranged at regular intervals and at a predetermined pitch).

Consequently, the base tape 101 is bonded to the print-receiving tape 103, on which the character R has been printed, by the feeding roller 107 and sub-roller 109 for integration into the tag label tape 110 with print which is delivered to the outside of the cartridge 100.

Subsequently, at step S2120, the control circuit 30 determines whether or not the tag label tape 110 with print has been transported by a predetermined distance (for example, a transport distance long enough for the RFID circuit element To, to which the print-receiving tape 103 has been bonded, to reach the feeding guides 13). The determination on the transport distance may be made, for example, by measuring the angle by which the motor 23 to drive cartridge shaft has rotated from the time the access mark PM has been detected by the sensor 19, or counting the number of pulses output from the cartridge shaft drive circuit 24 configured to drive the motor 23 to drive cartridge shaft. When the determination at step S2120 is YES, the flow goes to step S2200.

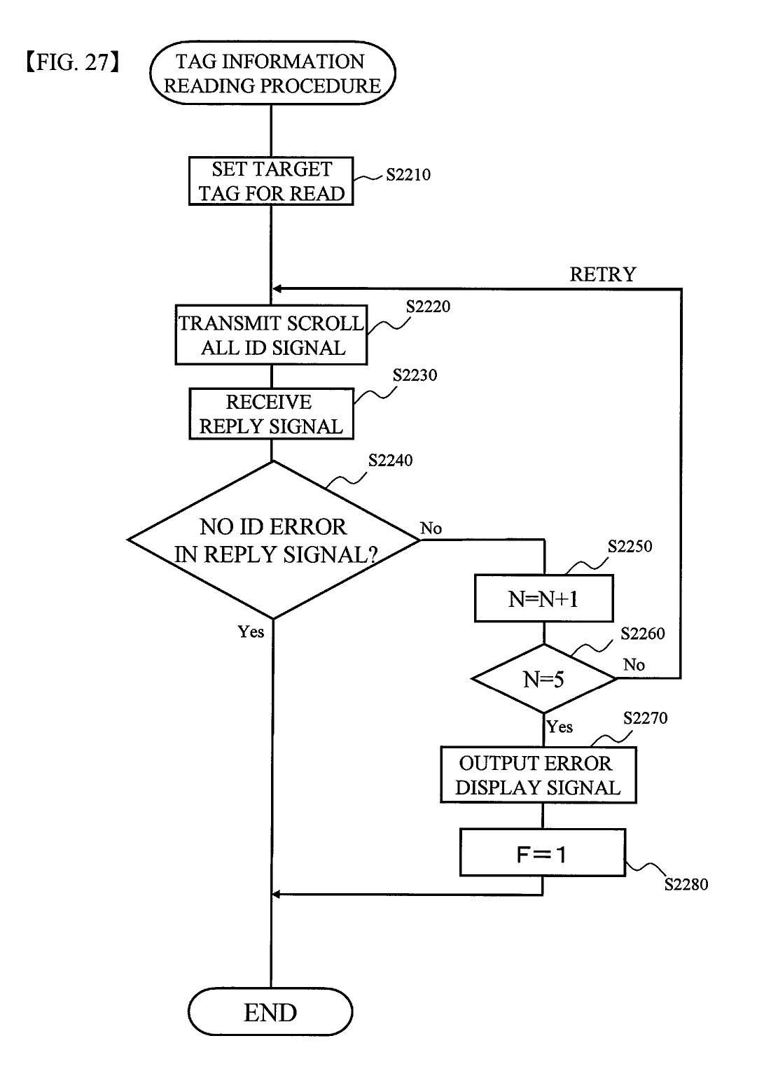

At step S2200, the control circuit 30 accesses the RFID tag circuit element To (for reading RFID tag information in this example) by transmitting a query signal to the RFID circuit element To for reading. Then, the control circuit 30 receives and reads a response signal including RFID tag information (see FIG. 27, later described, for further details). After step S2200 is completed, the flow goes to step S2125.

At step S2125, the control circuit 30 determines whether or not the flag F is set to “0.” When the read processing has been normally completed, the flag F remains to be “0” (see step S2280 in a flow chart illustrated in FIG. 27, later described). Accordingly, the determination at step S2125 should be YES, causing the flow to go to step S2130.

At step S2130, the control circuit 30 outputs a combination of the information read from the RFID circuit element To at step S2200 with the print information previously printed by the print head 10 corresponding thereto for storage in the information server 7 and route server 4 through the terminal 5 or general purpose computer 6 by way of the input/output interface 31 and communication network 3. The information may be stored, for example, in the route server 4. The stored data is stored such that the terminal 5 or general-purpose computer 6 has accesses thereto as required.

Subsequently, the flow goes to step S2135, where the control circuit 30 repeats a determination as to whether or not characters have been printed on the area of the print-receiving tape 103 corresponding to the RFID circuit element To which should be processed at this time, until the character has been completely printed on the area, in a manner similar to step S1135 in FIG. 14. The determination at step S2135 is YES when the character has been completely printed on the area, followed by the flow going to step S2140.

At step S2125 described above, if the reading procedure has not been normally completed for some reason, the flag F is set to “1” (see at step S2280 in the flow chart illustrated in FIG. 27, later described). Accordingly, the determination at step S2125 is NO, causing the flow to go to step S2137, where the control circuit 30 outputs a control signal to the print-head drive circuit 25 to stop the power to the print head 10 which stops the printing in response to the control signal. In this way, the control circuit 30 explicitly displays that a pertinent RFID circuit element To is defective through such interrupted printing. Then, the flow goes to step S2140.

At step S2140, the control circuit 30 determines whether or not the tag label tape 110 with print has been further transported by a predetermined distance (for example, a transport distance long enough for a RFID circuit element To under processing and a print area on the print-receiving tape 103 corresponding thereto to go beyond the cutter 15 by a predetermined length (margin)). The determination on the transport distance may also be made, for example, by measuring the angle by which the motor 23 to drive cartridge shaft has rotated from the time the access mark PM has been detected by the sensor 19, or counting the number of pulses output from the cartridge shaft drive circuit 24 configured to drive the motor 23 to drive cartridge shaft, in a manner similar to step S2120 described above. The determination at step S2140 is YES when the tag label tape 110 with print has been transported by the predetermined distance, causing the flow to go to step S2145.

At step S2145, the control circuit 30 outputs a control signal to each of the cartridge shaft drive circuit 24 and tape-feeding-roller drive circuit 29 to stop driving the motor 23 to drive cartridge shaft and tape-feeding-roller motor 28, thus stopping rotations of the ribbon take-up roller 106, feeding roller 107, and feed roller 17. This results in stopping the base tape 101 fed out from the base tape roll 102, the print-receiving tape 103 fed out from the print-receiving tape roll 104, and the tag label tape 110 with print transported by the feed roller 17. At this time, the cut line CL borne on the separation sheet 101d just reaches a position (opposite to the cutter 15) sandwiched by blades of the cutter 15.

Subsequently, at step S2150, the control circuit 30 outputs a control signal to the solenoid drive circuit 27 to drive the solenoid 26 which forces the cutter 15 to cut (break) the tag label tape 110 with print along the cut line CL. As described above, for example, the RFID circuit element To under processing and a printed area of the print-receiving tape 103 corresponding thereto have sufficiently passed beyond the cutter 15 at this time. The tag label tape 110 with print cut by the cutter 15 results in a RFID label T from which predetermined RFID tag information has been read from the RFID circuit element To and on which a predetermined character has been printed in correspondence to the RFID tag information (stated another way, the cutter 15 cuts off the RFID label T along the trailing edge on the downstream side in the transport direction).

Next, the flow goes to step S2155, where the control circuit 30 outputs a control signal to the tape-feeding-roller drive circuit 29 which responsively resumes driving the tape-feeding-roller motor 28 to rotate the feed roller 17. Consequently, the feed roller 17 resumes transporting the RFID label T produced in a label shape at step 2150 above toward the carry-out exit 16.

Then, the flow goes to step S2180, where the control circuit 30 outputs a control signal to tape-feeding-roller drive circuit 29 which responsively stops driving the tape-feeding-roller motor 28, for example, after the lapse of time or the transportation of the tag label tape 110 with print long enough to discharge the RFID label T to the outside of the apparatus 2 through the carry-out exit 16, causing the feed roller 17 to stop rotating. Then, the flow is terminated.

FIG. 27 is a flowchart illustrating in detail a procedure at step S2200 above.

Referring to FIG. 27, at step S2210, after the printing on the tag label tape 110 with print, a RFID tag circuit element To, from which information is to be read, is transported to the vicinity of the antenna 14, and the target tag is identified.

Next, at step S2220, the control circuit 30 outputs a “Scroll All ID” command to the signal processing circuit 22 for reading information stored in the RFID circuit element To in a manner similar to step S1501 in FIG. 17 in conformity to predetermined communication parameters and the like. Based on the “Scroll All ID” command, the signal processing circuit 22 generates a “Scroll All ID” signal as access information, which is transmitted to a RFID circuit element To intended for access (target RFID circuit element) through the radio frequency circuit 21, to prompt the RFID tag circuit element To return a relay signal.

Next, at step S2230, the tag producing apparatus 2 receives the reply signal (RFID tag information including tag ID information, article information and the like) transmitted from the target RFID circuit element To in response to the “Scroll All ID” signal through the antenna 14, in a manner similar to step S1502 in FIG. 17. Then, the control circuit 30 captures the reply signal through the radio frequency circuit 21 and signal processing circuit 22.

Next, the control circuit 30 determines at step S2240 whether or not the reply signal received at step S2230 is erroneous using a known error detecting code (CRC (Cyclic Redundancy Check) code or the like) in a manner similar to step S1503 in FIG. 17.

When the determination is NO, the flow goes to step S2250, where N is incremented by one, in a manner similar to step S1504 in FIG. 17. Then, the control circuit 30 further determines at step S2260 whether or not N is equal to five, in a manner similar to step S1505 in FIG. 17. When N is equal to or less than four (N≦4), the flow returns to step S2220, from which the control circuit 30 repeats a similar procedure. When N is equal to five (N=5), the flow goes to step S2270, where an error display signal is output to the terminal 5 or general-purpose computer 6 through the input/output interface and communication network 3, forcing the terminal 5 or general purpose computer 6 to display a corresponding failure (error) in the reading procedure, in a manner similar to steps S1506, S1507 in FIG. 17, (alternatively, a corresponding display may be made on a display device, not shown, provided in the tag-label producing apparatus 2 itself). Then, at step S2280, the control circuit 30 sets the flag F to “1,” followed by the termination of the flow.

When the determination at step S2240 is YES, this means that the RFID tag information has been successfully read from the target RFID circuit element To, followed by the termination of the flow.

In this event, the terminal 5 or general-purpose computer 6 displays, for example, the screen shown in the aforementioned FIG. 12.

Through the foregoing routine, the label producing apparatus 2 can access and read the RFID tag information (tag identification information and the like) stored in the IC circuit part 151 of the target RFID circuit element To within the cartridge 100. Also, when the control circuit 30 fails to correctly read the RFID tag information from the IC circuit part 151 within a predetermined number of times, the control circuit 30 knows that the RFID circuit element To is damaged, and can therefore determine whether or not the RFID label is defective.

The foregoing embodiment has shown an exemplary label producing apparatus which holds the tag label tape 110 with print running along the feeding guides 13, associated with the printing operation, within the access are a for accessing (reading/or writing) the RFID circuit element. The present invention, however, is not limited to such a label producing apparatus, but the RFID circuit element may be accessed while the tag label tape 110 with print is stopped at a predetermined position and held by the feeding guides 13.

In the foregoing description, the base tape 101 implements a first marked tape or label medium which has a decorative mark and a first identification mark for control borne at least one side thereof, and also implements a marked tape which has a decorative mark and an identification mark for control borne on at least one side thereof in respective aspects of the present invention. Also, the control circuit 30 which executes the control procedure illustrated in FIG. 10 implements a mark recognizing device configured to recognize the first identification mark on the marked tape during transport in accordance with the result of detection made by a detecting device in a first reading range on at least one side including the first identification mark, and the result of detection made by the detecting device in a second reading range on the at least one side including the decorative mark, and also implements a malfunction preventing device. Further, the control circuit 30 and sensor 19 implement a detector configured to detect the first identification mark on the marked tape which has the decorative mark and first identification mark for control, both of which are borne on at least one side thereof.

In the third embodiment configured as described above, during the production of the RFID label T, the base tape 101 is bonded to the print-receiving tape 103, on which a character has been printed, by the feeding roller 107 and sub-roller 109 to create the tag label tape 110 with print. Access information is generated by the signal processing circuit 22 and radio frequency circuit 21 and transmitted to the antenna 152 of the RFID circuit element To through the antenna 14 to access information in the IC circuit part 151 of the RFID circuit element To (reading the information in this example, and writing information in an exemplary modification, later described). Then, the tag label tape 110 with print having the thus accessed RFID tag circuit element To is cut at predetermined intervals (from one cut line CL to the next cut line CL) by the cutter 15 to produce individual RFID labels T. In this event, the sensor 19 detects the access marks PM borne on the base tape 101 at predetermined intervals, which are utilized by the control circuit 30 to control the print head 10 to start printing (step S2118 in FIG. 26), to control the positioning of the tag label tape 110 with print at the access position (step S2120), to control the positioning of the tag label tape 110 with print for cutting by cutter 15 (step S2140), thereby improving the accuracies of the start of printing, accessing, and tape cutting. In this event, in the third embodiment, the length XP of the access mark PM is set longer than the sensor reading range d in proportional to the reading range d of the sensor 19, such that the sensor 19 presents a predetermined difference when it detects the logo mark LM (first reading range) and when it detects the access mark PM (second reading range). In this way, even if the two types of marks PM, LM are borne together on the same side, the access mark PM can be reliably recognized based on the difference in the detection result presented by the sensor 19. In other words, the label producing apparatus of the third embodiment can prevent malfunctions and/or inappropriate operations in the detection process.

Not limited to the dimensional relationship between the two marks as described above, at least one of the size, color, and character/decoration pattern of the mark may be set in consideration of the reading range and performance of the sensor 19, so as to permit the sensor 19 to read the access mark PM easier than the logo mark LM, in which case similar advantages are provided. Also, the marks PM, LM may be borne not only on the separation sheet 101d on one side of the base tape 101, as described above, but also on the adhesive layer 101b on the other side of the base tape or on the print-receiving tape 103, or on both the separation sheet 101d and the adhesive layer 101b or print-receiving tape 103.

It should be understood that the third embodiment is not limited to the foregoing, but can be modified in various ways without departing from the spirit and technical idea. The following description will be focused on such exemplary modifications.

(3-1) When information is written into RFID circuit element:

While the foregoing description has been made on an exemplary RFID tag manufacturing system which produces read-only RFID tag (not writable), the present invention is not so limited, but can be applied to a RFID tag manufacturing system which involves writing information into the IC circuit part 151 of the RFID circuit element To.

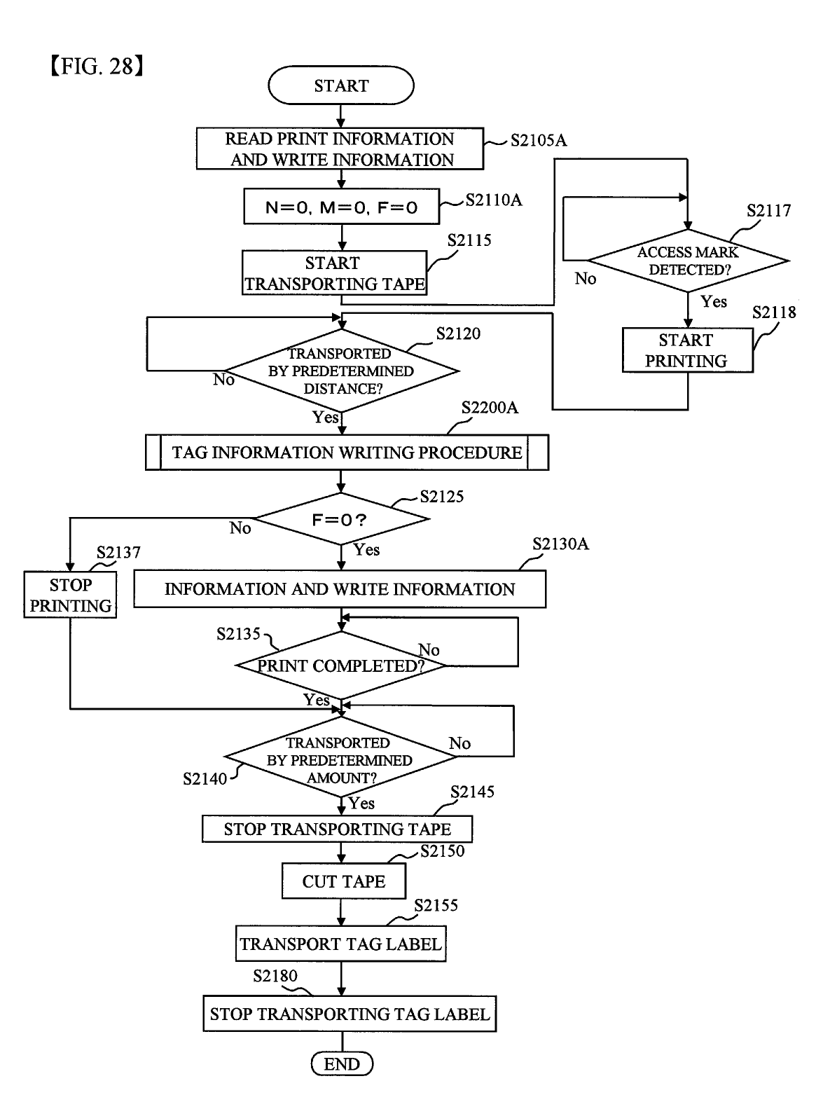

FIG. 28 is a flow chart illustrating a control procedure executed by the control circuit 30 in this exemplary modification, where steps equivalent to those in FIG. 26 are designated the same reference numerals.

Referring to FIG. 28, at step S2105A, the tag-label producing apparatus 2 reads, through the communication network 3 and input/output interface 31, information which is entered through the terminal 5 or general purpose computer 6 (or possibly through a manipulation panel, not shown, provided on the tag-label producing apparatus 2 itself) and which the operator wishes to write into the IC circuit part 151 of the RFID circuit element To; and print information which should be printed on the RFID label T by the print head 10. After the completion of the processing at step S2105A, the flow goes to step S2110A, where the control circuit 30 initializes a variable M (described later in greater detail) to zero, in addition to the aforementioned variable N and flag F.

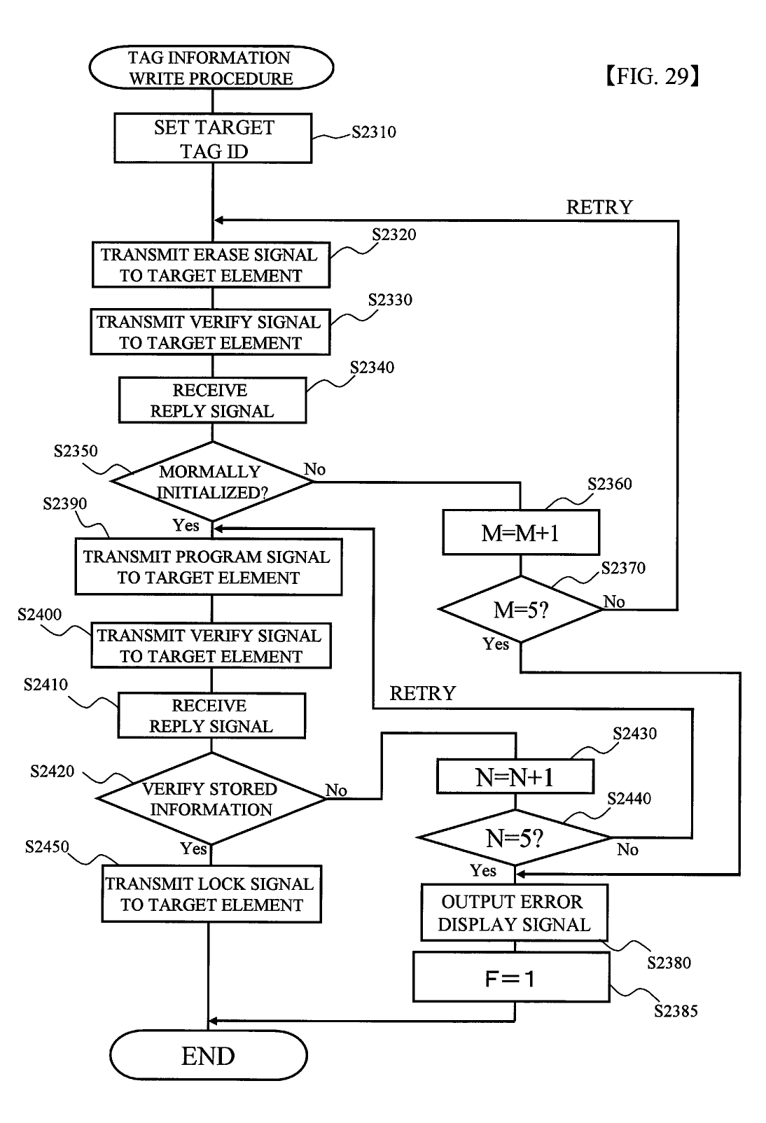

Subsequently, the flow goes to step S2200A through steps S2115, S2117, S2118, and S2120 similar to those in FIG. 26. At step S2200A, the control circuit 30 initializes (erases) the memory for writing RFID tag information including ID information, article information and the like associated with a specified tag ID (all or part) as identification information, and transmits and writes the RFID tag information to and into the RFID circuit element To (see FIG. 29, later described, for further details). After step S2200A is completed, the flow goes to step S2125, as is the case with FIG. 26.

At step S2125, the control circuit 30 determines whether or not the flag F is set to “0” in a manner similar to FIG. 26. When the determination at step S2125 is YES, the flow goes to step S2130A.

At step S2130A, the control circuit 30 outputs a combination of the information written into the RFID circuit element To at step S2200A with the print information previously printed by the print head 10 corresponding thereto for storage in the information server 7 and route server 4 through the terminal 5 or general purpose computer 6 by way of the input/output interface 31 and communication network 3. The information may be stored, for example, in the route server 4, as is the case with step S2130 in FIG. 26. The stored data is stored such that the terminal 5 or general-purpose computer 6 has accesses thereto, as required.

Since the subsequent procedure is substantially similar to FIG. 26, a description thereon is omitted.

FIG. 29 is a flowchart illustrating in detail a procedure at step S2200A above.

Referring to FIG. 29, at step S2310, the control circuit 30 sets an tag ID (or part thereof) which is identification information by a known appropriate method. Then, a RFID circuit element To (contained in a produced RFID label T), into which information is to be written, is transported to the vicinity of the antenna 14.

Subsequently, at step S2320, similar to step S1320 in FIG. 15 above, the control circuit 30 outputs an “Erase” command to the signal processing circuit 22 for specifying the tag ID (all or part) set at step S2310 above and initializing information stored in the memory part 157 of the RFID circuit element To. The signal processing circuit 22 responsively generates an “Erase” signal which is transmitted to the target RFID circuit element To through the radio frequency circuit 21 for initializing the memory part 157.

Next, the control circuit 30 outputs a “Verify” command to the signal processing circuit 22 for verifying the contents of the memory part 157 in a manner similar to step S1330 in FIG. 15. In response, the signal processing circuit 22 generates a “Verify” signal which is transmitted to the target RFID circuit element To through the radio frequency circuit 21 to prompt the RFID circuit element To return a reply. Then, at step S2340, the tag-label producing apparatus 2 receives a reply signal transmitted from the target RFID circuit element To in response to the “Verify” signal through the antenna 14, and the control circuit 30 captures the reply signal through the radio frequency circuit 21 and signal processing circuit 22, in a manner similar to step S1340 in FIG. 15.

Subsequently, steps S2350, S2360, S2370, S2380, S2385 are similar to steps S1350, S1360, S1370, S1380, S1385 in FIG. 10, respectively, so that a description thereon is omitted.

On the other hand, when the determination at step S2350 is YES, the flow goes to step S2390, where the control circuit 30 outputs a “Program” command to the signal processing circuit 22 for writing desired data into the memory part 157, in a manner similar to step S1390 in FIG. 10. In response, the signal processing circuit 22 generates a “Program” signal which is transmitted to the target RFID circuit element To through the radio frequency circuit 21 to write the information entered through the terminal 5 or general-purpose computer 6 into the memory part 157 of the target RFID circuit element To.

Subsequently, steps S2400, S2410, S2420, S2430, S2440, S2450 are similar to steps S1400, S1410, S1420, S1430, S1440, S1450 in FIG. 10, respectively, so that a description thereon is omitted.

The flow is terminated after step S2450 is completed.

Through the foregoing routine, desired information can be written into the IC circuit part 151 of the RFID circuit element To, intended for access, within the cartridge 100.

As described above, the foregoing exemplary modification provides substantially similar advantages to the aforementioned embodiment in the RFID tag manufacturing system which involves writing RFID tag information.

(3-2) When tapes are not bonded:

Instead of the third embodiment which involves directly printing a character on the print-receiving tape 103, and bonding the print-receiving tape 103 to the separate marked tape (base tape, tag tape) 101 containing RFID circuit elements To, the present invention can be applied to a RFID circuit element cartridge for a tag-label producing apparatus which involves printing a character on a print-receiving tape integrated with a marked tape (tag tape).

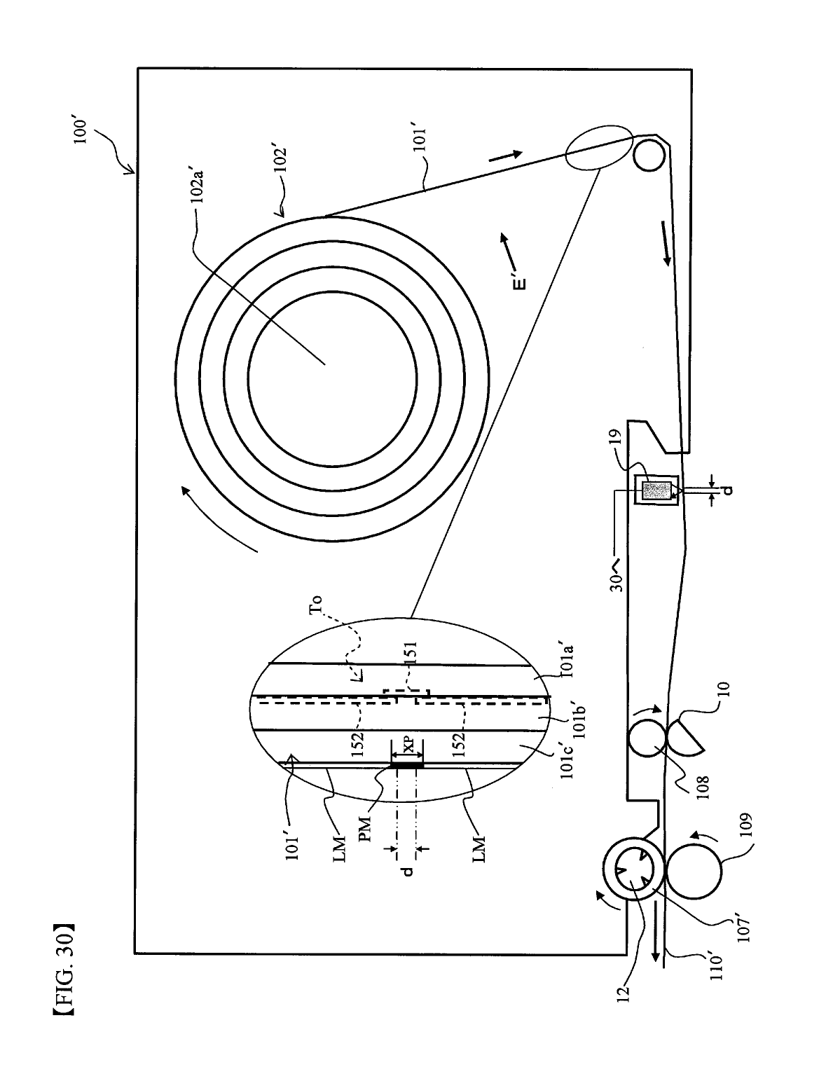

FIG. 30 is an explanatory diagram for describing in detail the structure of a cartridge 100′ according to this exemplary modification, and corresponds to the aforementioned FIG. 22. Parts equivalent to those in FIG. 22 are designated the same reference numerals, and descriptions on these parts are omitted as appropriate.

Referring to FIG. 30, the cartridge 100′ comprises a thermal tape roll 102′ which includes a rolled thermal tape 101′ (tag tape, first marked tape, marked tape, label medium), and a tape feed roller 107′ configured to feed the thermal tape 101′ to the outside of the cartridge 100′.

The thermal tape roll 102′ includes the elongated transparent thermal tape 101′ wound around a reel member (shaft member) 102a′, the axial direction (direction inward from the front on the sheet) of which is substantially perpendicular to the longitudinal direction of the tape 101′. The thermal tape 101′ is formed with a plurality of the RFID circuit elements To arranged in sequence in the longitudinal direction thereof.

In this example, the thermal tape 101′ wound around the reel member 102a′ to form the thermal tape roll 102′ has a three-layer structure (see a partially enlarged view in FIG. 30) which is made up of a print-receiving tape 101a′ made of PET (polyethylene terephthalate) or the like and having a heat-sensitive recording layer on the surface, an adhesive layer 101b′ made of an appropriate adhesive material, and a separation sheet (parting material) 101c′, which are laminated in this order from a side thereof which is rolled outward to the opposite side.

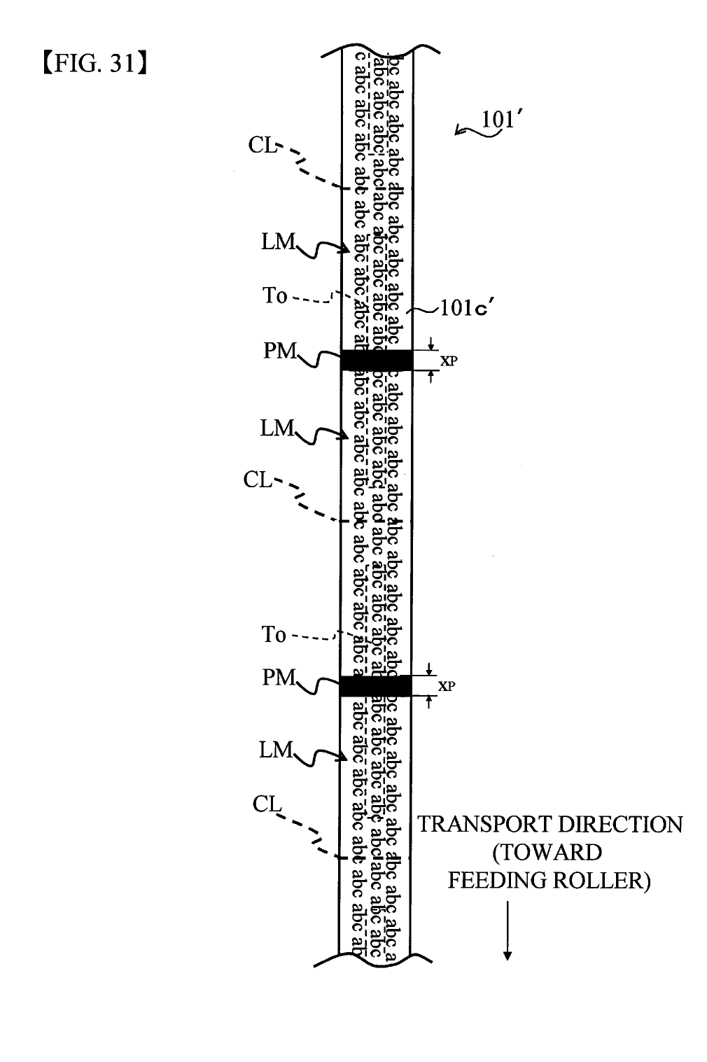

The IC circuit parts 151 configured to store information are embedded in the back side of the print-receiving tape 101a′, while the antennas 152 are formed on the back surface of the print-receiving tape 101a′. The separation sheet 101c′ is adhered to the back side of the print-receiving tape 101a through the adhesive layer 101b′. Then, the access mark PM is borne on the separation sheet 101c′, like the base tape separation sheet 101d in the aforementioned embodiment, for print start control timing, and positioning of the tape to the cutter cutting position CL. A majority of the surface on the separation sheet 101c′, except for the areas in which the access marks PM are printed, are filled with logo marks LM, i.e., decorative marks. FIG. 31 illustrates the separation sheet 101c′, as viewed in a direction indicated by an arrow E′ in FIG. 30, for depicting how the access marks and logo marks are printed on the separation sheet 101c′, and is substantially comparable to FIG. 23 in the aforementioned embodiment.

As the cartridge 100′ is loaded into the cartridge holder in the tag-label producing apparatus 2, and a roller holder (not shown) is moved from a spaced position to a contact position, the thermal tape 101′ is sandwiched between the print head 10 and platen roller 108, and is also sandwiched between the tape feed roller 107′ and sub-roller 109. Then, the tape feed roller driving shaft 12 is driven by a driving force of the motor 23 to drive cartridge shaft (see FIG. 2 above) to rotate the tape feed roller 107′, sub-roller 109, and platen roller 108 in synchronization, causing the thermal tape 101′ to be fed out from the thermal tape roll 102′.

The fed-out thermal tape 101′ is supplied to the print head 10 located at a downstream location in the transport direction. The print head 10 has a plurality of heat generating elements which are powered by the print drive circuit 25 (see FIG. 2) to print a character on the surface of the print-receiving tape 101a′ of the thermal tape 101′ to form a tag label tape 110 with print′ which is then delivered to the outside of the cartridge 100′. It should be understood that the character may be printed using an ink ribbon, as used in the third embodiment. In addition, an optical sensor 19 similar to that described above is disposed at a location upstream of the print head 10 in the transport direction for detecting the access marks PM, and applies a detection signal to the control circuit 30. The length XP of the access mark PM is larger than the reading range d of the sensor 19 in the longitudinal direction of the tape 101′ (left-to-right direction in FIG. 30), in a manner similar to the third embodiment.

After delivered outside of the cartridge 100′, the IC circuit part 151 in the tag label tape 110 with print′ is accessed for information (for reading information therefrom or writing information thereinto) through the antenna 14, in a manner similar to the third embodiment. The subsequent transport by the feed roller 17, cutting by the cutter 15, and the like are similar to the third embodiment, so that descriptions thereon are omitted.

Like the third embodiment described above, the foregoing exemplary modification has the advantage of reliably recognizing the access mark PM based on a difference in the results of detection made by the sensor 19, even when two types of marks PM, LM are borne on the same surface.

(3-3) When Blank Zone is Added at Least Before or after Identification Mark:

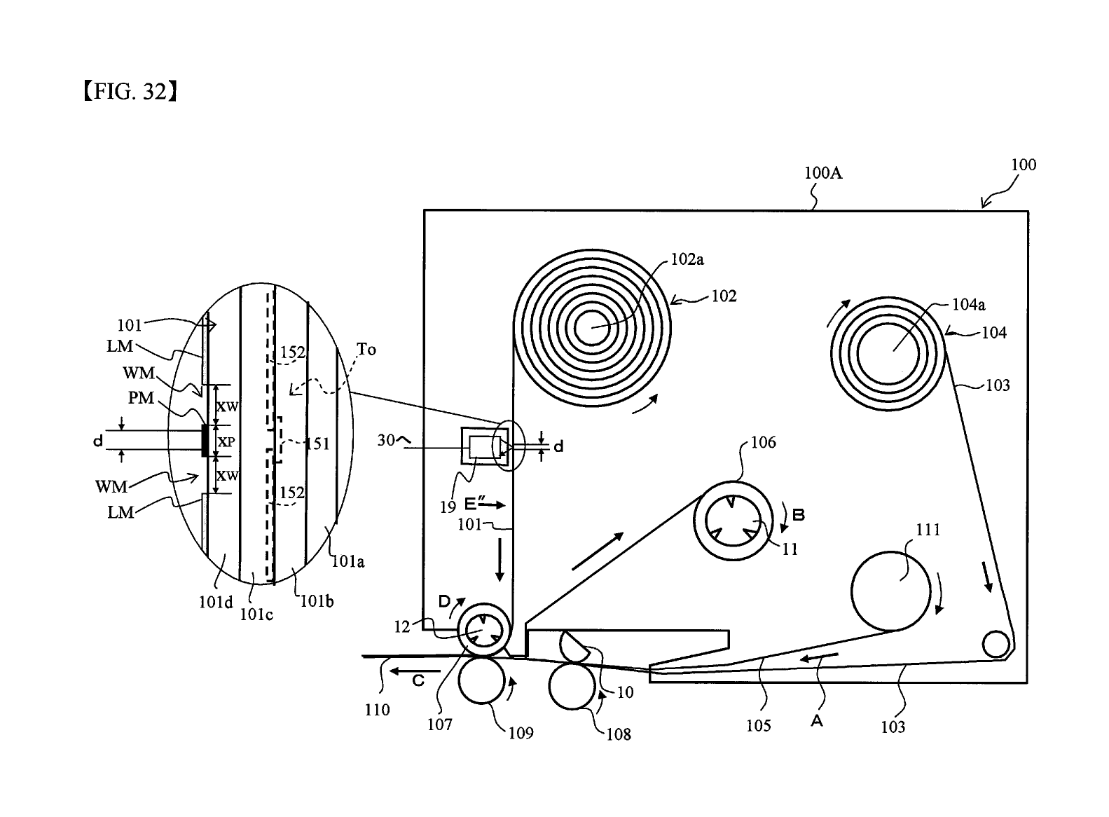

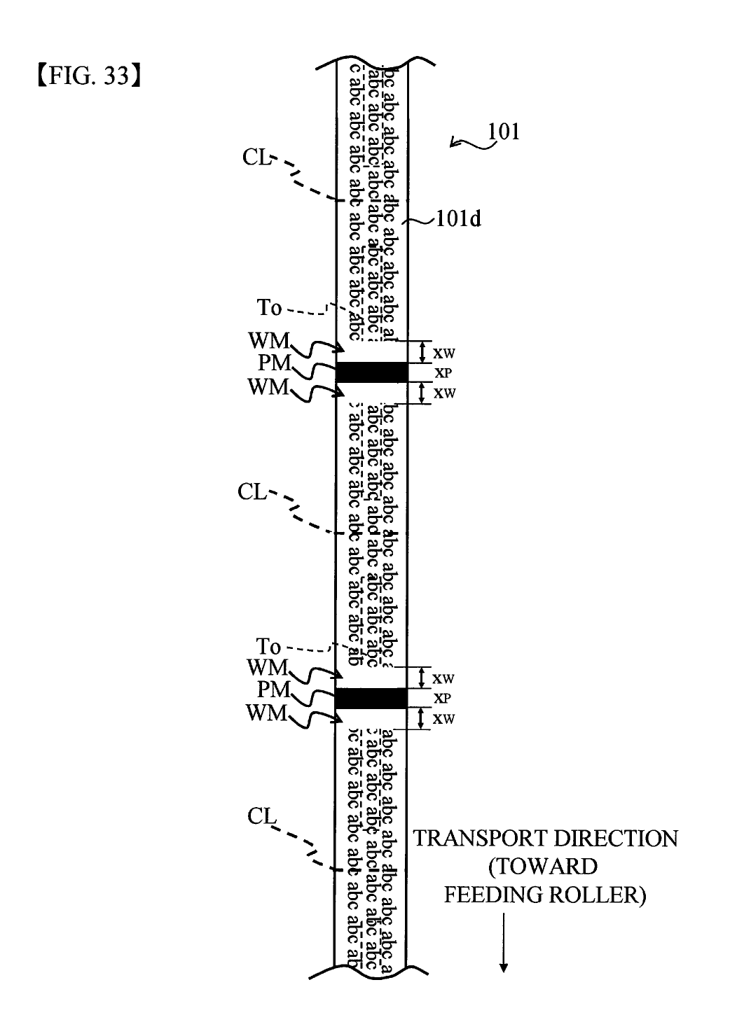

FIG. 32 is an explanatory diagram for describing in detail the structure of a cartridge in this exemplary modification, and corresponds to FIG. 22 in the aforementioned embodiment. FIG. 33 illustrates the separation sheet 101c′, as viewed in a direction indicated by an arrow E″ in FIG. 32, and corresponds to FIG. 23 in the aforementioned embodiment. Parts equivalent to those in FIGS. 22 and 23 are designated the same reference numerals, and descriptions on these parts are omitted or simplified as appropriate.

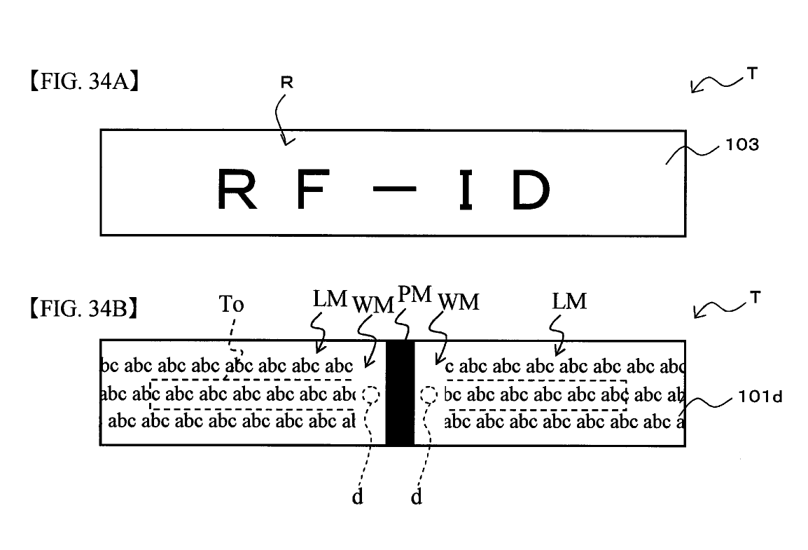

Referring to these FIGS. 32 and 33, in this exemplary modification, blank zones WM are added between the access mark PM and logo mark LM, respectively, in front of and/or at the back of the access mark PM in the direction in which the access marks PM are transported (i.e., longitudinal direction of the tape 101) on the surface of the base tape 101 on which the access marks PM and log marks LM are borne. Notably, in this exemplary modification, the dimension XW of the blank zone WM in the longitudinal direction of the base tape 101 is set to be larger than the reading range d of the sensor 19. FIGS. 34A and 34B are a top plan view and a bottom plan view illustrating the appearance of an exemplary RFID label T which is produced using the base tape 101, and are comparable to the aforementioned FIGS. 24A and 24B, respectively.

In this exemplary modification, as the base tape 101 is transported, the blank zone WM exists between the access mark PM and logo mark LM in the reading range of the sensor 19, such as logo mark LM -->blank zone WT -->access mark PM (in regard to the blank zone WM upstream of the access mark PM in the transport direction), or access mark PM -->blank zone WM -->logo mark LM (in regard to the blank zone WM downstream of the access mark PM in the transport direction). Accordingly, the sensor 19 detects only the blank zone WM without fail in a period between a period in which the sensor 19 should detect optical information corresponding to the access mark PM (with a very small amount of light reflected therefrom) and a period in which the sensor 19 should detect optical information corresponding to the logo mark LM (with a not so small amount of light reflected therefrom). Accordingly, the sensor 19 can detect the boundary between the access mark PM and blank zone WM without error, thus improving the positional accuracy. As a result, the access mark PM can be more accurately recognized than the third embodiment.

Also notably, in this exemplary modification, since the dimension XW of the blank zone WM in the longitudinal direction of the base tape 101 is larger than the readable zone d of the sensor 19, when the blank zone WM appears in the reading range of the sensor 19 as the base tape 101 is transported, the optical information corresponding to the blank zone WM alone exists in the reading range, so that the sensor 19 can reliably sense the information. As a result, the sensor 19 can reliably sense the blank zone WM to more accurately recognize the access mark PM.

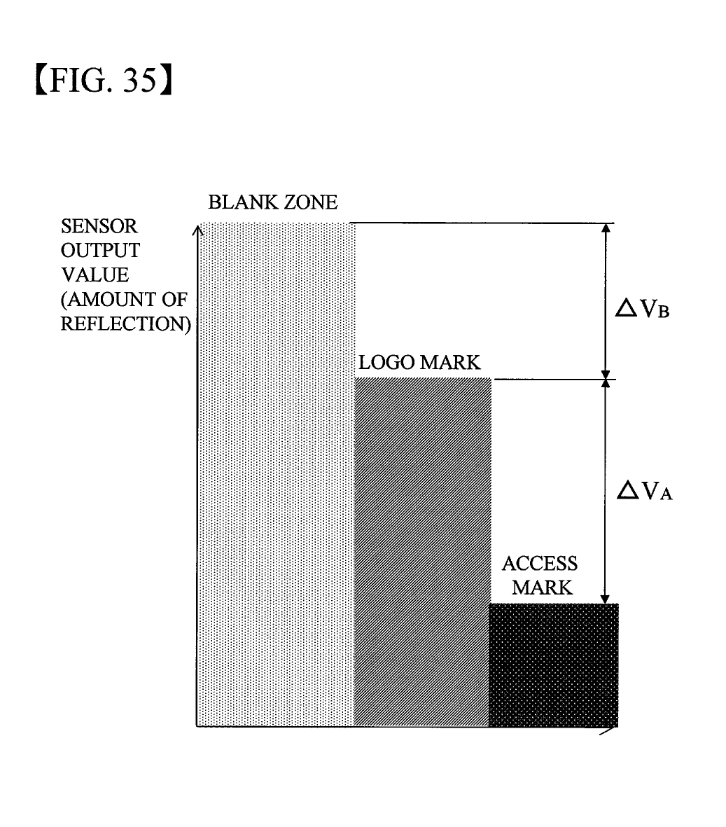

In this connection, it will be effective that the form of the base tape 101, and detection performance of the sensor 19 may be set for establishing a preferred relationship among detection signal output values generated by the sensor 19 when it detects the access mark PM, blank zone WM, and logo mark LM, respectively, in order to further improve the accuracy. FIG. 35 shows an example of detection signals generated by the sensor 19, representing output values (for example, voltages) of the detection signals on the vertical axis. From the fact that a larger amount of light reflected from a detected object results in a larger detection signal, the sensor 19 generates larger signal output values when it detects the blank zone WM, than when it detects the logo mark LM (second reading range), and than when it detects the access mark PM (first reading range). In this event, as illustrated, a difference ΔVA between the detection signal output value generated when the access mark PM is detected and the detection signal output value generated when the logo mark LM is detected may be larger than a difference ΔVB between the detection signal output value generated when the blank zone WM is detected and the detection signal output value generated when the logo mark LM is detected. By doing so, a distinctively large difference appears between the detection signal output values generated when the logo mark LM and the access mark PM are detected, respectively, the sensor 19 can more reliably recognize the access mark PM.

The tape configuration according to the exemplary modification described above may be applied to the exemplary modification (3-2) (the label producing apparatus which employs a thermal tape without bonding two tapes), such that the blank zone WM may be defined on the thermal tape. Similar advantages are provided as well in this application.

(3-4) Inclined Identification Mark:

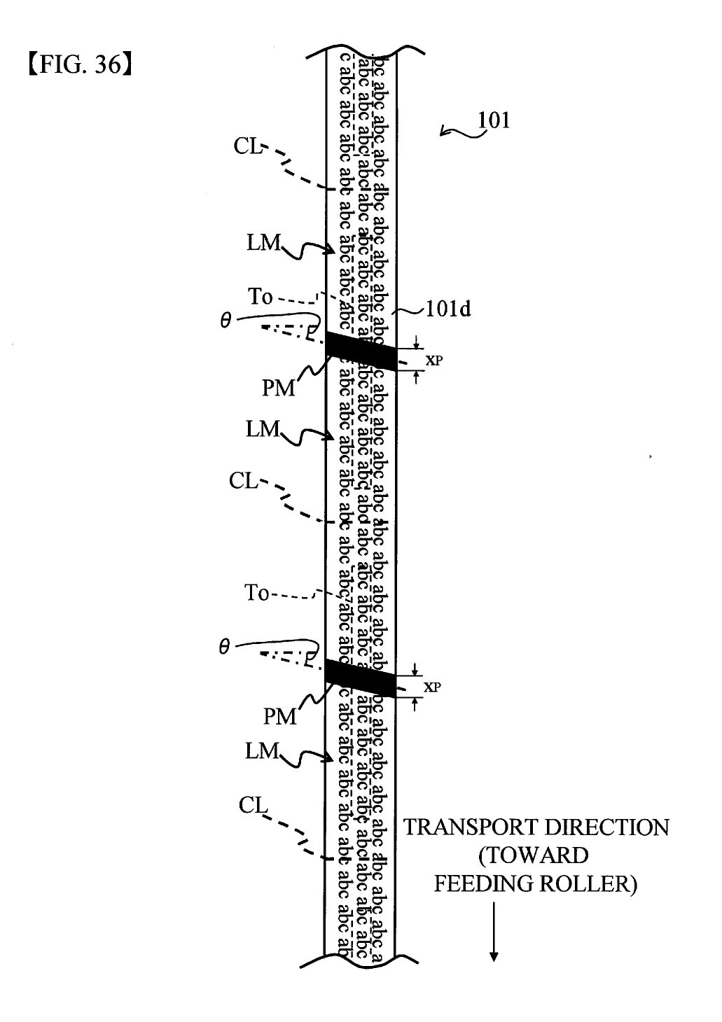

FIG. 36 is a diagram illustrating in detail the appearance of the base tape 101 in this exemplary modification, as viewed from the other side (back side), and comparable to FIG. 23 in the aforementioned embodiment. As illustrated in FIG. 36, in this exemplary modification, access marks PM are slantly borne at a predetermined angle θ to the width direction of the base tape 101 (left-to-right direction in FIG. 36). Such inclined access marks PM provide the following advantages.

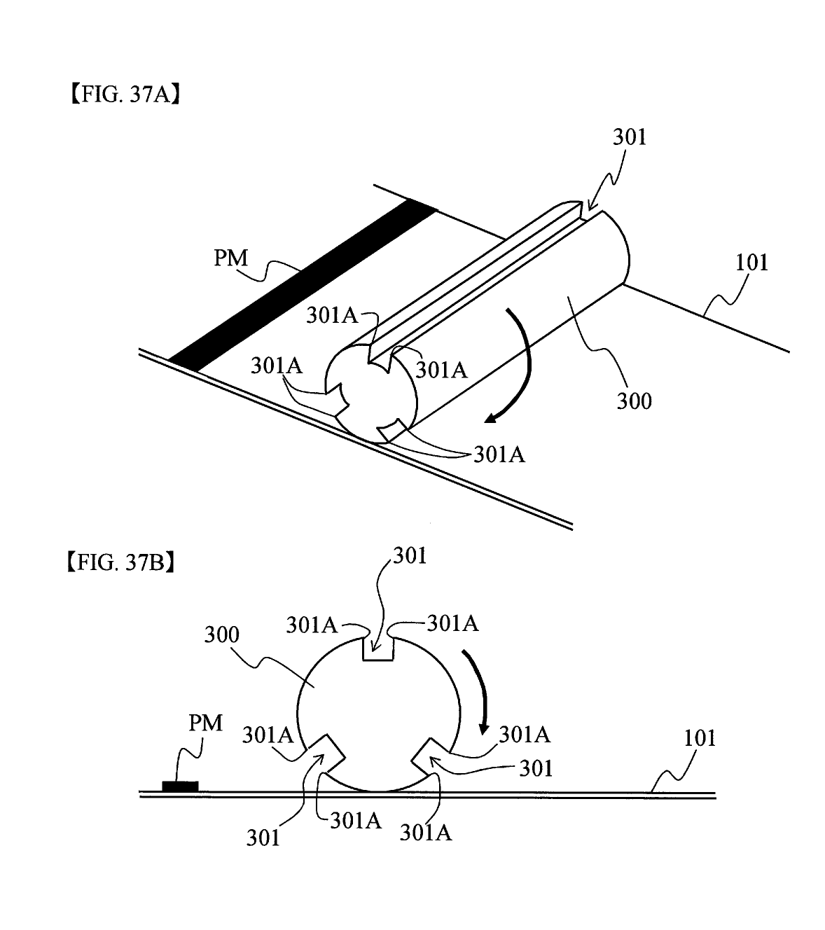

When the access marks PM are oriented in parallel with the width direction of the base tape 101 (in other words, perpendicular to the longitudinal direction of the base tape 101), for example, as shown in FIG. 37, the access marks PM will be printed while rotating a roll-shaped print master 300 which is formed with grooves 301 extending straightly in the axial direction of the print master 300 and arranged at predetermined locations on the circumference of the print master 300 for supplying ink for printing the access marks PM. In this event, as the roll-shaped master 300 rotates, the grooves 301 are intensively applied with repeated impact loads at the same circumferential position at which the grooves 301 are formed at all axial sites of the master 300. Therefore, as the access marks PM are continuously printed on the base tape, the grooves 301 can be locally worn or damaged at both edges 301A in the width direction of the grooves 301, possibly resulting in a lower durability of the master 300, difficulties in printing operations for a long time, or a lower print quality. Consequently, blurred identification marks may be printed on the base tape, resulting in a lower position detection accuracy.

In this exemplary modification, the access marks PM are not oriented in parallel with the width direction of the base tape, but slantly oriented at a predetermined angle. Accordingly, the master 300 is formed with the grooves 301 extending slantly with respect to the axial direction. Thus, unlike the foregoing, even the roll-shaped master 300 rotates, the circumferential positions, at which the grooves 301 are formed, shift respectively at all axial sites of the master 300, the grooves 301 are not applied with intensive loads but with mitigated loads, thus reducing the abrasion or local damages of the both end edges 301A. Accordingly, the access marks PM can be continuously printed for a longer time with a higher printing quality.

Also, since the access marks PM subtly differ from one another in the longitudinal position of the base tape 101 depending on the transversal position of the base tape 101, this difference can be utilized for corrections in controlling a timing for the print head 10 to start printing (location of a start point) or in positioning the base tape 101 such that it is cut at a cut position CL by the cutter 15. Specifically, the sensor 19 is adapted, for example, to be slidable in the width direction of the base tape 101. When a subtle shift is found between the access mark PM and cut position CL when the base tape 101 is actually cut by the cutter 15 based on the access mark PM, the sensor 19 may be slid in the width direction of the base tape 101 as appropriate to modify the position of the detected access mark PM in the longitudinal direction of the base tape 101 to make an adjustment for removing the shift.

(3-5) Reversion of Color:

In the foregoing embodiment, the access mark PM, logo mark LM, and blank zone WM are designed to reflect smaller amounts of light to the sensor 19 in this order (for example, the brightness is reduced in this order, or the ratio of printed areas to unprinted areas is reduced in this order). Conversely, the access mark PM, logo mark LM, and blank zone WM may be designed to reflect larger amount of light to the sensor 19 in this order, i.e., through reversion of brightness in the example described above (for example, the brightness is increased in this order, or the ratio of printed areas to unprinted areas is increased in this order).

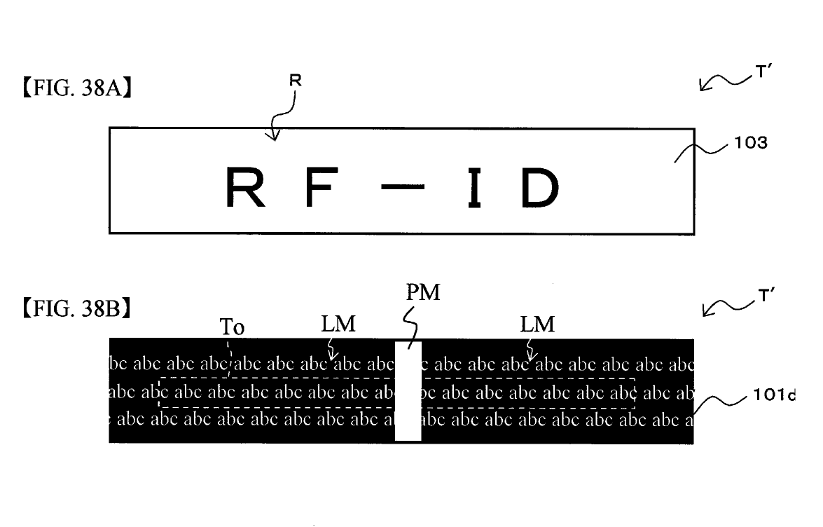

FIGS. 38A and 38B are a top plan view and a bottom plan view illustrating the appearance of an exemplary RFID label T′ which has the separation sheet 101d in reversed colors as described above, and correspond to FIGS. 24A and 24B, respectively. Such a RFID label T′ can provide similar advantages to the aforementioned embodiment. It should be understood that such a reversed color version of RFID label T′ can be applied to the aforementioned exemplary modifications (3-2), (3-3), (3-4), and provides similar advantages. In this event, the blank zone WM in the exemplary modification (3-3) will be painted, for example, in solid black.

(3-6) Others:

In the foregoing description, the sensor 19 is disposed relatively near the base tape 101 fed out from the base tape roll 102 (FIG. 22 and the like) or at a position upstream of the print head 10 in the transport direction (FIG. 30), but the position of the sensor 19 is not so limited, but may be disposed at any other appropriate position. In essence, the sensor is simply required to have at least one of defined size, color, and character/figure pattern such that a predetermined difference is found when the sensor 19 detects the access mark PM (first reading range) and when the sensor 19 detects the logo mark LM (second reading range). In accordance with such settings, the control circuit 30 may simply recognize the access mark PM in accordance with the result of a detection when the access mark PM is read (in the first reading range) and the result of a detection when the logo mark LM is read (in the second reading range). In this way, the sensor 19 can reliably detect the access mark PM even when two types of marks PM, LM are borne together on the same surface of the base tape, which is the essential advantage of the third embodiment.

Also, while the third embodiment has been described in connection with the label producing apparatus for producing a RFID label which contains the RFID circuit element, what is contained in the RFID label is not limited to the RFID circuit element. Further, the label may not always contain some object, but the label may be made up of, for example, a separation sheet and a label-shaped cut tape.

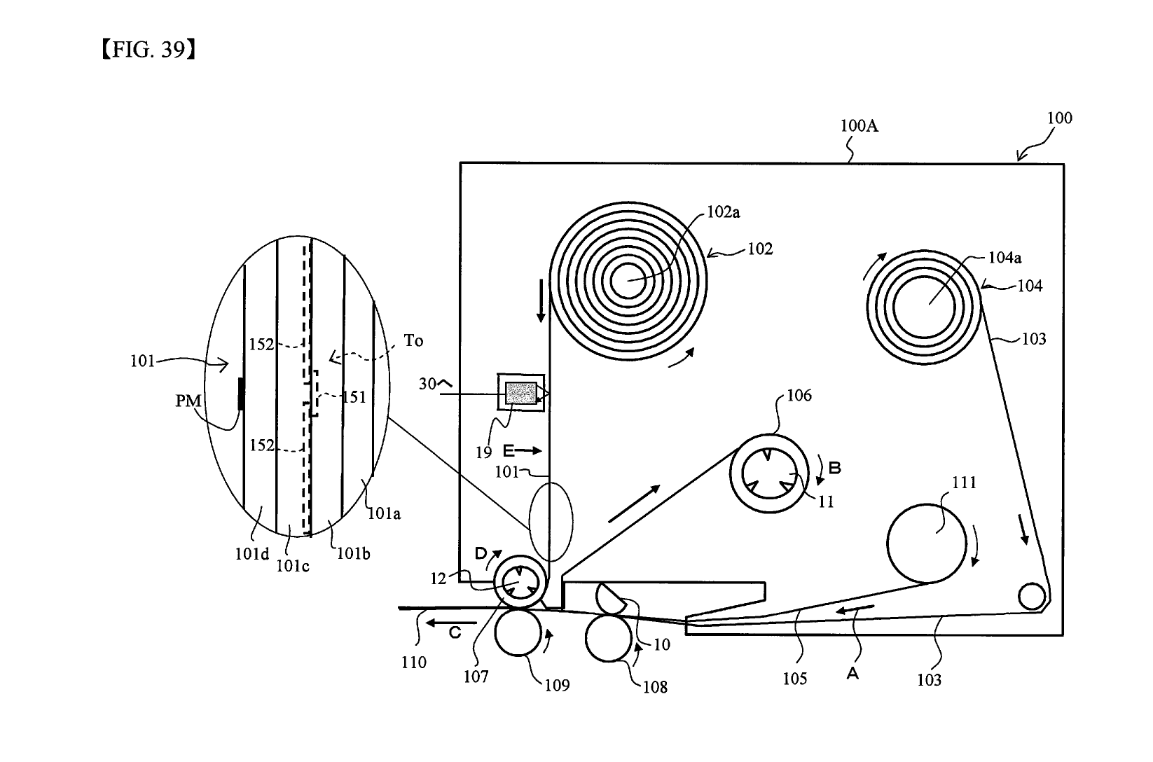

Now, a fourth embodiment of the present invention will be described with reference to FIGS. 39 to 73. Like the third embodiment, the fourth embodiment relates to a label producing apparatus which is provided with a device configured to prevent malfunctions of the detecting device configured to detect an object to be detected on a label medium. Parts equivalent to those in the first to third embodiments are designated the same reference numerals, and descriptions on these parts are omitted or simplified as appropriate.

Like the first to third embodiments, the label producing apparatus 2 of the fourth embodiment is applied, for example, to the RFID tag manufacturing system 1 illustrated in FIG. 1 above, and is similar in configuration to that illustrated in FIG. 32 described in the third embodiment. However, in the label producing apparatus 2 of the fourth embodiment, a distance Lo exists from a position opposite to the sensor 19 to a position opposite to the cutter 15 along the path on which the base tape 101 is transported (see the partially enlarged view in FIG. 32 above).

The radio frequency circuit 21 and RFID circuit element To are similar in detailed configuration to those in the third embodiment and to those illustrated in FIGS. 8, 9 above.

FIG. 39 is an explanatory diagram for describing in detail the structure of a cartridge 100 loaded in the label producing apparatus 2 of the fourth embodiment, and comparable to FIG. 32 in the third embodiment.

Referring to FIG. 39, in the fourth embodiment, on the separation sheet 101d of the base tape 101 comprised of the adhesive layer 101a (bonding adhesive layer), base film 101b (tape base layer), adhesive layer 101c (affixing adhesive layer), and separation sheet 101d (separation material layer) laminated in this order, access marks PM are borne (for example, by printing) at predetermined intervals for establishing a timing for controlling the print head 10 to start printing (i.e., location of a start point) and positioning the tape during transport.

Preferably, the sensor 19 is, for example, a reflective photo-electric sensor having a light emitter and a light receiver, as in the third embodiment. Light emitted from the light emitter is reflected by a reflective object (normal portion of the base tape 101, described later in greater detail), if any, between the light emitter and light receiver, and impinges on the light receiver, causing the sensor 19 to output a relatively large predetermined control output value to the control circuit 30. On the other hand, when there is no reflective object between the light emitter and light receiver (when light is absorbed by the access mark PM or is transmitted by the tape), the light emitted from the light emitter is not received by the light receiver, resulting in a zero value or a relatively small value of the control output value.

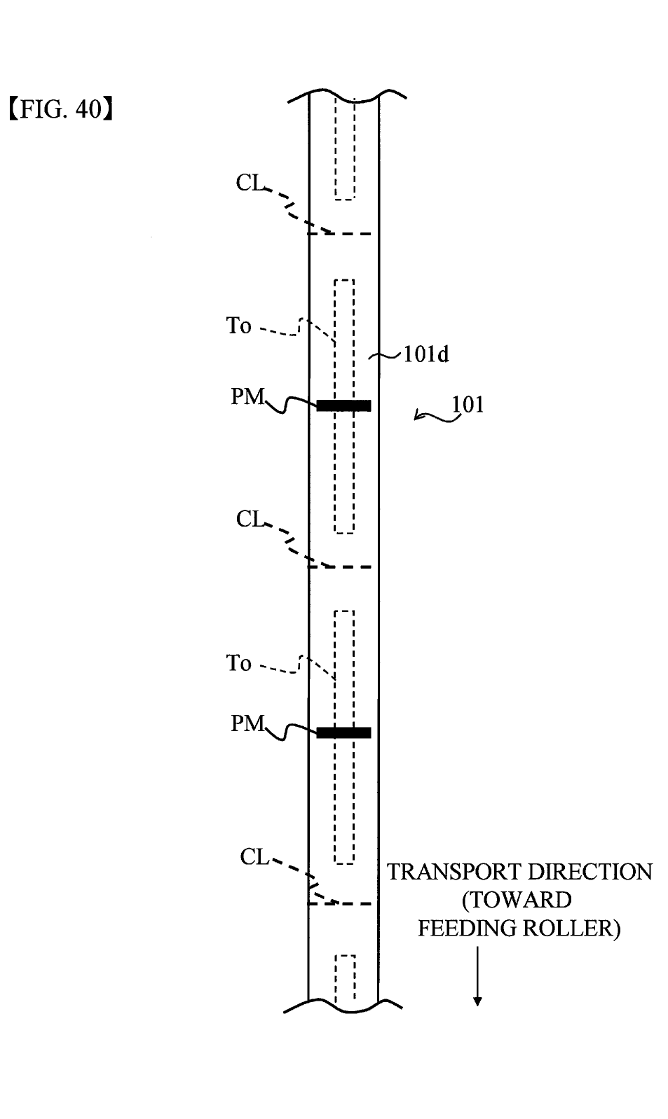

FIG. 40 is a diagram illustrating in detail the appearance of the base tape 101, viewed from one side (bask side) thereof as indicated by an arrow E in FIG. 39.

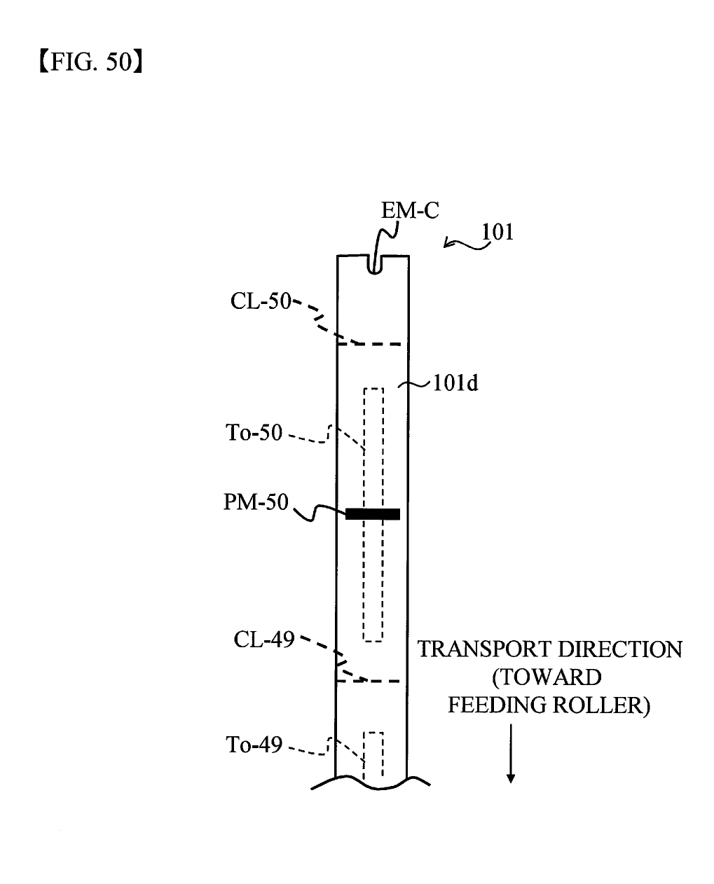

Referring to FIG. 40, the access marks PM (second identification marks) are borne on the separation sheet 101d of the base tape 101, corresponding to respective RFID circuit elements To, for use in controlling the print head 10 to start printing (location of a start point) or in positioning the base tape 101 such that it is cut at a cut position CL by the cutter 15 (described later in detail). The access marks PM are arranged at the same pitch at which the RFID circuit elements To are arranged, where the access mark PM is placed in substantially the same positional relationship to each RFID circuit element To (near the center of the RFID circuit element To in the longitudinal direction in this example). As a result, the base tape 101 in the base tape roll 102 includes the same number of access marks PM as the RFID circuit elements To. It should be noted that in FIG. 50, cut lines (scheduled cut lines) CL are shown in phantom line on the base tape 101, so that the base tape 101 is cut every predetermined length by the cutter 15 to produce RFID labels T, each of which contains one RFID circuit element.

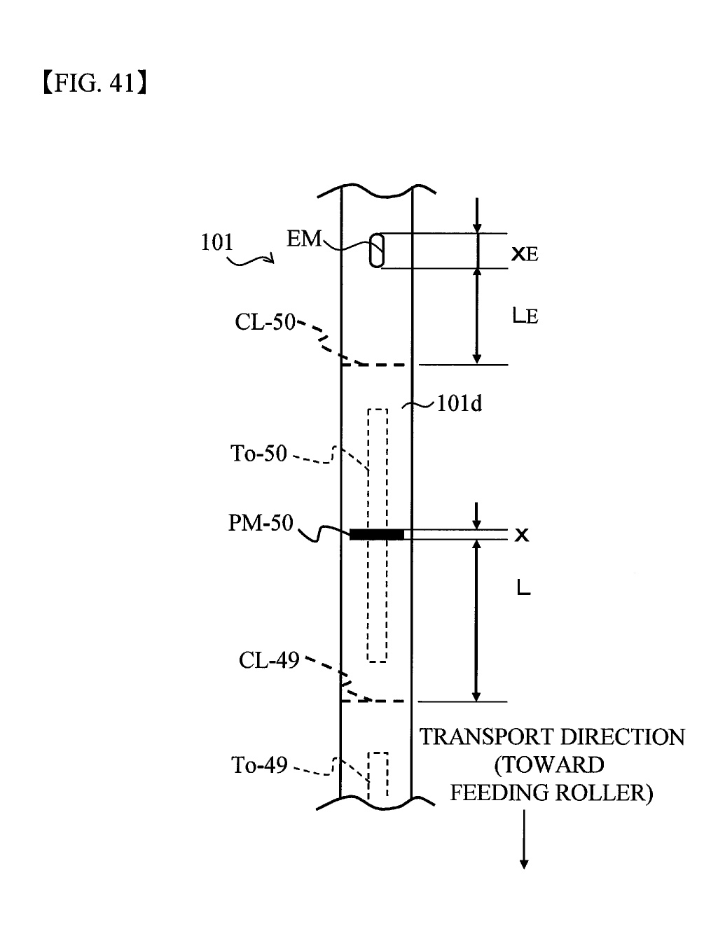

FIG. 41 is a diagram illustrating the structure of the base tape 101 shown in FIG. 40 near the end (terminal end) of the base tape in a direction in which the base tape 101 is fed out (i.e., near a portion of the base tape 101 which is attached to the base tape roll 102).

Referring to FIG. 41, 50 RFID labels T can be produced from the base tape 101 in this example. In FIG. 41, a suffix indicative of the order is added to the respective reference letter CL, in such a manner that the cut line associated with the production of the last or fiftieth RFID label T is designated “−50” suffixed to CL; the cut line associated with the production of the forty ninth RFID label T is designated “−49” suffixed to CL; and so forth. As a result, the RFID circuit element To-50 and access mark PM-50 associated with the production of the last or fiftieth RFID label T are positioned between the cut line CL-49 associated with the production of the forty-ninth RFID label T (forming the trailing edge of the RFID label T) and the cut line CL-50 associated with the production of the fiftieth RFID label T. Then, one of the most significant characteristics of the fourth embodiment lies in that an end mark EM, which is a hole (lacking portion or cutout) for detecting the tape end, is formed in a region near the end of the base tape 101 in the feed direction, more specifically, at a location downstream of the portion of the base tape 101 which is to be cut to produce the fiftieth RFID label T in the feed direction (in other words, downstream of the cut line CL-50 on the upper side in FIG. 41). In this example, the end mark EM is set such that the distance LE from the end mark EM to the cut line CL-50 is shorter than the normal distance L from the access mark PM (of each of first to forty-ninth RFID labels) to the corresponding cut line CL (in other words, the distance between the end mark EM and the access mark PM closest thereto is shorter than the pitch at which adjacent access marks PM are arranged (i.e., the pitch at which the RFID circuit elements To are arranged)). Also, in this event, the distance L is longer than the distance Lo from the aforementioned position opposite to the sensor 19 to the position opposite to the cutter 15, whereas the distance LE is shorter than the distance Lo. Further, the end mark EM has a length, i.e., dimension xE in the longitudinal direction of the base tape 101 (vertical direction in FIG. 41) is set to be larger than the dimension x of the access mark PM in the longitudinal direction of the base tape 101.

In this connection, the end (terminal) of the base tape 101 is fixed to the reel member 102a (axial member) of the base tape roll 102 with an appropriate means such as a strong adhesive or the like in this example, though illustration is omitted.

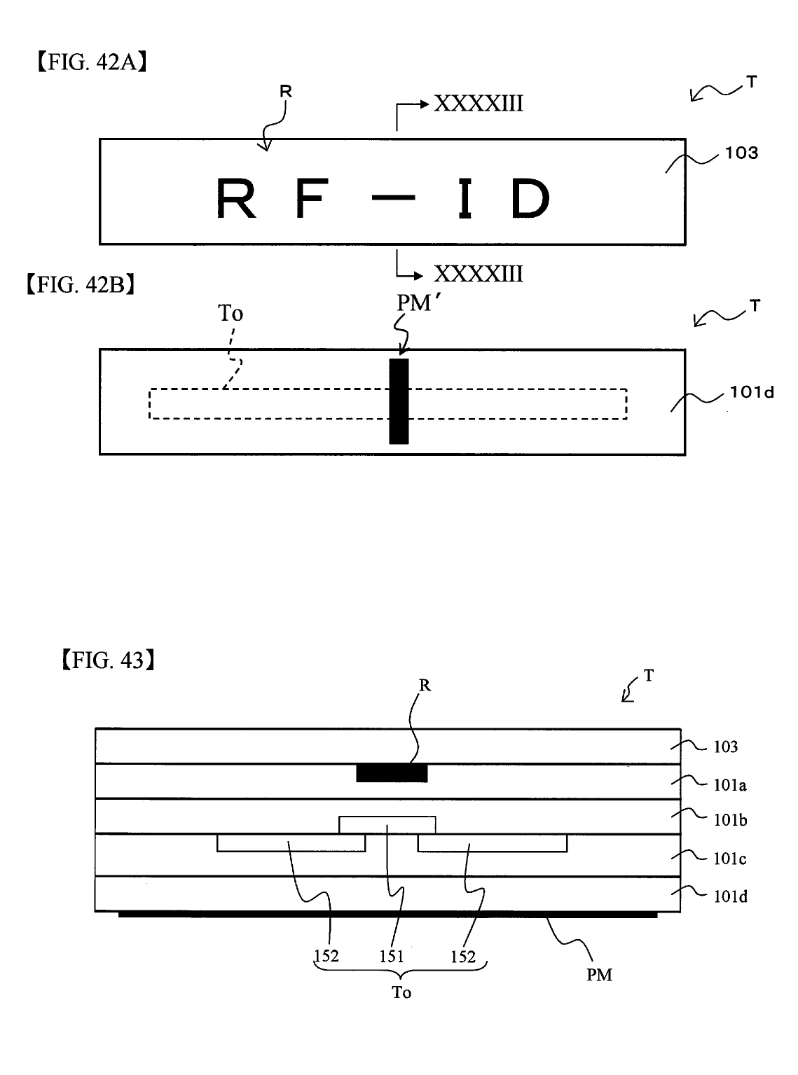

FIGS. 42A and 42B are diagrams illustrating the appearance of an exemplary RFID label T which has been completed after information has been read from the RFID circuit element To, and the tag label tape 110 with print has been cut, as described above. FIG. 42A is a top plan view (showing the print-receiving tape 103), and FIG. 42B is a bottom plan view (showing the separation sheet 101d). FIG. 43 in turn is a cross-sectional view taken along a section XXXXIII-XXXXIII′ in FIG. 42.

Referring to FIGS. 42A, 42B, 43, the RFID label T is in a five-layer structure in which the print-receiving tape 103 is added to the four-layer structure illustrated in FIG. 39. The five layers are comprised of the print-receiving tape 103, the adhesive layer 101a, the base film 101b, the adhesive layer 101c, and the separation sheet 101d, which are laminated from the print-receiving tape 103 (upper side in FIG. 43) to the opposite side (lower side in FIG. 43). As described above, the RFID circuit elements To, each including the antenna 152 and disposed on the back side of the base film 101b, are embedded in the adhesive layer 101c, and a character R (in this example, a character “RF-ID” indicative of the type of the RFID label T) is printed on the back side of the print-receiving tape 103. Also, the access mark PM is borne on the surface of the separation sheet 101d (on the front surface in FIG. 42B, and on the bottom surface in FIG. 43), for example, by printing.

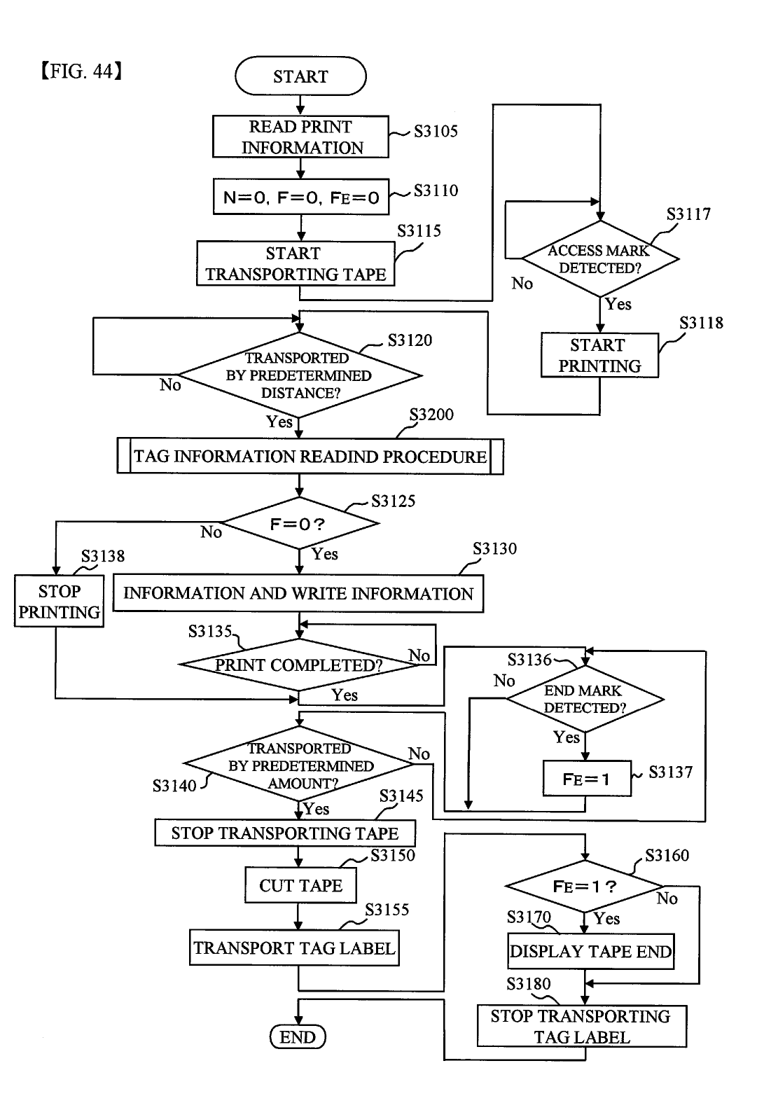

FIG. 44 is a flow chart illustrating a control procedure executed by the control circuit 30 during the production of the RFID label T in a scenario where a predetermined character is printed by the print head 10 on the print-receiving tape 103 which is transported while the base tape 101 is bonded to the print-receiving tape 103 to form the tag label tape 110 with print which is then cut into individual RFID labels T, each of which contains one RFID circuit element To.

Referring to FIG. 44, the flow is started in response to a read operation performed by the tag-label producing apparatus 2, for example, through the terminal 5 or general-purpose computer 6 (or possibly through a manipulation panel, not shown, provided on the tag-label producing apparatus 2 itself, which may be employed in the following embodiments and modifications). First, at step S3105, the tag-label producing apparatus 2 reads, through the communication network 3 and input/output interface 31, print information which is entered through the terminal 5 or general purpose computer 6 and which should be printed on the RFID label T by the print head 10, in a manner similar to step S2105 in FIG. 26 above.

Subsequently, at step 3110, the control circuit 30 initializes a flag FE associated with end mark detection to zero, in addition to a variable N for counting the number of times a retry is made (number of times of access retries), and a flag F indicative of a normal or a failed communication, similar to those at step S2110 in FIG. 26.

Then, at step S3115, the control circuit 30 outputs a control signal to the cartridge shaft drive circuit 24 to drive the ribbon take-up roller 106 and feeding roller 107 as well as the feed roller 17 with a driving force of the motor 23 to drive cartridge shaft in a manner similar to step S2115 in FIG. 26.

Next, the flow goes to step S3117, where the control circuit 30 determines whether or not the access mark PM is detected by the sensor 19 on the base tape 110 (whether or not a mark detection signal is entered). The determination at step S3117 is not YES while the access mark PM is not detected (as long as a portion of the separation sheet 101d in normal color, not including the access mark PM or the end mark EM, remains at the position opposite to the sensor 19, though the base tape 101 is being fed out). When the base tape 101 is further fed out to cause the access mark PM to reach the position opposite to the sensor 19, the access mark PM is detected by the sensor 19, causing the determination at step S3117 to be YES. Then, the flow goes to step S3118. At step S3118, the control circuit 30 outputs a control signal to the print-head drive circuit 25 which powers the print head 10. In response, the print head 10 starts printing the character R read at step S3105, such as characters, symbols, bar code or the like on a predetermined area of the print-receiving tape 103 (for example, an area which is to be bonded to the back side of base tape 101 in which RFID circuit elements To are arranged at regular intervals and at a predetermined pitch).

Consequently, the base tape 101 is bonded to the print-receiving tape 103, on which the character R has been printed, by the feeding roller 107 and sub-roller 109 for integration into the tag label tape 110 with print which is delivered to the outside of the cartridge 100.

Subsequently, steps S3120, S3200, S3125, S3130, S3135 are similar to steps S2120, S2200, S2125, S2130, S2135 in the aforementioned FIG. 26, where after determining the distance by which the tag label tape 110 with print has been transported, the control circuit 30 reads the RFID tag information from the RFID circuit element To (a detailed procedure at step S3200 may be the same procedure previously described in connection with FIG. 14, as is the case with step S2200). After confirming that the flag F is zero (F=0), the control circuit 30 stores the combination of the information read from the RFID circuit element To with the print information in the information server 7 and route server 4. Then, the control circuit 30 repeats the determination as to characters have been all printed on a corresponding area of a RFID circuit element To under processing at this time until the characters have been printed.

At step S3135, after the control circuit 30 confirms that the characters have been printed on the print-receiving tape 103, the flow goes to step S3136. At step S3136, the control circuit 30 determines whether or not the sensor 19 detects the end mark EM at the end of the base tape 101 (whether or not an end mark detection signal is entered). In a normal state where unused RFID circuit elements To still remain on the base tape 101, the sensor 19 does not detect the end mark EM, and therefore the determination at step S3136 is not YES, causing the flow to go to step S3140.

When unused RFID circuit elements To have been used up at this moment (the RFID circuit element To from which information was read at preceding step S3200 is the last (fiftieth in the aforementioned example in FIG. 41) RFID circuit element To arranged on the base tape 110), the determination at step S3136 is YES because the end mark EM reaches the position opposite to the sensor 19 before the cut line CL-50 reaches the position opposite to the cutter 15 after the base tape 101 has been transported by a predetermined distance from the fact that the distance LE from the end mark EM to the cut line CL-50 is shorter than the distance Lo from the position opposite to the sensor 19 to the position opposite to the cutter 15. In response, the control circuit 30 sets the tape end detection flag FE to one (FE=1) at step 3137, followed by the flow going to step S3140. Stated another way, since the distance LE is shorter than the distance L, the sensor 19 can detect the end mark EM during the production of a label using the last RFID circuit element To.

At step S3125 described above, if the reading procedure has not been normally completed for some reason, the flag F is set to “1” (see at step S2280 in the flow chart illustrated in FIG. 27, later described). Accordingly, the determination at step S3125 is NO, causing the flow to go to step S3138, where the control circuit 30 outputs a control signal to the print-head drive circuit 25 to stop the power to the print head 10 which stops the printing in response to the control signal. In this way, the control circuit 30 explicitly displays that a pertinent RFID circuit element To is defective through such interrupted printing. Then, the flow goes to the aforementioned step S3136.

At step S3140, the control circuit 30 determines whether or not the tag label tape 110 with print has been further transported by a predetermined distance (for example, a transport distance long enough for a RFID circuit element To under processing and a print area on the print-receiving tape 103 corresponding thereto to go beyond the cutter 15 by a predetermined length (margin)). The determination on the transport distance may also be made, for example, by measuring the angle by which the motor 23 to drive cartridge shaft has rotated from the time the access mark PM has been detected by the sensor 19, or counting the number of pulses output from the cartridge shaft drive circuit 24 configured to drive the motor 23 to drive cartridge shaft, in a manner similar to step S2120 described above. The determination at step S3140 is YES when the tag label tape 110 with print has been transported by the predetermined distance, causing the flow to go to step S3145.

At step S3145, the control circuit 30 outputs a control signal to each of the cartridge shaft drive circuit 24 and tape-feeding-roller drive circuit 29 to stop driving the motor 23 to drive cartridge shaft and tape-feeding-roller motor 28, thus stopping rotations of the ribbon take-up roller 106, feeding roller 107, and feed roller 17, in a manner similar to step S2145 in FIG. 26 above. This results in stopping the base tape 101 fed out from the base tape roll 102, the print-receiving tape 103 fed out from the print-receiving tape roll 104, and the tag label tape 110 with print transported by the feed roller 17. At this time, the cut line CL borne on the separation sheet 101d just reaches a position (opposite to the cutter 15) sandwiched by blades of the cutter 15.

Subsequently, at step S3150, the control circuit 30 outputs a control signal to the solenoid drive circuit 27 to drive the solenoid 26 which forces the cutter 15 to cut (break) the tag label tape 110 with print along the cut line CL, in a manner similar to step S2150 in FIG. 26 above. The tag label tape 110 with print cut by the cutter 15 results in a RFID label T from which predetermined RFID tag information has been read from the RFID circuit element To and on which a predetermined character has been printed in correspondence to the RFID tag information (stated another way, the cutter 15 cut off the RFID label T along the trailing edge on the downstream side in the transport direction).

Next, the flow goes to step S3155, where the control circuit 30 outputs a control signal to the tape-feeding-roller drive circuit 29 which responsively resumes driving the tape-feeding-roller motor 28 to rotate the feed roller 17, in a manner similar to step S2155 in FIG. 26. Consequently, the feed roller 17 resumes transporting the RFID label T produced in a label shape at step 3150 above toward the carry-out exit 16.

Then, the control circuit 30 determines at step S3160 whether or not the tape end detection flag FE is “1.” As described above, the flag FE is “0” in a normal state where unused RFID circuit elements To still remains on the base tape 110, so that the determination at step S3160 is not YES. The flow goes to step S3180, where the control circuit 30 outputs a control signal to tape-feeding-roller drive circuit 29 which responsively stops driving the tape-feeding-roller motor 28 after the lapse of time or the transportation of the tag label tape 110 with print long enough to discharge the RFID label T to the outside of the apparatus 2 through the carry-out exit 16, causing the feed roller 17 to stop rotating. Then, the flow is terminated.

On the other hand, when there is no longer any unused RFID circuit element To on the base tape 110, the tape end detection flag FE is “1.” As such, the determination at step S3160 is YES, and the control circuit 30 outputs a tape end display signal to the terminal 5 or general-purpose computer 6 through the input/output interface 31 and communication network 3 to display a corresponding tape end message (or such a message may be displayed on a display device, not shown, provided on the label producing apparatus 2). Then, the flow goes to step S3180, where the control circuit 30 stops the transport of the feed tape 110, followed by the termination of the flow.

In this event, the terminal 5 or general-purpose computer 6 displays, for example, the screen shown in the aforementioned FIG. 12.

Through the foregoing routine, the label producing apparatus 2 can access and read the RFID tag information (tag identification information and the like) stored in the IC circuit part 151 of the target RFID circuit element To within the cartridge 100. Also, when the control circuit 30 fails to correctly read the RFID tag information from the IC circuit part 151a predetermined number of times, the control circuit 30 knows that the RFID circuit element To is damaged, and can therefore determine whether or not the RFID label is defective.

In the foregoing description, the base tape 101, i.e., label medium implements a second marked tape, and also implements a marked tape having identification marks arranged at predetermined intervals and a label tape in respective aspects of the present invention. The control circuit 30 which executes the control procedure illustrated in FIG. 11 implements an end recognizing device configured to recognize the end of the second marked tape in accordance with a second identification mark and a lacking portion detected by the detecting device, and also implements a malfunction preventing device in respective aspects of the present invention. In addition, the control circuit 30 and sensor 19 implement a tape end detector for detecting the end in the feeding direction of the marked tape which has identification marks arranged at predetermined intervals.

In the forgoing embodiment configured as described above, during the production of the RFID label T, the base tape 101 is bonded to the print-receiving tape 103, on which a character has been printed, by the feeding roller 107 and sub-roller 109 to create the tag label tape 110 with print. Access information is generated by the signal processing circuit 22 and radio frequency circuit 21 and transmitted to the antenna 152 of the RFID circuit element To through the antenna 14 to access information in the IC circuit part 151 of the RFID circuit element To (reading the information in this example, and writing information in an exemplary modification, later described). Then, the tag label tape 110 with print having the thus accessed RFID tag circuit element To is cut at predetermined intervals (from one cut line CL to the next cut line CL) by the cutter 15 to produce individual RFID labels T. In this event, the sensor 19 detects the access marks PM borne on the base tape 101 at predetermined intervals, which are utilized by the control circuit 30 to control the print head 10 to start printing (step S1118 in FIG. 11), to control the positioning of the tag label tape 110 with print at the access position (step S1120), and to control the positioning of the tag label tape 110 with print for cutting by cutter 15 (step S1140), thereby improving the accuracies of the start of printing, accessing, and tape cutting in this embodiment.

When RFID labels T are produced one by one as the base tape 101 is fed out as described above, the base tape 101 is eventually exhausted from the base tape roll 102 so that RFID labels T can no longer be produced. In this embodiment, the sensor 19 detects the end mark EM at the end of the base tape 101 in the feeding direction to recognize the end, allowing the control circuit 30 to know that the base tape 101 will be used up in short order. In other words, the label producing apparatus of the fourth embodiment can prevent malfunctions and/or inappropriate operations in the detection process to reliably detect the end of the base tape 101.

Since the end mark EM is implemented by a lacking portion (hole) through the base tape 101, a simple mechanical process is only required to provide the end mark EM. Accordingly, as compared with a conventional tape which has an end mark made of a different material, the base tape 101 can be processed for detection of the tape end in a simple process and at an extremely low cost.

Further, when the base tape 101 is bonded to the print-receiving tape 103 to create the RFID label T as described above, it is a general tendency that the overall length of the base tape 111 is set shorter than the overall length of the print-receiving tape 103 in the cartridge 100 (in other words, the print-receiving tape 103 still remains when the base tape 101 is used up) when the base tape roll 102 and print-receiving tape roll 104 are manufactured and positioned, from the fact that the base tape 101 containing the RFID circuit elements To is more expensive than the print-receiving tape 103. Therefore, supposing that no action is taken to detect the end of tape, the base tape 101 is used up earlier and is no longer fed out. The tape (tag label tape 110 with print) remains stationary downstream of the location at which the base tape 101 is bonded to the print-receiving tape 103 (where they are sandwiched by the feeding roller 107 and sub-roller 109), whereas the remaining print-receiving tape 103 is still fed out from the second roller 104. As such, the print-receiving tape 103 fed out from the second roller 104 has nowhere to go, and can meanderingly stay, for example, in piles in a space upstream of the feeding roller 107 and sub-roller 109 (so-called jamming). As described above, in this embodiment, when the sensor 19 detects the tape end of the base tape 101, the control circuit 30 stops the motor 23 to drive cartridge shaft to stop transporting all the tapes (step S3180 in FIG. 44) after produced RFID labels T have been discharged, thus making it possible to prevent the jamming as described above. In addition, since the terminal 5 or general-purpose computer 6 displays that the tape end is detected (step S3170), the operator can be prevented from performing operations for a gain producing RFID labels T by mistake after the last RFID label T has been discharged. Accordingly, the jamming can be prevented as well in this meaning.

Also notably, in this embodiment, the end mark EM formed through the base tape 101 has the dimension xE in the longitudinal direction of the base tape 101 longer than the dimension x of the access mark PM in the longitudinal direction of the tape 101. By thus setting the dimensions of the two marks, when the sensor 19 detects the end mark EM at step S3136 shown in FIG. 44, the tape end can be recognized only when the sensor 19 detects a non-reflective area larger than the non-reflective area detected at step S3117. Thus, the sensor 19 can be prevented from erroneously detecting the end mark EM to increase the reliability of the detection.

Further, since the end of the base tape 101 in the feeding direction is fixed to the reel member 102a of the base tape roll 102, the base tape 101 can be restricted and forcedly stopped when the base tape 101 is eventually used up during the production of RFID labels.

Since the access marks PM are borne on the separation sheet 101d which is removed when the RFID label T is used, the complete RFID label T itself is free of the marks or traces thereof, thus improving the RFID label in aesthetic sense.

It should be understood that the fourth embodiment is not limited to the foregoing, but can further be modified in various ways without departing from the spirit and technical idea. The following description will be focused on such exemplary modifications.

(4-1) Different Shape/Implementation of Hole (Cutout)

In the fourth embodiment described above, the base tape 101 is formed with a single cutout like a rectangular hole as shown in FIG. 41, but the cutout is not so limited, and the base tape 101 may be formed with a different cutout.

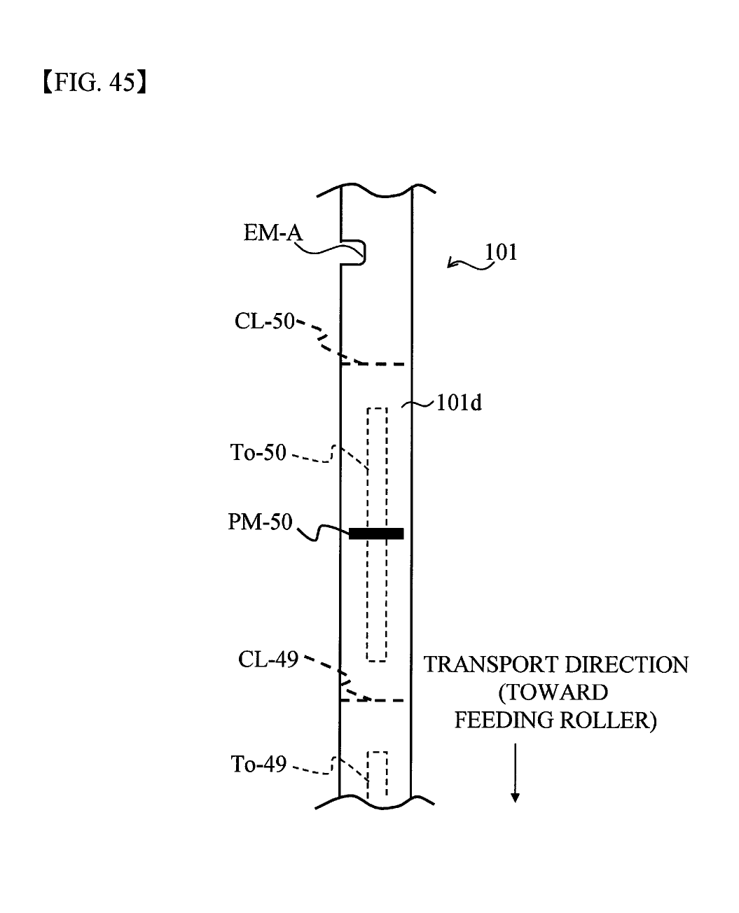

FIG. 45 is a diagram illustrating the structure of the base tape 101 near the end thereof, showing an exemplary modification to the cutout. FIG. 45 corresponds to FIG. 41 above. Referring to FIG. 45, in this exemplary modification, the base tape 101 is formed with an end mark EM-A which is a incision (cutout) cut into the base tape 101 from one edge (left-hand edge in the illustrated example) in the width direction (near the end). It should be noted that the end mark EM-A is longer than the access mark PM in the longitudinal direction, like the end mark EM. Also, the distance from the end mark EM-A to the cut line CL is shorter than the distance from the access mark PM to the cut line CL.

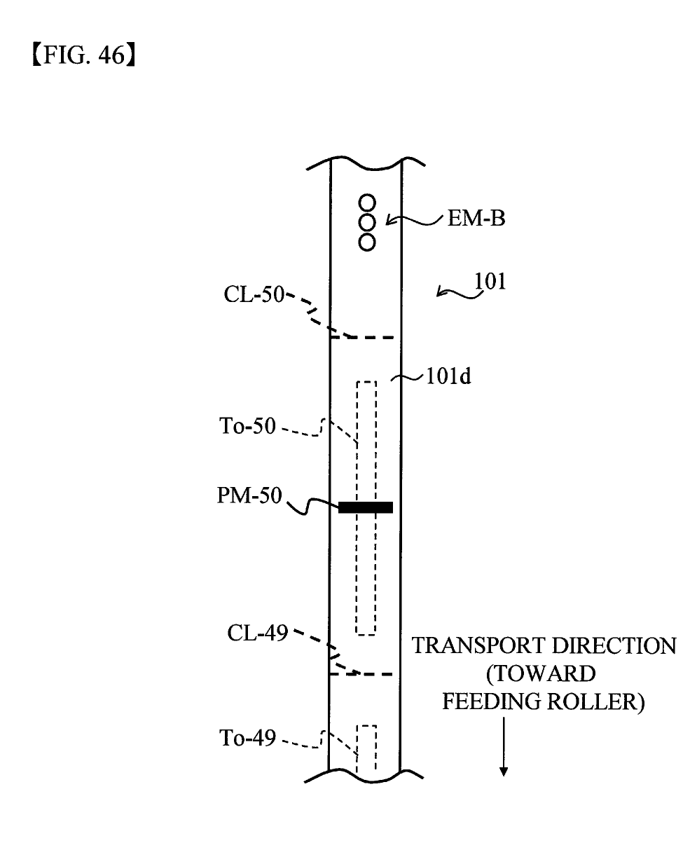

FIG. 46 is a diagram illustrating the structure of the base tape 101 near the end thereof, showing another exemplary modification to the cutout. FIG. 46 corresponds to FIGS. 41 and 45 above. Referring to FIG. 46, in this exemplary modification, the base tape 101 is formed with an end mark EM-B comprised of a plurality (three in this example) of holes (cutouts) near the end thereof. Like the end mark EM, the end mark EM-B is longer than the access mark PM in the longitudinal direction. Also, the distance from the end mark EM-B to the cut line CL is shorter than the distance from the access mark PM to the cut line CL.

The two exemplary modifications described above provide similar advantages to those of the fourth embodiment with the detection by the sensor 19 and the control by the control circuit 30 based on the detection similar to those in the fourth embodiment.

(4-2) Detection of Released Tape End:

In the foregoing description, the sensor 19 detects the hole (cutout) near the end of the base tape 101, which is fixed to the reel member 102a for detecting the end of the base tape 101 fed out from the base tape roll 102, but this is not a limitation. Specifically, the end of the base tape 101 may not be fixed to the reel member 102a but simply in contact with the same, for example, with the aid of an adhesive of the like. When the base tape 101 is used up, the end of the base tape 101 comes off the reel member 102a, so that the base tape 101 is released and transported as it is. Then, the sensor 19 may detect a free state (absence of the base tape 101) as the lacking portion for recognition by the control circuit 30.

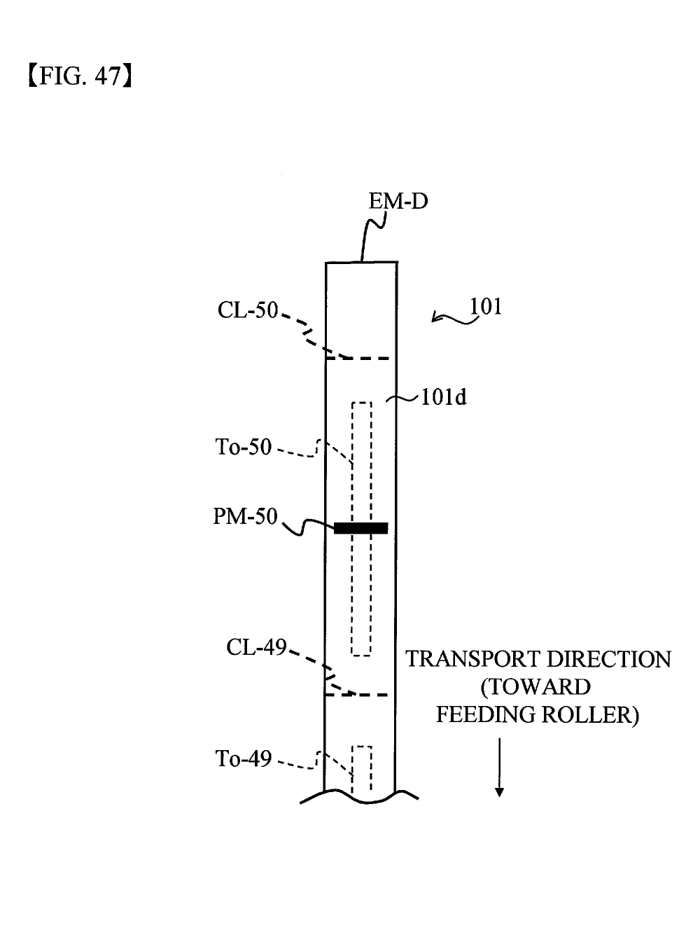

FIG. 47 is a diagram illustrating the structure of the base tape 101 near the end, showing such an exemplary modification. FIG. 47 corresponds to FIG. 41 above. FIG. 47 illustrates that the end of the base tape 101 comes off the reel member 102a, so that the base tape 101 is transported toward the feeding roller 107, where a free end (lacking portion) EM-D is detected when the base tape 101 comes off the reel member 102a. It should be noted that the distance from the free end (lacking portion) EM-D to the cut line CL is shorter than the distance from the access mark PM to the cut line CL, as is the case with the aforementioned end mark EM and the like.

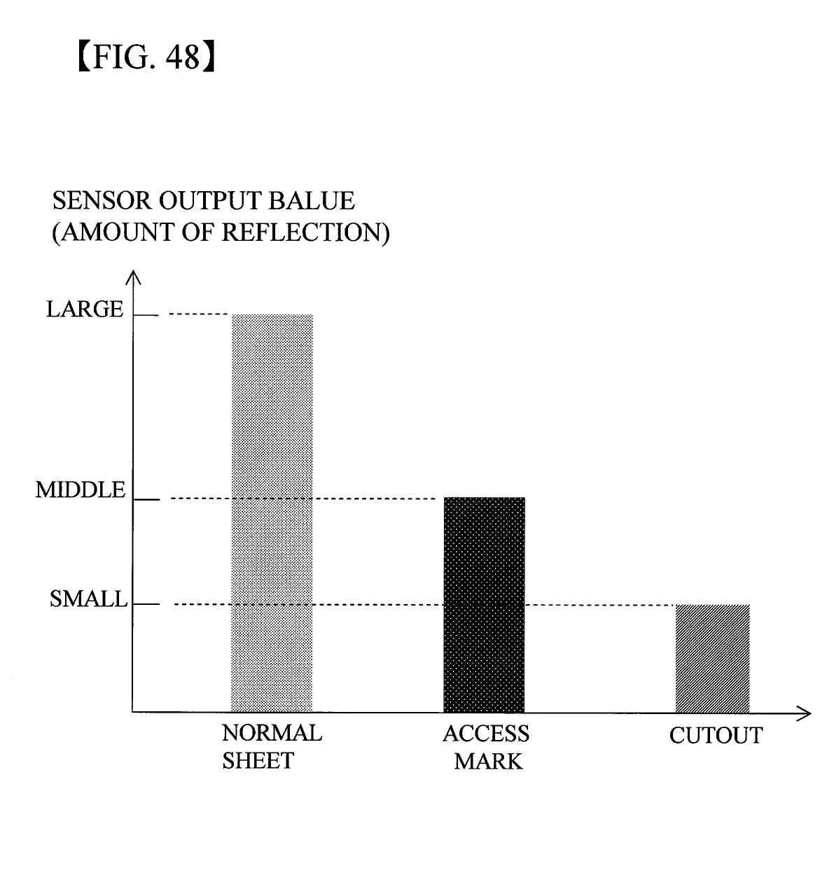

FIG. 48 is a diagram showing a table stored in the control circuit 30 (for example, in a storage device such as the ROM) for recognizing the tape end with the free end EM-D. Referring to FIG. 48, the vertical axis represents the magnitude of signals detected by the sensor 19. As described above, the sensor 19 is a reflection type detecting device which outputs a control output value in accordance with the amount of reflected light. The shown table, which corresponds to the detection principle of the sensor 19, allows the control circuit 30 to recognize that a category associated with the largest control output value (in other words, the largest amount of reflected light) is the normal separation sheet 101d free from the lacking portion (hole, incision, released tape or the like) or the access mark (in black or the like); a category associated with the smallest control output value (in other words, the smallest amount of reflected light) is a lacking portion (hole, incision, released tape or the like); and a category associated with an intermediate control output value (in other words, an intermediate amount of reflected light) is the access mark (in black or the like). Stated another way, the control circuit 30 recognizes the tape end when the detection signal from the sensor 19 presents the smallest magnitude based on the difference among the three output values (three regions shown in FIG. 48).

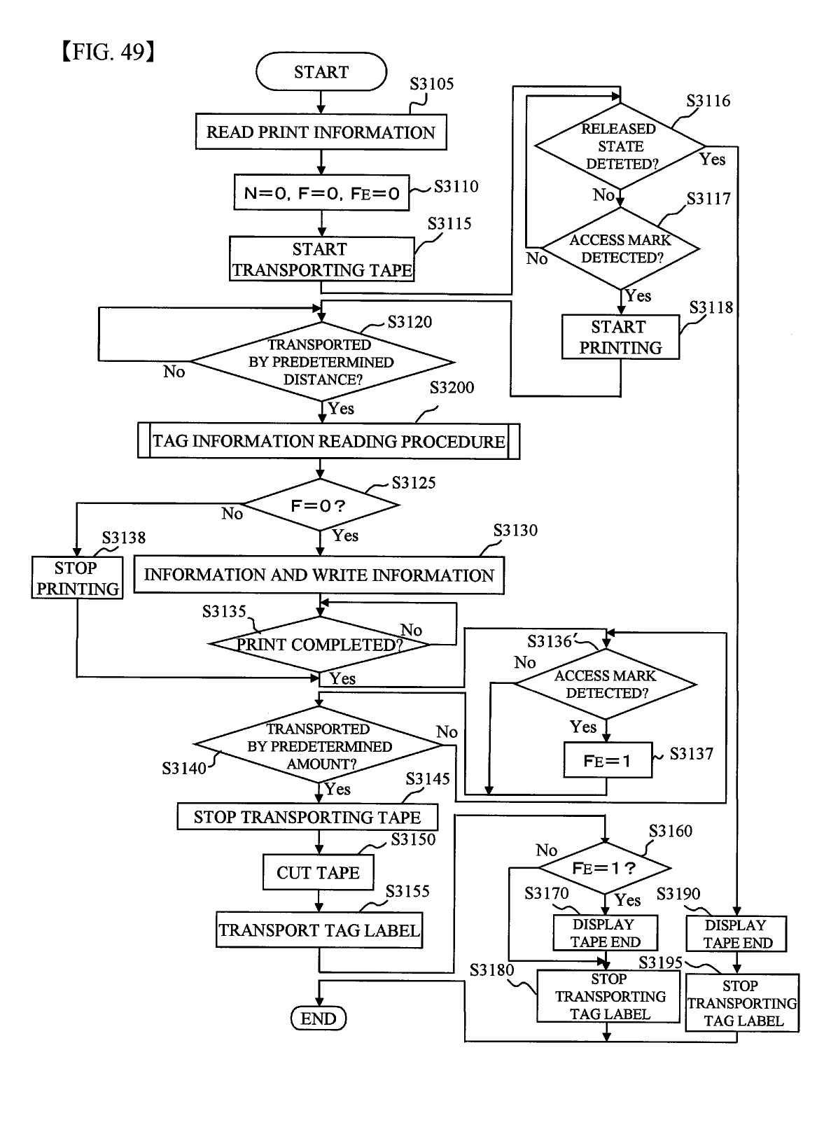

FIG. 49 is a diagram illustrating a control procedure executed by the control circuit 30 in this exemplary modification, and corresponds to FIG. 44 above. Steps equivalent to those in FIG. 44 are designated the same reference numerals, and descriptions thereon are omitted as appropriate.

Referring to FIG. 49, FIG. 49 differs from FIG. 44 in that step S3116 is additionally provided between steps S3115 and 3117, and steps S3190 and S3195 are additionally provided. Specifically, the flow goes to step S3116 after the control circuit 30 starts transporting the base tape 101 and print-receiving tape 103 at step S3115. At step S3116, the control circuit 30 determines whether or not the sensor 19 detects the free mend EM-D of the base tape 101. More specifically, the control circuit 30 determines whether or not a detection signal from the sensor 19 falls within the “lacking portion category” shown on the lowermost region of FIG. 48. When the determination at step S3116 is YES, the control circuit 30 assumes that the base tape 101 has already been released from the reel member 102a. The flow goes to additional step S3190, where the control circuit 30 forces the terminal 5 or general-purpose computer 6 to display that the base tape 101 has reached the end, similar to that at step S3170. Next, the flow goes to step S3195, where the control circuit 30 outputs control signals to the cartridge shaft drive circuit 24 and tape-feeding-roller drive circuit 29 to stop transporting all the tapes, in a manner similar to step S3145 above, followed by the termination of the flow.

When the determination at step S3116 is not YES, the flow goes to step S3117, where a similar procedure is performed. When the determination at step S3117 is not YES, the flow returns to step S3116 from which similar procedures are repeated.

FIG. 49 also differs from FIG. 44 in that step S3136′ is substituted for step S3136 corresponding thereto. Specifically, when the control circuit 30 determines at step S3135 that characters have been printed on the print-receiving tape 103, the flow goes to step S3136′, where the control circuit 30 determines whether or not the sensor 19 detects the lacking portion EM-D of the base tape 101, in a manner similar to step S3116 above. When the determination is YES, the control circuit 30 assumes that the end of the base tape 101 has been released from the reel member 102a. Then, the control circuit 30 sets the tape end detection flag FE to “1” (FE=1) at the aforementioned step S3137. The flow next goes to step S3140. When the determination at step S3136′ is not YES, the flow directly goes to step S3140. Since the subsequent procedure is similar to that in FIG. 44, a description thereon is omitted.

In the foregoing exemplary modification, since the base tape 101 may have a simple free end (in contact with the reel member 102a), the base tape 101 can be processed for detection of the tape end in a simple process and at an extremely low cost, as is the case with the fourth embodiment.

Further, in the foregoing exemplary modification, the output value from the sensor 19 is divided into three categories as shown in FIG. 48, such that the control circuit 30 recognizes the free end EM-D based on these categories, the sensor 19 can prevent the control circuit 30 from erroneously recognizing the free end EM-D, thus increasing the reliability of the detection. Also, since the control circuit 30 recognizes the tape end only based on the difference among detection signal output values irrespective of the dimensions of the marks (x, xE) in the longitudinal direction of the base tape 101 in a manner similar to the fourth embodiment, the tape need not be driven upon detection. Stated another way, the control circuit 30 can correctly recognize that the free end EM-D exists at the position opposite to the sensor 19 even if the tape is intentionally stopped or even if the tape is unintentionally stopped for some reason.

The foregoing approach may be applied to the detection and recognition of the end mark at the end of the base tape 101 which does not have a free end in the fourth embodiment and exemplary modification (4-1). Specifically, the control circuit 30 previously stores the table of FIG. 48 in the storage device, such that the control circuit 30 may determine whether or not a detection signal falls within the “smallest detected value” category in the lowermost region in FIG. 48 when the determination is made at step S3136 in the flow of FIG. 44; and may determine whether or not a detection signal falls within the “intermediate detected value” category in the intermediate region in FIG. 48 when the determination is made at step S3117. In this event, since the end marks EM, EM-A, EM-B can be detected and recognized even if the base tape 101 is not being driven, the end marks EM, EM-A, EM-B need not have the dimensions in the longitudinal direction of the base tape 101 longer than the access mark PM.

Alternatively, the base tape 101 may have a linear free end EM additionally formed with an incision or the like, as illustrated in FIG. 50. This base tape 101 provides similar advantages to those described above.

(4-3) Employment of Light Absorbing Device:

In the fourth embodiment and exemplary modifications (4-1), (4-2) thereto described above, the control circuit 30 recognizes the end marks EM, EM-A, EM-B and free ends EM-C, EM-D taking advantage of fact that light emitted from the light emitter of the sensor 19 passes through the end marks EM, EM-A, EM-B and free ends EM-C, EM-D to the opposite side of the base tape 101, so that the light receiver of the sensor 19 receives reduced amounts of light reflected from the end marks EM, EM-A, EM-B and free ends EM-C, EM-D. However, the recognition is not so limited. Alternatively, the light passing through the base tape 101 may be received by a light absorbing device.

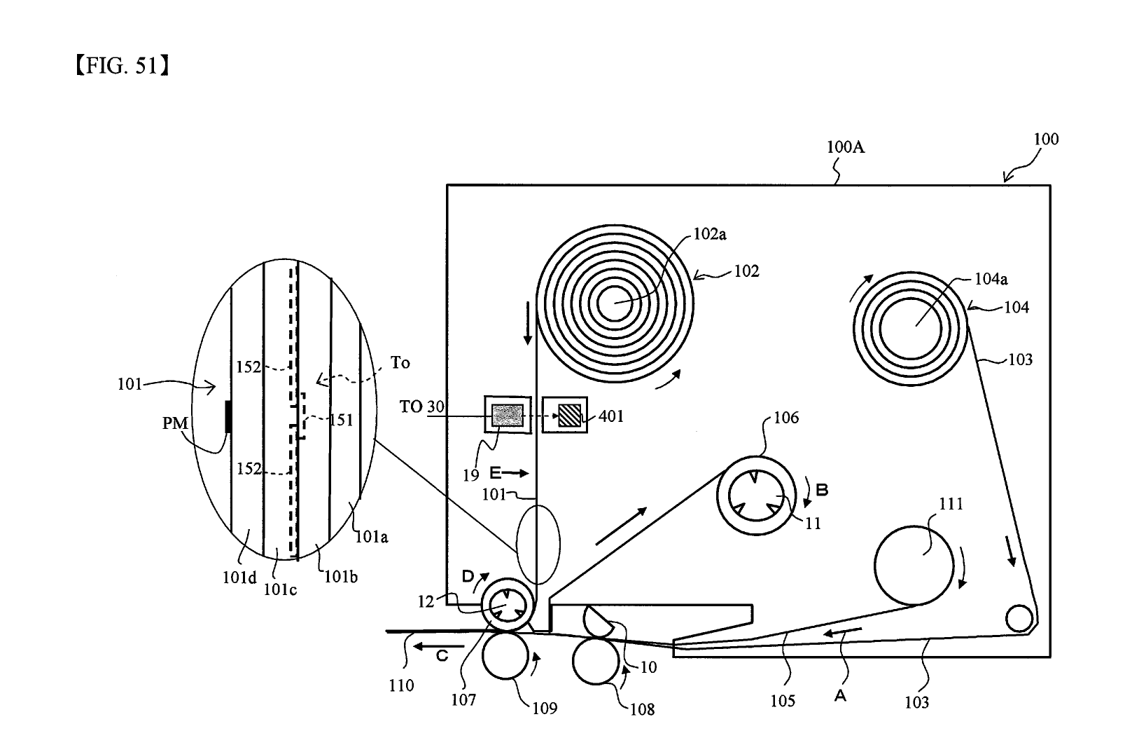

FIG. 51 is an explanatory diagram for describing in detail the structure of a cartridge in such an exemplary modification, and corresponds to FIG. 39. Parts equivalent to those in FIG. 39 are designated the same reference numerals, and descriptions thereon are omitted as appropriate.

Referring to FIG. 51, in this exemplary modification, a known appropriate light absorbing member 401 is disposed at a position opposite to the sensor 19 across the feeding path of the base tape 101, such that the light absorbing member 401 absorbs light (optical detection signal) from the light emitter of the sensor 19.

In this way, as light emitted from the light emitter of the sensor 19 reaches the light absorbing member 401 positioned on the opposite side across the tape through a lacking portion such as the end mark EM, EM-A, EM-B, or free end EM-C, EM-D of the base tape 101, the light is absorbed by the light absorbing device 401 and therefore does not return to the light receiver of the sensor 19. As a result, substantially no light is incident on the light receiver of the sensor 19 at the lacking portion of the base tape 101, whereas some light signal is incident on the light receiver of the sensor 19 at the access mark PM, so that the difference therebetween can be made more distinctive to improve the accuracy of detection.

(4-4) Employment of Reflector:

Instead of the light absorbing member in the exemplary modification (4-3), a reflector may be used to change the direction of light.

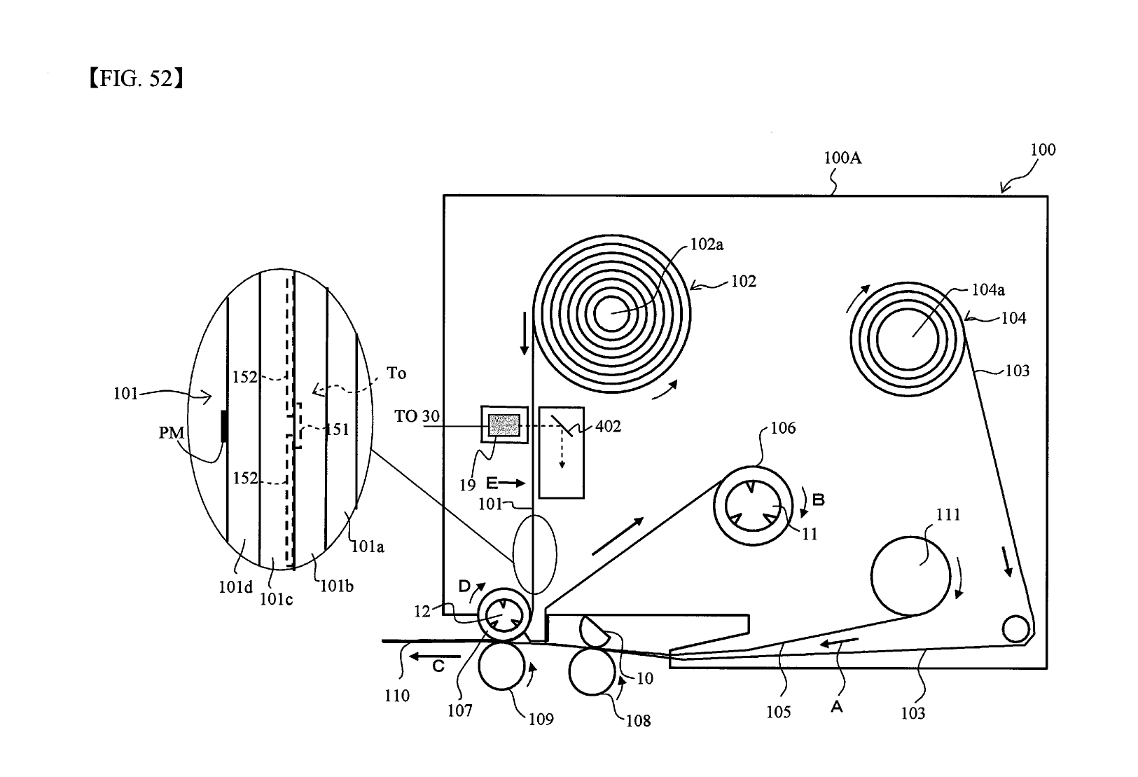

FIG. 52 is an explanatory diagram for describing in detail the structure of a cartridge for use in such an exemplary modification, and corresponds to FIGS. 39 and 51 above. Parts equivalent to those in FIG. 39 are designated the same reference numerals, and descriptions thereon are omitted as appropriate.

Referring to FIG. 52, in this exemplary modification, a known appropriate reflector (reflecting device) 402 is disposed at a position opposite to the sensor 19 across the feeding path of the base tape 101, such that the reflector 402 deflects light (optical detection signal) from the light emitter of the sensor 9 to a direction away from the sensor 19 (approximately 90° of deflection in this example).

In this way, as light emitted from the light emitter of the sensor 19 reaches the reflector 402 positioned on the opposite side across the tape through a lacking portion such as the end mark EM, EM-A, EM-B, or free end EM-C, EM-D of the base tape 101, the light is deflected by the reflector 402 at an angle of approximately 90°, and therefore does not return to the light receiver of the sensor 19. As a result, substantially no light is incident on the light receiver of the sensor 19 at the lacking portion of the base tape 101, whereas some light signal is incident on the light receiver of the sensor 19 at the access mark PM, so that the difference therebetween can be made more distinctive to improve the accuracy of detection.

(4-5) When Information is Written into RFID Circuit Element:

While the foregoing description has been made on an exemplary RFID tag manufacturing system for producing read-only RFID tag (not writable), the present invention is not so limited, but can be applied to a RFID tag manufacturing system which involves writing information into the IC circuit part 151 of the RFID circuit element To.

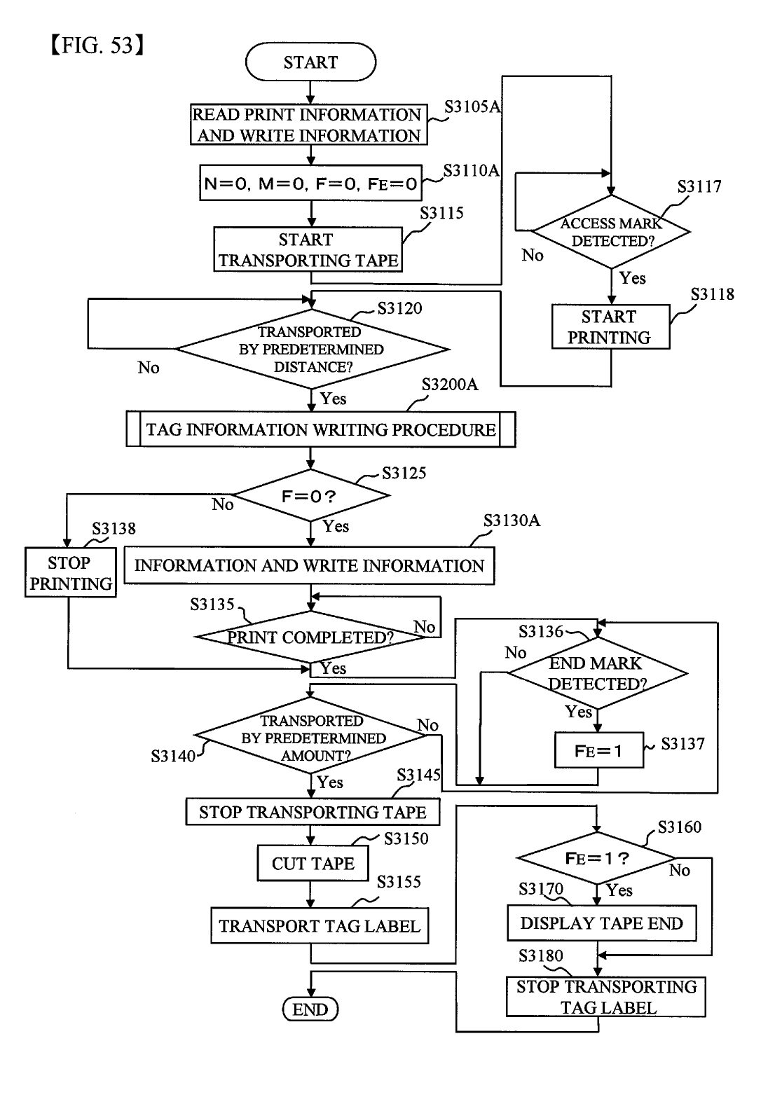

FIG. 53 is a flow chart illustrating a control procedure executed by the control circuit 30 in this exemplary modification, and is comparable to the aforementioned FIG. 44, where steps equivalent to those in FIG. 44 are designated the same reference numerals.

Referring to FIG. 53, at step S3105A, the tag-label producing apparatus 2 reads, through the communication network 3 and input/output interface 31, information which is entered through the terminal 5 or general purpose computer 6 (or possibly through a manipulation panel, not shown, provided on the tag-label producing apparatus 2 itself) and which the operator wishes to write into the IC circuit part 151 of the RFID circuit element To; and print information which should be printed on the RFID label T by the print head 10. After the completion of the processing at step S3105A, the flow goes to step S3110A, where the control circuit 30 initializes a variable M (described later in greater detail) to zero, in addition to the aforementioned variable N and flags F, FE.

Subsequently, the flow goes to step S3200A through steps S3115, S3117, S3118, and S3120 similar to those in FIG. 44. At step S3200A, the control circuit 30 initializes (erases) the memory for writing RFID tag information including ID information, article information and the like of a specified tag ID (all or part) or identification information, and transmits and writes the RFID tag information to and into the RFID circuit element To. Since details on this procedure are similar to those shown in n FIG. 28, a description thereon is omitted. After step S3200A is completed, the flow goes to step S3125, as is the case with FIG. 44.

At step S3125, the control circuit 30 determines whether or not the flag F is set to “0” in a manner similar to FIG. 44. When the determination at step S3125 is YES, the flow goes to step S3130A.

At step S3130A, the control circuit 30 outputs a combination of the information written into the RFID circuit element To at step S2200A with the print information previously printed by the print head 10 corresponding thereto for storage in the information server 7 and route server 4 through the terminal 5 or general purpose computer 6 by way of the input/output interface 31 and communication network 3. The information may be stored, for example, in the route server 4, as is the case with step S3130 in FIG. 44. The stored data is stored such that the terminal 5 or general-purpose computer 6 has accesses thereto as required.

Since the subsequent procedure is substantially similar to FIG. 44, a description thereon is omitted.

Through the foregoing routine, desired information can be written into the IC circuit part 151 of the RFID circuit element To, intended for access, within the cartridge 100.

As described above, the foregoing exemplary modification provides substantially similar advantages to the aforementioned fourth embodiment in the RFID tag manufacturing system which involves writing RFID tag information.

(4-6) When Tapes are not Bonded:

Instead of the fourth embodiment which involves directly printing a character on the print-receiving tape 103, and bonding the print-receiving tape 103 to the separate tag tape (base tape) 101 containing RFID circuit elements To, the present invention can be applied to a RFID circuit element cartridge for a tag-label producing apparatus which involves printing a character on a print-receiving tape integrated with a marked tape (tag tape).

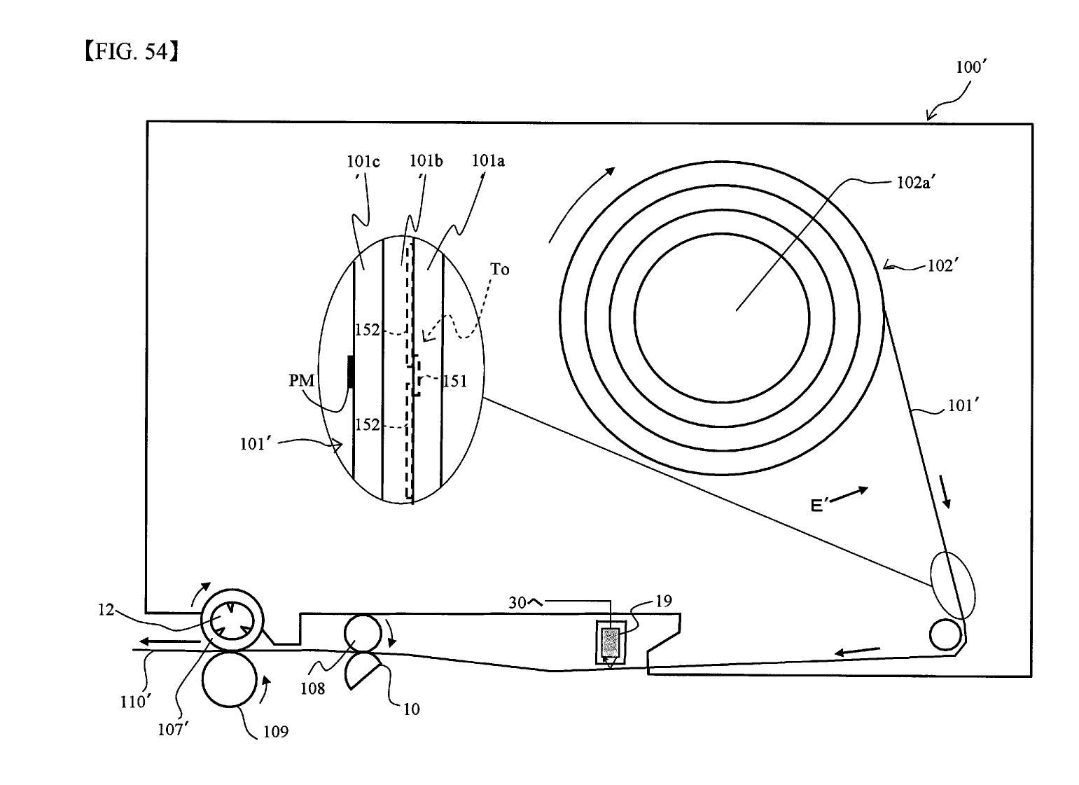

FIG. 54 is an explanatory diagram for describing in detail the structure of a cartridge 100′ according to this exemplary modification, and corresponds to the aforementioned FIG. 39. Parts equivalent to those in FIG. 39 are designated the same reference numerals, and descriptions on these parts are omitted as appropriate.

Referring to FIG. 54, the cartridge 100′ comprises a thermal tape roll (first roll, labeled tape roll) 102′ which includes a rolled thermal tape 101′ (second marked tape, marked tape, label tape, label medium), and a tape feed roller 107′ configured to feed the thermal tape 101′ to the outside of the cartridge 100′.

The thermal tape roll 102′ includes the elongated transparent thermal tape 101′ wound around a reel member (shaft member) 102a′, the axial direction (direction inward from the front on the sheet) of which is substantially perpendicular to the longitudinal direction of the tape 101′. The thermal tape 101′ is formed with a plurality of the RFID circuit elements To arranged in sequence in the longitudinal direction thereof.

In this example, the thermal tape 101′ wound around the reel member 102a′ to form the thermal tape roll 102′ has a three-layer structure (see a partially enlarged view in FIG. 54) which is made up of a print-receiving tape 101a′ made of PET (polyethylene terephthalate) or the like, an adhesive layer 101b′ made of an appropriate adhesive material and having a heat-sensitive recording layer on the surface, and a separation sheet (separation material) 101c′, which are laminated in this order from a side thereof which is rolled outward to the opposite side.

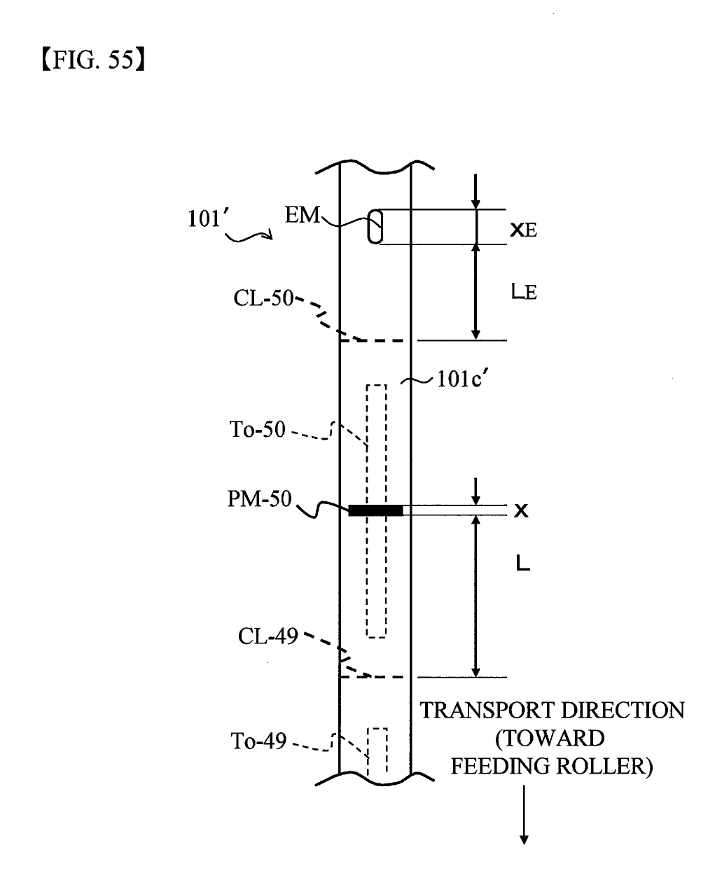

The IC circuit parts 151 configured to store information are embedded in the back side of the print-receiving tape 101a′, while the antennas 152 are formed on the back surface of the print-receiving tape 101a′. The separation sheet 101c′ is adhered to the back side of the print-receiving tape 101a′ through the adhesive layer 101b′. Then, the access mark PM is borne on the separation sheet 101c′, like the base tape separation sheet 101d in the aforementioned embodiment, for print start control timing, and positioning of the tape to the cutter cutting position CL. FIG. 55 illustrates the separation sheet 101c′, as viewed in a direction indicated by an arrow E′ in FIG. 54, for depicting how the access marks are printed on the separation sheet 101c′ (near the end of the print-receiving tape 101a′, and is substantially comparable to FIG. 41 in the aforementioned embodiment.

As the cartridge 100′ is loaded into the cartridge holder in the tag-label producing apparatus 2, and a roller holder (not shown) is moved from a spaced position to a contact position, the thermal tape 101′ is sandwiched between the print head 10 and platen roller 108, and is also sandwiched between the tape feed roller 107′ and sub-roller 109. Then, the tape feed roller driving shaft 12 is driven by a driving force of the motor 23 to drive cartridge shaft to rotate the tape feed roller 107′, sub-roller 109, and platen roller 108 in synchronization, causing the thermal tape 101′ to be fed out from the thermal tape roll 102′.

The fed-out thermal tape 101′ is supplied to the print head 10 located at a downstream location in the transport direction. The print head 10 has a plurality of heat generating elements which are powered by the print drive circuit 25 to print a character on the surface of the print-receiving tape 101a′ of the thermal tape 101′ to form a tag label tape 110 with print′ which is then delivered to the outside of the cartridge 100′. It should be understood that the character may be printed using an ink ribbon, as used in the fourth embodiment. In addition, an optical sensor 19 similar to that described above is disposed at a location upstream of the print head 10 in the transport direction for detecting the access marks PM and end marks EM, and applies a detection signal to the control circuit 30.

After delivered outside of the cartridge 100′, the IC circuit part 151 in the tag label tape 110 with print′ is accessed (for reading information therefrom or writing information thereinto) through the antenna 14, in a manner similar to the fourth embodiment. The subsequent transport by the feed roller 17, cutting by the cutter 15, and the like are similar to the fourth embodiment, so that descriptions thereon are omitted.

In the foregoing exemplary modification, the thermal tape 101′ can be processed for detection of the tape end in a simple process and at an extremely low cost, as is the case with the fourth embodiment.

(4-7) Employment of Tape without Tag:

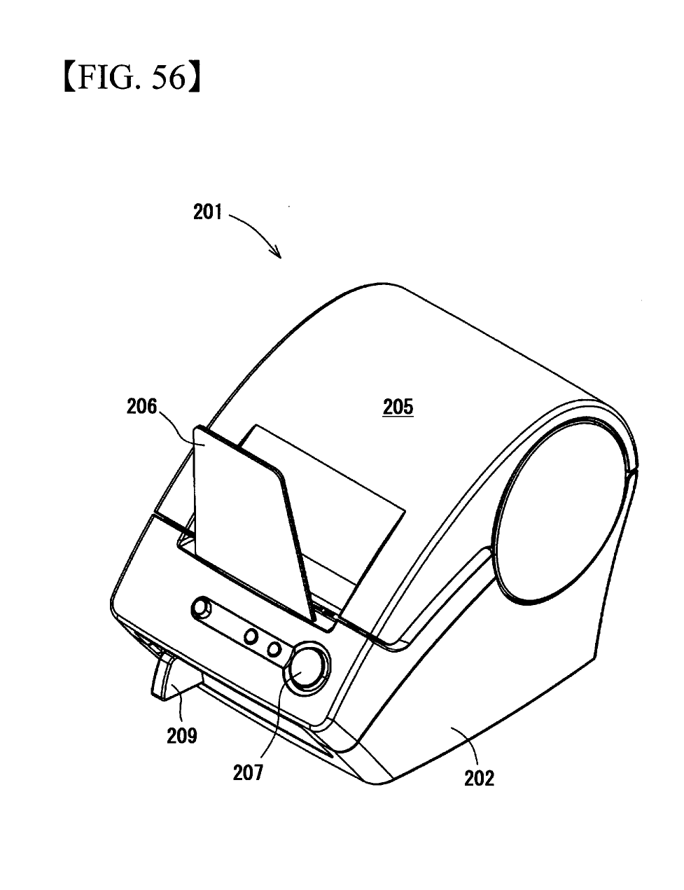

FIG. 56 is a perspective view generally illustrating the structure of a label producing apparatus for producing normal printed labels using a normal label tape which does not contain RFID circuit elements To.

Referring to FIG. 56, a label producing apparatus 201 comprises a housing 202; a top cover 205 made of transparent resin; a tray 206 made of transparent resin and implanted in front of the top cover to oppose substantially the center of the same; a power supply button 207 disposed in front of the tray 206; a cutter lever 209; and the like.

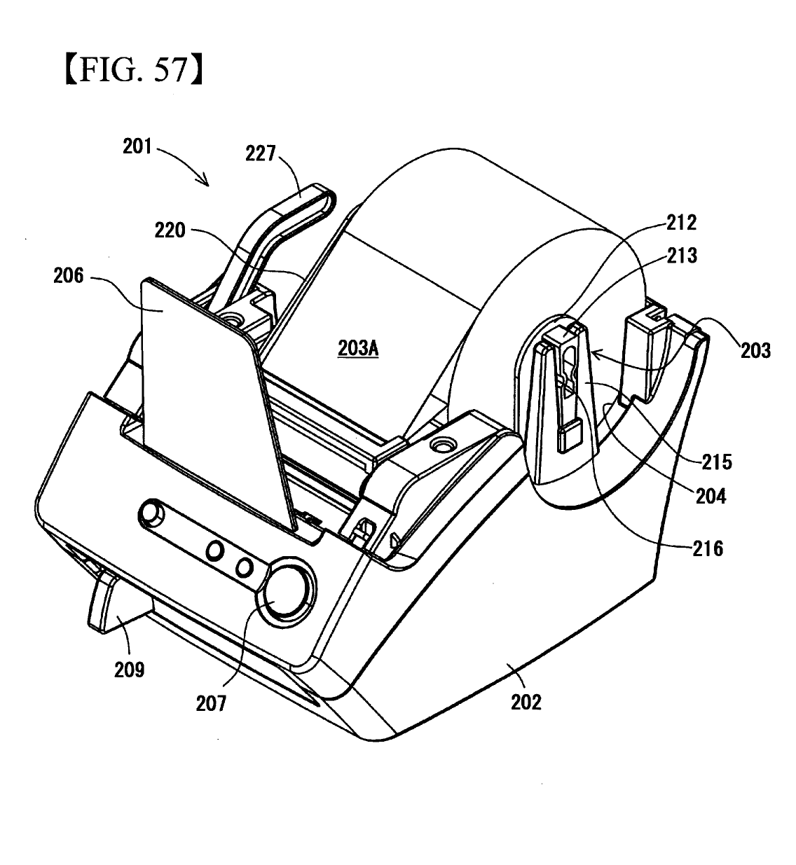

FIG. 57 is a perspective view illustrating the label producing apparatus of FIG. 56 when the cover 205 is removed therefrom.

Referring to FIG. 57, a tape holder 203 is fitted in a tape holder rest (container holder) 204. The tape holder 203 comprises a positioning/holding member 212 and a guide member 220, and is rotatably wound with a label tape (second marked tape, marked tape, label medium) 203A of a predetermined width. Specifically, the guide member 220 is disposed on one side wall, and the positioning/holding member 212 is disposed on the other side wall across the label tape 203A such that they intersect with the axial line of the label tape 203A substantially at right angles. The top cover 205 is movably attached to the upper rear edge of the housing 202 to cover the top of the tape holder rest 204.

A holder supporting member 215 is also disposed on one side edge of the tape holder rest 204 in a direction substantially perpendicular to a transport direction. The holder supporting member 215 is formed with a first positioning groove 216 which is open to the above and has an elongated inverted C-shape, as viewed from the front. An attachment member 213 is protrusively disposed outside of the positioning/holding member 212. The attachment member 213 is shaped to have a vertically elongated rectangular cross-sectional shape which tapers downward, as viewed from the front. The attachment member 213 is closely fitted into the first positioning groove 216 which tapers downward for insertion into the holder supporting member 215. In this connection, the height of a projection of the attachment member 213 is formed to be substantially equal to the width of the first positioning groove 216.

A lever 227 is disposed at the front end in the transport direction of the other side edge of the tape holder rest 204.

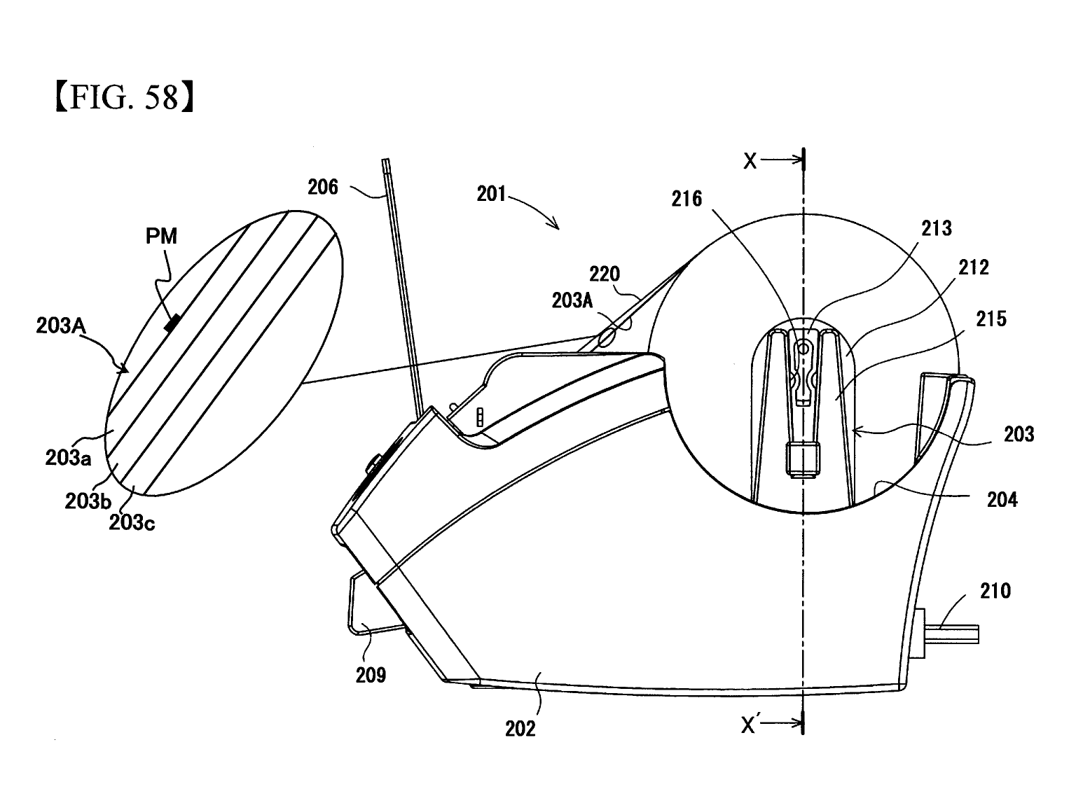

FIG. 58 is a side view illustrating the structure of FIG. 57.

Referring to FIG. 58, a label tape 203A is in a three-layer structure (see the partially enlarged view) made up of a separation sheet (separation material layer) 203a, an adhesive layer (bonding adhesive layer) 203b, and a self-chromogenic elongated heat-sensitive sheet (so-called thermal paper) 203c laminated in this order from the outside (upper left side in FIG. 58) to the opposite side (lower right side in FIG. 58) in this example.

The separation sheet 203a is adhered to the back side (upper left side in FIG. 58) of the heat-sensitive sheet 203c with the adhesive layer 203b. The separation sheet 203a is removed when a finally completed label LA is adhered to a predetermined article or the like, such that the label LA can be adhered to the article or the like with the adhesive layer 203b.

A power supply cord 210 is connected to one aide end of the back of the housing 202.

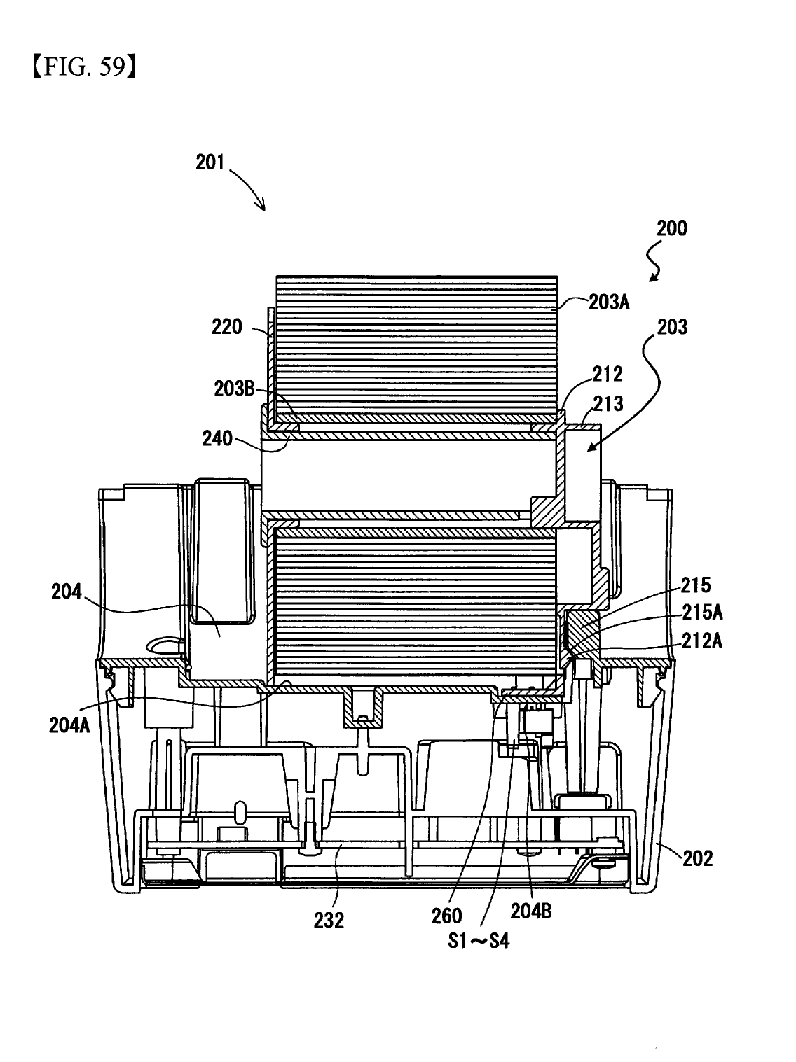

FIG. 59 is a cross-sectional view D taken along a section X-X′ in FIG. 58.

Referring to FIG. 59, the label tape 203A is rolled around a tape tube (shaft member) 203B. The label tape 203A and tape tube 203B, and tape holder 203 comprising positioning/holding member 212, guide member 220 and the like make up a tag tape roll 200 (label container).

A substantially cylindrical holder shaft member 240 is extended through the tape tube 203B between the positioning/holding member 212 and guide member 220 such that it is oriented in the axial direction. The tape holder 203 is mainly made up of the positioning/holding member 212, guide member 220, and holder shaft member 240.

An engaging recess 215A is formed at an inner proximal end of the holder supporting member 215, and an elastic engaging piece 212A protruded at the lower end of the positioning/holding member 212 is in engagement with the engaging recess 215A.

An elongated rectangular positioning recess 204A, as viewed in plan view, is formed to a predetermined depth (for example, approximately 1.5-3 mm) substantially vertically to the transport direction from the inner proximal end of the holder supporting member 215 on the bottom surface of the tape holder rest 204. A control board 232 is disposed below the tape holder rest 204. The control board 232 comprises a control circuit configured to control respective mechanisms under the control of an external personal computer or the like.

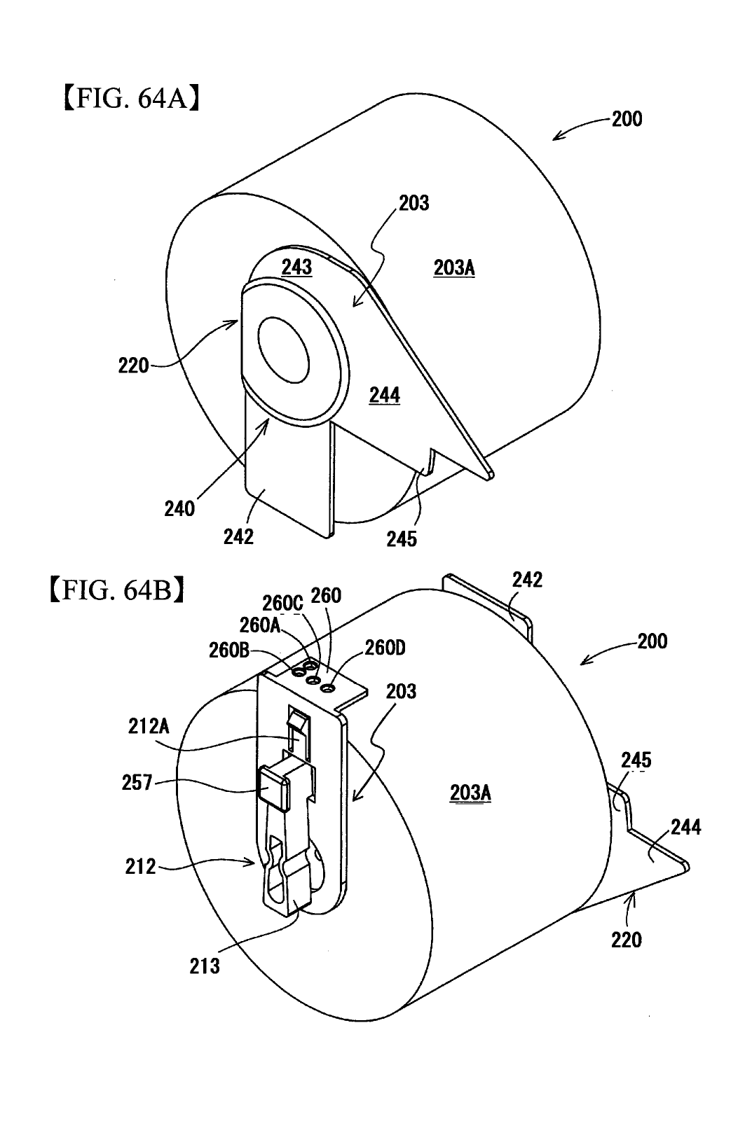

The positioning recess 204A has a width substantially equal to the width of each lower end edge of the positioning/holding member 212 and guide member 220 which make up the tape holder 203. A discrimination recess 204B is formed in a portion opposite to a tape discriminating part 260 (also see FIGS. 64 to 66, later described) extended inward substantially at right angles from the lower end edge of the positioning/holding member 212 at the inner proximal end of the holder supporting member 215 of the positioning recess 204A.

The discriminating recess 204B, which is in the shape of a rectangular elongated in the transport direction, is formed deeper by a predetermined depth (for example, approximately 1.5 to 3 mm) than the positioning recess 204A. The discriminating recess 204B is provided with four tape discriminating sensors S1, S2, S3, S4 arranged substantially in L-shape in this example for discriminating the type of the label tape 203A. Each of these tape discriminating sensors S1-S4 is comprised of a known push-type mechanical switch made up of a plunger, a micro-switch and the like. Each plunger is disposed such that its upper end protrudes from the bottom surface of the discriminating recess 204B to the vicinity of the bottom surface of the positioning recess 204A. Then, the tape discriminating sensors S1-S4 detect whether or not there are respective sensor holes (later described) in the tape discrimination part 260, such that the control circuit 30 detects the type of the label tape 203A loaded in the tape holder 203 based on on/off signals from the sensors S1-S4.

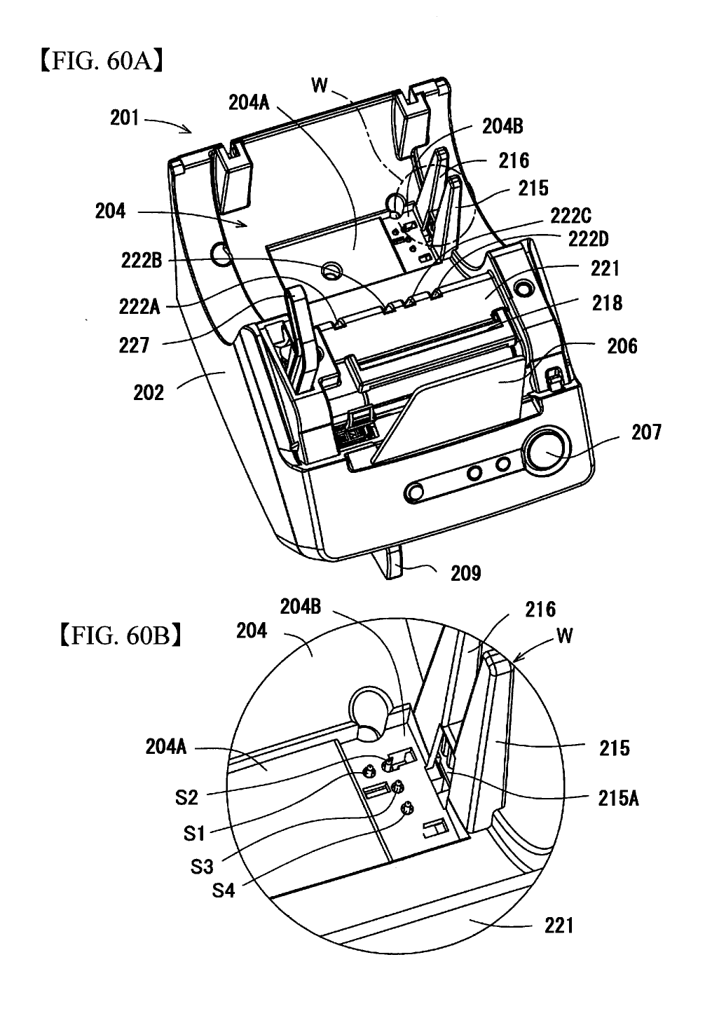

FIGS. 60A and 60B are a perspective view illustrating the label producing apparatus of FIG. 56 when the top cover and tag tape roll are removed therefrom, and an enlarged perspective view of a portion W in FIG. 58A.

Referring to FIGS. 60A and 60B, a carrier 221 is provided for carrying the leading end of the guide member 220 which forms part of the tape holder 203. The carrier 221 substantially horizontally extends from the rear end edge of an insertion port 218, through which the label tape 203A is inserted, to the front upper end edge of the tape holder rest 204. The guide member 220 in turn has the leading end which extends to the insertion port 218.

Four second positioning grooves 222A-222D are formed at end edge corners of the rear side of the carrier 221 in the transport direction, substantially in L shape in cross section, corresponding to a plurality of widths of label tape 203A. Each second positioning groove 222A-222D is formed such that part of a portion of the guide member 220, which forms part of the tape holder 203, in contact with the carrier 221 can be inserted into the groove from above. The positioning recess 204A extends from the inner proximal end of the holder supporting member 215 to a position opposite to the second positioning groove 222A.

The tag tape roll 200 of this embodiment, which is made up of the tape tube 203B, label tape 203A, and tape holder 203 is removably loaded in the tape holder rest 204 by fitting the attachment member 213 of the positioning/holding member 212 into the first positioning groove 216 of the holder supporting member 215, engaging the elastic engaging piece 212A protruding at the lower end of the positioning/holding member 212 into the engaging recess 215A formed at the inner proximal end of the holder supporting member 215, inserting the bottom surface of the leading end of the guide member 220 into each second positioning groove 222A-222D, and fitting the lower end of the guide member 220 into the positioning recess 204A such that the lower end comes into contact with the positioning recess 204A.

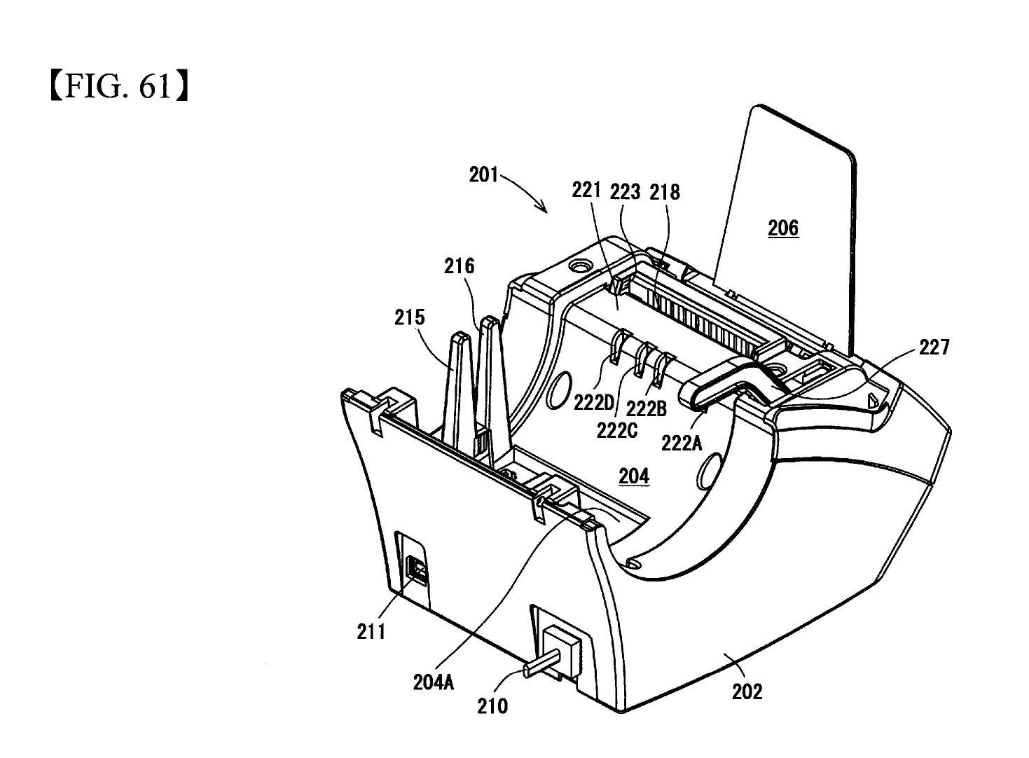

FIG. 61 is a rear perspective view illustrating the label producing apparatus of FIG. 56 when the top cover is removed therefrom.

Referring to FIG. 61, a guide rib 233 is implanted at a side edge of the insertion port 218 closer to the holder supporting member 215. The side edge (left-hand edge in FIG. 61) of the insertion port 218 closer to the holder supporting member 215 is formed to come to a position opposite to the inner end surface of the positioning/holding member 212 which is inserted into the holder supporting member 215.

It should be noted that a connector 211 is provided for connection with a personal computer, not shown, or the like on the other side end of the back surface of the housing 202. The connector 211 may conform to the USB (Universal Serial Bus) standard or the like.

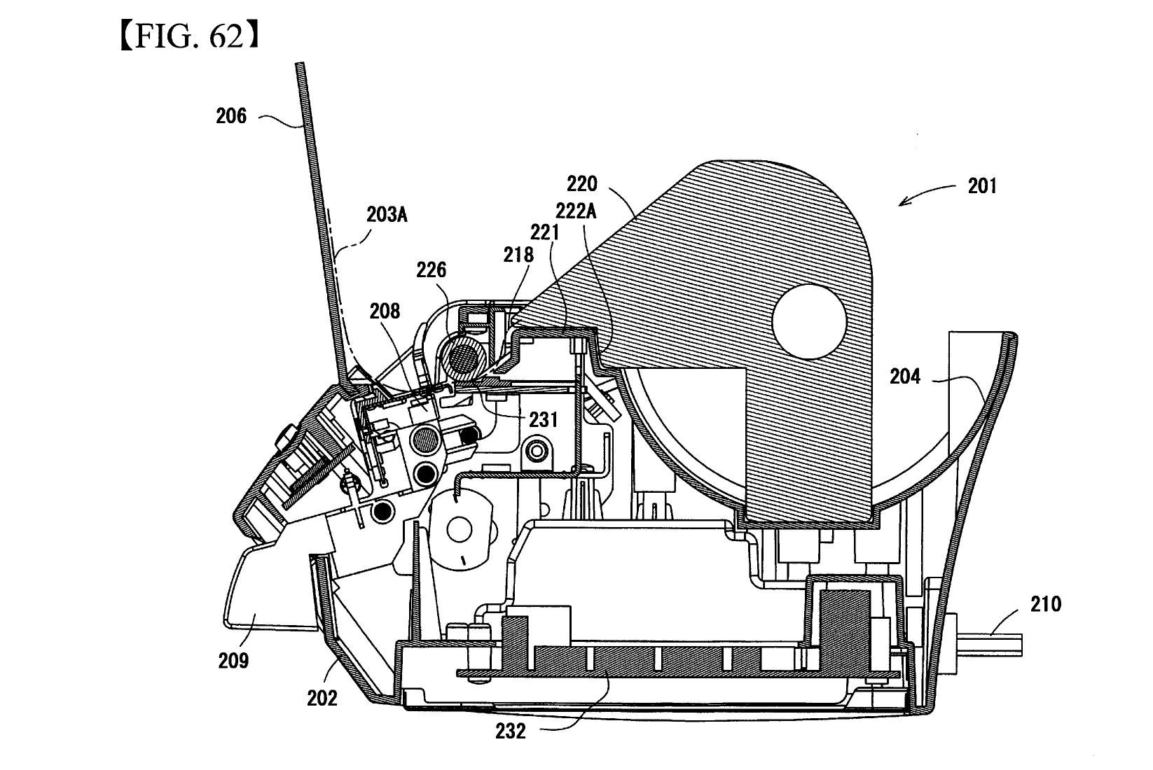

FIG. 62 is a side sectional view illustrating the label producing apparatus of FIG. 56 loaded with the tape holder, with the top cover removed therefrom.

Referring to FIG. 62, a cutter unit 208 is moved to left and right by the cutter lever 209 disposed on the front side surface for movements to left and right. A thermal head (print head) 231 for printing is disposed below the cutter unit 208 at a location upstream (to the right in FIG. 62) in the direction in which tape 203A is transported. A platen roller 226 (feeding device) is disposed at a position opposite to the thermal head 231.

The thermal head 231 is moved down to space apart from the platen roller 226 by pivoting upward the lever 227 for up/down moving operations. Conversely, the thermal head 231 is moved up by pivoting downward the lever 227 to urge the label tape 203A against the platen roller 226, resulting in a print available state.

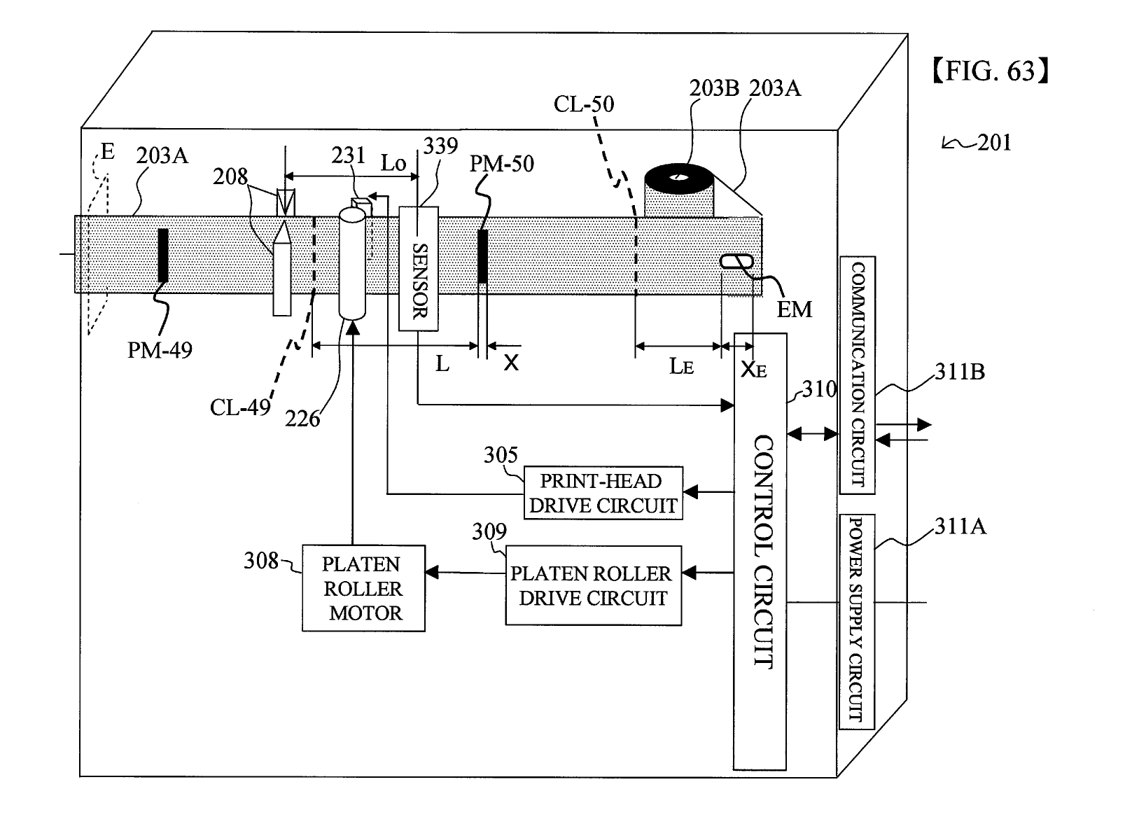

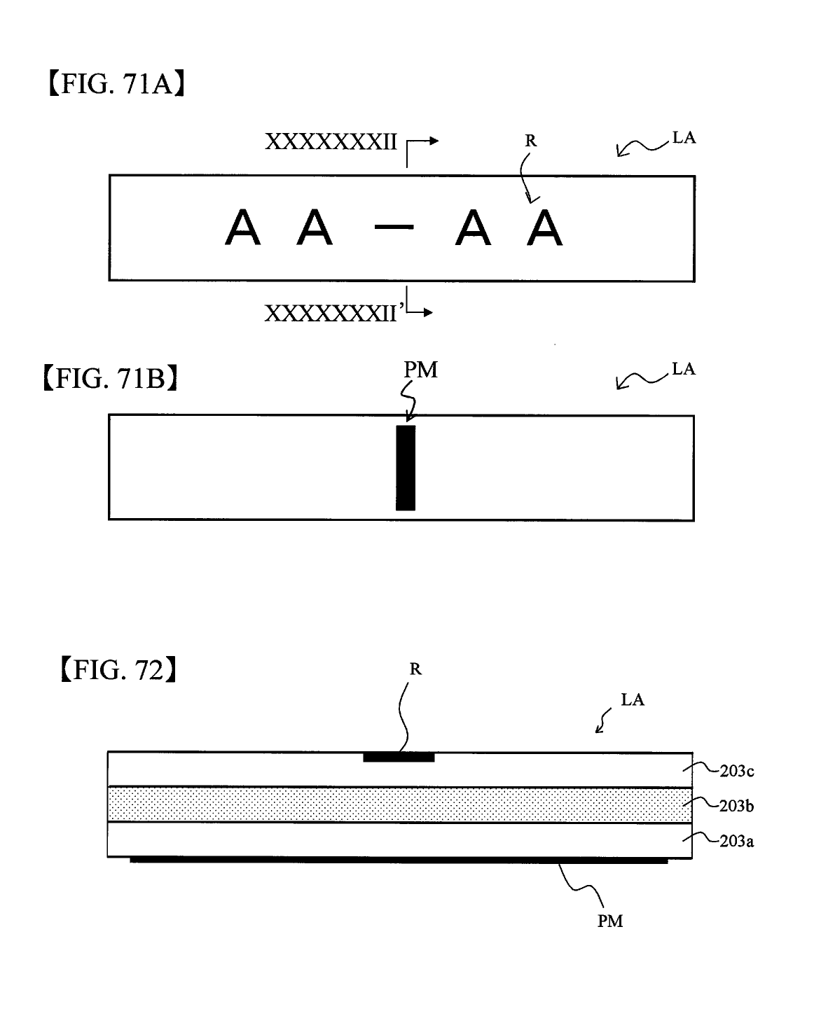

Specifically, for executing a printing process, the lever 227 is first pivoted upward to bring one side edge of the label tape 203A into contact with the inner surface of the guide member 220. The other side edge of the label tape 203A is inserted into the insertion port 218 while it is brought into contact with the guiding rib 223 implanted at the side edge of the insertion port 218. Then, as the lever 227 is pivoted downward, desired characters or the like can be printed on the label tape 203A. When the lever 227 is pivoted downward in this state, the label tape 203A inserted from the insertion port 218 is urged toward the platen roller 226 by the line type thermal head 231. Then, the platen roller 226 is driven to rotate by a pulse motor 308 (or a stepping motor or the like, see FIG. 63, later described), while the thermal head 231 is driven, whereby characters or image data can be sequentially printed on a print surface of the label tape 203A while it is being transported. Then, the printed label tape 203A discharged on the tray 206 is cut off by the cutter unit 208 by moving the cut lever 209 to the right to produce a label LA (see FIG. 71, later described).

FIG. 63 is a conceptual diagram illustrating a control system of the label producing apparatus 201.

Referring to FIG. 63, the label producing apparatus 201 comprises a sensor 339 configured to optically detect the presence or absence of the label tape 203A on the feeding path toward the carry-out exit E and detecting access marks and end mark borne on a tape, later described; the platen roller 226 configured to transport the label tape 203A and transporting the label LA, after it is cut off from the label tape 203A, to the carry-out exit E for delivery to the outside; a print-head drive circuit 305 configured to control to power the thermal head 231; a platen roller drive circuit 309 configured to control the platen roller motor 308 configured to drive the platen roller 226; and a control circuit 310 configured to generally control the operation of the label producing apparatus 201 through the print-head drive circuit 305, platen roller drive circuit 309 and the like.

The label tape 203A wound around the tape tube 203B has access marks PM borne (for example, by printing) on the separation sheet 203c at predetermined intervals for establishing a timing for controlling the print head 231 to start printing (i.e., location of a start point) and positioning the tape during transport, in a manner similar to the aforementioned fourth embodiment (a suffix following hyphen has a similar meaning to that in FIG. 41).

Specifically, in this example, 50 labels LA can be produced from the label tape 203A. In FIG. 63, a suffix indicative of the order is added to the respective reference letter CL, in such a manner that the cut line associated with the production of the last or fiftieth label LA is designated “−50” suffixed to CL; the cut line associated with the production of the forty ninth label LA is designated “−49” suffixed to CL; and so forth. As a result, access mark PM-50 associated with the production of the last or fiftieth label LA is positioned between the (scheduled) cut line CL-49 by the cutter unit 208, associated with the production of the forth ninth label LA (the CL-49 defines the trailing edge of the label LA), and the cut line CL-50 associated with the production of the fiftieth label LA itself. In addition, an end mark EM, which is a hole (cutout, lacking portion) for detecting the tape end, is formed in a region near the end of the label tape 203A in the feed direction, more specifically, at a location downstream of the portion of the label tape 203A which is to be cut to produce the fiftieth label LA in the feed direction (in other words, downstream of the cut line CL-50, to the right in FIG. 63). In this example, like the fourth embodiment, the end mark EM is set such that the distance LE (not shown) from the end mark EM to the cut line CL-50 is shorter than the normal distance L from the access mark PM (of each of first to forty-ninth labels) to the corresponding cut line CL. Also, in this event, the distance L is slightly longer than the distance Lo from the aforementioned position opposite to the sensor 339 to the position opposite to the cutter unit 208, whereas the distance LE is shorter than the distance Lo. Further, the end mark EM has a length, i.e., dimension xE in the longitudinal direction of the label tape 203A (vertical direction in FIG. 63) is set to be larger than the dimension x of the access mark PM in the longitudinal direction of the label tape 203A.

Though not shown, the end (terminal) of the label tape 203A is fixed to the tape tube 203B or holder shaft member 240 with an appropriate means such as a strong adhesive or the like in this example.

The control circuit 310, which is based on a so-called microcomputer, comprises a central processing unit (CPU), a ROM, a RAM and the like, though detailed illustration is omitted. The control circuit 310 performs signal processing in accordance with a program previously stored in the ROM using a temporary storage function of the RAM. The control circuit 310 is powered by a power supply circuit 311A, and is connected, for example, to a communication network through a communication circuit 311B, so that the control circuit 310 can communicate information with a route server, other terminals, general purpose computer, information server and the like, all of which are not shown, and are connected to the communication network.

FIGS. 64A and 64B are a perspective view taken from upper front, and a perspective view taken from lower back, illustrating in detail the structure of the tag tape roll 200 loaded in the tag-label producing apparatus 201 illustrated in FIG. 56.

Referring to FIGS. 64A and 64B, the guide member 220 of the tape holder 203 provided in the tag tape roll 200 is formed with a first extension 242 inserted into the positioning recess 204A formed on the bottom surface of the tape holder rest 204 to come into contact with the bottom surface of the positioning recess 204A; a second extension 243 which extends outward to cover the front outer end surface over approximately one quarter of the circumference of the label tape 203A; and a third extension 244 which has an upper end edge extending forwardly downward from the periphery of the second extension 243 to the vicinity of the insertion port 218 (see FIG. 61) of the label tape 203A.

The third extension 244 has the leading end, the lower surface of which is substantially horizontally formed and is in contact with the aforementioned carrier 221 of the label producing apparatus 201, such that one side edge of the loaded label tape 203A is guided to the insertion port 218 by the inner surfaces of the third extension 244 and second extension 243. Also, a fourth extension 245 is formed to extend by a predetermined length from a position opposite to the rear end edge of transport direction of the carrier 221 on the lower end surface of the third extension 244 to the first extension 242. The leading end of the fourth extension 245 in the transport direction is configured to fit in any of the second positioning groove 222A-222D corresponding to the width of the loaded label tape 203A when the lower end surface of the third extension 244 comes into contact with the carrier 221 (see FIG. 62 above).

A guide part 257 is formed at the lower end of the attachment member 213 of the positioning/holding member 212 of the tape holder 203. The guide part 257 is substantially rectangular in shape, as viewed from the front. The guide part 257 extends outward by a predetermined length (approximately 1.5 to 3 mm in this example) in each of the left and right directions from the lower end of the attachment member 213. For loading the tape holder 203, the guide part 257 formed at the lower end of the attachment member 213 is brought into contact with the outer end surface of the holder supporting member 215, and the attachment member 213 is inserted into the first positioning groove 216. Consequently, the tape holder 203 can be readily positioned and loaded in the tape holder rest 204.

The lower end edge of the extension 246 of the positioning/holding member 212 is extended downward by a predetermined length (approximately 1 mm to 2.5 mm in this example) from the lower end edge of the guide member 220. An elongated rectangular tape discriminating part (tag tape identifier) 260 is formed at the lower end edge to extend by a predetermined length inwardly substantially at right angles.

The tape discrimination part 260 has the sensor holes 260A-260D which are arranged in L-shape as a whole, and extend therethrough at predetermined positions opposite to the respective tape discriminating sensors (sensor devices) S1-S4. The tape discrimination part 260 functions to identify the type of the label tape 203A in cooperation with the sensor S1-S4.

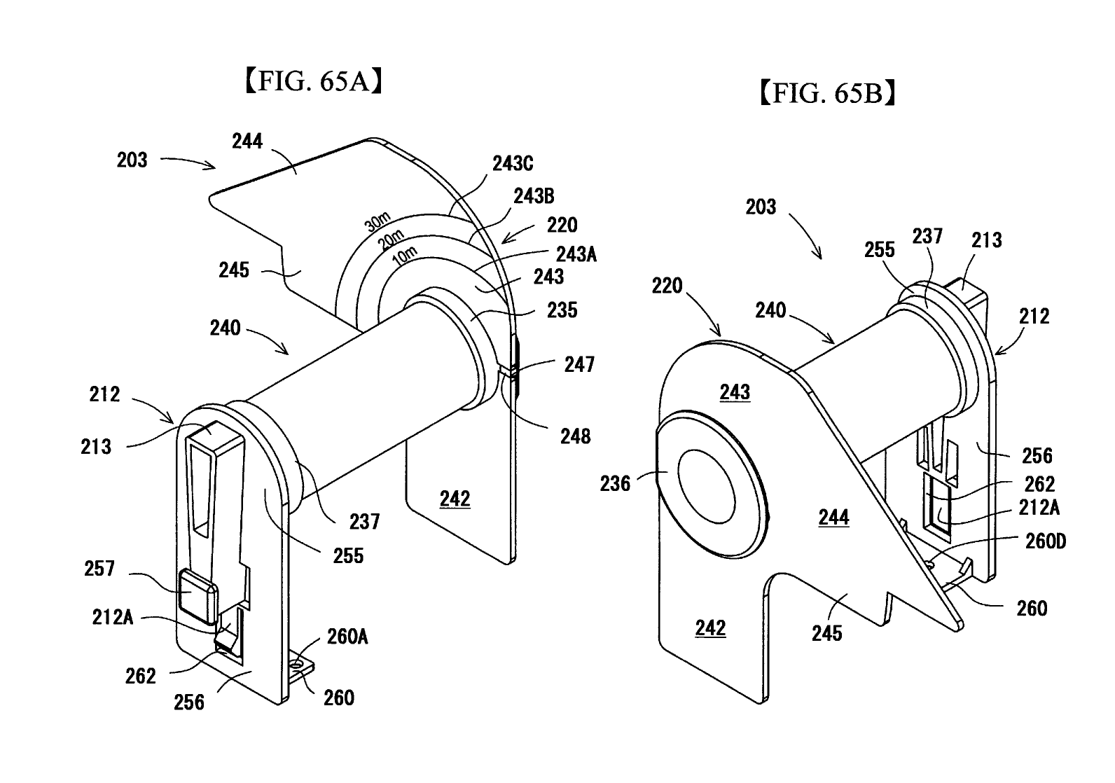

FIG. 65A is a perspective view of the tape holder, as viewed from an obliquely backward direction, and FIG. 65B is a perspective view of the tape holder, as viewed from an obliquely forward direction.

Referring to FIGS. 65A and 65B, the guide member 220 is provided with a first cylinder 235 which is inserted into one end side edge of a cylindrical hole of the tape tube 203B, causing the guide member 220 to come into contact with one end surface of the label tape 203A. On the other hand, the positioning/holding member 212 is provided with a second cylinder 237 which is inserted into the tape tube 203B on the other side, causing the position holding member 212 to come into contact with the other end surface of the label tape 203A. These first cylinder 235 and second cylinder 237 rotatably hold the tape tube 203B around which the label tape 203A is wound.

The holder shaft member 240 has one end side inserted into the first cylinder 235 and the guide member 220. A flange 236 is formed on the peripheral surface of one end side surface of the holder shaft member 240. The flange 236 is secured to the outer end surface of the first cylinder 235. The other side end of the holder shaft member 240 is inserted into the second cylinder 237 of the positioning/holding member 212, and is secured to the second cylinder 237.

In the foregoing structure, the first extension 242 of the guide member 220 extends downward from the lower outer periphery of the outer end surface of the first cylinder 235. Cutouts 247 are formed at the upper end of the first cylinder 235, i.e., at both left and right centers of the periphery of the outer end surface of the first cylinder 235. Each cutout 247 has a rectangular shape, as viewed from the front.

Scales 243A, 243B, 243C are formed on the inner surface of the respective extensions 243, 244, 245 of the guide member 220 for indicating the wound length 10 meters, 20 meters, 30 meters of the loaded label tape 203A. It should be noted that a maximum of approximately 30 meters of label tape 203A can be wound around the tape holder 203.

On the other hand, a flange 255 is formed on the periphery of the second cylinder 237 of the positioning/holding member 212, and an extension 256 is formed to extend downward from a lower periphery of the flange 255. The flange 255 and extension 256 have their inner sides in contact with the outer end surfaces of the label tape 203A and tape tube 203B. Then, the attachment member 213 is protrusively disposed to be substantially perpendicular to the substantial center of the outer side surfaces of the flange 255 and extension 256 in the width direction (upper left to lower right in FIG. 65A), i.e., from the end edge of the axial center of the holder shaft member 240 to the axial center.

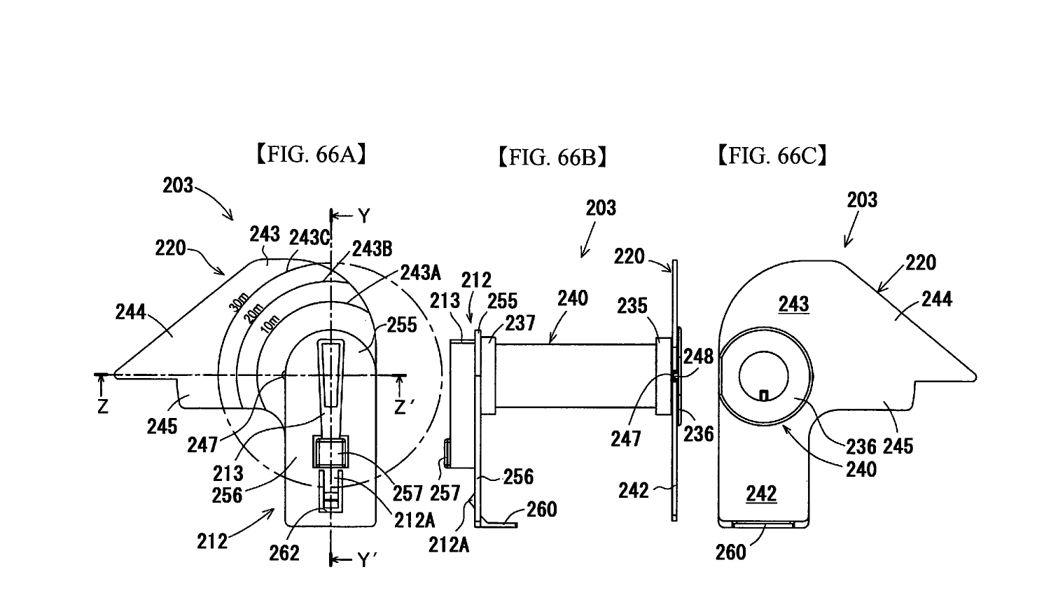

FIG. 66A is a left side view illustrating in detail the structure of the tape holder 203, FIG. 66B is a front view of the tape holder 203, and FIG. 66C is a right side view of the tape holder 203.

Referring to FIGS. 66A to 66C, the holder shaft member 240 is bridged between the positioning/holding member 212 and guide member 220, as described above. A plurality of holder shaft members 240 having different lengths are provided corresponding to the tape tubes 203B having different lengths (for example, four kinds). By choosing an appropriate one from the plurality of holder shaft members 240, a plurality of types of tape holders 203 can be readily manufactured for holding label tapes 203A of different widths.

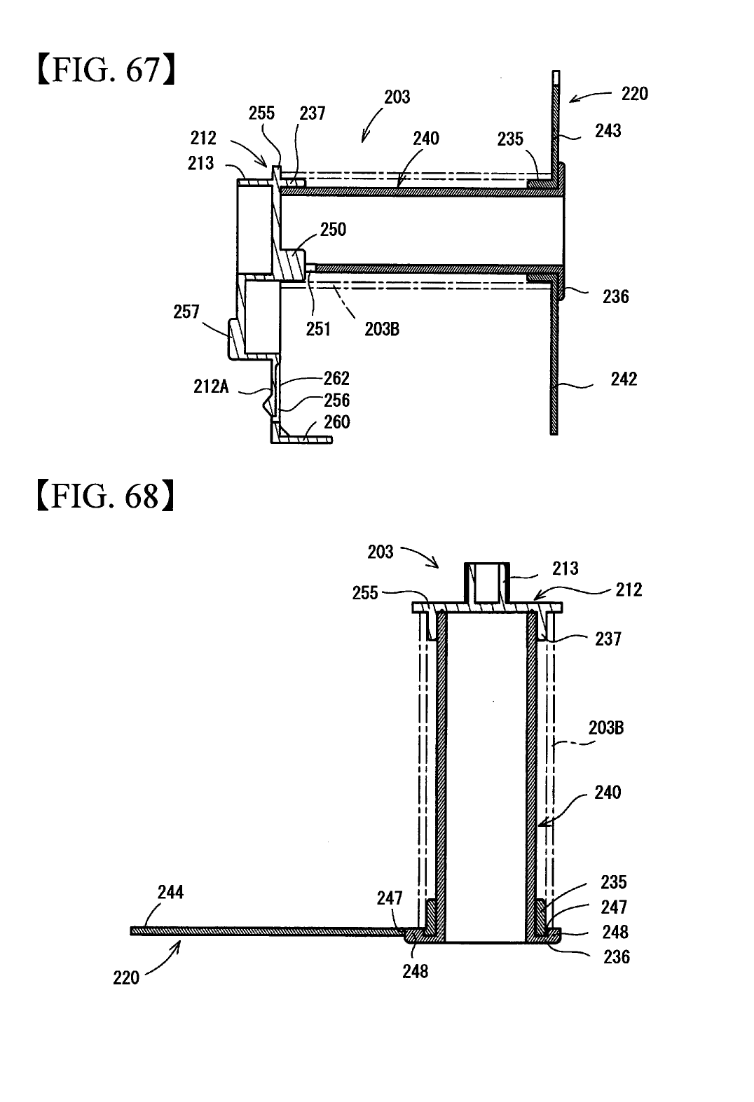

FIG. 67 is across-sectional view taken along a Y-Y′ section in FIG. 66A.

Referring to FIG. 67, a substantially vertically elongated cutout 251 is formed at the leading end of the holder shaft member 240 which is inserted into the second cylinder 237 of the positioning/holding member 212. A positioning rib 250 is formed at an inner lower end of the second cylinder 237 to protrude inwardly in the axial direction. The positioning rib 250 is inserted into the cutout 251, such that the positioning/holding member 212 and guide member 220 can be positioned through holder shaft member 240.

A vertically elongated rectangular through hole 262 is formed in the extension 256 below the lower end of the attachment member 213 of the positioning/holding member 212. An elastic engaging piece 212A is formed at the upper end edge of the through hole 262. The elastic engaging piece 212A is formed with a projection which projects outward toward the leading end in a downward direction.

FIG. 68 is a cross-sectional view taken along a section Z-Z′ in FIG. 66A.

Referring to FIG. 68, each positioning projection 248 protruded on the inner surface of the flange 236 of the holder shaft member 240 is inserted into the cutout 247 of the first extension 242, thereby positioning the holder shaft member 240 to the guide member.

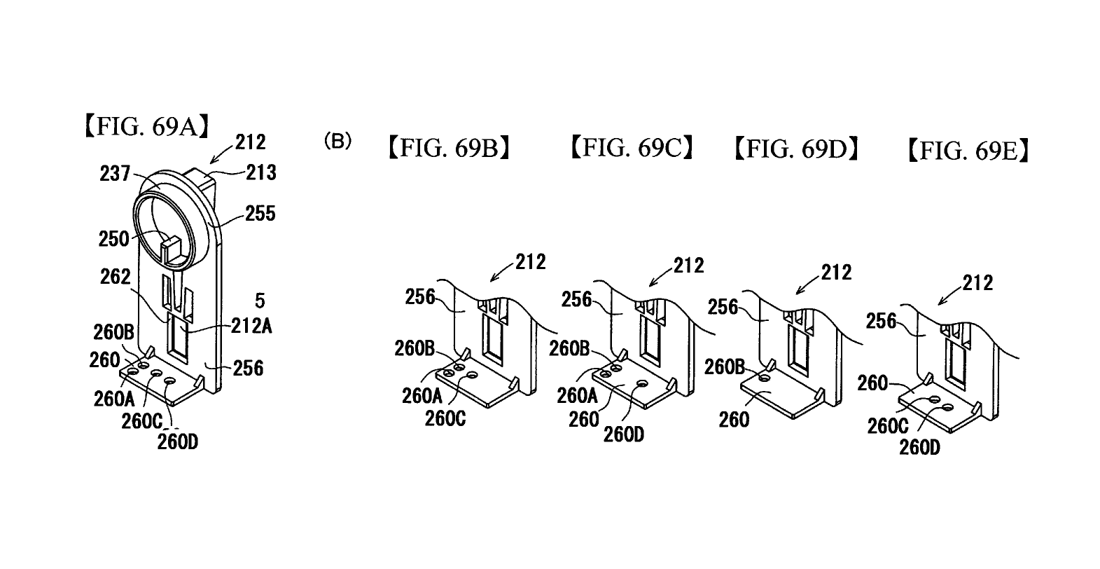

FIGS. 69A to 69E are diagrams each illustrating an example of sensor holes bored through the tape discrimination part 260 of the positioning/holding member 212 for representing the type of tag tape.

FIG. 69A illustrates an example of four sensor holes 260A-260D bored through the tape discrimination part 260, as described above. The aforementioned tape discriminating sensors S1-S4 are disposed in the discrimination recess 204B of the tape holder rest 204 in correspondence to the tape discrimination holes 260A-260D. Each of the sensors S1-S4 has its plunger projecting from the bottom surface of the discriminating recess 204B to the vicinity of the bottom surface of the positioning recess 204A at all times, causing the associated micro-switch to turn off. When the respective sensor holes 260A-260D are present at positions opposite to the sensor discrimination sensors S1-S4, respectively, the plungers are not pressed down to leave the micro-switches off, causing the sensors S1-S4 to output off signals. When the respective sensor holes 260A-260D of the tape discrimination part 260 are not present at positions opposite to the tape discrimination sensors S1-S4, respectively, the plunger are pressed down to turn on the micro-switches, causing the sensors S1-S4 to output on signals.

In this way, the four sensors S1-S4 are associated with the result of detection as to the presence or absence of the four sensor holes 260A-260D, and the presence and absence of each sensor hole are corresponded to “1” and “0,” respectively. Thus, the type of the label tape 203A fitted in the tape holder 203 can be represented by a four-bit code (in other words, 16 types of label tapes can distinguished from one another). FIGS. 69A-69E show examples of the 16 possible combinations. Specifically, FIG. 69A shows that all the sensor holes 260A, 260B, 260C, 260D exist, so that the sensors S1-S4 output a detection signal “1,1,1,1”; FIG. 69B shows that the sensor holes 260A, 260B, 260C exist, so that the sensors S1-S4 output detection signal “1,1,1,0”; FIG. 69C shows that the sensor holes 260A, 260B, 260D exist, so that the sensors S1-S4 output a detection signal “1,1,0,1”; FIG. 69D shows that the sensor hole 260B exists, so that the sensors S1-S4 output a detection signal “0,1,0,0”; and FIG. 69E shows that the sensor holes 260C, 260D exist, so that the sensors S1-S4 output a detection signal “0,0,1,1.”

As described above, the tape discrimination part 260 disposed at the inner lower end edge of the positioning/holding member 212 is inserted into the discrimination recess 204B, and the sensors S1-S4 detect the presence or absence of the respective sensor holes 260A-260D, thereby making it possible to detect the type of the label tape 203A fitted in the tape holder 203.

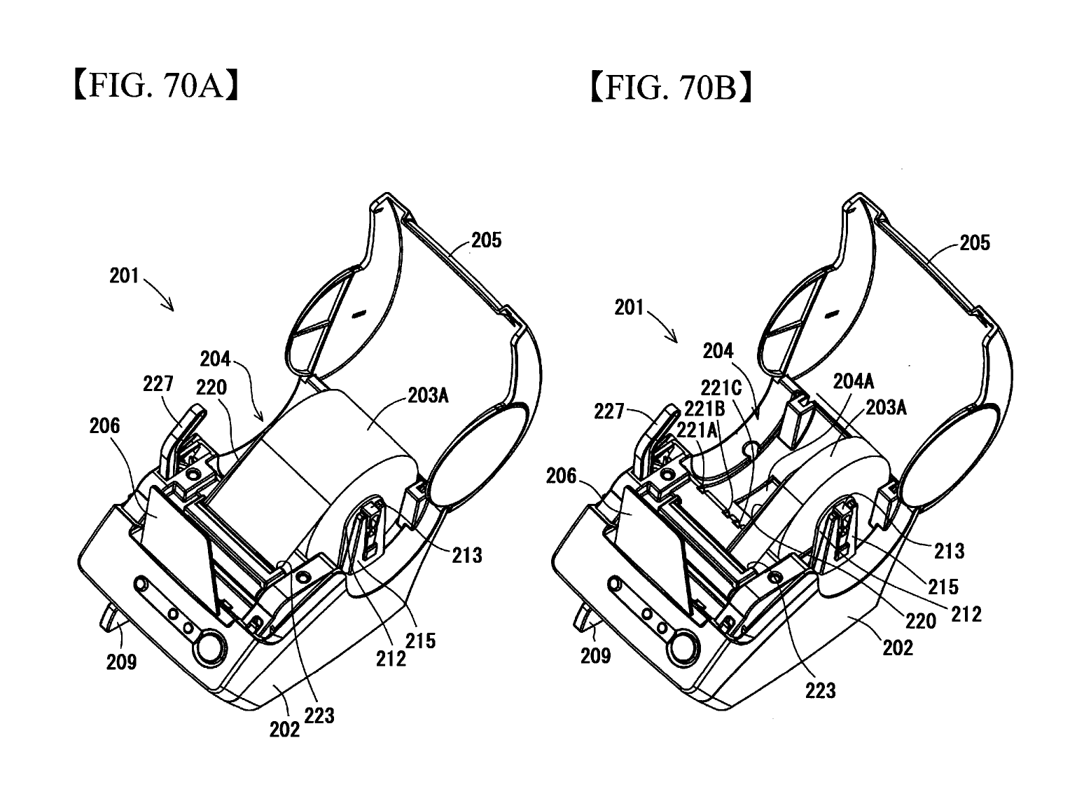

FIGS. 70A and 70B are explanatory diagrams each illustrating how the tape holder 203 configured as described above is loaded in the label producing apparatus 201.

FIG. 70A illustrates an example in which the label producing apparatus 201 is loaded with a tape holder 203 which has a label tape 203A of a maximum width wound around the tape tube 203B. Referring first to FIG. 70A, the attachment member 213 of the positioning/holding member 212 of the tape holder 203 is inserted into the positioning groove 216 of the holder supporting member 215. Then, the lower end surface of the third extension 244 of the guide member 220 of the tape holder 203 is placed on the carrier 221, and the fourth extension 245 of the guide member 220 is inserted into the second positioning groove 221A formed at the rear corner of the carrier 221 in the transport direction. Also, the lower end edge of the first extension 242 of the guide member 220 is inserted into and brought into contact with the positioning recess 204A formed in the bottom surface of the tape holder rest 204.

In this event, simultaneously, the tape discrimination part 260 formed at the lower end of the extension 256 of the positioning/holding member 212 of the tape holder 203 is inserted into the discriminating recess 204B formed inside of the proximal end of the holder supporting member 215, and the elastic engaging piece 212A is brought into engagement with the engaging recess 215A formed at the proximal end of the holder supporting member 215.

With the foregoing manipulations, the tape holder 203 is removably loaded in the tape holder rest 204, and the tape discrimination sensors S1-S5 can detect the presence or absence of the respective sensor holes 260A-260E in the tape discrimination part 260 opposite to the tape discrimination sensors S1-S5.

Subsequently, with the lever 227 pivoted upward, the label tape 203A is drawn out while one side edge of the label tape 203A is kept in contact with the inner side surface of the guide member 220. Then, the label tape 203A is inserted into the insertion port 218 while the other side edge of the label tape 203A is kept in contact with the guide rib 223 implanted at the side edge of the insertion port 218. Then, the lever 227 is pivoted downward, causing the thermal head 231 to urge the leading end of the label tape 203A to the platen roller 226. Now, the label tape 203A is ready for printing.

FIG. 70B illustrates an example in which the label producing apparatus 201 is loaded with a tape holder 203 which has a label tape 203A of a minimum width wound around the tape tube 203B. Referring to FIG. 70B, the attachment member 213 of the positioning/holding member 212 of the tape holder 203 is inserted into the positioning groove 216 of the holder supporting member 215. Then, the lower end surface of the third extension 244 of the guide member 220 of the tape holder 203 is placed on the carrier 221, and the fourth extension 245 of the guide member 220 is inserted into the second positioning groove 221D formed at the rear corner of the carrier 221 in the transport direction. Also, the lower end edge of the first extension 242 of the guide member 220 is inserted into and brought into contact with the positioning recess 204A formed in the bottom surface of the tape holder rest 204.

In this event, simultaneously, the tape discrimination part 260 formed at the lower end of the extension 256 of the positioning/holding member 212 of the tape holder 203 is inserted into the discriminating recess 204B formed inside of the proximal end of the holder supporting member 215, and the elastic engaging piece 212A is brought into engagement with the engaging recess 215A formed at the proximal end of the holder supporting member 215.

With the foregoing manipulations, the tape holder 203 is removably loaded in the tape holder rest 204, and the tape discrimination sensors S1-S5 can detect the presence or absence of the respective sensor holes 260A-260E in the tape discrimination part 260 opposite to the tape discrimination sensors S1-S5.

Subsequent manipulations such as pivoting the lever 227 upward are similar to the foregoing, so that a description thereon is omitted.

FIGS. 71A and 71B are diagrams illustrating the appearance of an exemplary label LA which is formed after the label tape 203A has been cut in a manner described above. FIG. 71A is a top plan view D, and FIG. 71B is a bottom plan view. FIG. 72 in turn is a cross-sectional view taken along a section XXXXXXXII-XXXXXXXII′ in FIG. 71.

Referring to FIGS. 71A, 71B, 72, the label LA is in a three-layer structure made up of a heat-sensitive sheet 203c, an adhesive layer 203b, and a separation sheet 203a, laminated in this order from the surface side (upper side in FIG. 72) to the opposite side (lower side in FIG. 72). Additionally, a character R (in the example, a character “AA-AA”) is printed on the surface of the heat-sensitive sheet 203c.

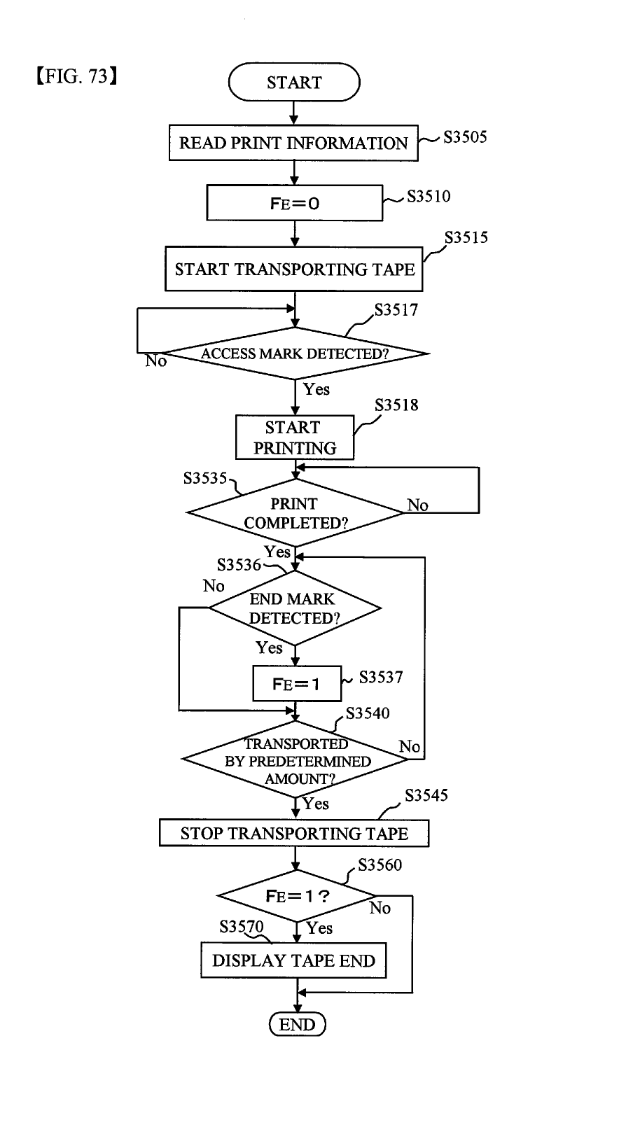

FIG. 73 is a flow chart illustrating a control procedure executed by the control circuit 310.

Referring to FIG. 73, First, at step S3505 comparable to S3105 in FIG. 44, the tag-label producing apparatus 2 reads print information which is entered through an appropriate manipulating device, not shown, associated with the label producing apparatus 201 (or the terminal 5 or general purpose computer 6) and which should be printed on the label LA by the print head 231.

Subsequently, at step 3510, the control circuit 310 initializes a flag FE associated with the detection of the end mark EM to zero in a manner similar to step S3110.

Then, at step S3515, the control circuit 310 outputs a control signal to the platen roller drive circuit 309 to drive or rotate the platen roller 266 with a driving force of the platen roller motor 308. In this way, the rolled label tape 203A is sequentially fed out and transported toward the downstream.

Next, the flow goes to step S3517, where the control circuit 310 determines whether or not the access mark PM is detected by the sensor 339 on the label tape 203A (whether or not a mark detection signal is entered). The determination at step S3517 is not YES while the access mark PM is not detected (as long as a portion of the separation sheet 203a in normal color, not including the access mark PM or the end mark EM, remains at the position opposite to the sensor 339, though the label tape 203A is being fed out). When the label tape 203A is further fed out to cause the access mark PM to reach the position opposite to the sensor 339, the access mark PM is detected by the sensor 339, causing the determination at step S3517 to be YES. Then, the flow goes to step S3518. At step S3518, the control circuit 310 outputs a control signal to the print-head drive circuit 305 which powers the print head 231. In response, the print head 231 starts printing the character R read at step S3205, such as characters, symbols, bar code or the like on a predetermined area of the label tape 203A

Consequently, the flow goes to step S3535, where the control circuit 310 repeats a determination as to whether or not characters have been printed on the predetermined area of the label tape 203A, until the character has been completely printed on the area. The determination at step S3535 is YES when the character has been completely printed on the area, followed by the flow going to step S3536.

At step S3536, the control circuit 310 determines whether or not the sensor 339 has detected the end mark EM near the end of the label tape 203A (whether or not an end mark detection signal has been entered). In a normal state where the label tape 203A has not been fed out up to the end thereof, the sensor 339 does not detect the end mark EM, and therefore the determination at step S3536 is not YES, causing the flow to go to step S3540.

When the label tape 203A is approaching to the tape end and can provide the last label LA at this moment, the determination at step S3136 is YES because the end mark EM reaches the position opposite to the sensor 339 before the cut line CL-50 reaches the position opposite to the cutter unit 208 after the label tape 203A has been transported by a predetermined distance from the fact that the distance LE from the end mark EM to the cut line CL-50 is shorter than the distance Lo from the position opposite to the sensor 339 to the position opposite to the cutter unit 208. In response, the control circuit 310 sets the tape end detection flag FE to one (FE=1) at step 3537, followed by the flow going to step S3540.

At step S3540, the control circuit 310 determines whether or not the label tape 203A has been transported by a predetermined distance (for example, a transport distance long enough for the cut line CL of the label tape 203A to go beyond the cutter 15 by a length equal to one label LA). The determination on the transport distance may also be made, for example, by measuring the angle by which the platen roller motor 308 has rotated from the time the access mark PM has been detected by the sensor 339, or counting the number of pulses output from the platen roller drive circuit 309 configured to drive the platen motor 308, in a manner similar to step S3120 in FIG. 44 described above. The determination at step S3540 is YES when the label tape 203A has been transported by the predetermined distance, causing the flow to go to step S3545.

At step S3545, the control circuit 310 outputs a control signal to each of the platen roller drive circuit 309 to stop driving the platen motor 308, thereby stopping the rotation of the platen roller 226. This results in stopping the label tape 203A fed out from the roll and transported by the platen roller 226. At this time, the cut line CL borne on the separation sheet 201a just reaches the position opposite to the cutter unit 208. In this state, the operator manually operates the cutter lever 209 to move the cutter unit 208 to cut the label tape 203A along the cut line CL. Consequently, the label LA can be produced.

Subsequently, at step S3560, the control circuit 310 determines whether or not the tape end detection flag FE is “1.” As described above, the flag FE is “0” in a normal state where the label tape 203A is not approaching the end thereof, so that the determination at step S3560 is not YES, followed by the termination of the flow. On the other hand, when the label tape 203A is approaching to the tape end and can provide the last label LA, the tape end detection flag FE is “1.” As such, the determination at step S3560 is YES, causing the control circuit 30 to output a tape end display signal to a display device, not shown, provided on the label producing apparatus 201 to make a corresponding display (alternatively, the tape end display signal may be output to the terminal or general-purpose computer through the communication circuit 311B and communication network to display the corresponding tape end message) at step S3507. Then, the flow is terminated.

In the foregoing description, the control circuit 310 implements a malfunction preventing device configured to prevent malfunctions of the detecting device configured to detect an object to be detected on a label medium in respective aspects of the invention.

The foregoing exemplary modification configured as described above can also provide similar advantages to those of the fourth embodiment.

Specifically, during the production of the labels LA, after the label tape 203A is printed, the printed label 203A is cut at predetermined intervals (from one cut line CL to the next cut line CL) by the cutter unit 208 to produce individual labels LA. In this event, the sensor 339 detects the access marks PM borne on the label tape 203A at predetermined intervals, which are utilized by the control circuit 310 to control the print head 231 to start printing (step S3518 in FIG. 73), and to control the positioning of the label tape 203A for cutting by cutter unit 208 (step S3540), thereby improving the accuracies of the start of printing, accessing, and tape cutting.

When labels LA are produced one by one as the label tape 203A is fed out as described above, the label tape 203A is eventually exhausted from the roll so that labels LA can no longer be produced. In this embodiment, the sensor 339 detects the end mark EM at the end of the label tape 203A in the feeding direction to recognize the end, allowing the control circuit 310 to know that the label tape 203A approaching to it send. In other words, the label producing apparatus of the exemplary modification can prevent malfunctions and/or in appropriate operations in the detection process to reliably detect the tape end. Since the end mark EM is implemented by a lacking portion (or a hole, an open end or the like) through the label tape 203A, a simple mechanical process, such as boring, is only required to provide the end mark EM. Accordingly, as compared with a conventional tape which has an end mark made of a different material, the label tape 203A can be processed for detection of the tape end in a simple process and at an extremely low cost.

Further notably, in the foregoing exemplary modification, the end mark EM formed through the label tape 203A has the length xE longer than the length x of the access mark PM. By thus setting the lengths of the two marks, when the sensor 339 detects the end mark EM at step S3536 shown in FIG. 73, the tape end can be recognized only when the sensor 339 detects a non-reflective area larger than the non-reflective area detected at step S3517. Thus, the sensor 339 can be prevented from erroneously detecting the end mark EM to increase the reliability of the detection.

Further, since the end of the label tape 203A in the feeding direction is fixed to the tape tube 203B or holder shaft member 240, the label tape 203A, while being fed out, can be restricted and forcedly stopped when the label tape 203A is eventually used up during the production of labels.

Since the access marks PM are borne on the separation sheet 201a which is removed when the label LA is used, the complete label LA itself is free of the marks or traces thereof, thus improving the label in aesthetic sense.

(4-8) Others:

(a) Sensor Position:

In the foregoing description, the sensor 19 is disposed relatively near the base tape 101 fed out from the base tape roll 102 (FIG. 39 and the like) or at a position upstream of the print head 10 in the transport direction (FIG. 54), but the position of the sensor 19 is not so limited, but may be disposed at any other appropriate position. Also, the end mark EM is detected during the production of the last label based on the access mark PM, and the tape end is notified after the last label has been discharged to stop transporting the tape. The present invention is not either so limited. In essence, during the production of a normal label, the access mark PM is simply required to be available for at least some control associated with the production of labels (print start control, cut position determination, and the like), and in regard to the tape end, the end mark EM may be provided in the form of cutout near the end of the tape. In this way, the tape can be processed for detection of the tape end in a simple process and at an extremely low cost, which is the essential advantage of the present invention.

(b) Sensor Type:

While the optical reflective sensor 19 has been used in the foregoing embodiment, the sensor is not so limited. Alternatively, a photo-sensor, for example, may be used for detection. Further alternatively, magnetic identifiers may be borne on the tapes 101, 101′ and be detected by a magnetic detecting device. Similar advantages can also be provided when such alternative sensors are used.

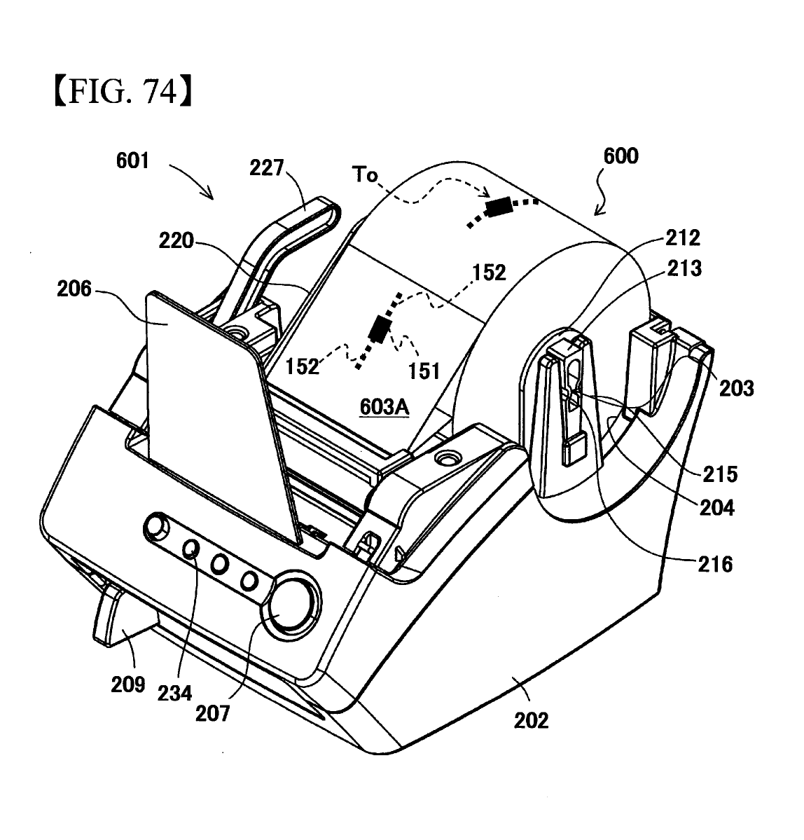

In the following, a fifth embodiment of the present invention will be described with reference to FIGS. 74 to 91. A label producing apparatus of the fifth embodiment is provided with a malfunction preventing device configured to prevent malfunctions of a cutter (cutter) configured to cut a label medium. Parts equivalent to those in the first to fourth embodiments are designated the same reference numerals, and descriptions thereon are omitted or simplified as appropriate.

Like the first to fourth embodiments described above, a label producing apparatus 601 of the fifth embodiment is applied, for example, to the aforementioned RFID tag manufacturing system 1 illustrated in FIG. 1, and is substantially similar in configuration to that illustrated in FIGS. 54 to 73 described in connection with the exemplary modification (4-6) of the fourth embodiment. The lag label producing apparatus 601 of the fifth embodiment, however, differs in that the apparatus 601 employs a label medium which is a tag tape 603A containing RFID circuit elements To, and communicates with the RFID circuit elements To over the air using the signal processing circuit, radio frequency circuit, apparatus antenna and the like in the first to third embodiments.

FIG. 74 is a perspective view illustrating the label producing apparatus (tag-label producing apparatus) of the fifth embodiment when the cover 205 is removed therefrom, and is comparable to FIG. 57 in the fourth embodiment.

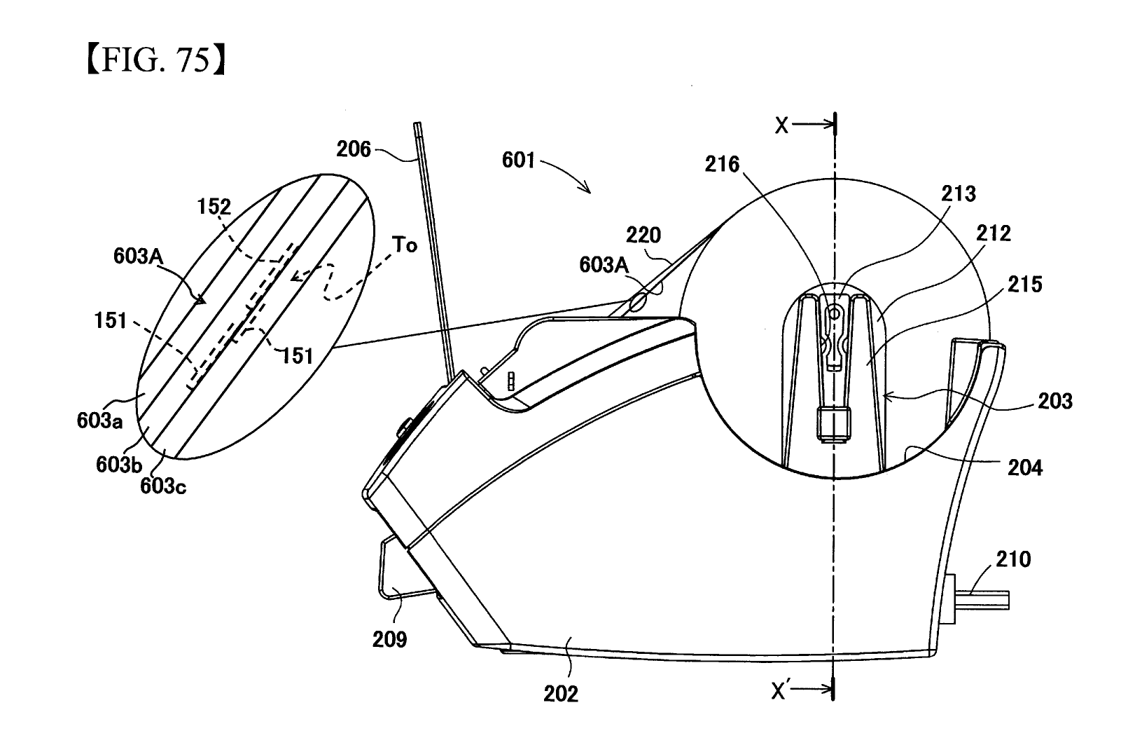

Referring to FIG. 74, a tape holder 203 is fitted in a tape holder rest (container holder) 204. The tape holder 203 is rotatably wound with a label medium which is a tag tape 603A of a predetermined width. Specifically, the tag tape 603A is rolled around a tape tube (reel member) 603B (not shown, see FIG. 75, later described). In the illustrated example, the tag tape 603A is provided, along the center line thereof in the width direction, with RFID circuit elements To, each of which comprises an IC circuit part 151 and antenna 152. A tag tape roll (label container) 600 is made up of the tag tape 603A and tape tube 603B, and the tape holder 203 which comprises the positioning/holding member 212, guide member 220, and the like.

A substantially cylindrical holder shaft member 240 (not shown. Similar in structure to that of the fourth embodiment) is extended through the tape tube 603B between the positioning/holding member 212 and guide member 220 such that it is oriented in the axial direction. The tape holder 203 is mainly made up of the positioning/holding member 212, guide member 220, and holder shaft member 240.

The RFID circuit elements To contained in the tag tape 603A are similar in functional configuration to the one illustrated in the aforementioned FIG. 10, so that a description thereon is omitted. An LED 234 will be described later.

FIG. 75 is a side view illustrating the structure of FIG. 74.

Referring to FIG. 75, the tag tape 603A is in a three-layer structure (see the partially enlarged view) made up of a separation sheet (separation material layer) 603a, an adhesive layer (bonding adhesive layer) 603b, and a self-chromogenic elongated heat-sensitive sheet (so-called thermal paper) 603c laminated in this order from the outside (upper left side in FIG. 75) to the opposite side (lower right side in FIG. 75) in this example.

In the illustrated example, the heat-sensitive sheet 603c is provided with the IC circuit part 151 integrally formed on the back surface thereof (on the upper left side in FIG. 75) for storing information, and an antenna 152 connected to the IC circuit part 151 configured to transmit/receive information on the surface of the back side of the heat-sensitive sheet 603c. The IC circuit part 151 and antenna 152 make up a RFID circuit element To. The separation sheet 603a is adhered to the back side (upper left side in FIG. 75) of the heat-sensitive sheet 603c with the adhesive layer 603b. The separation sheet 603a is removed when a finally completed RFID label T is adhered to a predetermined article or the like, such that the RFID label T can be adhered to the article or the like with the adhesive layer 603b.

The cross-sectional structure along a section X-X in FIG. 75 is similar to the structure illustrated in FIG. 59, where, like the fourth embodiment, a discriminating recess 204B (not shown, see FIG. 59 above), formed in the tape holder rest 204, is provided with four tape discriminating sensors S1, S2, S3, S4 (tape-type sensing devices, see FIG. 58 above) for discriminating the type of the tag tape 603A. Each of these tape discriminating sensors S1-S4 detects whether or not there are respective sensor holes (see FIG. 33 above) in the tape discrimination part 260, such that the control circuit detects the type of the tag tape 603A loaded in the tape holder 203 based on on/off signals from the sensors S1-S4. It should be noted that the sensors S1-S4 are configured to enable the control circuit to identify a loaded tag tape in terms of the type, printing position, width, presence or absence of a tag, and the like.

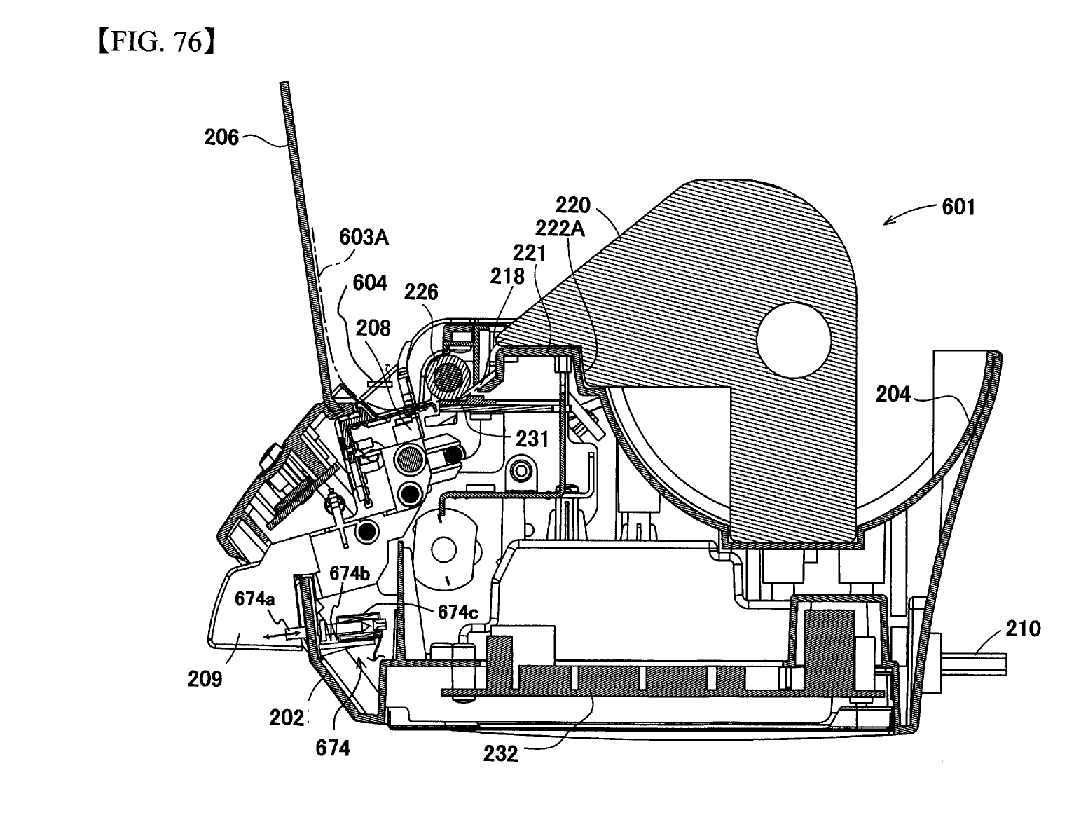

FIG. 76 is a side sectional view illustrating the label producing apparatus of FIG. 75 loaded with the tape holder, with the top cover removed therefrom.

Referring to FIG. 76, a cutter unit 208 can be limited in its cutting operation by a solenoid stopper (mechanical lock) 674. Specifically, the solenoid stopper 674 comprises a plunger 674a arranged for axial advancement and retraction (left-to-right direction in FIG. 7, as indicated by arrows), a spring 674b for urging the plunger 674a in the advancing direction, and a solenoid 674c configured to drive the plunger 674a in the retracting direction. The plunger 674a locks movements of the cutter lever 209 to the left and right to limit the cutting operation of the cutter 208 when the plunger 674a advances by an urging force of the spring 674b while the solenoid 674c is not powered, and releases the lock to free the cutter unit 208 from the locked cutting operation when the plunger 674a is retracted by the powered solenoid 674c.

The print head 231 is moved down to space apart from the platen roller 226 by pivoting upward the lever 227 for up/down moving operations. Then, the thermal head 231 is moved up by pivoting the lever 227 downward to urge the tag tape 603A against the platen roller 226, making the thermal head 231 ready for printing.

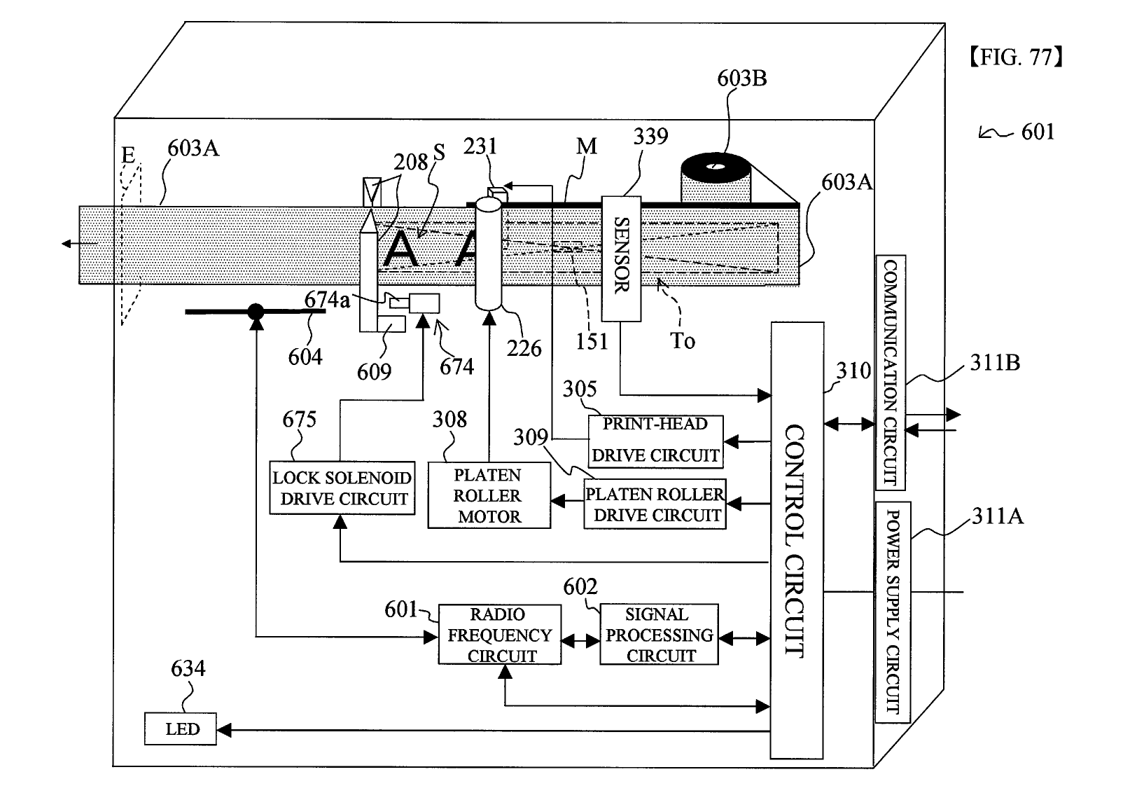

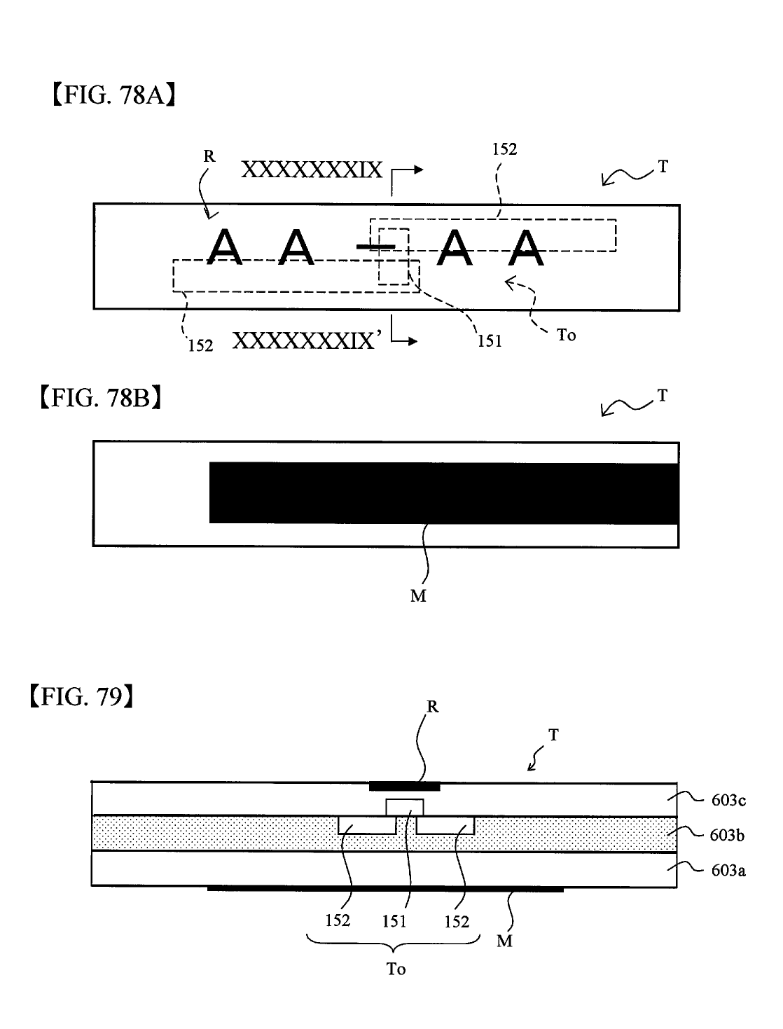

Specifically, for executing a printing process, the lever 227 is first pivoting upward to bring one side edge of the tag tape 603A into contact with the inner surface of the guide member 220. The other side edge of the tag tape 603A is inserted into the insertion port 218 while it is brought into contact with the guiding rib 223 implanted at the side edge of the insertion port 218. Then, as the lever 227 is pivoted downward, desired characters or the like can be printed on the tag tape 603A. When the lever 227 is pivoted downward in this state, the tag tape 603A inserted from the insertion port 218 is urged toward the platen roller 226 by the line type thermal head 231. Then, the platen roller 226 is driven to rotate by a pulse motor 308 (or a stepping motor or the like, see FIG. 77, later described), while the thermal head 231 is driven, whereby characters or image data can be sequentially printed on a print surface of the tag tape 603A while it is being transported. Further, in the fifth embodiment, the IC circuit part 151 is accessed (for reading or writing information) through the antenna 152 of the RFID circuit element To through an antenna (apparatus antenna device) 604 positioned on the downstream side in the transport direction. Then, the printed tag tape 603A discharged on the tray 206 is cut off by the cutter unit 208 by moving the cut lever 209 to the right to produce a RFID label T which contains the RFID circuit element To (see FIG. 78, later described).

FIG. 77 is a conceptual diagram illustrating a control system of the label producing apparatus 601.

Referring to FIG. 77, the tag tape 603A wound around the tape tube 603B is provided, along the center line thereof in the width direction, with RFID circuit elements To, each of which comprises an IC circuit part 151 and antenna 152, as described above. Also, in this example, an area corresponding to each RFID circuit element To in the thickness direction of the tag tape 603A defines a print area S (described later in detail) on which a character R corresponding to each RFID circuit element To is printed by the print head 231. After the printing, signals are transmitted/received to/from the RFID circuit element To contained in the tag tape 603A through the antenna 604 over the air using a high frequency in the UHF band, microwaves or the like. The printed tag tape 603A is cut by the cutter unit 208 by manipulating the cutter lever 209 as described above to produce a RFID label T.

In addition, the label producing apparatus 601 comprises a mark sensor 339 which serves as an identifier sensing device configured to optically detect the presence or absence of the tag tape 603A on the feeding path toward the carry-out exit E and detecting identification marks M (cut identifier) printed substantially along the RFID circuit elements To on the tag tape 603A; the platen roller 226 configured to transport the tag tape 603A and transporting the label T, after it is cut off from the tag tape 603A, to the carry-out exit E; a radio frequency circuit 601 (similar in configuration to the radio frequency circuit 21 in the first to fourth embodiments, so that a detailed description thereon is omitted) for accessing (reading or writing) information (RFID tag information) in the IC circuit part 151 of the RFID circuit element To through the antenna 604; a signal processing circuit 602 (similar in configuration to the signal processing circuit 22 in the first to fourth embodiments, so that a detailed description thereon is omitted) configured to process signals read from the IC circuit part 151 of the RFID circuit element To and received through the radio frequency circuit 601 in a predetermined manner to read information, and accessing the IC circuit part 151 of the RFID circuit element To through the radio frequency circuit 601; the print-head drive circuit 305 configured to control to power the thermal head 231; a platen roller drive circuit 309 configured to control the platen roller motor 308 configured to drive the platen roller 226; a lock solenoid drive circuit 675 configured to control to power the solenoid 674; the control circuit 310 configured to generally control the operation of the label producing apparatus 601 through the radio frequency circuit 602, signal processing circuit 602, print-head drive circuit 305, platen roller drive circuit 309, lock solenoid drive circuit 675 and the like; and the LED 234 which is turned on in response to a control signal from the control circuit 310. Optionally, the label producing apparatus 601 may also comprise a feeding guide configured to hold a RFID tag circuit element To in a predetermined access area opposite to the antenna 604 upon transmission/reception of signals over the air, and guiding each of cut RFID labels T.

As previously described, the mark sensor 339 is, for example, a reflective photo-electric sensor having a light emitter and a light receiver. Light emitted from the light emitter is reflected by a black identification mark M (cut identifier) applied at a predetermined location on the tag tape 603A, and impinges on the light receiver, causing the sensor 339 to output a corresponding control output.

FIGS. 78A and 78B are diagrams illustrating the appearance of an exemplary RFID label T which is formed after information has been read from (or written into) the RFID circuit element To, and the label tape 603A has been cut in a manner described above. FIG. 78A is a top plan view, and FIG. 78B is a bottom plan view. FIG. 79 in turn is a cross-sectional view taken along a section XXXXXXXIX-XXXXXXXIX′ in FIG. 78.

Referring to FIGS. 78A, 78B, 79, the RFID label T is in a three-layer structure made up of a heat-sensitive sheet 603c, an adhesive layer 603b, and a separation sheet 603a, laminated in this order from the surface side (upper side in FIG. 79) to the opposite side (lower side in FIG. 79), as described above. Additionally, a RFID circuit element To comprising an IC circuit part 151 and an antenna 152 is embedded in the back side of the heat-sensitive sheet 603c (the RFID circuit element To may be arranged upside down in FIG. 79), and a character R (in the example, a character “AA-AA”) is printed on the surface of the heat-sensitive sheet 603c. Further printed on the surface of the separation sheet 603a are solid black identification marks M which extends from a position behind the leading end of the antenna 152 in the front direction in the transport direction (on the left side in FIG. 78A) to the trailing edge of the label T (on the right side in FIG. 78A).

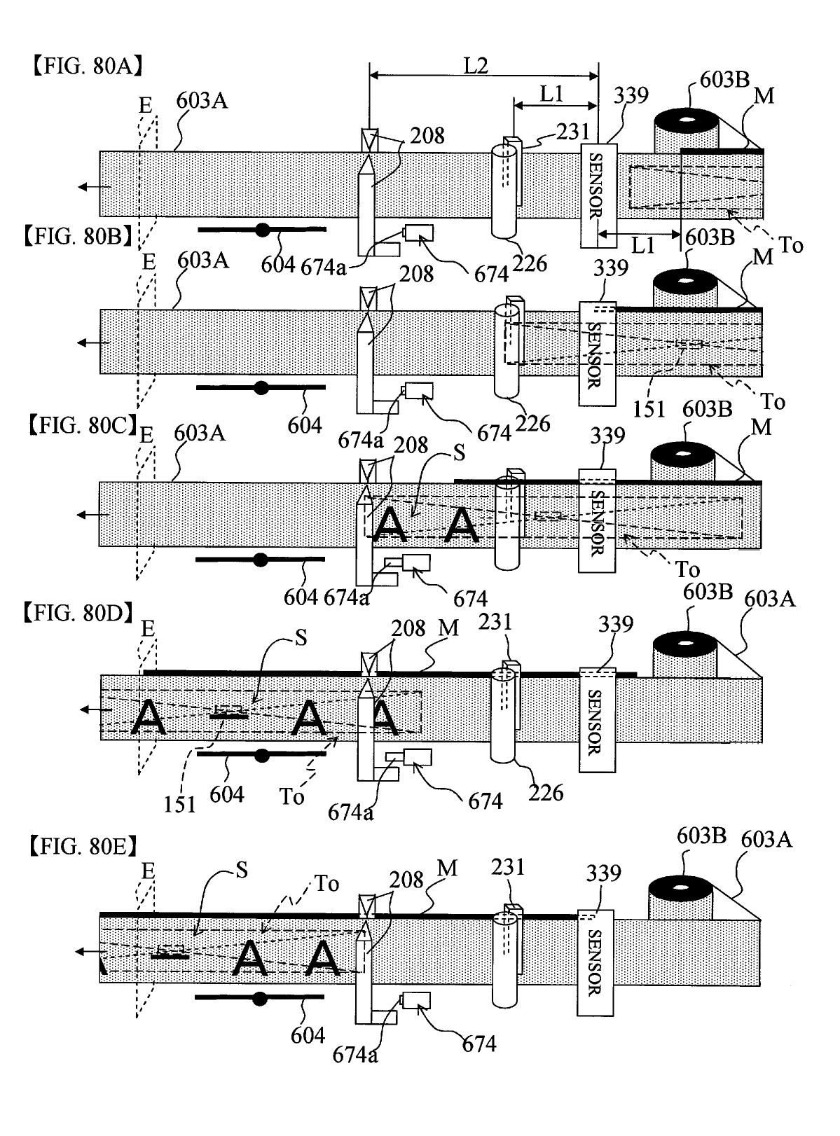

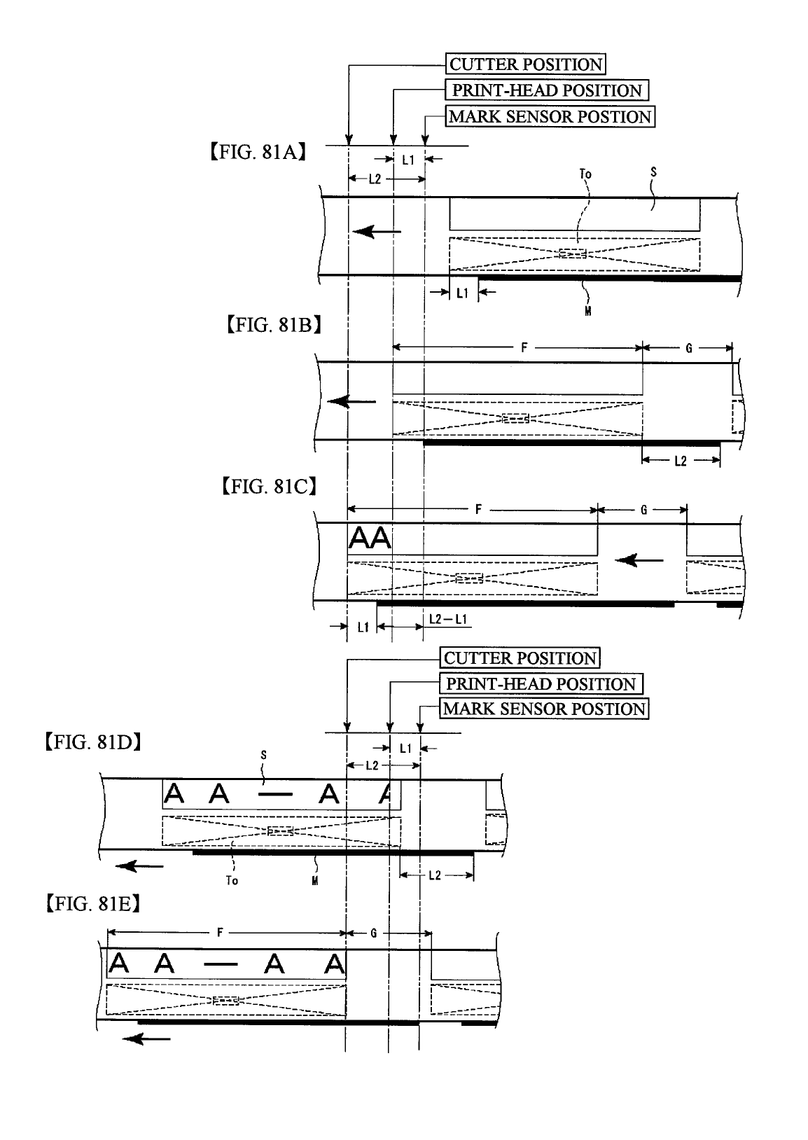

In the tag-label producing apparatus 601 in the basic configuration as described above, the most significant feature of the fifth embodiment lies in that the print head 231 is controlled in its printing operation, while the cutter unit 208 is controlled (limited) in its cutting operation in accordance with the identification mark M detected by the sensor 339 during the transport of the tag tape 603A. In the following, behaviors in the control based on the transported position will be described with reference to FIGS. 80 and 81.

FIGS. 80A-80E are explanatory diagrams illustrating the positional relationship of the identification mark M and RFID circuit element To on the sequentially fed tag tape 603A to the mark sensor 339, print head 231, and cutter unit 208. FIGS. 81A-81E are conceptual diagrams illustrating in greater detail the positional relationship among the print area S, RFID circuit element To, and identification mark M of the tag tape 603A in the respective states shown in FIGS. 80A-80E.

First, FIGS. 80A and 81A illustrate a state immediately after the tag tape 603A has been fed out from the tape tube 603B to provide the RFID circuit element To associated with the RFID label T which is now being produced.

As illustrated, in this embodiment, the distance between the mark sensor 339 and printhead 231 in the tape transport direction, and the distance from the leading end of the RFID circuit element To in the tape transport direction (downstream side) to the leading end of the identification mark M, offset therefrom, in the tape transport direction are both equal to L1. Then, the distance L2 between the mark sensor 339 and cutter unit 208 is longer than the distance L1.

In the illustrated state, the identification mark M is not detected by the mark sensor 339, and the plunger 674a of the solenoid stopper 674 is at a retracted position (lock release position), so that the cutter unit 208 is operable to cut the tape 603A.

As the tag tape 603A is transported forward from this state, the leading end of the RFID circuit element To in the tape transport direction reaches the position of the print head 231 (see FIGS. 80B and 81B).

Here, in this embodiment, for controlling the cutter unit 208 to limit its cutting operation, a cut prohibited area F is defined across the overall length corresponding to each the RFID circuit elements To arranged sequentially on the tag tape 603A in the longitudinal direction, and a cut allowed area G is defined in an area between two adjacent RFID circuit elements To (see FIG. 81B). In this event, the solid black identification mark M has been borne corresponding to the overall length of the cut prohibited area F, for example, by previously printing on the surface of the separation sheet 603a (see FIG. 79) of the tag tape 603A, as described above. The leading end of the identification mark M in the tape transport direction is at a position offset by the aforementioned L1 toward the upstream side in the transport direction from the leading end of the cut prohibited area F (in other words, the RFID circuit element To) in the tape transport direction. The trailing edge of the identification mark M in the tape transport direction (upstream side) is at a position offset by the aforementioned L2 toward the upstream side in the transport direction from the trailing edge of the cut prohibited area F.

As a consequence of the identification mark M defined as described above, when the leading edge of the identification mark M reaches the position of the mark sensor 339 as the tag tape 603A is moved, the leading edge of the print area S corresponding to the RFID circuit element To reaches the position of the print head 231. In response, as the identification mark M is detected by the mark sensor 339, a character R is printed on the print area S.

As the tag tape 603A is further transported forward from the state illustrated in FIGS. 80B and 81B, the leading edge of the RFID circuit element To (in other words, the cut prohibited area F) in the tape transport direction reaches the position of the cutter unit 208 (see FIGS. 80C and 81C). In this state, since the identification mark M is already being detected by the mark sensor 339 as described above, the arrival of the RFID circuit element To at this position is detected by sensing that the tag tape 603A has advanced by L2-L1 from the state illustrated in FIGS. 80B and 81B (identification mark M detection start state), as will be later described in greater detail. In response to this detection, the plunger 674a of the solenoid stopper 674 is driven to the advanced position (lock position), thus disabling the cutter unit 208 to cut the tape 603A.

FIGS. 80D and 81D illustrate a state in which the tag tape 603A is further transported forward from the state illustrated in FIGS. 80C and 81C, with the RFID circuit element To (in other words, the cut prohibited area F) being passing the position of the cutter unit 208. In this event, the mark sensor 339 is still detecting the existence of the identification mark M.

As the tag tape 603A is further transported forward from the state illustrated in FIGS. 80D and 81D, the trailing edge of the RFID circuit element To (in other words, the cut prohibited area F) in the tape transport direction reaches the position of the cutter unit 208 (see FIGS. 80E and 81E). At this time, the aforementioned dimension setting relationship causes the trailing edge of the identification mark M to reach the position of the mark sensor 339. Therefore, as the identification mark M is no longer detected by the mark sensor 339, the RFID circuit element To (cut prohibited area F) is regarded to fall out of the position of the cutter unit 208 on the downstream side in the transport direction (in other words, the cut allowed area G opposes the cutter unit 208). In response, the plunger 674a of the solenoid stopper 674 is again driven to the retracting position (lock release position), thus allowing the cutter 208 to cut the tape 603A (see FIGS. 80E and 81E).

In this way, this embodiment corresponds to the detection of the identification mark M to the timing at which the cut prohibited area F or cut allowed area G opposes the cutter unit 208, while the tag tape 603A is being fed out, to control the solenoid stopper 674 to prohibit or allow the cutting operation of the cutter unit 208.

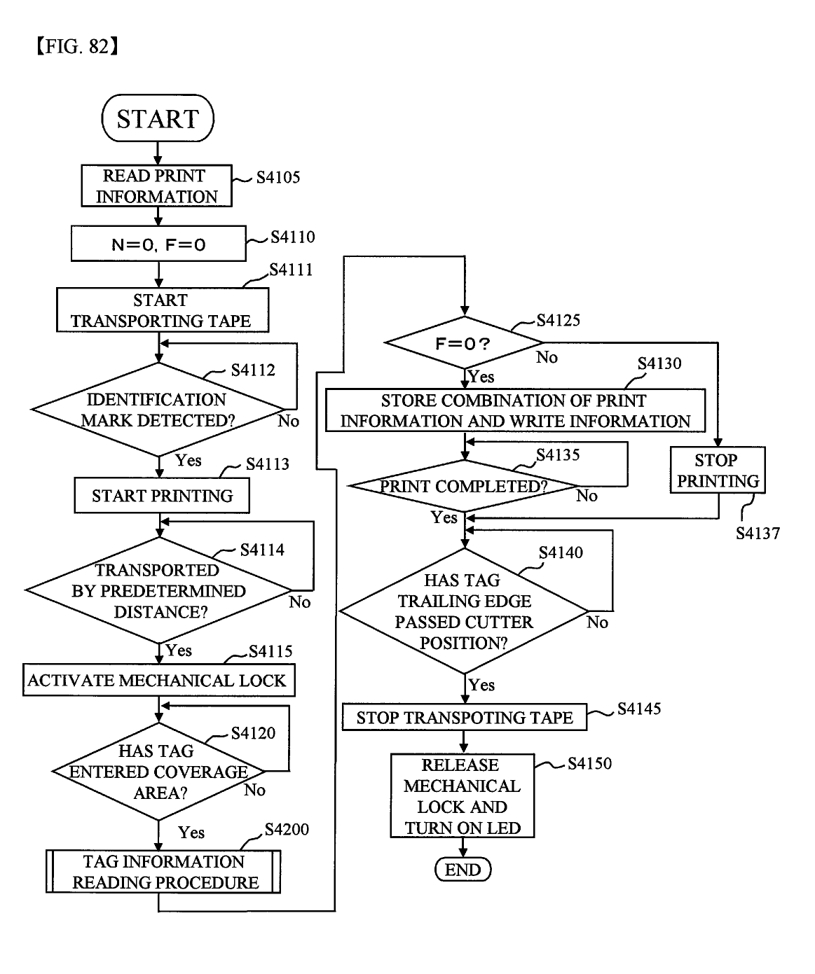

FIG. 82 is a flow chart illustrating a control procedure executed by the control circuit 310 for conducting the control as described above.

This flow is started when the tape discrimination sensors S1-S4 detect a tag tape 603A including RFID circuit elements To (do not detect a tag-less tape) in the tag-label producing apparatus 601. In the tag-label producing apparatus 601 of this embodiment, though details are omitted, the tag-less tape can be contained in the tape holder 203 and loaded into the tag-label producing apparatus 601 instead of the tag tape 603A, in which case the tape discrimination sensors S1-S4, for example, detect the discrimination part 260 indicative of the tag-less tape.

Referring to FIG. 82, at step S4105, the tag-label producing apparatus 601 first reads, through the communication circuit 311B and input/output interface, print information which is entered through a terminal or general purpose computer, not shown, and which should be printed on the RFID label T by the print head 231.

Subsequently, at step 4110, the control circuit 310 initializes a variable N for counting the number of times a retry is made (number of times of access retries), and a flag F indicative of a normal or a failed communication when no response is returned from the RFID circuit element To.

Then, at step S4111, the control circuit 310 outputs a control signal to the platen roller drive circuit 309 (see FIG. 77) to rotate the driving shaft of the platen roller 226 with a driving force of the platen roller motor 308 comprised of a pulse motor, by way of example. This causes the tag tape 603A rolled around the tape tube (reel member) 603B to be fed out therefrom.

Next, the flow goes to step S4112, where the control circuit 310 determines whether or not the identification mark M is detected by the mark sensor 339 on the fed tag tape 603A. The determination at step S4112 is not YES when the mark sensor 339 detects the identification mark M, where the identification mark M has reached the position of the mark sensor 339, and the leading end of the print area S corresponding to the RFID circuit element To has reached the print head 231 (see FIGS. 80B and 81B). Then, the flow goes to step S4113, where the control circuit 310 outputs a control signal to the print-head drive circuit 305, forcing the print head 231 to start printing a character R on the print area S.

At next step S4114, the control circuit 310 determines whether or not the tag tape 603A has been transported further by a predetermined amount (i.e., the transport distance equal to L2-L1) from the time the identification mark M was detected at step S4112. The determination on the transport distance at this time may also be made, for example, by counting the number of pulses output from the platen roller drive circuit 309 configured to drive the platen roller motor 308.

The determination at step S4112 is YES when the tag tape 603A has been transported further by L2-L1 from the time the identification mark M was detected, causing the leading end of the RFID circuit element To (in other words, cut prohibited area F) to reach the position of the cutter unit 208. Then, the flow goes to step S4115.

At step S4115, the control circuit 310 outputs a control signal to the lock solenoid drive circuit 675 to stop powering the solenoid 674c of the solenoid stopper 674 (i.e., the solenoid 674c has been so far powered so that the cutter unit 208 is released from the locked state), forcing the spring 674b to drive the plunger 674a forward to limit the cutter lever 209 in its manipulations to the left and right. In this way, the cutter unit 208 is limited in the cutting operation (locked state, see FIGS. 80C and 81C).

Next, at step S4120, the control circuit 310 determines whether or not the tag tape 603A has been transported further by a predetermined amount from the time the solenoid stopper 674 is activated at step S4115 (for example, whether the leading end of the RFID circuit element To has reached the position opposite to the antenna 604 or near this position where the RFID circuit element To can be read). The determination on the transport distance at this time may also be made, for example, by counting the number of pulses output from the platen roller drive circuit 309 configured to drive the platen roller motor 308, in a manner similar to the foregoing. When the determination at step S4120 is YES, the flow goes to step S4200.

At step S4200, the control circuit 310 performs a tag information reading procedure, where the tag-label producing apparatus 601 transmits a query signal to the RFID circuit element To for reading, and receives and reads a response signal including RFID tag information. Details on the tag information reading procedure are similar to that illustrated in the flow chart of FIG. 27 in the third embodiment, so that a description thereon is omitted. After the completion of the procedure at step S4200, the flow goes to step S4125.

At step S4125, the control circuit determines whether or not the flag F is “0” (F=0). When the reading procedure has been normally completed, the flag F remains at “0” (F=0) (see step S2280 in the flow chart shown in FIG. 11 above), so that the determination at step S4125 is YES, causing the flow to go to step S4130.

At step 4130, the control circuit 30 outputs a combination of the information read from the RFID circuit element To at step S4200 with the print information previously printed by the print head 231 corresponding thereto for storage in the information server 7 and route server 4 through a terminal or a general purpose computer, not shown, by way of the communication circuit 311B. The information may be stored, for example, in a database such that the terminal or general-purpose computer has accesses thereto as required.

Subsequently, at step S4135, after the control circuit 310 confirms that all the characters R have been printed on the print area S corresponding to the RFID circuit element To which is currently under processing among those on the tag tape 603A, the flow goes to step S4140.

At step S4125 described above, if the reading procedure has not been normally completed for some reason, the flag F is set to “1” (see at step S2280 in the flow chart illustrated in FIG. 27, later described). Accordingly, the determination at step S4125 is NO, causing the flow to go to step S4137, where the control circuit 30 outputs a control signal to the print-head drive circuit 305 (see FIG. 77) to stop the power to the print head 231 which stops the printing in response to the control signal. In this way, the control circuit 310 explicitly displays that a pertinent RFID circuit element To is defective through such interrupted printing. Then, the flow goes to the aforementioned step S4140.

At step S4140, the control circuit 310 determines whether or not the printed tag tape 603A has been transported further by a predetermine amount (for example, the overall length of the RFID circuit element To, in other words, the cut prohibited area F) from the time the solenoid stopper 674 was activated at step S4115 (whether or not the trailing edge of the RFID circuit element To or cut prohibited area F has passed the cutter unit 208). As described above, this determination is made based on whether or not the mark sensor 339 no longer detects the identification mark M on the tag tape 603A. The determination at step S4140 is YES when the identification mark M is no longer detected because this means that the trailing edge of the identification mark M has passed the position of the mark sensor 339, and the trailing edge of the RFID circuit element To or cut prohibited area F has passed the cutter unit (see FIGS. 80E and 81E). Accordingly, the flow goes to step S4145.

At step S4145, the control circuit 310 outputs a control signal to the platen roller drive circuit 309 (see FIG. 77), forcing the platen roller motor 308 to stop rotating the driving shaft of the platen roller 226. In this way, the transport of the tag tape 603A is stopped.

Next, the flow goes to step S4150, where the control circuit 310 outputs a control signal to the lock solenoid drive circuit 675 to power the solenoid 674c of the solenoid stopper 674 to retract the plunger 674a, thus unlocking the cutter unit 208. In this way, the cutter 208 is allowed to cut the tag tape 603A. In addition, the control circuit 310 outputs a light control signal to LED 634 to turn on the LED 634. After step S4150 is completed, the flow is terminated.

Through the foregoing flow, the label producing apparatus 601 can access and read the RFID tag information stored in the IC circuit part 151 of the target RFID circuit element To under processing on the tag tape 603A. Also, the tag tape 603A is cut at a proper position by manually moving the cutter lever 209 of the cutter unit 208 in the direction across the tag tape 603A. Consequently, the tag-label producing apparatus 601 produces the RFID label T from which the RFID tag information has been read from the RFID circuit element To and on which the predetermined character has been printed.

In the foregoing description, the solenoid stopper 674, lock solenoid drive circuit 675, and control circuit 310 which executes the flow of FIG. 82 implement a cut limiting device configured to limit the operation of the cutter such that the cutter is disabled in the cut prohibited area and is enabled in the cut allowed area corresponding to the tag tape fed out by the driving shaft in accordance with the detection result of the identifier sensing device in the respective aspects of the present invention. The combination of these components also implements a malfunction preventing device. Also, the stop of the transport of the tape for cutting is not allowed at steps S4145 and S4150 through step S4140 unless a confirmation has been made that the print has been completed at step S4135 in FIG. 82. This control matter by control circuit 310 is comparable to a print-avoiding device configured to limit the operation of the cutter so as to avoid cutting in the print area in accordance with a printing operation on the tag tape by the printing device.

The platen roller drive circuit 309 in turn constitutes a drive control device configured to control the driving shaft such that the fed tag tape is stopped when the cutter opposes the cut allowed area.

The fifth embodiment configured as described above provides the following advantages.

Specifically, in the tag-label producing apparatus 601 of the fifth embodiment, the tag tape 603A is fed out by the driving shaft of the platen roller 226, and predetermined information is read from (or written into, see an exemplary modification, later described) the RFID circuit element To contained in the tag tape 603A through a communication over the air by way of the antenna 604. Then, the tag tape 603A is cut to a predetermined length by the cutter unit 208 to produce a RFID label.

In this event, the tag tape 603A is provided with the identification mark M for identifying the cut prohibited area F and cut allowed area G. The identification mark M is detected by the mark sensor 339, such that, in accordance with the result of the detection, the solenoid stopper 674 limits the operation of the cutter unit 208 through the cutter lever 209, thus enabling the cutter unit 208 to cut the tag tape 603A in the cut allowed area G but disabling the cutter unit 208 to cut the tag tape 603A in the cut prohibited area F (in other words, preventing malfunctions and/or inappropriate operations during the cutting operation). In this way, the tag tape 603A can be cut at proper positions to efficiently produce the RFID labels T in sequence while the cutting unit 208 is reliably prevented from erroneously cutting part of the IC circuit 151 or antenna 152 of the RFID circuit element To on the tag tape 603A to destroy functions of the RFID tag. As a result, the reliability of the products can be improved by preventing defective RFID labels T. In addition, the blades of the cutter unit 208 can be prevented from damages and abrasion possibly resulting from erroneously cutting the RFID circuit element To.

Notably, in the fifth embodiment, when the tag tape 603A is fed out and transported by the platen roller 226, the transport of the tape is automatically stopped at the position at which the cutter unit 208 opposes the cut allowed area G (see step S4145 in FIG. 82), so that the cutter unit 208 can be manually operated through the cutter lever 209 to cut the tape. In other words, since the tag tape 603A is automatically transported until the cut allowed area G is reached, the operator need not perform the tape feeding operation, and can therefore is burdened with less efforts.

Further notably, in the fifth embodiment, since the identification marks M, i.e., cut identifiers are borne on the tag tape 603A in a strip shape sequentially over the overall length of the tag tape 603A, simple control can also be conducted. Specifically, a period in which the identification mark M can be detected can be corresponded one-to-one to a period in which the cut prohibited area F opposes the cutter unit 208, in accordance with the amount of fed tag tape 603A, such that the cutter unit 208 can be prohibited to cut the tag tape 603A when the identification mark M can be detected.

Further notably, in the fifth embodiment, before executing the flowchart illustrated in FIG. 82, the control circuit 310 determines whether or not a tape loaded in the tape holder 203 is the tag tape 603A including RFID circuit elements To in accordance with the result of detections made by the sensors S1-S4 (tape-type sensing devices), and selectively limits the cutter unit 208 in its cutting operation based on the flowchart of FIG. 82 in accordance with the result of the determination (the control circuit 310 implements a switching control device). In this way, when the tape holder 203 is loaded, for example, with a normal tape without RFID circuit elements To so that the cutter unit 208 need not be limited in operation, the control circuit 310 can refrain from such operation limitations. Alternatively, instead of the sensors S1-S4 as described above, other types of mechanical switches, or known optical or magnetic reading devices such as a bar code scanner may be used to detect whether a tape contains the RFID circuit elements To. Further alternatively, the cartridge may be provided with the RFID circuit elements To, such that the tag-tape producing apparatus 601 can read information stored therein through an antenna device associated therewith.

Also notably, in the fifth embodiment, in the flow illustrated in FIG. 82 executed by the control circuit 310, the disablement of stop transporting the tape for cutting is not allowed, at steps S4145 and S4150 through step S4140, unless a confirmation has been made that the print has been completed at step S4135 in FIG. 82. Specifically, supposing that a printed tag label is produced by printing a character on a tag tape itself or a print-receiving tape, which is to be bonded to the tab tape, by the printing device, if the tag tape is cut across the print area, even if the print area falls within the cut allowed area which does not contain the RFID circuit element, the printed character is broken in the middle, resulting in a defective product. Accordingly, the print-avoiding device provided in the cut limiting device can prevent the cutter from cutting the tag tape in the print area, thereby avoiding such detrimental effects to ensure that the product is improved in reliability. In this connection, while the control circuit 310 determines at step S4135 whether or not the print has completed in the flow of FIG. 82 in the fifth embodiment, step S4135 is not always required as long as it is concerned with the essential advantage of the present invention of preventing the cutter unit from erroneously cutting the RFID circuit element To.

Further notably, in the fifth embodiment, the LED 634 is turned on or off to indicate whether the cutter unit 208 opposes the cut prohibited area F or cut allowed area G, based on the result of the detection made by the mark sensor 339. In this way, the operator is clearly informed of whether the cutter unit 208 is currently allowed to cut the tag tape or prohibited from cutting the tag tape.

It should be understood that the fifth embodiment is not limited to the foregoing, but can be modified in various ways without departing from its spirit and technical idea. The following description will be focused on such exemplary modifications.

(5-1) Cutting Operation of Cutter Unit Driven by Solenoid Based on Manual Activity:

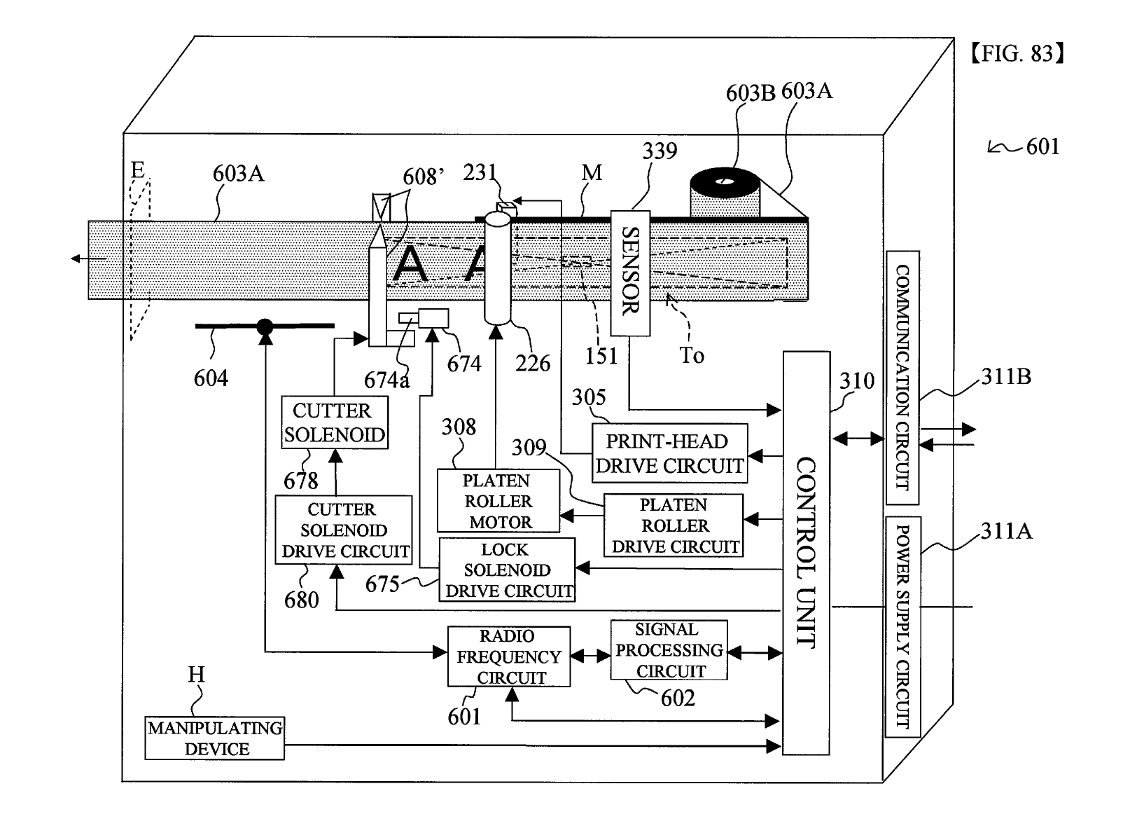

FIG. 83 is a conceptual diagram illustrating a control system of the tag-label producing apparatus 601 according to one exemplary modification, and corresponds to FIG. 77 in the fifth embodiment. Parts equivalent to those in the fifth embodiment are designated the same reference numerals, and descriptions thereon are omitted. As illustrated, in the tag-label producing apparatus 601 according to this exemplary modification, as the operator activates a manipulating device (for example, a push button or an appropriate manipulation key) H, an associated manipulation signal is applied to the control circuit 310 which responsively outputs a control signal to a cutter solenoid drive circuit 680. The cutter solenoid drive circuit 680 activates a cutter solenoid 678 to drive a blade (not shown) of a cutter unit 208′ toward or away from a tag tape 603A, forcing the cutter unit 208′ to cut the tag tape 603A.

In this event, when the cut prohibited area F exists at a position opposite to the cutter unit 208′, as determined based on a signal of the mark sensor 339 indicative of a detected identification mark M, the control circuit 310 forces the lock solenoid drive circuit 675 to drive the plunger 674a of the solenoid stopper 674 forward to lock (limit) the cutting operation by the cutter unit 208′.

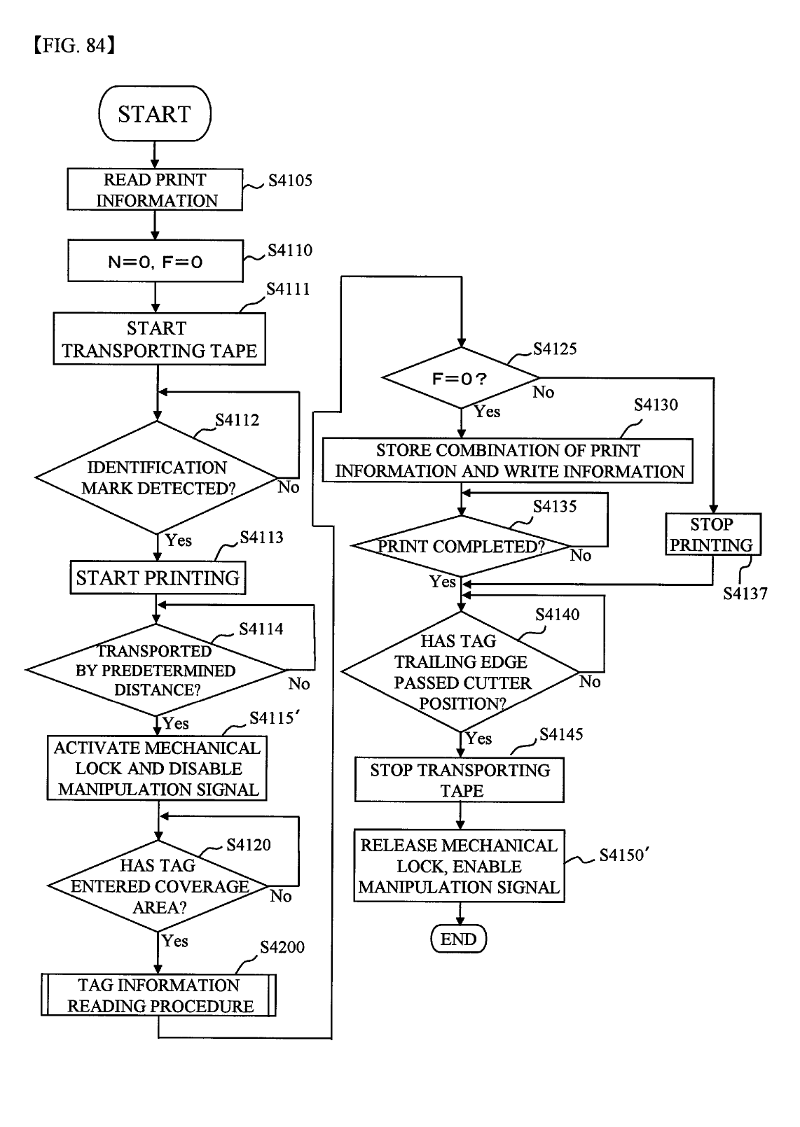

FIG. 84 is a flow chart illustrating a control procedure executed by the control circuit 310 for implementing the foregoing actions in the exemplary modification, and corresponds to FIG. 82 in the fifth embodiment. Similar steps to those in FIG. 82 are designated the same reference numerals, and descriptions thereon are omitted.

Referring to FIG. 84, the illustrated flow chart differs from the flow chart of FIG. 82 in that step S4115′ is substituted for step S4115 in FIG. 82, and step S4150′ is substituted for step S4150 in FIG. 82.

In other words, the processing from steps S4105 to S4114 is executed in the same manner as the flow of FIG. 82.

The flow goes to step S4115′ when the determination at step S4114 is YES. At step S4115′, the control circuit 310 outputs a control signal to the lock solenoid drive circuit 675 to stop powering the solenoid 674c of the solenoid stopper 674, thus driving the plunger 674a forward to mechanically limit the cutting operation by the blade of the cutter unit 208′, in a manner similar to step S4155 in FIG. 82. Further, the control circuit 310 disables a manipulation signal generated by the operator who pushes the manipulating device H (the control circuit 310 may not receive or recognize the manipulation signal, or may receive the manipulation signal but may not output a control signal to the cutter solenoid drive circuit 680 in response to the manipulation signal) to limit the operation of the cutter solenoid 678 in a software approach.

Since subsequent steps S4120 to S4145 are similar to those in FIG. 82, descriptions thereon are omitted.

Upon completion of step S4145, the flow goes to step S4150′. At step 4150′, the control circuit 310 outputs a control signal to the lock solenoid drive circuit 675 to power the solenoid 674c of the solenoid stopper 674, forcing the plunger 674a to retract to release the cutter unit 208′ from the limitations to its operations, in a manner similar to step S4150 above. Further, the control circuit 310 enables (makes effective) the manipulation signal generated from the manipulating device to release the cutter solenoid 678 from limited operations by the software approach.

According to the tag-label producing apparatus 601 of this exemplary modification, where the tag tape 603A fed out and transported from the tape tube 603B is cut by the cutter unit 208′ in response to a manipulation on the manipulating device, the cutter unit 208′ can be controlled not to cut the tag tape 603A in the cut prohibited area F, and to cut the tag tape 603A only in the cut allowed area G, in a similar manner to the fifth embodiment.

Notably, in this event, the transport of the tag tape 603A is automatically stopped at the position at which the cutter unit 208 opposes the cut allowed area G, i.e., the tag tape 603A is automatically transported to the position at which the cut allowed area G opposes to the cutter unit 208′, so that the operator need not perform the tape feeding operation, and can therefore is burdened with less efforts.

In the foregoing exemplary modification, the operation of the cutter solenoid 678 is locked by a software approach through the cutter solenoid drive circuit 680, together with the mechanical lock by the solenoid stopper 674. However, both locking operations are not always required, but anyone maybe sufficient. Specifically, when the solenoid stopper 674 mechanically locks the cutting operation of the cutter unit 208, the cutter solenoid 678 need not be limited in activation by a software approach. Conversely, when the cutter solenoid 678 is limited in activation by a software approach, the solenoid stopper 674 may be omitted. In these scenarios, similar advantages are provided as in the fifth embodiment.

(5-2) Automatic Cutting Operation of Cutter Unit (Auto-Cutter)

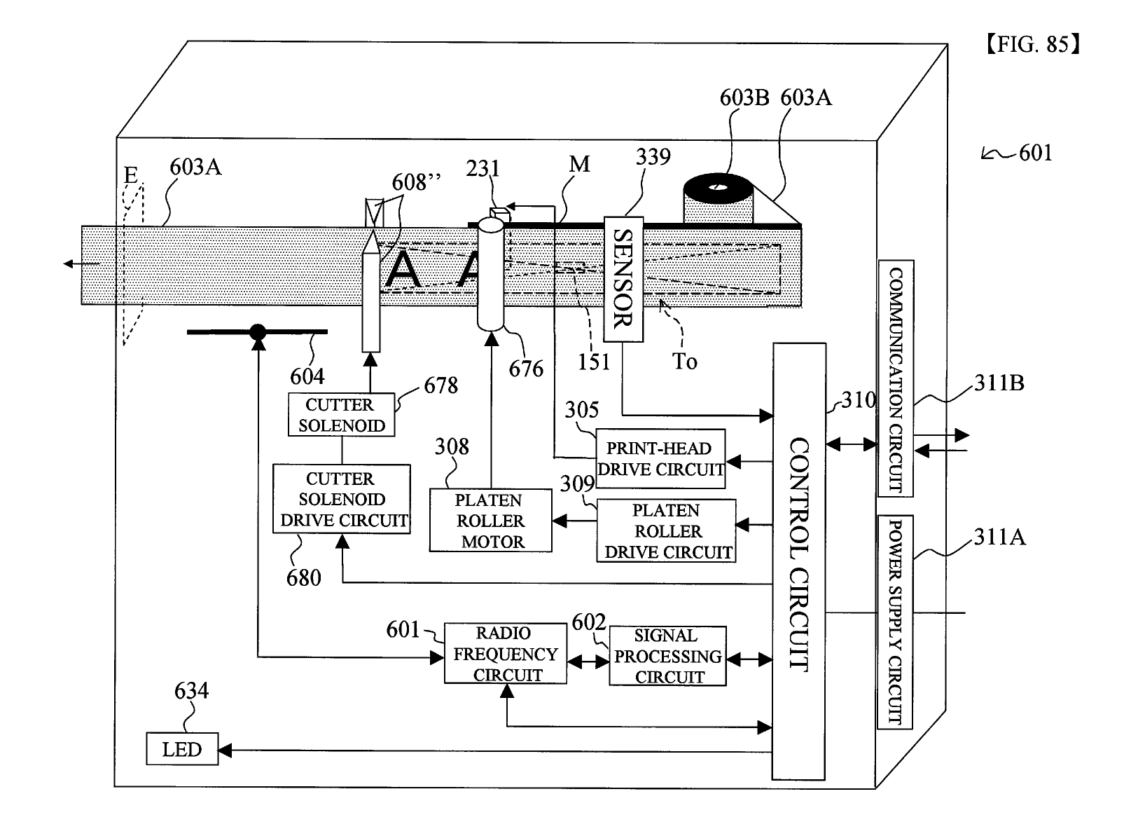

FIG. 85 is a conceptual diagram illustrating a control system of the tag-label producing apparatus according to another exemplary modification, and corresponds to FIG. 77 in the fifth embodiment. Parts equivalent to those in the fifth embodiment are designated the same reference numerals, and descriptions thereon are omitted. As illustrated, in the tag-label producing apparatus 601 according to this exemplary modification, when a tag tape 603A is transported in a predetermined state, as determined based on a signal from the mark sensor 339 indicative of a detected identification mark M, the control circuit 310 stops transporting the tag tape 603A, and outputs a control signal to the cutter solenoid drive circuit 680 to drive the cutter solenoid 678, thus activating a cutter unit 280″to automatically cut the tag tape 603A.

In this event, when the cut prohibited area F is present at a position opposite to the cutter unit 280″, as determined based on a signal from the mark sensor 339 indicative of a detected identification mark M, the cutter unit 208″ is prevented (limited) from cutting the tag tape 603A, whereas when the cut allowed area G is present at the position opposite to the cutter unit 280″, the cutter unit 208″ is allowed to cut the tag tape 603A.

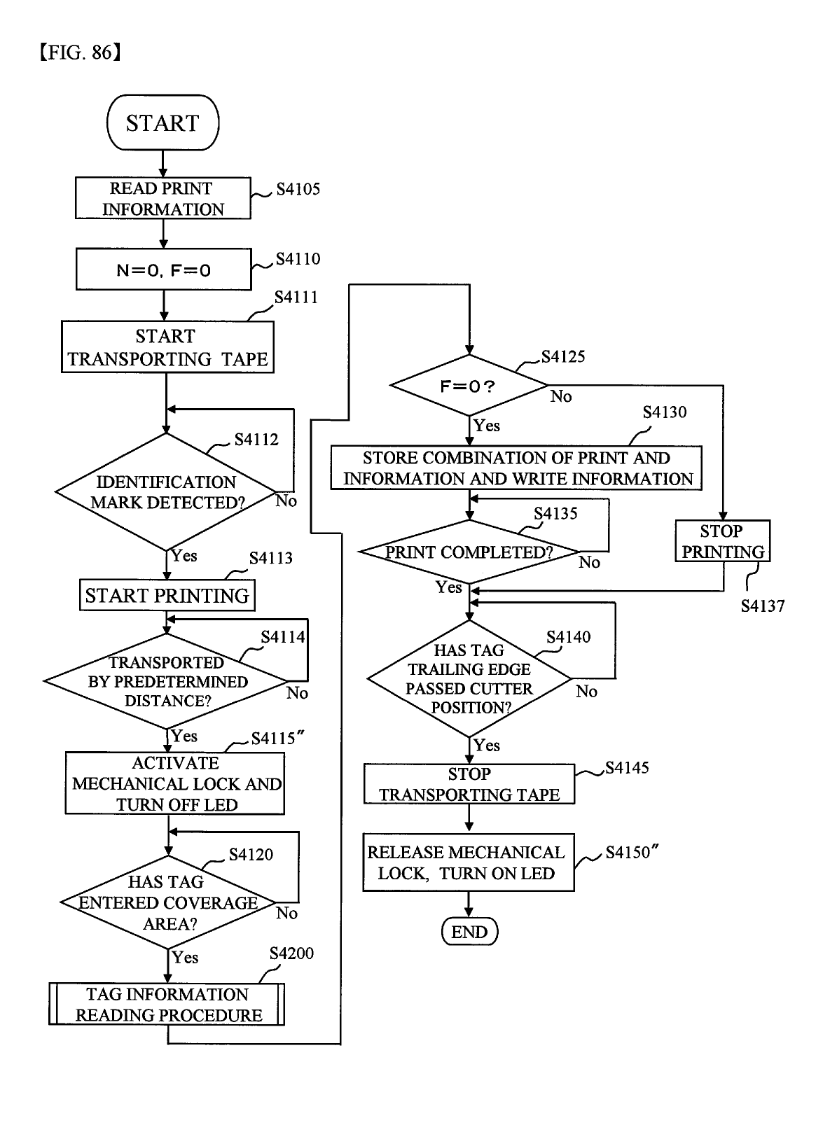

FIG. 86 is a flow chart illustrating a control procedure executed by the control circuit 310 for implementing the foregoing actions in the exemplary modification, and corresponds to FIG. 82 in the fifth embodiment and to FIG. 84 in the exemplary modification (5-1). Similar steps to those in FIGS. 82 and 84 are designated the same reference numerals, and descriptions thereon are omitted.

Referring to FIG. 86, the illustrated flow chart differs from the flow chart of FIG. 84 in that step S4115″ is substituted for step S4115′ in FIG. 84, and step S4150″ is substituted for step S4150′ in FIG. 84.

In other words, the processing from steps S4105 to S4114 is executed in the same manner as the flow of FIG. 82 and the flow of FIG. 84.

The flow goes to step S4115″ when the determination at step S4114 is YES. At step S4115″, the control circuit 310 outputs a control signal to the cutter solenoid drive circuit 680 to maintains a blade of the cutter unit 208″ at a position retracted from the feeding path of the tag tape 603A through the cutter solenoid 678 (in other words, the activation of the cutter unit 208″ is locked in response to a control signal from the control circuit 310 in a software approach). The control circuit 310 also outputs a control signal to the LED 234 which responsively turns off.

Since subsequent steps S4120 to S4145 are similar to those in FIG. 82, descriptions thereon are omitted.

Upon completion of step S4145, the flow goes to step S4150″. At step 4150″, the control circuit 310 outputs a control signal to the cutter solenoid drive circuit 680 to move the blade of the cutter unit 280″ forward toward the tag tape 603A to cut the printed tag tape 603A (cutting operation) (in other words, the cutter unit 208″ is released from the locked state in response to a control signal from the control circuit 310 in a software approach). The control circuit 310 also outputs a light control signal to the LED 234 which responsively turns on.

In the foregoing description, the control circuit 310 which executes the flow of FIG. 86 implements a cutting-operation control device configured to control an automatic cutting operation of the cutter such that the cutter does not cut the tag tape in the cut prohibited area, and cuts the tag tape in the cut allowed area.

According to the tag-label producing apparatus 601 of this exemplary modification, where the tag tape 603A fed out and transported from the tape tube 603B is automatically cut by the cutter unit 208″, the cutter unit 208″ can be controlled not to cut the tag tape 603A in the cut prohibited area F, and to automatically cut the tag tape 603A only in the cut allowed area G, in a similar manner to the fifth embodiment. Also, the automatic stop can effectively reduce the burden on the operator, as is the case with the fifth embodiment and exemplary modification (5-1).

Also, like the fifth embodiment described above, the LED 634 is turned on or off to indicate whether the cutter unit 208″ opposes the cut prohibited area F or cut allowed area G, based on the result of the detection made by the mark sensor 339. In this way, the operator is clearly informed of whether the cutter unit 208″ is currently allowed to cut the tag tape or prohibited from cutting the tag tape.

(5-3) Short Marks (So-Called Trigger Marks) Borne at Start Point and End point of Cut Prohibited Area as Identification Marks:

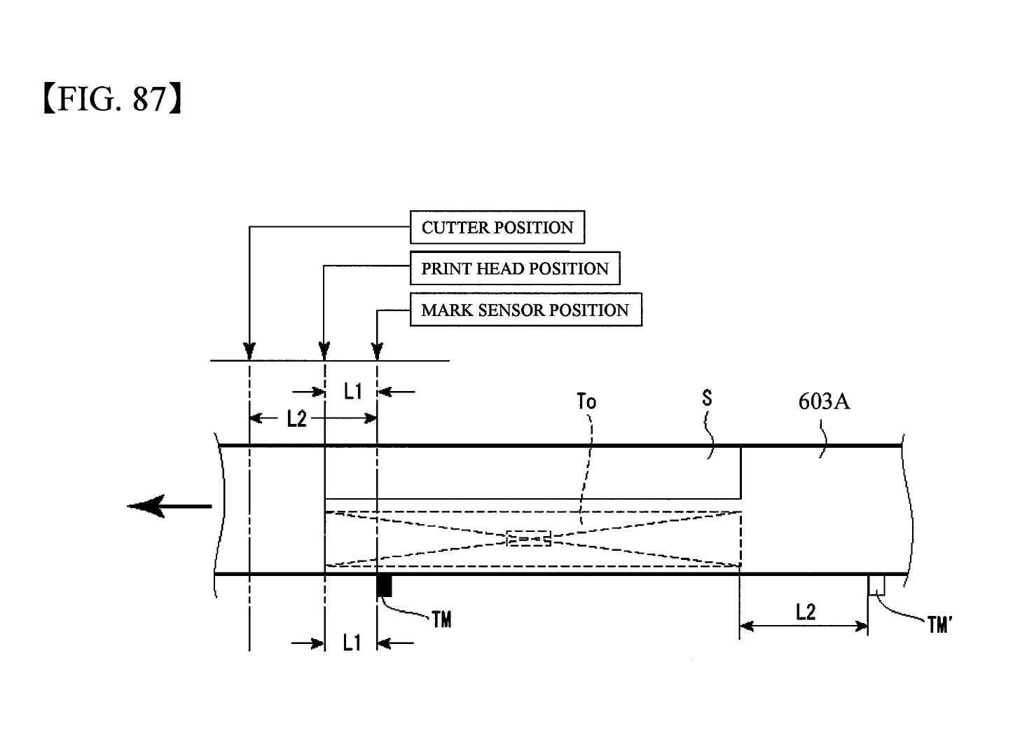

FIG. 87 is a conceptual diagram illustrating in detail the positional relationship among the print area S of the tag tape 603A, the RFID circuit element To, and cut identifiers (a start point trigger mark TM and an end point trigger mark TM′) in one exemplary modification. Parts equivalent to those in the fifth embodiment are designated the same reference numerals, and descriptions thereon are omitted.

Referring to FIG. 87, in the illustrated exemplary modification, the identification mark M borne across the overall length of the cut prohibited area F, as illustrated in FIG. 81B, is replaced with a start point trigger mark TM indicative of the front end position of the cut prohibited area F in the longitudinal direction of the tag tape 603A, and an end point trigger mark TM′ indicative of the rear end position of the same, which are borne on the tag tape 603A as cut identifiers. Specifically, the start point trigger mark Tm is borne at a position spaced by the aforementioned distance L1 from the leading end of the RFID circuit element To (in other words, the cut prohibited area F) of the tag tape 603A in the transport direction toward the upstream side in the transport direction, and the endpoint trigger mark TM′ is borne at a position spaced by the aforementioned distance L2 from the trailing edge of the RFID circuit element To (in other words, the cut prohibited area F) toward the upstream side in the transport direction.

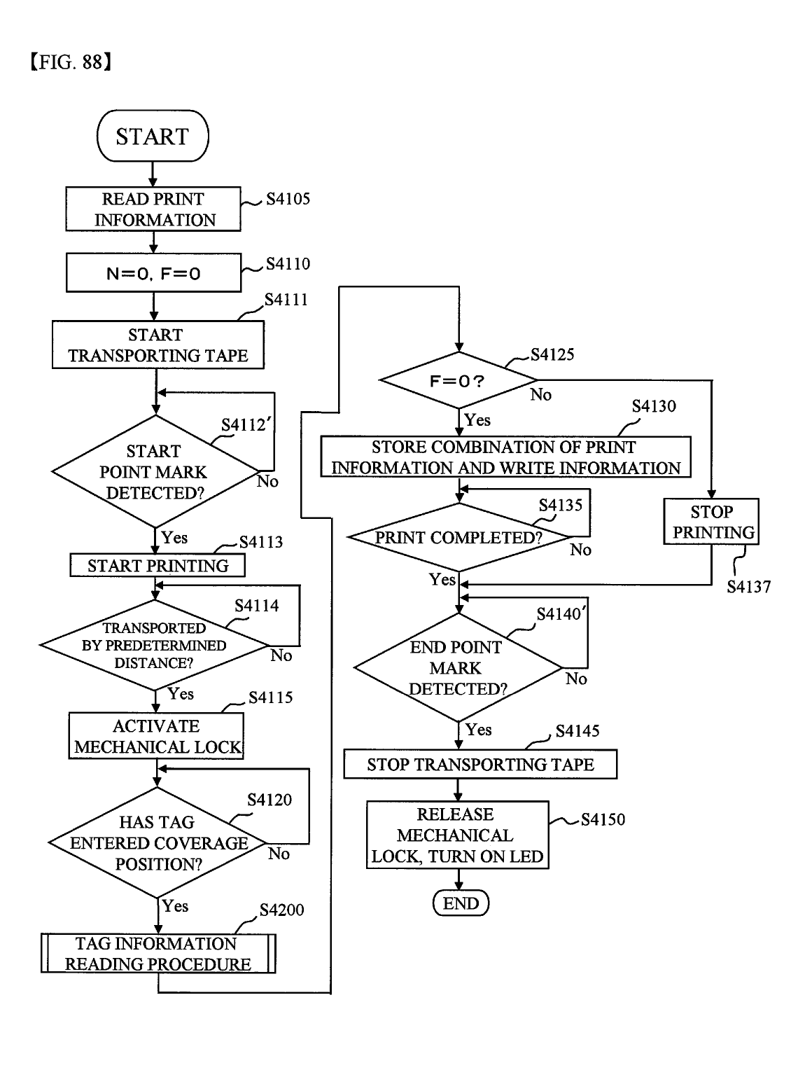

FIG. 88 is a flow chart illustrating a control procedure executed by the control circuit 310 for implementing the foregoing actions in the exemplary modification, and corresponds to FIG. 82 in the fifth embodiment. Steps equivalent to those in FIG. 82 are designated the same reference numerals, and descriptions thereon are omitted.

Referring to FIG. 88, the illustrated flow chart differs from the flow chart of FIG. 82 in that step S4112′ is substituted for step S4112 in FIG. 82, and step S4140′ is substituted for step S4140 in FIG. 82.

In other words, the processing from steps S4105 to S4111 is executed in the same manner as the flow of FIG. 82.

Subsequently, at step S4112′, the control circuit 310 determines whether or not the mark sensor 339 detects the start point trigger mark TM on the fed tag tape 603A. The determination at step S4112′ is YES when the start point trigger mark TM is detected because this means that the leading end of the print area S corresponding to the RFID circuit element To has reached the position of the print head 231 (comparable to the state illustrated in the aforementioned FIGS. 80B and 81B), causing the flow to go to step S4113.

The processing from steps S4113 to S4135 is executed in the same manner as the flow of FIG. 82, so that descriptions thereon are omitted.

Upon completion of the step S4135, the flow goes to step S4140′. At step S4140′, the control circuit 310 determines whether or not the mark sensor 339 detects the end point trigger mark TM′ on the fed tag tape 603A. The determination at step S4140′ is YES when the end point trigger mark TM′ is detected because this means that the trailing edge of the RFID circuit element To (in other words, the cut prohibited area F) has gone beyond the position of the cutter unit 208 (comparable to the state illustrated in the aforementioned FIGS. 80E and 81E), causing the flow to go to step S4145.

The processing at subsequent steps S4145 and S4150 is similar to the flow of FIG. 82, so that descriptions thereon are omitted.

According to the tag-label producing apparatus 601 of the foregoing exemplary modification, the cut prohibited area F is identified by positional information of the start point trigger mark TM and end point trigger mark TM′ instead of the elongated identification mark M, and the solenoid stopper 674 limits the cutter unit 208 in its cutting operation in a manner similar to the fifth embodiment described above. Consequently, the exemplary modification provides similar advantages to those of the fifth embodiment. In addition, in comparison with the identification mark M representative of the overall longitudinal length of the cut identifier as in the fifth embodiment, the cut identifiers can be locally borne in limited areas. Accordingly, the cut identifiers can be relatively easily borne on the tag tape.

In the foregoing exemplary modification, the trigger marks TM, TM′ are set at the start point position and end point position of the cut prohibited area F. Stated another way, they can represent the end point position and start point position of the cut allowed position G.

(5-4) Start Point Trigger Mark Alone Borne on Tag Tape:

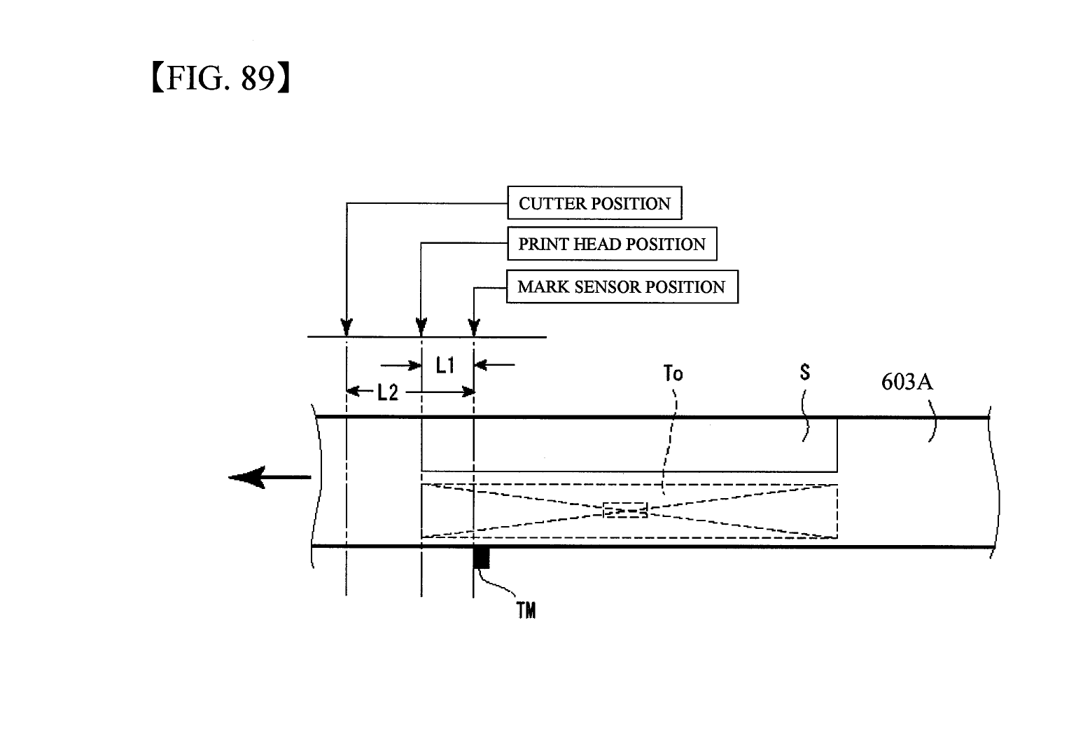

FIG. 89 is a conceptual diagram illustrating in detail the positional relationship among the print area S of the tag tape 603A, the RFID circuit element To, and cut identifiers (a start point trigger mark TM and an end point trigger mark TM′) in another exemplary modification. Parts equivalent to those in the fifth embodiment are designated the same reference numerals, and descriptions thereon are omitted.

Referring to FIG. 89, in the illustrated exemplary modification, the start point trigger mark TM alone is borne on the tag tape 603A, but the end point trigger mark TM′ is omitted in the exemplary modification (5-3). The positional information, which would be otherwise acquired from the end point trigger mark TM′ is provided by additional information on the distance from the start point trigger mark TM.

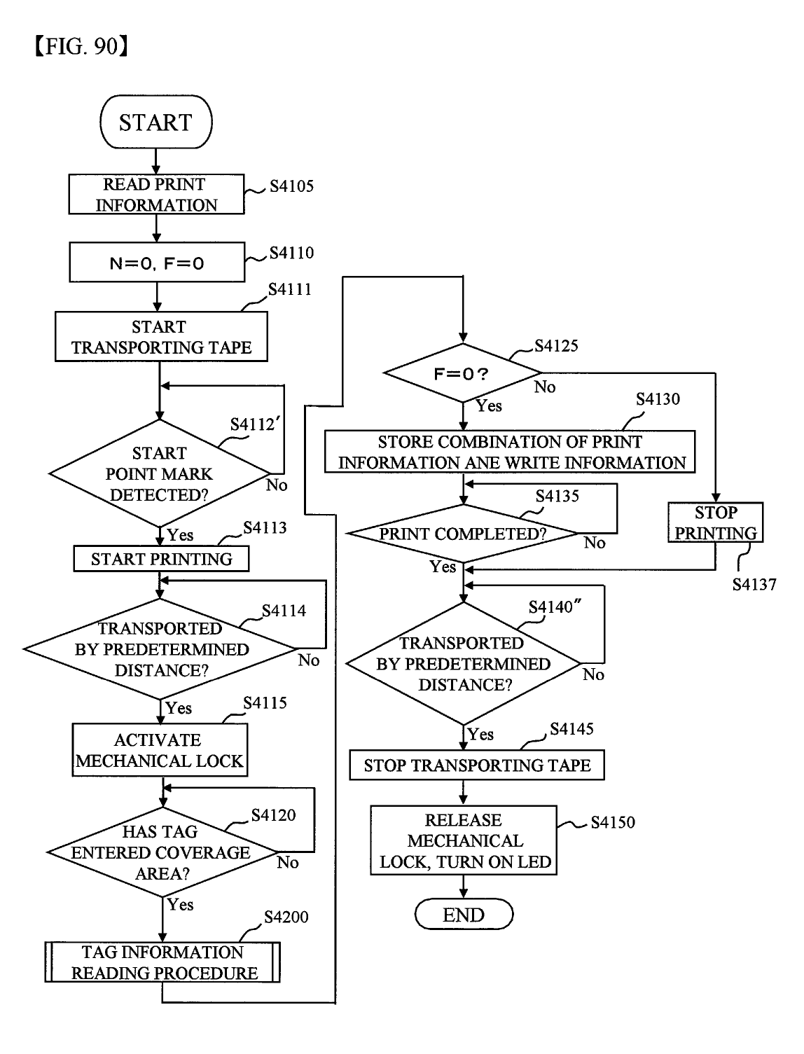

FIG. 90 is a flow chart illustrating a control procedure executed by the control circuit 310 for implementing the foregoing actions in the exemplary modification, and corresponds to FIG. 88 above. Steps equivalent to those in FIG. 88 are designated the same reference numerals, and descriptions thereon are omitted.

Referring to FIG. 90, the flow chart of FIG. 90 differs from the flow chart of FIG. 88 in the exemplary modification (5-3) in that step S4140″ is substituted for step S4140′ in FIG. 88.

In other words, the processing from steps S4105 to S4135 is executed in the same manner as the flow of FIG. 88.

Subsequently, at step S4140″, the control circuit 310 determines whether or not the tag tape 603A has been transported by a predetermined amount from the time the start point trigger mark TM has been detected at step S41121 to a point equivalent to the end point trigger mark TM′ in the exemplary modification (5-3). The determination on the transport distance at this time may also be made, for example, by counting the number of pulses output from the platen roller drive circuit 309 configured to drive the platen roller motor 308 in a manner similar to step S4114 in FIG. 82 in the fifth embodiment. When the control circuit 310 confirms that the tag tape 603A has been transported by the predetermined amount from the pulse counts, the determination at step S4140″ is YES, causing the flow to go to step S4145.

The processing at subsequent steps S4145 and S4150 is similar to the flow of FIG. 82, so that descriptions thereon are omitted.

According to the tag-label producing apparatus 601 of the foregoing exemplary modification, the control circuit 310 recognizes the cut prohibited area F (or cut allowed area G) from the start point information provided by the start point trigger mark TM, and the end point information provided from the number of counts from the start point position (length information), so that the tag-label producing apparatus 601 can provide similar advantages to those of the fifth embodiment. In addition, in comparison with the exemplary modification (5-3), the cut identifier can be locally borne in a more limited area. Accordingly, the cut identifier can be relatively easily borne on the tag tape.

(5-5) Blank Zones Specified in Cut Allowed Area G:

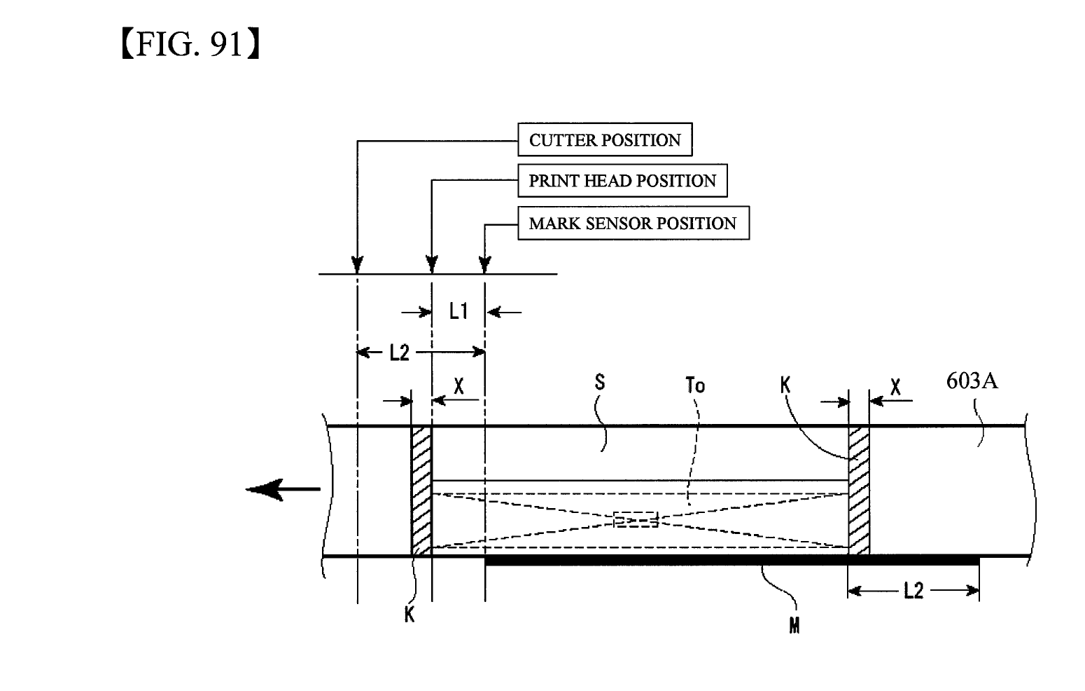

FIG. 91 is a conceptual diagram illustrating in detail the positional relationship among the print area S of the tag tape 603A, the RFID circuit element To, identification mark M, and blank zones K in another exemplary modification. Parts equivalent to those in the fifth embodiment are designated the same reference numerals, and descriptions thereon are omitted.

Referring to FIG. 91, in the illustrated exemplary modification, blank zones K are defined in the cut allowed area G of the tag tape 603A. Each of the blank zone K has a length X from the front or rear end of the cut prohibited area F in the longitudinal direction of the tag tape 603A. In these zones, the tag tape 603A is not cut (even if they fall within the cut allowed area G in which no RFID circuit element To is contained). The blank zones are previously set by the operator using the manipulation key H (see FIG. 83) on a terminal PC external to the tag-label producing apparatus 601 or on the tag-label producing apparatus 601. Though a detailed description is omitted, with the blank zones K thus set, the cutter unit 208 is controlled (locked) not to cut the tag tape 603A in the cut prohibited area F and blank zones K. In this way, the cutter unit 208 can be formed to perform a cutting operation corresponding to the specified blank zone K.

(5-6) Others:

(A) When information is written into RFID circuit element:

While the foregoing description has been made on an exemplary RFID tag manufacturing system which produces read-only RFID tag (not writable), the present invention is not so limited, but can be applied to a RFID tag manufacturing system which involves writing information into the IC circuit part 151 of the RFID circuit element To.

In this event, in a procedure comparable to step S4105 in the aforementioned FIG. 22, information to be written into the IC circuit part 151 of the RFID circuit element To is read in addition to print information on a character which should be printed on the RFID label T by the print head 231. In a procedure comparable to step S4200, the control circuit 30 initializes (erases) the memory for writing RFID tag information including ID information, article information and the like of a specified tag ID (all or part) or identification information, and transmits and writes the RFID tag information to and into the RFID circuit element To. Then, in a procedure comparable to step S4130, a combination of the information written into the RFID circuit element To at step S2200 with the print information previously printed by the print head 231 corresponding thereto is stored in the memory.

This exemplary modification also provides similar advantages to those of the foregoing embodiment when information is written into the IC circuit part 151 of the RFID circuit element To.

(B) When Tag Tape is Bonded to Print-Receiving Tape:

In the foregoing embodiment, a character is printed on the tag tape 603A wound around the tape tube 603B by the print head 231, while information is read from or written into the RFID circuit element To contained in the tag tape 603A, and the resulting tag tape 603A is cut to a predetermined length to produce the RFID label T. The present invention, however, is not so limited. Alternatively, the present invention can also be applied to a label producing apparatus which produces a RFID label by feeding out a tag tape (base tape) fed out from a tag tape roll, where the tag tape contains RFID circuit elements To arranged at predetermined intervals in the longitudinal direction of the tag tape, feeding out a print-receiving tape fed out from a print-receiving tape roll different from the tag tape roll, printing a character on the print-receiving tape by a print head, bonding the tag tape to the print-receiving tape to create a tag label tape with print, and cutting the tag label tape with print to a predetermined length. In this event, the cut identifier, i.e., identification marks M and trigger marks TM, TM′ can be borne on the base tape or on the print-receiving tape. The identifier sensing device may be associated with either the base tape or the print-receiving tape to detect the cut identifiers borne thereon. In these modifications, similar advantages can be provided.

(C) Operation from Outside of Apparatus:

In the foregoing description, part or all of various operations performed through the manipulating device H or the like on the tag-label producing apparatus 601 may be performed from another terminal, a general purpose computer, or the like connected to the tag-label producing apparatus 601 through the communication circuit 311B.

In the respective embodiments and exemplary modifications described above, other than those previously described, instead of producing the RFID label T by cutting the tape 110, 603A, which has undergone the print and access to the RFID circuit element To (for reading or writing) by the cutter 15 or cutter unit 208, 208′, 208″, when label bases (so-called die cut labels) having a predetermined size corresponding to a label and previously separated from one another are borne sequentially on a tape fed out from a roll, the tape may not be cut by the cutter 15 or cutter unit 208, 208′, 208″, but a label base (containing an accessed RFID circuit element To and having a corresponding character printed thereon) may be separated from the tape after it has been discharged from the discharge port 16, E to produce a RFID label T.

In the respective embodiments and exemplary modifications described above, other than those previously described, the present invention may also be applied to a label producing apparatus which prints a character on a print-receiving tape bonded to a tag tape (free from bonding) instead of the label producing apparatus which prints a character on a print-receiving tape 103 different from a tape 101 which contains RFID circuit elements To. The present invention is not limited either to the label producing apparatus which reads or writes RFID tag information from or into the IC circuit part 151 of the RFID circuit element To, and prints a character for identifying the RFID circuit element To by the print head 10, 231. Since such printing may not always be required, the present invention can also be applied to a label producing apparatus which simply reads or writes RFID tag information.

Further, while the foregoing description has been mainly given of an exemplary scenario where a tag tape is wound around a reel member to form a roll, and the roll is loaded in a cartridge, from which the tag tape is fed out, the present invention is not so limited. For example, elongated or rectangular sheets or tapes (including those made by feeding out a tape wound around a roll and cut to an appropriate length), each of which contains at least a one RFID circuit element, may be stacked in a predetermined cartridge (for example, stacked one above another on a tray), which is loaded into a cartridge holder in the label producing apparatus. Then, the sheets or tapes may be individually fed out from the cartridge to undergo the printing and writing procedures to produce RFID labels.

It is also contemplated to removably load the roll directly in the tag-label producing apparatus, or send elongated or rectangular tapes or sheets by a predetermined feeder mechanism external to the tag-label producing apparatus and supply them one by one into the tag-label producing apparatus. Further alternatively, the tag tape is not limited to a cartridge-based form, but a tape roll may not be removable, i.e., may be fixed or integrated in the tag-label producing apparatus. In such alternatives, similar advantages are provided.

It should be noted that the “Scroll All ID” signal, “Scroll ID” signal, “Erase” signal, “Verify” signal, “Program” signal and the like used in the foregoing description conform to the specifications laid down by EPC global. EPC global is a non-profit legal person jointly founded by International EAN Association which is an international organization of distribution code, and uniformed Code Council (UCC) which is a distribution code organization of the United State. Alternatively, such signals may conform to other standards as long as they provide similar functions.

Other than those previously described above, approaches according to the foregoing embodiments and exemplary modifications thereto may be utilized in combination as appropriate.

Though not specifically illustrated, the present invention can be modified in various manners in practices without departing from the spirit and scope of the invention.

Though not individually exemplified, the present invention is put into practice with various changes in a range not departing from its gist.

What is claimed is:

1. An apparatus for producing a label comprising:
a container holder configured to removably hold a label container capable of sequentially supplying a label medium;
a feeding device configured to feed the label medium supplied from said label container; and
a malfunction preventing device configured to prevent malfunctions of said feeding device, or malfunctions of a cutter configured to cut said label medium, or malfunctions of a detecting device configured to detect an object to be detected on said label medium.

2. An apparatus for producing a label according to claim 1, wherein:
said container holder receives said label container which comprises a cartridge for producing a label, said cartridge for producing a label including a first roll having a base tape with an adhesive surface wound around the peripheral surface of a first shaft member, and a second roll having a print-receiving tape wound around the peripheral surface of a second shaft member, said base tape making up said label medium, said print-receiving tape being bonded to said base tape,
said malfunction preventing device comprises a groove or a projection, wherein said first shaft member of said label cartridge includes said groove or said projection formed on at least part of the peripheral surface thereof to prevent malfunctions of said feeding device, and
said apparatus for producing a label is configured to feed out said base tape and said print-receiving tape from said first roll and said second roll, respectively, print a predetermined character on said print-receiving tape, and bond said printed print-receiving tape with said base tape to produce a label.

3. An apparatus for producing a label according to claim 1, wherein:
said container holder receives said label container which comprises a cartridge for producing a label including a third roll and a fourth roll, said third roll including a base tape comprised of a tape base with an adhesive surface disposed on one side in a plane direction of said tape base, said base tape being wound in a circumferential direction such that said base tape is laminated on a radial direction to form said third roll, said fourth roll having a wound print-receiving tape, said base tape and said print-receiving tape making up said label medium, said print-receiving tape being bonded to said base tape,
said malfunction preventing device comprises non-adhesive area included in said base tape in said third roll loaded in said cartridge for producing a label, said non-adhesive area being provided at a tip of said base tape along a winding direction of said base tape, said non-adhesive area having substantially no adhesive force inward in the radial direction, to prevent malfunctions of said feeding device, and
said apparatus for producing a label is configured to feed out said base tape and said print-receiving tape from said third roll and said fourth roll, respectively, print a predetermined character on said print-receiving tape, and bond said printed print-receiving tape with said base tape to produce a label.

4. An apparatus for producing a label according to claim 1, wherein:
said label medium comprises a first marked tape, and said object includes optical information present in a predetermined reading range on at least one side of said first marked tape, wherein said detecting device is configured to detect said optical information when said first marked tape is transported in a longitudinal direction thereof, said first marked tape having a decorative mark and a first identification mark for control borne on said at least one side thereof, and
said malfunction preventing device comprises a mark recognizing device which is configured to recognize said first identification mark on said first marked tape being transported in accordance with the result of a detection made by said detecting device on a first reading range on said at least one side including said first identification mark, and in accordance with the result of a detection made by said detecting device in a second reading range on said at least one side including said decorative mark, to prevent malfunctions of said detecting device.

5. An apparatus for producing a label according to claim 1, wherein:
said label medium comprises a second marked tape, and said object comprises second identification marks arranged at predetermined intervals on a second marked tape, and a lacking portion formed at an end portion of said second marked tape in a transport direction thereof, wherein said detecting device is configured to optically detect said second identification marks and said lacking portion, and
said malfunction preventing device comprises an end recognizing device configured to recognize said end portion of said second marked tape in accordance with said second identification marks and said lacking portion detected by said detecting device to prevent malfunctions of said detecting device.

6. An apparatus for producing a label according to claim 1, wherein:
said label medium comprises a tag tape having a plurality of RFID circuit elements arranged in the longitudinal direction thereof, wherein said feeding device comprises a driving shaft configured to feed out said RFID label,
said cutter cuts said fed tag tape,
said apparatus for producing a label further comprises an identifier sensing device configured to detect a cut identifier defined on said tag tape or a tape adhered for identifying a cut prohibited area and a cut allowed area of said tag tape in correspondence to the position at which said RFID circuit element is disposed on said tag tape, and
said malfunction preventing device comprises a cut limiting device configured to limit said cutter in operation such that said cutter is disabled to cut said cut prohibited area and said cutter is enabled to cut said cut allowed area in correspondence to the fed-out of said tag tape by said driving shaft, in accordance with the result of a detection made by said identifier sensing device, to prevent malfunctions of said cutter.

7. An apparatus for producing a label according to claim 6, wherein:
said cut limiting device is configured to limit a cutting operation of said cutter to said cut prohibited area through a manual action, and allow the cutting operation of said cutter to said cut allowed area through said manual action.

8. An apparatus for producing a label according to claim 6, wherein:
said cut limiting device includes a cutting-operation control device configured to control an automatic cutting operation of said cutter such that said cutter does not cut said cut prohibited area and cuts said cut allowed area.

9. An apparatus for producing a label according to claim 7, further comprising:
a drive control device configured to control said driving shaft such that said driving shaft stops feeding out said tag tape when said cutter opposes said cut allowed area.

10. An apparatus for producing a label according to claim 6, wherein:
said identifier sensing device is configured to detect said cut identifier arranged to represent the overall length of said cut prohibited area or said cut allowed area in the tape longitudinal direction.

11. An apparatus for producing a label according to claim 6, wherein:
said identifier sensing device is configured to detect said cut identifier arranged to represent the position of an end in the tape longitudinal direction of said cut prohibited area or said cut allowed area.

12. An apparatus for producing a label according to claim 11, wherein:
said cut limiting device is configured to limit said cutter in operation in accordance with positional information of said cut identifier detected by said identifier sensing device, and information on the length of said cut prohibited area or said cut allowed area corresponding to said cut identifier in the tape longitudinal direction.

13. An apparatus for producing a label according to claim 6, further comprising:
a tape-type sensing device configured to detect whether or not a tape includes said RFID circuit element; and
a switch-control device configured to switch a carry-out or not the limit of said cutter in operation by said cut limiting device in accordance with the result of detection by said tape-type sensing device.

14. An apparatus for producing a label according to claim 6, wherein:
said cut limiting device is configured to limit said cutter in operation based on a manipulation signal for specifying a position at which said cutter cuts in said cut allowed area.

15. An apparatus for producing a label according to claim 6, further comprising:
printing device configured to print a predetermined character on said tag tape or a print-receiving tape bonded to said tag tape,
wherein said cut limiting device comprises a print-avoiding device configured to limit said cutter in operation in response to a printing operation of said printing device on said tag tape or said print-receiving tape, such that said cutter avoids cutting a printed area by said printing device on said tag tape or said print-receiving tape.

16. An apparatus for producing a label according to claim 6, further comprising:
a display device configured to display whether said cutter opposes said cut prohibited area or opposes said cut allowed area corresponding to said tag tape roll fed out by said driving shaft based on the result of the detection by said identifier sensing device.

17. An apparatus for detecting a mark configured to detect a identification mark for control on a marked tape, said marked tape having said identification mark for control and a decorative mark on at least one side thereof, said apparatus for detecting comprising:
a detecting device configured to detect optical information in a predetermined reading range on said at least one side when said marked tape is transported in a longitudinal direction thereof; and
a recognizing device configured to recognize said identification mark on said marked tape during the transport in accordance with the result of a detection made by said detecting device in a first reading range on said at least one side including said identification mark, and in accordance with the result of a detection made by said detecting device in a second reading range on said at least one side including said decorative mark.

18. An apparatus for detecting a mark according to claim 17, wherein:
said detecting device is operable in a reading area in the tape longitudinal direction, said reading area being smaller than the widths of said identification mark and a blank zone in the tape longitudinal direction, and larger than a maximum length of said decorative mark in the tape longitudinal direction.

19. An apparatus for detecting a mark according to claim 17, wherein:
said marked tape includes a blank zone on said at least one-side surface thereof, defined to be positioned at least one side of the one side and the other side from said identification mark in the tape longitudinal direction between said decorative mark and said identification mark,
wherein said detecting device is configured such that a difference between an output value of a detection signal in said first reading range and an output value of a detection signal in said second reading range has a larger value than a difference between an output value of a detection signal in said blank zone and said output value of a detection signal in said second reading range.

20. An apparatus for detecting a tape end configured to detect an end portion of a marked tape in a direction in which said marked tape is fed out, said marked tape having identification marks arranged at predetermined intervals, said apparatus comprising:
a detecting device configured to optically detect said identification mark and a lacking portion at said end portion of said marked tape; and
an end recognizing device configured to recognize said end portion of said marked tape in accordance with said identification mark and said lacking portion detected by said detecting device.

21. An apparatus for detecting a tape end according to claim 20, wherein:
said end recognizing device is configured to recognize said end portion of said marked tape when said detecting device detects said identification mark, and subsequently detects said lacking portion having a longitudinal length longer than said identification mark.

22. An apparatus for detecting a tape end according to claim 20, wherein:
said end recognizing device is configured to recognize said end portion of said marked tape based on a difference between an output value of a detection signal generated when said detecting device detects said identification mark, an output value of a detection signal generated when said detecting device detects said lacking portion, and an output value of a detection signal generated when said detecting device detects an area other than said identification mark and said lacking portion.

23. An apparatus for detecting a tape end according to claim 20, further comprising:
a light absorbing device configured to absorb an optical detection signal from said detecting device, wherein said light absorbing device is positioned on the opposite side to said detecting device across a feeding path of said marked tape.

24. An apparatus for detecting a tape end according to claim 20, further comprising:
a reflecting device configured to reflect an optical detection signal from said detecting device, wherein said reflecting device is positioned on the opposite side to said detecting device across a feeding path of said marked tape.

25. A cartridge for producing a label comprising:
a first roll having a base tape with an adhesive surface wound around the peripheral surface of a first shaft member, and a second roll having a print-receiving tape wound around the peripheral surface of a second shaft member, said print-receiving tape being bonded to said base tape, said first shaft member including a groove or a projection on at least part of the peripheral surface of said first shaft member; and
said cartridge for producing a label adapted to be removably loaded into an apparatus for producing a label configured to feed out said base tape and said print-receiving tape from said first roll and said second roll, respectively, print a predetermined character on said print-receiving tape, and bond said printed print-receiving tape with said base tape to produce a label,

26. A cartridge for producing a label according to claim 25, wherein:
said print-receiving tape is set to have an overall length longer than an overall length of said base tape.

27. A cartridge for producing a label comprising:
a third roll and a fourth roll, said third roll including a base tape comprised of a tape base with an adhesive surface disposed on one side in a plane direction of said tape base, said base tape being wound in a circumferential direction such that said base tape is laminated on a radial direction to form said third roll, said fourth roll having a wound print-receiving tape, said print-receiving tape being bonded to said base tape,
wherein said tape cartridge is adapted to be removably loaded into an apparatus for producing a label configured to feed out said base tape and said print-receiving tape from said third roll and said fourth roll, respectively, print a predetermined character on said print-receiving tape, and bond said printed print-receiving tape with said base tape to produce a label,
wherein said base tape in said third roll includes a non-adhesive area which has substantially no adhesive force inward in the radial direction, said non-adhesive area being provided at a tip of said base tape along a winding direction of said base tape.

28. A cartridge for producing a label according to claim 27, wherein:
said print-receiving tape includes an extension such that an overall length of said print-receiving tape is longer than an overall length of said base tape.

29. A cartridge for producing a label according to claim 27, wherein:
said base tape of said third roll is a tag tape having a plurality of RFID circuit elements arranged at predetermined intervals in a longitudinal direction.

30. A roll of tape for producing a label having a label tape with an adhesive surface wound around the peripheral surface of a shaft member, the axial direction of which is substantially perpendicular to a longitudinal direction of said label tape,
said shaft member comprises a groove or a projection formed on at least part of the peripheral surface.

31. A roll of tape for producing a label according to claim 30, wherein:
said shaft member comprises a plurality of grooves or projections distributed substantially over the entirety of said peripheral surface.

32. A roll of tape for producing a label according to claim 30, wherein:
said groove or said projection of said shaft member is oriented substantially in parallel with said axial direction of said shaft member.

33. A roll of tape for producing a label according to claim 30, wherein:
said grooves of said shaft member are formed such that a tip of a projection of said shaft member between adjacent ones of said grooves is inclined towards a winding direction of said label tape.

34. A roll of tape for producing a label according to claim 30, wherein:
said projection of said shaft member is formed such that a tip of said projection is inclined towards a winding direction of said label tape.

35. A roll of tape for producing a label according to claim 30, wherein:
said grooves or projections are distributed to a plurality of locations on said peripheral surface of said shaft member.

36. A roll of tape for producing a label according to claim 35, wherein:
said grooves or projections are formed in both end portions of said peripheral surface in the axial direction.

37. A roll of tape for producing a label according to claim 30, wherein:
said label tape comprises a tag tape having a plurality of RFID circuit elements arranged at a plurality of locations at predetermined intervals in the longitudinal direction, said tag tape being wound around said peripheral surface of said shaft member.

38. A roll of tape for producing a label having a label tape comprised of a tape base with an adhesive surface disposed on one side in a plane direction of said tape base, said label tape being wound in a circumferential direction such that said label tape is laminated on a radial direction to form said roll of tape for producing a label,
wherein said label tape includes anon-adhesive area which has substantially no adhesive force inward in the radial direction, said non-adhesive area being provided at a tip of said label tape along a winding direction of said label tape.

39. A roll of tape for producing a label according to claim 38, wherein:
said tip of said label tape along a winding direction of said label tape comprises a turned edge formed by folding back an end of a laminate structure including said tape base and said adhesive surface in the longitudinal direction of said label tape such that said tape base is positioned on the innermost side in the radial direction of said roll.

40. A roll of tape for producing a label according to claim 38, wherein:
said tip of said label tape along a winding direction of said label tape comprises a first non-adhesive member which is disposed at an end of the laminate structure including said tape base and said adhesive surface in the longitudinal direction of said label tape to cover said adhesive surface.

41. A roll of tape for producing a label according to claim 38, wherein:
said tip of said label tape along a winding direction of said label tape comprises a second non-adhesive member disposed at an end of the laminate structure including said tape base and said adhesive surface in the longitudinal direction of said label tape to extend said tape.

42. A roll of tape for producing a label according to claim 38, wherein:
said tip of said label tape along a winding direction of said label tape a length in the longitudinal direction of said label tape long enough to circle at least once in the circumferential direction along the direction in which said label tape is wound.

43. A roll of tape for producing a label according to claim 38, further comprising:
a shaft member having an axial direction substantially perpendicular to the longitudinal direction of said label tape, said adhesive surface of said label tape being wound around the peripheral surface of said shaft member.

44. A roll of tape for producing a label according to claim 43, wherein:
said shaft member comprises an engaging recess into which said non-adhesive area is inserted for engagement therewith.

45. A roll of tape for producing a label according to claim 38, wherein:
said label tape is wound such that a hollow is formed inside of the radially innermost portion including said tip of said label tape along a winding direction of said label tape.

46. A roll of tape for producing a label according to claim 38, wherein:
said label tape comprises a tag tape having a plurality of RFID circuit elements arranged at predetermined intervals in a longitudinal direction.

47. A roll of tape for producing a label having a label tape wound around a shaft member having an axial direction substantially perpendicular to a longitudinal direction of said label tape, wherein:
said label tape comprises:
identification marks arranged at predetermined intervals; and
a cutout formed at an end portion of said label tape in a direction in which said label tape is fed out.

48. A roll of tape for producing a label according to claim 47, wherein:
said identification marks are made optically distinguishable from the rest of said tape.

49. A roll of tape for producing a label according to claim 47, wherein:
said cutout formed through said label tape has a length in the longitudinal direction of said label tape larger than a length of said identification mark in the longitudinal direction of said label tape.

50. A roll of tape for producing a label according to claim 47, wherein:
said label tape comprises a plurality of cutouts.

51. A roll of tape for producing a label according to claim 47, wherein:
said label tape is fixed to said shaft member at said end portion in the direction in which said label tape is fed out.

52. A roll of tape for producing a label according to claim 47, wherein:
said label tape is removably engaged with said shaft member at said end portion in the direction in which said label tape is fed out.

53. A roll of tape for producing a label according to claim 47, wherein:
said label tape comprises a tag tape having a plurality of RFID circuit elements arranged at a predetermined pitch in the longitudinal direction, and
said identification marks are borne on said label tape corresponding to said RFID circuit elements arranged at the predetermined intervals.

54. A roll of tape for producing a label according to claim 53, wherein:
said label tape has said plurality of RFID circuit elements provided in a tape base layer, and
said identification marks are borne on a separation material layer, said separation material layer covering an affixing adhesive layer configured to adhere said base layer to an object to affix, said separation material layer being detachably laminated on said affixing adhesive layer.

55. A roll of tape for producing a label according to claim 47, wherein:
the distance between said cutout and said identification mark closest thereto is shorter than the distance between adjacent ones of said identification marks.

56. A marked tape having a decorative mark and an identification mark for control, said marks being borne on at east one side thereof, wherein:
said decorative mark and said identification mark are set in terms of at least one of size, color, and character/figure pattern thereof, corresponding to a reading range of a detecting device configured to optically detect said identification mark, such that a predetermined difference is found in detection results when said detecting device reads said decorative mark and when said detecting device reads said identification mark.

57. A marked tape according to claim 56, further comprising:
a plurality of RFID circuit elements arranged at predetermined intervals in the longitudinal direction in correspondence to said identification marks.

58. A marked tape according to claim 56, wherein:
said identification mark has a dimension which is set larger than said reading range of said detecting device.

59. A marked tape according to claim 56, comprising:
a blank zone positioned on said at least one-side surface thereof, defined to be positioned at least one side of the one side and the other side from said identification mark in the tape longitudinal direction between said decorative mark and said identification mark.

60. A marked tape according to claim 59, wherein:
said blank zone has a longitudinal dimension larger than the reading range of said detecting device.

61. A marked tape according to claim 56, wherein:
said identification marks are slantly provided at a predetermined angle to the width direction of said marked tape.
